(19) United States
(12) Patent Application Publication
(10) Pub. No.: US 2024/0403619 A1
(43) Pub. Date: Dec. 5, 2024

(54) NEUROMORPHIC ARTIFICIAL NEURAL NETWORK ARCHITECTURE BASED ON DISTRIBUTED BINARY (ALL-OR-NON) NEURAL REPRESENTATION

(71) Applicant: SilicoSapien Inc., Lewes, DE (US)

(72) Inventor: Youssef Mahmoud Massoud Shaiba Nassar, 6th Of October City (EG)

(73) Assignee: SilicoSapien Inc., Lewes, DE (US)

(21) Appl. No.: 18/802,585

(22) Filed: Aug. 13, 2024

Related U.S. Application Data
(63) Continuation-in-part of application No. PCT/US23/62482, filed on Feb. 13, 2023.
(60) Provisional application No. 63/267,968, filed on Feb. 14, 2022.

(51) Int. Cl. G06N 3/0499; G06N 3/088

(52) U.S. Cl. CPC G06N 3/0499; G06N 3/088

(57) ABSTRACT

An artificial neuromorphic neural network architecture including a feedforward connectivity structure and/or a lateral connectivity structure, a method of processing input signals with an artificial neuromorphic neural network architecture, and a generalization process. An architecture takes in as inputs a set numerical representation of raw sensory data, represented by a binary set of receptive nodes whereby, following a set of algorithms and using a particular connectivity structure achieves a set of output nodes which abstracts and generalizes efficiently over the sensory data without a need for optimization and via the introduction of selective nodes. The architecture also includes a secondary layer of connectivity structure which takes in as input a set of distributed selective nodes and produces a set of collective connectivity amongst said set of selective nodes, which results into collective excitation and collective inhibition behaviors amongst the connected nodes.

### CROSS-REFERENCE TO RELATED APPLICATIONS

This application is filed under 35 U.S.C. §§ 111 (a) and 365 (c) as a continuation-in-part application of International Patent Application No. PCT/US2023/062482, filed on Feb. 13, 2023, which application claims the benefit under 35 U.S.C. § 119 (c) of U.S. Provisional Patent Application No. 63/267,968, filed on Feb. 14, 2022, which applications are incorporated herein by reference in their entireties.

### FIELD OF THE DISCLOSURE

This application relates to an architecture and systems and methods for implementing artificial neural networks, and in particular, to implementing an artificial neural network with connections that associate qualitative elements of sensory inputs through distributed qualitative neural representations and replicating neural selectivity.

### BACKGROUND

The development of neural network architectures took a few different trajectories, one of which is the development of neural network architectures that are based on some form of associative memory. This includes neural network architectures like, BAM networks (hetero-associative memory), Hebbian learning based networks, Hopfield networks (auto-associative memory), and Boltzmann machines.

Another trajectory which the engineering of artificial neural network took is the development of neural network architectures that are based on some form of optimization technique, mainly backpropagation, and this includes, multi-layer perceptrons, artificial neural networks, convolution neural networks, recurrent neural networks, generative adversarial neural networks, autoencoders and many more.

In the past decade, research and development of neural network architectures was heavily focused on the use of optimization in neural networks, as optimization-based neural networks have shown significant utility in a wide array of subject domains, and performed more accurately than any previous models in some domains despite high performance costs.

A classical example would be image classification in the domain of computer vision, which convolution neural network architectures dominated as a result of their significantly high precision and accuracy in accomplishing the task. Another example would be speech recognition in the natural language processing domain, where recurrent neural network architectures reign supreme.

On the other hand, the utilization of associative memory based neural network architectures in tasks like image classification or speech recognition has been neglected in favor of optimization, whereas optimization became almost the only possible technique used in the learning algorithm of a typical state of the art neural network architecture that tackles such complex tasks in these domains.

Traditional neural network architectures follow an optimization-based learning algorithm, where they are geared towards error driven learning. While error driven learning is considered a form of learning that the mammalian brain architecture employs on the macro level across cortical lobes (via inter-cortical neural communications) where it occurs via reinforcement behaviors through a network of connections spanning the basal ganglia, the nucleus accumbens and the orbitofrontal cortex, it is not the more general form of learning utilized by the mammalian brain architecture on the micro level across individual neurons within a given cortical lobe in the neocortex (via intra-cortical neural communications).

The mammalian neural network architecture, employs an association based on repetition learning model as opposed to an error driven learning model on the micro level across individual neurons that belong to the same cortical lobe.

Information in a mammalian neural network architecture is represented through the formation of associations which occur between a set of distributed binary neurons, and is retained through the modulation of these associations based on the frequency of appearance of such information, and not through any form of cost minimization that are based on quantitatively represented features learned via minimizing cost values.

In other words, in the mammalian neural network architecture, information is stored, maintained and modulated through webs of connections under the influence of direct experience and based on the persistence of such information in the environment.

In optimization-based neural networks, the input nodes represent numerical values (quantitative values) associated to the qualitative features of the input as representations of such qualitative features (e.g., pixel colors (qualitative) translated into numerical values (quantitative)).

Such quantitative turned qualitative features act as data points that can be statistically segregated from other data points through fitting an N dimensional hyperplane (or its nonlinear equivalent curve) represented by a mathematical function all within the confine of some N+ dimensional space domain where the data points are scattered.

The structure of the hyperplane (or its nonlinear equivalent curve) function, is dictated by the hyperparameters of this network which include first and foremost the structure of the connections as well as other hyperparameters like the activation function and the number of layers. How well the function segregates the scattered data points is dictated by how well the optimization-based neural network architecture is trained.

The weights/connections in an optimization-based neural network architecture, merely play the role of knobs that adjust the N dimensional slope and axes intercepts of the N dimensional hyperplane (or its nonlinear equivalent curve) function within the N+ dimensional hyperspace domain. This is because these weights are by definition the slope variable of the N dimensional function.

Adjusting these weights in an optimization-based learning algorithm typically involves minimizing the cost function, that is itself the N dimensional hyperplane (or its nonlinear equivalent curve) function as a function of a quantitatively measured error.

The learning algorithm in error driven learning can be visualized as playing the role of warping the N dimensional hyperplane (or its nonlinear equivalent curve) around the data points which are being fed such that it creates generalized mathematical boundaries around each cluster of data points that belong to one predefined class.

This is possible only when there is a statistically significant correlation between the different quantitatively represented data points across a given class/set and happens in the training phase of the network.

The mammalian brain however, is not a quantitative machine which calculates and compares statistically significant quantitatively represented features, but rather directly deals with qualitative features and compares them qualitatively not quantitatively.

On this work we stay true to the nature of biological network processing, first, by using connections not as a means to calculate and optimize but as a mean to associate qualitative elements of sensory inputs through distributed qualitative neural representations, and second, by replicating an important feature in biological neural networks, which is neural selectivity.

There are two fundamental processes which govern mammalian learning and which all mammalian intelligent behaviors are bound by, these are, recollection, which is tasked with the retention of information and its retrieval, and recognition, which is tasked with the classification of information and generalization.

In the mammalian brain, the use of connections as a means to associate qualitative elements of sensory inputs through distributed qualitative neural representations is the basis by which the process of recollection works, whilst the process of neural selectivity is the basis by which the process of recognition works.

In this application, we replicate such processes in our newly introduced neural network architecture, the neuromorphic neural network architecture (NNN) and we introduce a new learning method based on neural selectivity.

### SUMMARY OF THE DISCLOSURE

The present disclosure is directed to systems and methods for implementing artificial neural networks with connections that associate qualitative elements of sensory inputs through distributed qualitative neural representations and replicating neural selectivity.

An artificial neuromorphic neural network architecture which takes in as inputs a set of numerical representation of raw sensory data, represented by a binary set of receptive nodes whereby, following a set of algorithms and using a particular connectivity structure achieves a set of output nodes which abstracts and generalizes efficiently over the sensory data without a need for optimization by mimicking the mammalian brain's process of selectivity and via the introduction of selective nodes, thereby mimicking the cognitive tasks of mammalian brain generalization and mammalian brain classification and recognition.

The architecture also comprises a secondary layer of connectivity structure which takes in as input a set of distributed selective nodes and produces a set of collective connectivity amongst said set of selective nodes, which results into collective excitation and collective inhibition behaviors amongst the connected nodes, mimicking the cognitive tasks of mammalian brain's processes of recollection and memory formation.

Generally, in one aspect, an artificial neural network architecture is provided. The architecture includes a pair of layers comprising first and second layers; a plurality of transmitter nodes and a plurality of receiver nodes arranged within the pair of layers, each of the transmitter and receiver nodes comprising an activity state variable, a first positive accumulator variable, a first negative accumulator variable, and a weighted sum variable; a first combination of connection pairs arranged between the pluralities of transmitter and receiver nodes to connect a transmitter node in the first layer with a receiver node in the second layer, the first combination of connection pairs comprising a first connection pair and a second connection pair; first and second unidirectional influencer connections of the first and second connection pairs, respectively, configured to influence the activity state variable of the receiver node in the second layer; and messenger connections of the first and second connection pairs configured to detect time dependent correlations of activity states relating to the transmitter node in the first layer and the receiver node in the second layer. The first and second unidirectional influencer connections of the first and second connection pairs, respectively, are configured to increment the first positive accumulator variable and the first negative accumulator variable, respectively, of the receiver node in the second layer at least partially based on a weight value of the connection, where the weight variables are modulated according to the time dependent correlations of activity states detected by the messenger connections of the first and second connection pairs, respectively.

In an example, the first and second unidirectional influencer connections are configured to influence the activity state variable of a receiver node in the plurality of receiver nodes.

In an example, the weighted sum variable of a receiver node of the plurality of receiver nodes comprises a value which represents a difference between the positive accumulator variable and the negative accumulator variable of the receiver node and the value generates an influence on the activity state variable of the receiver node.

In a further example, the influence on the activity state variable occurs according to a rate that is directly proportional to a value stored in the weighted sum variable.

In an example, each of the first and second unidirectional influencer connections comprises a weight variable and an influence latency variable representing a transmission time delay of influence and each of the messenger connections comprises a messaging latency variable representing a transmission time delay of messaging.

In a further example, each of the first and second unidirectional influencer connections is configured to increment the positive accumulator variable or the negative accumulator variable of the receiver node in the plurality of receiver nodes, the increment being proportional to its weight variable and after a time equal to its transmission time delay of influence.

In an example, the first and second unidirectional influencer connections comprise an influencer excitatory connection and the messenger connections comprise a messaging excitatory connection, and the time dependent correlation of activity states is detected by the messaging excitatory connection and registered if a message signal is sent through the messaging excitatory connection after a time period equal to the transmission time delay of messaging, the message signal is sent when the receiver node is active, and the transmitter node is active before or while the receiver node is active.

In a further example, the time period is measured from a moment of activation of the transmitter node in the plurality of transmitter nodes.

In an example, the first and second unidirectional influencer connections comprise an influencer reverse inhibitory connection and the messenger connections comprise a messaging reverse inhibitory connection, and the time dependent correlation of activity states is detected by the messaging reverse inhibitory connection and registered if a message signal is sent through the messaging reverse inhibitory connection after a time period equal to the transmission time delay of messaging, the message signal is sent when the transmitter node is inactive, and the transmitter node is inactive before or while the receiver node is active.

In a further example, the time period is measured from a moment of inactivation of the transmitter node in the plurality of transmitter nodes.

Generally, in another aspect, an artificial neural network architecture is provided. The architecture includes a pair of layers comprising first and second layers; a first plurality of transmitter nodes and a first plurality of receiver nodes arranged within the first and second layers of the pair of layers, each transmitter node and each receiver node of the first pluralities of transmitter and receiver nodes comprising a first activity state variable, a first positive accumulator variable, a first negative accumulator variable, and a weighted sum variable; a second plurality of transmitter nodes and a second plurality of receiver nodes arranged within the first or second layer of the pair of layers, each transmitter node and each receiver node of the second pluralities of transmitter and receiver nodes comprising a second activity state variable, a second positive accumulator variable, a second negative accumulator variable, and a quotient variable; a combination of feedforward connection pairs arranged to connect a transmitter node in the first plurality of transmitter nodes and a receiver node in the first plurality of receiver nodes, the feedforward connection pairs comprising unidirectional influencer connections and messenger connections; and a combination of lateral connection pairs arranged to connect a transmitter node in the second plurality of transmitter nodes and a receiver node in the second plurality of receiver nodes, the lateral connection pairs comprising unidirectional influencer connections and messenger connections. The unidirectional influencer connections of the feedforward connection pairs are configured to increment the first positive accumulator variable or the first negative accumulator variable of the first plurality of transmitter and receiver nodes at least partially based on a first time dependent correlation of activity states detected by a messenger connection of the feedforward connection pairs. Additionally, the unidirectional influencer connections of the lateral connection pairs are configured to modulate the second positive accumulator variable and the second negative accumulator variable, respectively, of the second plurality of transmitter and receiver nodes at least partially based on a second time dependent correlation of activity states detected by the messenger connections of the lateral connection pairs.

In an example, the unidirectional influencer connections of the lateral connection pairs comprise an influencer normal inhibitory connection and the unidirectional messenger connections of the lateral connection pairs comprise a messaging normal inhibitory connection, and the second time dependent correlation of activity states is detected by the messaging normal inhibitory connection and registered if a message signal is sent through the messaging normal inhibitory connection after a time period equal to the transmission time delay of messaging, the message signal is sent when the transmitter node is active, and the transmitter node is active before or while the receiver node is inactive.

In an example, the influence on the activity state variable occurs according to a rate that is directly proportional to a value stored in the quotient variable.

Generally, in yet another aspect, an artificial neural network architecture is provided. The architecture includes a receptive layer that is dissected into a predefined amount of spatial kernels, each spatial kernel encompassing a predefined amount of receptive cells, each receptive cell comprising a predefined amount of receptive nodes; and a selective layer that is dissected into a plurality of selective cells, each selective cell comprising a predefined amount of selective nodes. The receptive layer is configured to transmit information to the selective layer. Additionally, at least one selective cell of the plurality of selective cells of the selective layer encompasses a pre-allocated size of a receptive field that represents boundaries of a spatial kernel of the receptive layer.

In an example, at least two receptive nodes of a receptive cell that belongs to the spatial kernel form feedforward connection pairs with at least one selective node of the at least one selective cell, and a first feedforward connection pair of the feedforward connection pairs comprises a first transmission time delay value that is the same as a second transmission time delay value of a second feedforward connection pair of the feedforward connection pairs.

In an example, a selective node of the at least one selective cell is configured to receive feedforward connection pairs from each receptive node of each receptive cell of the spatial kernel, the selective node configured to receive a first feedforward connection pair of the feedforward connection pairs from a first receptive cell of the spatial kernel and a second feedforward connection pair of the feedforward connection pairs from a second receptive cell of the spatial kernel, wherein the first and the second feedforward connection pairs comprise first and second transmission time delay values that are equivalent to each other.

In an example, each selective node of the at least one selective cell is configured to receive feedforward connection pairs from each receptive node of each receptive cell of the spatial kernel, a first selective node of the at least one selective cell is configured to receive a first feedforward connection pair of the feedforward connection pairs from a first receptive cell of the spatial kernel, a second selective node of the at least one selective cell, different than the first selective node, is configured to receive a second feedforward connection pair of the feedforward connection pairs from a second receptive cell of the spatial kernel, wherein the first and the second feedforward connection pairs comprise first and second transmission time delay values that are different from each other.

In an example, at least one selective node of the selective nodes comprises at least one dual-state gate that represents one receptive cell and feedforward connections from the one receptive cell, and wherein the at least one dual-state gate is configured to block the information transmitted through messenger connections from the receptive layer in a first state and allow the information transmitted through messenger connections from the receptive layer in a second state.

In a further example, the at least one dual-state gate is configured to turn on if it receives information from an excitatory influencer connection only if the influencer excitatory connection projects from a layer that is at least two layers before the layer which receives the information.

In yet a further example, the at least one dual-state gate is configured to turn off if it does not receive information from an excitatory influencer connection that projects from a layer that is at least two layers before the layer which receives the information.

Generally, in a further aspect, a method of processing input signals with an artificial neural network architecture is provided. The method includes providing pluralities of transmitter and receiver nodes in a pair of layers comprising first and second layers; providing a combination of connection pairs to connect the pluralities of transmitter and receiver nodes, the combination of connection pairs comprising first and second unidirectional influencer connections; connecting the combination of connection pairs between a transmitter node in the first layer with a receiver node in the second layer; detecting time dependent correlations of activity states relating to the transmitter node in the first layer and the receiver node in the second layer via messenger connections of the combination of connection pairs; and influencing a positive accumulator variable and a negative accumulator variable in the receiver node in the second layer via the first and the second unidirectional influencer connections of the combination of connection pairs, respectively, according to a weight value that is based at least in part on the detected time dependent correlations of activity states detected.

In an example, influencing the positive accumulator variable and the negative accumulator variable in the receiver node in the second layer comprises incrementing the variables in proportion to weight values of the first and the second unidirectional influencer connections, respectively, and after a time equal to a transmission time delay of influence of the first and the second unidirectional influencer connections, respectively.

In an example, incrementing the positive accumulator variable and the negative accumulator variable by the first and the second unidirectional influencer connection, respectively, comprises incrementing the positive accumulator variable according to a linear growth function and the negative accumulator variable at least according to an exponential growth function.

In a further example, the incrementing for the second unidirectional influencer connection comprises an exponential growth function followed by a linear growth function after a defined point, and the first and second unidirectional influencer connections are initially set to different strength values.

In an example, the positive accumulator variable and the negative accumulator variable are decremented by the first and the second unidirectional influencer connections, respectively, and decrementing the positive accumulator variable is according to a linear decay function and decrementing the negative accumulator variable is at least according to an exponential decay function.

In a further example, the decrementing of the second unidirectional influencer connection comprises a linear decay function followed by an exponential decay function after a defined point, and the first and second unidirectional influencer connections are initially set to different strength values.

In an example, subtracting a value in the negative accumulator variable from a value in the positive accumulator variable of the receiver node in the second layer and storing a result of the subtraction in the weighted sum variable of the receiver node in the second layer.

Generally, in still a further aspect, a method of processing input signals with an artificial neural network architecture is provided. The method includes providing pluralities of transmitter and receiver nodes in at least one layer; providing a combination of connection pairs to connect the pluralities of transmitter and receiver nodes, the combination of connection pairs comprising first and second unidirectional influencer connections; connecting the combination of connection pairs between a transmitter node and a receiver node in the at least one layer; detecting time dependent correlations of activity states relating to the transmitter and receiver nodes in the at least one layer via messenger connections of the combination of connection pairs; and influencing a positive accumulator variable and a negative accumulator variable in the receiver node in the at least one layer via the first and second unidirectional influencer connections of the combination of connection pairs, respectively, based at least in part on the detected time dependent correlations of activity states.

In an example, influencing the positive accumulator variable and the negative accumulator variable in the receiver node in the at least one layer comprises modulating the variables in proportion to weight values of the first and second unidirectional influencer connections, respectively, and after a time equal to a transmission time delay of influence of the first and second unidirectional influencer connections, respectively.

In a further example, incrementing the positive accumulator variable and the negative accumulator variable by the first and the second unidirectional influencer connection, respectively, comprises incrementing according to a linear growth function.

In a further example, the positive accumulator variable and the negative accumulator variable are decremented by the first and the second unidirectional influencer connections, respectively, wherein the decrementing is according to a linear decay function.

In an example, dividing a total magnitude of signals stored in the positive accumulator variable by a total magnitude of signals stored in the negative accumulator variable in the receiver node in the at least one layer, subtracting a value from a result of the division, and storing a result in the quotient variable of the receiver node in the at least one layer.

Generally, in a further example aspect, a generalization process is provided. The process includes forming, by two or more nodes that belong to at least one layer, feedforward connections with a common selective node or a common group of selective nodes, and each of the two or more nodes form the feedforward connections independently and at different instances of time; and independently activating, by the two or more nodes, the common selective node or the common group of selective nodes thereby strengthening the feedforward connections formed between the two or more nodes and the common selective node or the common group of selective nodes.

In an example, the process further includes comparing a first frequency of activation of the common selective node or a first node of the common group of selective nodes to a second frequency of activation of the common selective node or a second node of the common group of selective nodes; and weakening, using a decay function, a feedforward connection between the two or more nodes and the common selective node or the first node of the common group of selective nodes when the first frequency of activation is less than the second frequency of activation.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic graphical representation of a spike-time dependent synaptic plasticity modulation graph, in accordance with aspects of the present disclosure.

FIG. 2 is a schematic graphical representation of an example modified spike-time dependent synaptic plasticity modulation graph, in accordance with aspects of the present disclosure.

FIG. 3A shows schematic graphical representations of an example modified spike-time dependent synaptic plasticity modulation graph paired with an example activity graph, in accordance with aspects of the present disclosure.

FIG. 3B shows schematic graphical representations of an example modified spike-time dependent synaptic plasticity modulation graph paired with an example activity graph, in accordance with aspects of the present disclosure.

FIG. 3C shows schematic graphical representations of an example modified spike-time dependent synaptic plasticity modulation graph paired with an example activity graph, in accordance with aspects of the present disclosure.

FIG. 4A shows a schematic representation of receptive cells in a 3×3 kernel bound region, each receptive cell containing two nodes per cell labeled “on” and “off”, in accordance with aspects of the present disclosure.

FIG. 4B shows a schematic representation of the node pairs of the receptive cells of FIG. 4A, with connections from a center node to all other surrounding node pairs, in accordance with aspects of the present disclosure.

FIG. 4C shows a schematic representation of an activation map for the nodes of FIGS. 4A and 4B as a result of the network perceiving a white horizontal line amidst a black surrounding area within a 3×3 patch of its visual perception, in accordance with aspects of the present disclosure.

FIG. 4D shows a schematic representation of strengthening connections between all the nodes of FIGS. 4A, 4B, and 4C which happen to be active simultaneously, in accordance with aspects of the present disclosure.

FIG. 5 shows a schematic representation of three layers of nodes according to an artificial neuromorphic neural network, in accordance with aspects of the present disclosure.

FIG. 6 shows columns representing layers of nodes according to an artificial neuromorphic neural network, in accordance with aspects of the present disclosure.

FIG. 7 shows a schematic representation of a single example receptive kernel and an example selective cell where each connection from a receptive cell to a selective cell includes a feedforward specialization connection pair, in accordance with aspects of the present disclosure.

FIG. 8 shows a schematic graphical representation of a number of stimulus encounters over time relative to strength values as growth functions for reverse inhibitory connections and excitatory connections to show a gradual increase in selectivity, in accordance with aspects of the present disclosure.

FIG. 9A shows a schematic graphical representation of long-term potentiation including field postsynaptic potentials plotted as a percent amplitude from baseline and as a function of time, in accordance with aspects of the present disclosure.

FIG. 9B shows a schematic graphical representation of long-term potentiation based on example first and second pulses that are separated by no more than a predefined duration of time to demonstrate a compounding effect of net amplitude change, in accordance with aspects of the present disclosure.

FIG. 10 shows an example schematic representation of excitatory and reverse inhibitory connection types between an example receptive kernel of a first layer and its corresponding selective cell, along with example normal inhibitory connections between selective nodes of the selective cell, in accordance with aspects of the present disclosure.

FIG. 11 shows an example schematic representation of nodes of example neural network layers that use segmentation and transpassing connections to represent an object of focus while disregarding noise information, in accordance with aspects of the present disclosure.

FIG. 12A shows an example object of focus within a canvas, in accordance with aspects of the present disclosure.

FIG. 12B shows example nodes on a first layer of an example neural network encompassing individual parts of the object of focus of FIG. 12A and an example node on a second layer of the example neural network receiving input from the nodes on the first layer via transpassing connections to encompass the entirety of the object of focus of FIG. 12A, in accordance with aspects of the present disclosure.

FIGS. 13A-13D show example receptive field regions that can be perceived by a visual implementation of an artificial neuromorphic neural network architecture, in accordance with aspects of the present disclosure.

FIG. 14 shows example receptive nodes connected to a selective node via a bus of three feedforward specialization connection pair, each having a different latency value, in accordance with aspects of the present disclosure.

FIG. 15 shows an example representation of the activation of different input selective nodes based on perception of different visual objects, where the different input selective nodes are connected to an output selective node, in accordance with aspects of the present disclosure.

FIG. 16 shows example nodes on first, second, and third layers using example latency values, in accordance with aspects of the present disclosure.

FIG. 17 shows a plurality of nodes each node connected to another with a bus of connections, in accordance with aspects of the present disclosure.

FIG. 18 shows an example result after pruning most of the connections shown in FIG. 17, in accordance with aspects of the present disclosure.

FIG. 19 shows a plurality of nodes including activated and unactivated nodes and including connection arrows which represent the set of nodes a given node has influence over and the direction of said influence, in accordance with aspects of the present disclosure.

FIG. 20 shows another plurality of nodes similar to FIG. 19 except the active nodes are concentrated within the bottom left side of the node plurality, in accordance with aspects of the present disclosure.

FIG. 21 shows an example set of twelve nodes arranged in a 3×4 grid and two directions of activation influence, in accordance with aspects of the present disclosure.

FIG. 22 shows an example plurality of nodes represented as a single web within a receptive patch which takes the form of a vase and directions of activation influence, in accordance with aspects of the present disclosure.

FIG. 23 shows an example plurality of nodes and the connections between the nodes, in accordance with aspects of the present disclosure.

FIG. 24 shows a simple example of share-ability across a basic layered neural network structure, in accordance with aspects of the present disclosure.

FIG. 25 shows exemplary illustrations of vehicles that share a few common features and a web structure for each illustration, each web structure including a set of selective nodes, in accordance with aspects of the present disclosure.

FIG. 26 shows an example implementation of an excitatory influencer connection using a transistor in an electric circuit with current flowing in the positive direction, a diode, a memristor, an accumulator as well as a small voltage supplier, all present on the circuit, in accordance with aspects of the present disclosure.

FIG. 27 shows an example implementation of an excitatory messenger connection, an electrical circuit which connects to the terminals of the memristor from the circuit in FIG. 26, where the circuit is characterized by two transistor gates, as well as a negative voltage supplier, in accordance with aspects of the present disclosure.

FIG. 28 shows an example circuit responsible for executing a decay function, in accordance with aspects of the present disclosure.

FIG. 29 shows the circuits of FIGS. 26, 27, and 28, all on top of each other to demonstrate a holistic view of an example normal excitatory connection, in accordance with aspects of the present disclosure.

FIG. 30 shows a large exemplary circuit which represents a node, two positive accumulators, and two negative accumulators, where the circuit is configured to supply influencer and messenger connections, in accordance with aspects of the present disclosure.

FIG. 31 depicts three shapes arranged in three opposing directions.

FIG. 32 depicts an elevational view of a Necker cube.

FIG. 32A depicts the Necker cube of FIG. 32 from the perspective of a first vantage point and FIG. 32B depicts the Necker cube of FIG. 32 from the perspective of another vantage point.

FIG. 33 shows an example entire learning curve of a selective node on a feedforward connectivity structure, in accordance with aspects of the present disclosure.

FIG. 34 shows an example selective node encompassing receptive areas in a plurality of layers, in accordance with aspects of the present disclosure.

FIG. 35 shows a set of forward connectivity paths from one layer onto other layers, the set of forward connectivity paths including direct and residual connections, and a set of nodes for each layer exhibiting the information received from the direct and residual connections, in accordance with aspects of the present disclosure.

FIG. 36 shows three layers of nodes including a layer of receptive nodes, a layer of selective nodes, and a selective pool region, in accordance with aspects of the present disclosure.

FIG. 37 shows a graph of example respective major clock periods at which each of a plurality of selective nodes that belong to a given selective pool arranged in sequence is activated, in accordance with aspects of the present disclosure.

FIG. 38 shows another graph of example respective major clock periods at which each of a plurality of selective nodes that belong to a given selective pool arranged in sequence is activated, in accordance with aspects of the present disclosure.

FIG. 39 shows an example stimulus of a digit on a grid of binary cells, in accordance with aspects of the present disclosure.

FIG. 40 shows 6 stimuli representing the possible combinations of white and black single full horizontal lines in a grid of binary cells, in accordance with aspects of the present disclosure.

FIG. 41 shows 6 stimuli representing different combinations of white and black knots and crosses in a grid of binary cells, in accordance with aspects of the present disclosure.

FIG. 42 shows 6 stimuli representing the possible combinations of white and black single full vertical lines in a grid of binary cells, in accordance with aspects of the present disclosure.

FIG. 43 shows the stimulus of a digit of FIG. 39 on a receptive grid of binary cells where each cell can either be black or white, in accordance with aspects of the present disclosure.

FIG. 44 illustrates two layers of receptive nodes in generalization processes, in accordance with aspects of the present disclosure.

FIG. 45 depicts a process of sensory abstraction on an iteration in generalization processes, in accordance with aspects of the present disclosure.

FIG. 46 depicts another iteration of receptive nodes in generalization processes, in accordance with aspects of the present disclosure.

FIG. 47 shows a generalization process involving independent activation of a selective node, in accordance with aspects of the present disclosure.

### DETAILED DESCRIPTION

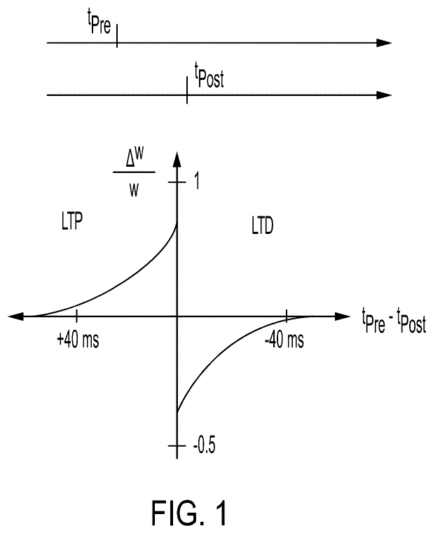

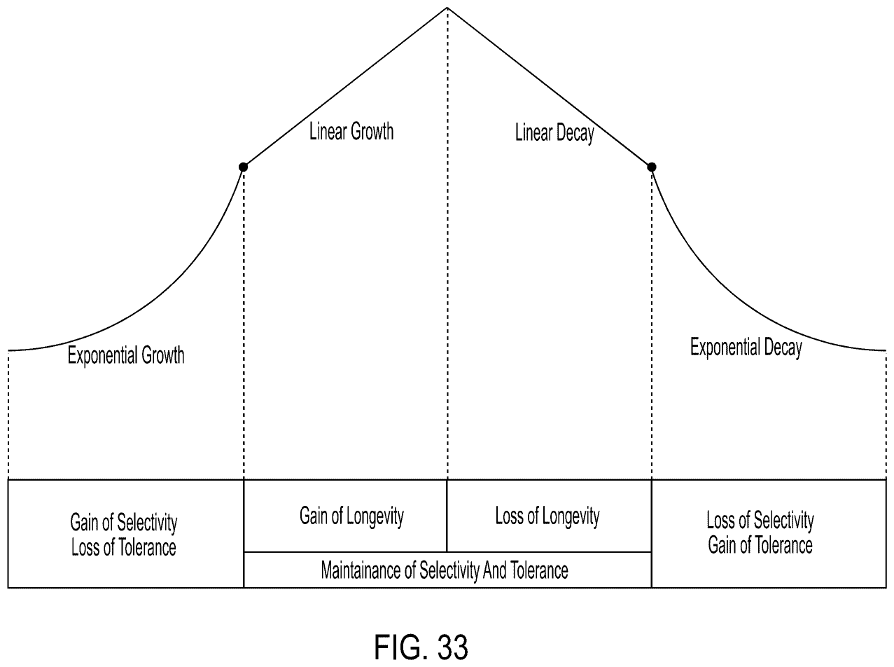

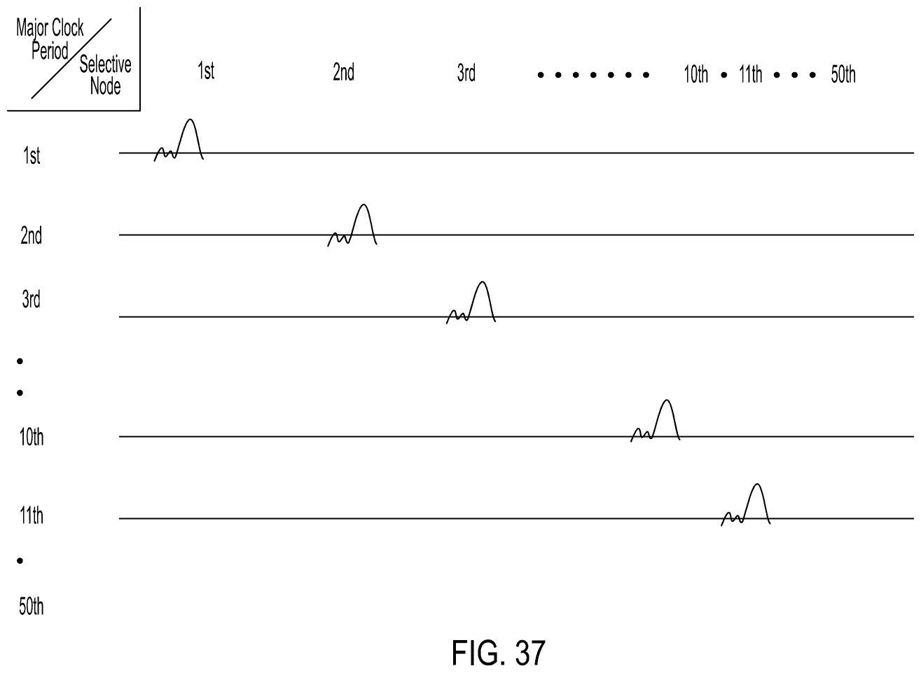

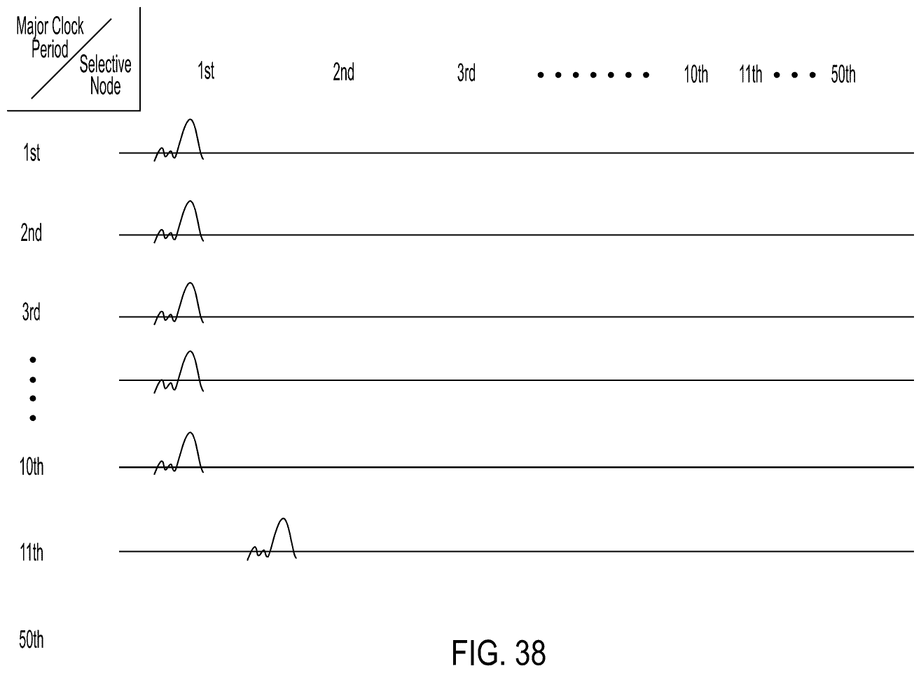

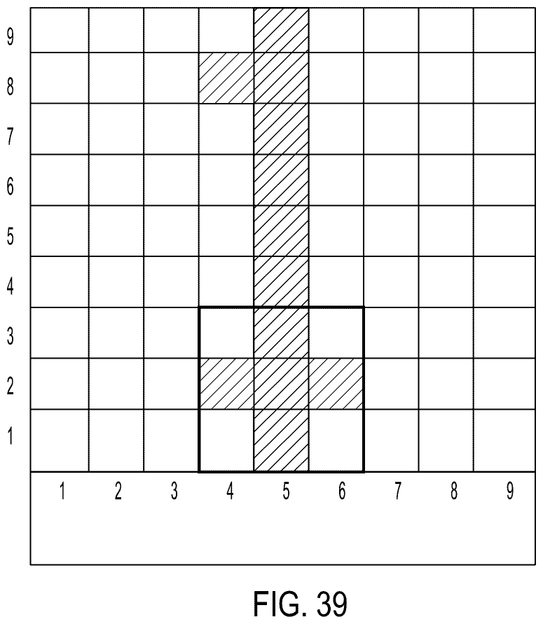

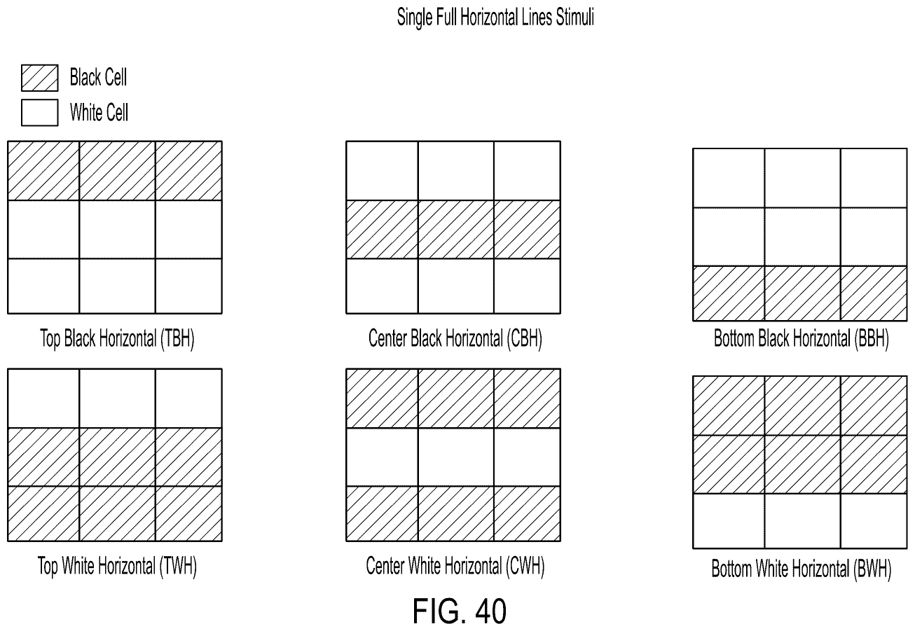

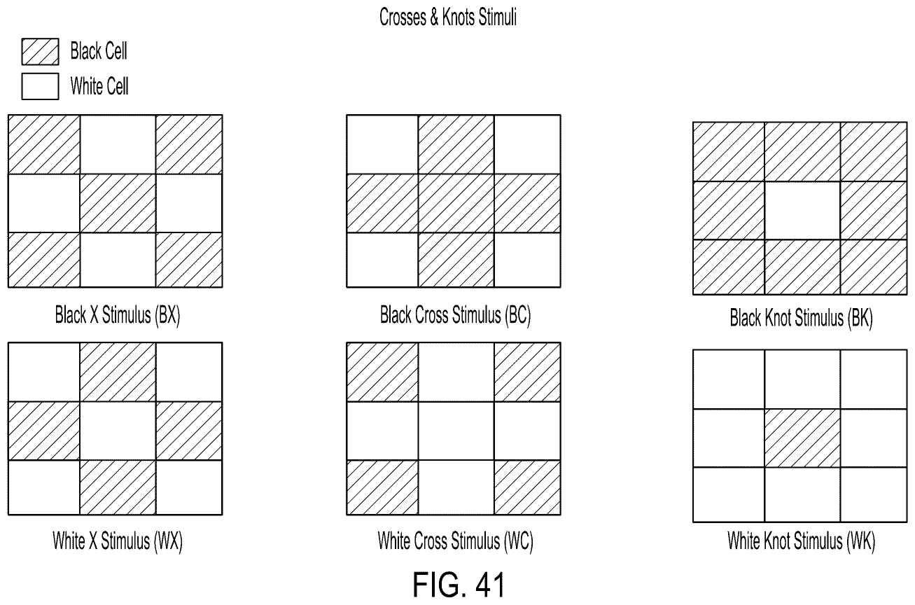

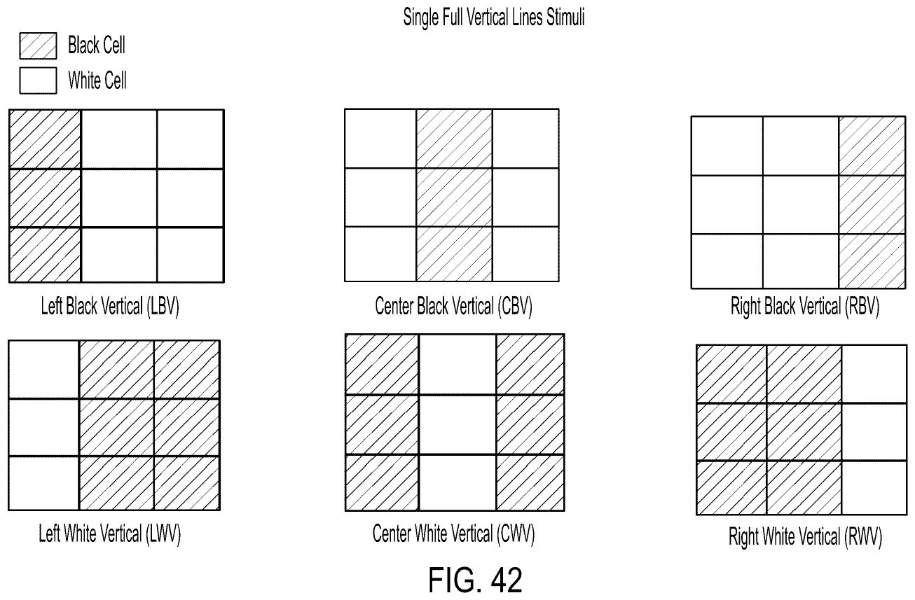

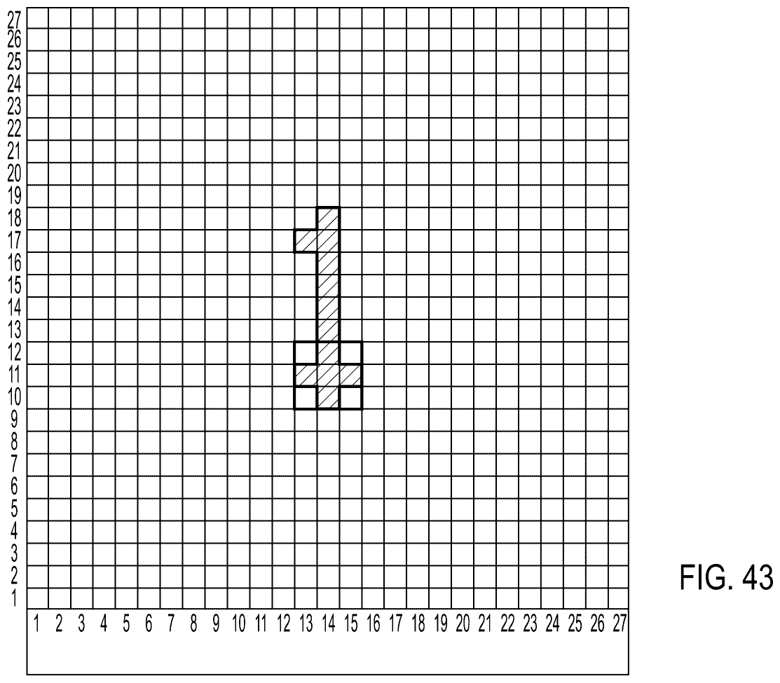

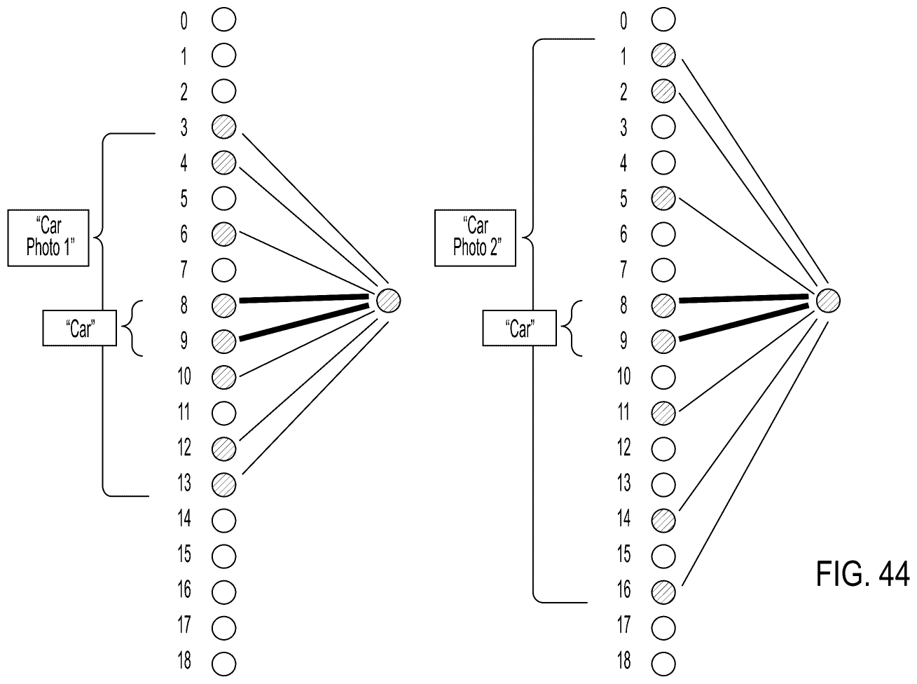

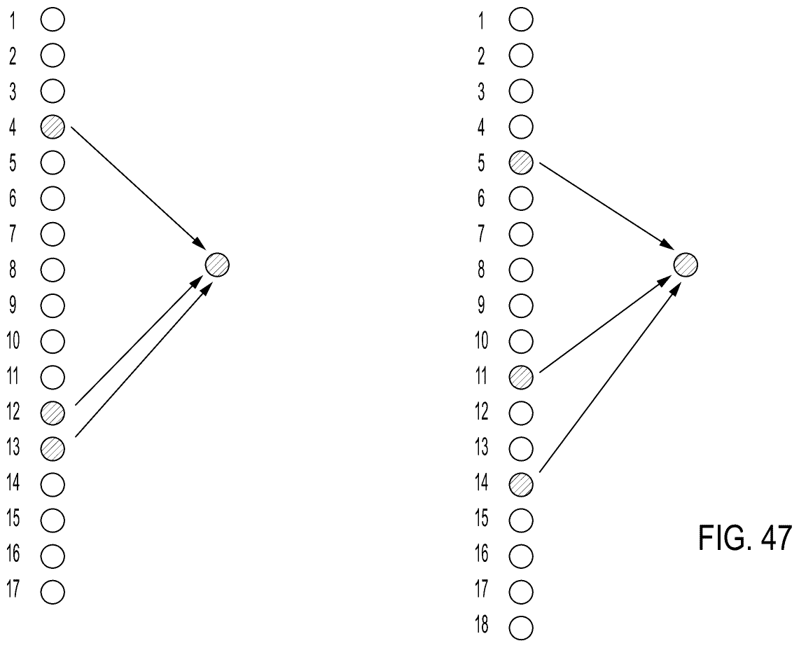

The present disclosure describes an artificial neuromorphic neural network architecture including a feedforward connectivity structure and/or a lateral connectivity structure. The architecture takes in as inputs a set numerical representation of raw sensory data, represented by a binary set of receptive nodes whereby, following a set of algorithms and using the feedforward and/or lateral connectivity structure achieves a set of output nodes which abstracts and generalizes efficiently over the sensory data without a need for optimization and via the introduction of selective nodes. The architecture also includes a secondary layer of connectivity structure which takes in as input a set of distributed selective nodes and produces a set of collective connectivity amongst said set of selective nodes, which results into collective excitation and collective inhibition behaviors amongst the connected nodes. The learning algorithm is laid out in Section 1 below. The feedforward connectivity structure is laid out in Section 2 below. The lateral connectivity structure is laid out in Section 3 below. The process of qualitative generalization is laid out in Section 4 below. Example implementations are described throughout and in Section 5 below. The following description should be read in view of FIGS. 1-47.

### Section 0 (A Brief Introduction on Biological Neural Networks)

In this section we describe the structure of biological neurons and its connections as the neuromorphic neural network architecture model we introduce is inspired by it and bases some of its main components as well as its learning algorithm upon it. Unlike traditional state of the art neural network architectures, a well understanding of the neuromorphic neural network architecture model requires an understanding of some basic features of biological neurons, and the next few paragraphs provide such necessary knowledge required to understand the subsequent sections.

### Section 0-A (Neural Components)

In this sub section we describe the basic components of the biological neuron and briefly explore the processes by which they communicate with one another.

A neuron in the mammalian brain is divided into three parts, dendritic arborizations, a cell body (includes the soma), and an axon. The dendritic arborizations constitute a set of dendrites which receive inputs from other neurons, such that each dendrite contains a presynaptic terminal which receives inputs from other neurons.

The type of inputs which we are concerned with here are mainly inhibitory and excitatory neurotransmitters, GABA and Glutamate, respectively. The axon sends outputs through its postsynaptic terminals to other neurons by releasing from its postsynaptic terminal those same neurotransmitters establishing a neuronal communication.

When a neuron receives neurotransmitters through its presynaptic junctions those neurotransmitters attach to the neurotransmitter receptors found in the presynaptic junction which act as gates that open when a sufficient amount of neurotransmitters bind with their respective receptors.

When these gates open they allow for either an influx of positive sodium ions (which equates to a positive voltage signal) or an influx of negative chloride ions (which equates to a negative voltage signal) to either depolarize or hyperpolarize the cells, respectively, which in other words either excites or inhibits the cell, respectively. Those positive and negative graded potential signals received by the dendrites are gathered and somatically integrated/summed up within the cell body.

The neuron cell is initially at a resting potential of around −70 millivolts, and when it receives from its dendritic arborizations a summed signal which allows it to cross a certain threshold which is around −55 mv, i.e., a +15 mv of summed graded potential, the axon of the neuron begins to send an action potential to its postsynaptic terminal which releases in turn neurotransmitters to the next presynaptic terminal of the next neuron and so on propagating forward.

Inhibition to a given neuron that is being inhibited renders this neuron less likely to fire action potentials since inhibition hyperpolarizes the neuron's cell and therefore draws the summed graded potential signal away from the threshold (negative voltage values).

On the other hand, excitation to a given neuron that is being excited renders this neuron more likely to fire action potentials since excitation depolarizes the neuron's cell and the summed graded potential signals are drawn close to the threshold (positive voltage values), which can lead to an action potential.

The neurotransmitter receptor gates open in a probabilistic manner, which means it is not guaranteed that such gates would open when a presynaptic junction receives said neurotransmitters but it is rather more probable, and there is a direct correlation between the amount of neurotransmitters sent and the probability of the neurotransmitter receptors opening their gates that in turn allow for an ion influx into the cell.

### Section 0-B (Spike-Time, Neuroplasticity & Mammalian Learning)

In this sub section we describe neuroplasticity and some basic processes through which the mammalian neurons develop connections with one another.

The connections in the mammalian neural network architecture undergo modulations which follow what is technically referred to as the spike-time dependent synaptic plasticity modulation graph as shown in FIG. 1.

The spike-time dependent synaptic plasticity modulation graph of FIG. 1 represents the time difference between the activation of the presynaptic neuron and the postsynaptic neuron, such that the part of the axis which lies left to the vertical axis represents positive time difference which is obtained by subtracting the time of activation of the presynaptic node from the time of activation of the postsynaptic node, whilst the part of the axis which lies to the right of the vertical axis represents negative time difference which is also obtained by subtracting the time of activation of the postsynaptic node from the time of activation of the postsynaptic node. The horizontal axis represents the time difference between the activation of the presynaptic neuron and the postsynaptic neuron. The vertical axis represents the relative synaptic changes/modulations which occur as a result of spike-time dependent pair activation of a presynaptic node and a postsynaptic node. These relative synaptic changes/modulations are relative to the original synaptic strength before said pair activation occurred. For positive delta time, i.e., leftwards relative to the vertical axis, the synaptic changes are positive, indicating an increase in synaptic strength in what is referred to as Long Term Potentiation (LTP), whilst for negative delta time, i.e., rightwards relative to the vertical axis, the synaptic changes are negative, indicating a decrease in synaptic strength in what is referred to as Long Term Depreciation (LTD).

The graph shows the synaptic change behavior of a pair of presynaptic and postsynaptic neurons which fire at the same time or at relatively a few milliseconds within each other, where said neurons develop synaptic potentiation or depression based on the sequence of the presynaptic and postsynaptic activations, such that if the post synaptic neuron activates 20 milliseconds before the pre synaptic neuron, a synaptic potentiation is established leading to a strengthening of the connection, and when the post synaptic neuron fires/activates after the pre synaptic neuron, a synaptic depression is established leading to a weakening of said connection.

Neuroplasticity governs the mammalian brain's neural connectivity. Two types of neuroplasticity exist, synaptic and structural, synaptic plasticity occurs when a successful communication is frequent between a presynaptic junction and a post synaptic junction of the neuron which is receiving information, in that case an increase in the presence of neurotransmitter receptors in the presynaptic junction occurs in a process referred to as synaptic potentiation.

This renders the presynaptic junction more sensitive to neurotransmitters where a later communication between the two neurons is facilitated and this is because the probability that any receptor gate opens leading to an ion influx rises with the rise in the amount of receptor gates present and the more gates are opened the more ion influx a given cell receives. This translates to more graded potential, i.e., more positive/negative voltage values.

On the other hand when the communication between a presynaptic junction and a post synaptic junction is less frequent, less neurotransmitter receptors in the presynaptic junction become present rendering the presynaptic junction less sensitive to neurotransmitters in a process referred to as synaptic depression and hence a later communication between the two neurons becomes less facilitated since the probability of these receptor gates opening drops where less ion influx, i.e., less added/subtracted voltage values can occur due to a lower amount of receptor gates.

An axon could form multiple synaptic junctions with a single dendrite and a single dendrite can form many synaptic junctions with many axons from different neurons. Along one single dendrite there could exist hundreds of what neuroscientists refer to as dendritic spines each forming a synaptic junction with post synaptic axons, and in total a dendritic arborization can form as many as 15000 spines, i.e., 15000 synaptic connections with various axons from various neurons.

Structural plasticity happens when successful communication between one neuron's axon and another neuron's dendritic arborizations is frequent, in contrary to synaptic plasticity which is local to a postsynaptic axon with its specific presynaptic spine, structural plasticity happens on a more global scale between neurons.

In the case that the postsynaptic neuron and the presynaptic neuron fire more frequently together the postsynaptic neuron develops more spines and branches with the axon of the presynaptic neuron in a process referred to as sprouting, whilst in the case that the presynaptic neuron and the postsynaptic neuron fire less frequently together the postsynaptic neuron starts losing spines and dendritic branches with the axon of the presynaptic neuron in a process referred to as pruning. If the frequency gets too low the postsynaptic and presynaptic neurons would totally lose their connection.

When a connection is strengthened and changes occur in the amount of receptors found in the postsynaptic neurons, the changes do not last forever as they return back to a given baseline. In other words the amount of receptor gates returns back to its original value before synaptic modulation occurred from stimulation, these changes could last for minutes or hours for synaptic plasticity, and months or years for structural plasticity.

Biologically it is relatively harder to break structural connections than it is to dispose of neurotransmitter receptors. Both synaptic plasticity and structural plasticity are two fundamental processes which govern the entire mammalian learning processes as they participate in processes related to the formation, retention and forgetting of short term and long term memories.

In this application we are concerned with the effect of one particular type of synaptic plasticity, more specifically long term potentiation (LTP). LTP can be described as the persistent strengthening of a synapse based on recent stimulations, where they produce a long lasting increase in signal transmission between a given presynaptic and postsynaptic neuron. Such increase in signal transmission is emblematic to the fact that the plastic changes are the direct result of an increase of neurotransmitter receptors on the postsynaptic spine which as was clarified earlier leads to an increase in the amount of ion influx since more open gates equate to more ion influx and therefore greater voltage signals.

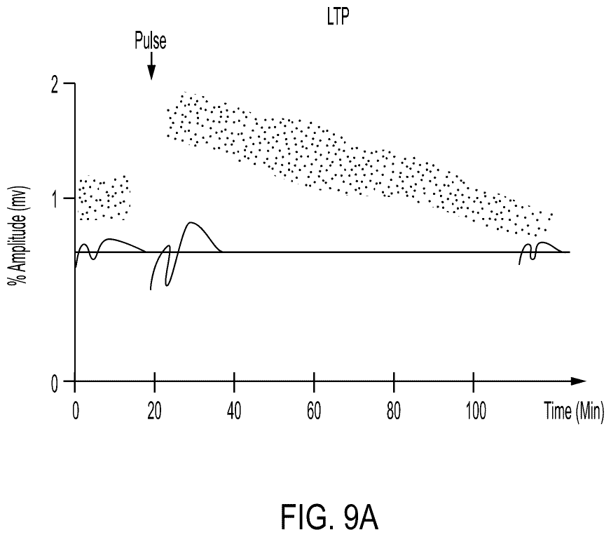

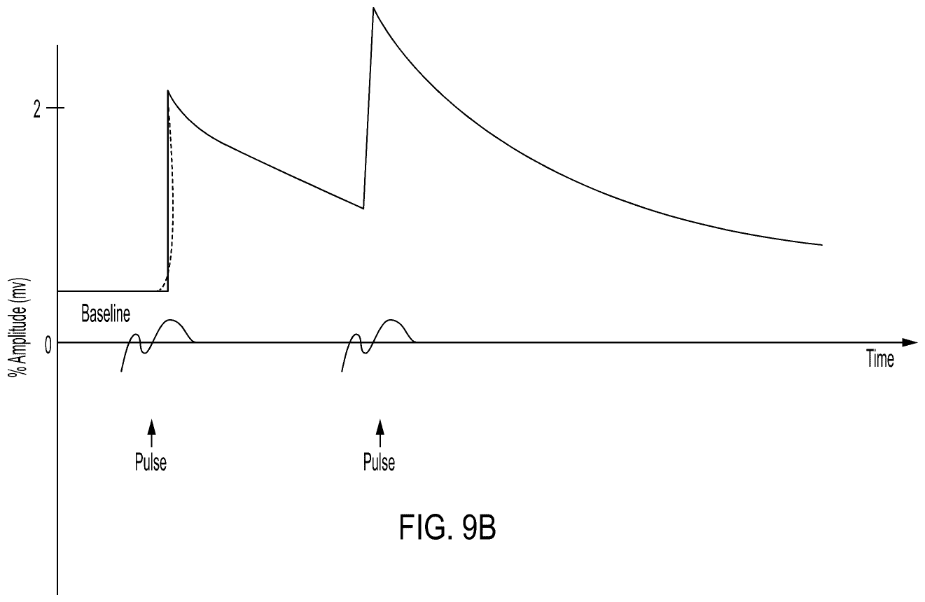

LTP is established by sending high frequency pulses of stimulation (typically at a 100 HZ) to a particular postsynaptic cell, which causes an increase in the amount of neurotransmitter receptor gates on the cell. In one example referring to FIG. 9A, the effects of LTP last around 2-3 hours before the caused changes/modulations return back to the baseline.

In FIG. 9A, the vertical axis represents the relative change in amplitude, the bottommost horizonal axis shows the progression of time in minutes, and the horizontal axis above the time axis is set to represent the time at which an electrical spike is induced between a presynaptic-postsynaptic neuron pair, these are shown as squiggly lines that represent the overall action-potential pulse of a given axon terminal. The sparse set of dots depict the increase of field postsynaptic potentials plotted as % amplitude from baseline and as a function of time. Shown on the figure increment in relative amplitude (relative to baseline) upon the introduction of a second spike directly following a primary one, then over the progression of time said % amplitude experiences a reduction over time until it reaches the baseline around 120-180 minutes later. This overall describes the process of long term potentiation.

After a change occurs and at another time within the 2-3 hours' window, when the presynaptic axon is stimulated to send neurotransmitters to the postsynaptic cell which underwent LTP, the graded potential (voltage) of the signal transmitted by the postsynaptic cell is higher than it was before it underwent LTP, this is again due to the increase amount of neurotransmitter receptor gates which lead to an increase in ion influx which leads to an increase in the signal's magnitude.

After the 2-3 hour window lapses, the changes return back to the baseline where the amount of neurotransmitter receptor gates is reduced back to their original value and at any time after this when we stimulate the presynaptic cell again, the signal that the postsynaptic cell transmits falls back to its normal magnitude as the LTP effect would have worn out.

We model plasticity in this architecture using two functions, a growth function which is a function of stimulation and another decay function that is a function of time. The growth function models the process of strengthening a connection per one unit of stimulation, where more stimulation would lead to more strengthening. The decay function models the return of the strength value to the baseline after a certain period of time and we refer to it as the deterioration curve, where a connection deteriorates over time which means the strengths of the connection weakens over time.

Because the deterioration curve takes the form of a decay function, when we re-stimulate the particular synaptic junction, i.e., add another stimulation to the junction before the first decay function resulted from the first stimulation reaches its baseline amplitude, and therefore introduce a second stimulation at an early time within the 2-3 hours window of the curve as shown in FIG. 9B, the amplitude of the new potentiation curve from the second stimulation is added to the amplitude of the curve of the first stimulation leading to a multiple of the initial value and the overall decay function lasts significantly longer.

As shown in FIG. 9B, the vertical axis represents the relative change in amplitude, and the horizontal axis shows the progression of time in minutes. The line above the time axis is set to represent the time at which an electrical spike was induced between a presynaptic-postsynaptic neuron pair, these are shown as squiggly lines that represent the overall action-potential pulse of a given axon terminal. The nonlinear graphs depict the increase of field postsynaptic potentials plotted as % amplitude from baseline and as a function of time. On the figure and similar to FIG. 9A, there are shown increments in relative amplitude (relative to baseline) upon the introduction of a second spike following a primary one but only after a little duration of time has passed, and similar to the graph in FIG. 9A, over the progression of time said % amplitude experiences a reduction over time until it reaches the baseline, however in this scenario the time at which said baseline amplitude is reached is temporally distant relative to its counterpart in FIG. 9A. This is as a result of the total amplitude gain showcased around the second spike which has a total gain that exceeds the prior amplitude change in what could be referred to as a compounding effect of net amplitude change.

While if the stimulation was far at the end of the decay function curve, but within the 2-3 hours curve time window, the second added decay curve amplitude over the first decay curve's amplitude barely sums up to a slightly greater over all amplitude.

On the other hand, if the second stimulation occurs outside the 2-3 hours window of the first curve, i.e., when the amplitude of the first curve resulted from the first stimulation has reached its baseline which is zero amplitude of synaptic change, then the second stimulation will only return the overall decay function's amplitude to its original length and the overall decay function does not change and lasts exactly the same 2-3 hours.

This means with relatively high frequency of re-stimulation of the same dendritic junction (not to misinterpret with the frequency of the stimulus, e.g., 50-100 HZ), the change in the synaptic junction lasts significantly longer. However, with relatively low frequency of re-stimulation, the change lasts relatively not as long but slightly longer than the initial 2-3 hours range. Finally, if the re-stimulation happens within an even lower frequency, outside the 2-3 hours window curve, i.e., with a period that lasts 2-3 hours or more, the synaptic change lasts exactly the same which is 2-3 hours.

### Section 1 (The Learning Algorithm)

In this section we showcase a learning algorithm that we have developed which is based on associative memory and which in conjunction with the neural network architecture we introduce in the later sections, perform more efficiently than optimization-based neural network architectures performed in supervised learning settings. This learning algorithm can be adjusted to perform in both supervised and unsupervised settings.

This learning algorithm mimics the mammalian brain learning process, and therefore it uses unconventional means as compared with traditional neural network architectures. This learning algorithm and its subsequent use across the embodiment of the neuromorphic neural network architecture, is referred to under the broader term we introduce as, neuromorphic learning, which can be considered a third counterpart as compared with traditional learning techniques commonly known as machine learning and deep learning.

In other words neuromorphic learning which is a doctrine we introduce in this disclosure is the third instantiation of learning methodologies utilized in Data science and Artificial intelligence, after machine learning and deep learning. As is clarified herein, it is the most efficient learning mechanism amongst all three.

As was clarified above, the development of neural network architectures took two main paths, one path which had its neural network architectures be based on some form of associative memory, which include neural networks like, BAM networks (hetero-associative memory), Hebbian learning based networks, Hopfield networks (auto-associative memory), and Boltzmann machines, and another path which had its neural network architectures be based on some form of optimization techniques, mainly backpropagation, and these include, multi-layer perceptrons, Artificial neural networks, Convolution neural networks, Recurrent neural networks, Generative adversarial neural networks, Autoencoders and many more.

The majority of research and development of the state of the art in neural network architecture engineering, is heavily focused on developing the latter path, the optimization-based neural networks path, as these networks have shown significant utility in a wide array of subject domains, and performed more accurately than any previous models in some domains despite high performance costs. A classical example would be image classification in the domain of computer vision, which convolution neural network architectures dominated as a result of their significantly high precision and accuracy. Another example would be speech recognition in the natural language processing domain, where recurrent neural network architectures reign supreme. On the other hand, the utilization of associative memory based neural network architectures in tasks like image classification or speech recognition has been almost neglected in favor of optimization, whereas optimization becomes almost the only possible technique used in the learning algorithm of a typical state of the art neural network architecture that tackles these types of problems in these domains.

In this section we showcase an unsupervised learning algorithm that we have developed which is based on associative memory and which in conjunction with the neural network architecture we introduce in the later sections, would perform more efficiently than optimization-based neural network architectures performed in supervised learning settings. This learning algorithm can be adjusted to perform in both supervised and unsupervised settings. This learning algorithm we introduce mimics the mammalian brain learning process, and therefore it uses unconventional means as compared with traditional neural network architectures. This learning algorithm hereafter is referred to as neuromorphic learning.

Before we clarify the details behind neuromorphic learning, and since the reader might have preconceived notions based on their understanding of traditional state of the art neural network architectures, which would inevitably act as obstacles while clarifying most of the important aspects of this neuromorphic neural network architecture (NNNs), we need to first clarify the difference between the role of weights/connections in traditional state of the art neural network architectures that are based on optimization and the role of connections in a mammalian brain architecture as well as NNNs within the context of associative memory. Highlighting such difference aids the reader and frees them from unnecessary assumptions and preconceived notions that might have accumulated due to their own research and studies of traditional state of the art neural network architectures.

Traditional neural network architectures follow an optimization-based learning algorithm, where they are geared towards error driven learning. While error driven learning is considered a form of learning that the mammalian brain architecture employs on the macro level across cortical lobes (via inter-cortical neural communications) where it occurs via reinforcement behaviors through a network of connections spanning the basal ganglia, the nucleus accumbens and the orbitofrontal cortex, it is not the more general form of learning utilized by the mammalian brain architecture on the micro level across individual neurons within a given cortical lobe in the neocortex (via intra-cortical neural communications).

The mammalian neural network architecture, employs an association based on repetition learning model as opposed to an error driven learning model on the micro level across individual neurons that belong to the same cortical lobe.

Information in a mammalian neural network architecture is represented through the formation of associations which occur between a set of distributed binary neurons, and is retained through the modulation of said associations based on the frequency of appearance of such information, and not through any form of cost minimization that are based on quantitatively represented features learned via minimizing cost values.

In other words, in the mammalian neural network architecture, information is stored, maintained and modulated through webs of connections under the influence of direct experience and based on the persistence of such information in the environment.

For example, a human child learns that apples are fruits by repetitive association, where they constantly hear the association between the two concepts, the concept of apples and the concept of fruits until both concepts form a mental association to one another, on the other hand if that same child was told that apples are vegetables persistency across a duration of time, they would form a different set of mental associations, one which would be between the concepts of apples and vegetables as opposed to between the concepts of apples and fruits, over time they might forget the old information where the association breaks (synaptic pruning), and the new information manifested in the new connection between the two new concepts persists due to repetitive simultaneous encountering which in this example, is the simultaneous verbal encountering of the concept of apples and vegetables, this is regardless of the truth value behind the information.

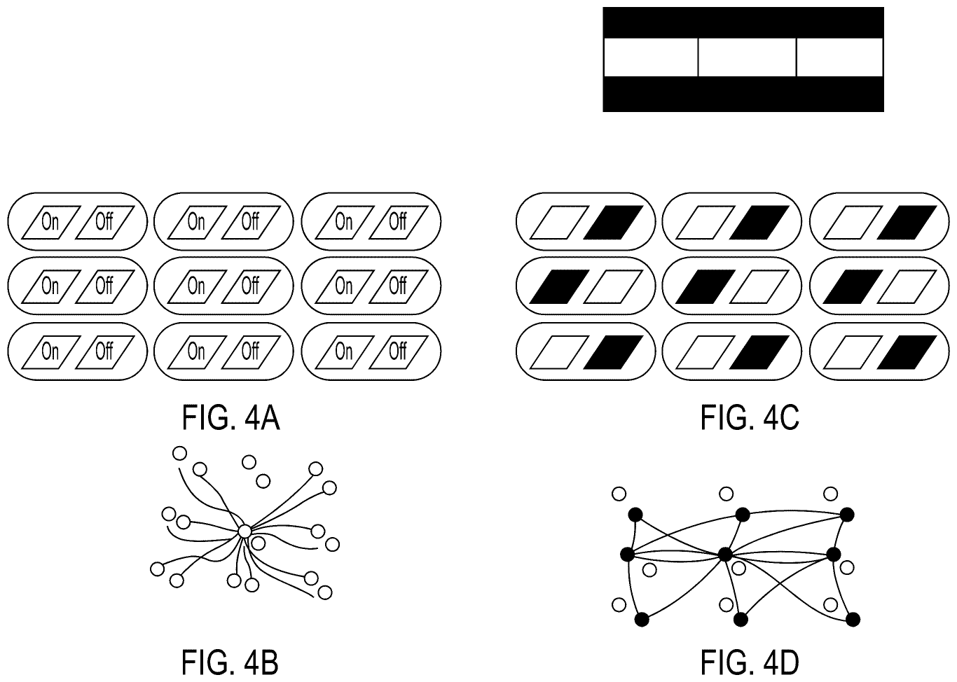

A simpler example would be a visual stimulus, assuming that a visual scene can only be represented by black pixels and white pixels, assuming we have two types of neurons, “on” neurons and “off” neurons, such that “on” neurons would only respond to white pixels and “off” neurons would only respond to black pixels, and assuming that the connections between the input layer and the next layer is one-to-one, which means every input neuron connects to one neuron directly in front of it from the layer next to it, as shown in FIG. 4A. According to this example, we further assume that the neurons of this next layer are laterally connected (i.e., connected to neurons that belong to the same layer) and that a neuron in this layer can only connect laterally to a patch of nine neurons surrounding it as shown in FIG. 4B.

FIG. 4A shows 9 receptive cells in a 3×3 kernel bound region, each containing two nodes per cell labeled “on” and “off”, where “on” nodes represent white pixels, and “off” nodes represent black pixels. FIG. 4B shows the 9 node pairs of FIG. 4A with their connections, but for fear of confusion we only show one center node from the node pair connecting to all other surrounding nodes, however this shall carry the same for all nodes in the graph. FIG. 4C shows the resultant activation map for said nodes of FIG. 4B as a result of the network perceiving a white horizontal line amidst a black surrounding area within a 3×3 patch of its visual perception (see grid above FIG. 4C). FIG. 4C shows the “off” and “on” nodes which activate in correspondence to their designated white/black pixels, where dark nodes represent activated nodes and white nodes represent not activated nodes, this is regardless of whether “on” nodes or “off” nodes are active/inactive. FIG. 4D shows the connectivity which are getting strengthened between all the nodes which happen to be active simultaneously.

If we assume a stimulus is projected onto the first layer of neurons, the input layer, represent two parallel black lines in a particular orientation within a white background as shown in FIG. 4C, then the “on” neurons from the next layer respond to the particular white background spots, whilst the “off” neurons respond to the spots that represent the black lines whilst retaining the same spatial distribution represented by the stimulus since the feedforward connections are made to be one-to-one. If we then base the formation of connections between those laterally connected neurons in that next layer on the simultaneous activation of those neurons, what we would end up with is a web of lateral connections formed in the next layer which connects all the on-off neurons that were activated together (simultaneously) as a result of projecting the stimulus, forming what neuroscientists call, a mental representation of the external stimulus. This happens through a web of neural connections, where this web of interconnected neurons acts as a qualitative representation of the external stimulus and not a quantitative representation of that external stimulus, as it records the stimulus through collective representation manifested in the collective group of interconnected specific neurons which represent the input stimulus.

In optimization-based neural networks, the input nodes represent numerical values (quantitative values) associated to the qualitative features of the input as representations of such qualitative features (e.g., pixel colors (qualitative) translated into numerical values (quantitative)).

Such quantitative turned qualitative features act as data points that can be statistically segregated from other data points through fitting a N dimensional hyperplane (or its nonlinear equivalent curve) represented by a mathematical function all within the confine of some N+ dimensional space domain where said data points are scattered.

The structure of said hyperplane (or its nonlinear equivalent curve) function, is dictated by the hyper parameters of this network which include first and foremost the structure of the connections as well as other hyper parameters like the activation function and the number of layers. How well said function segregates the scattered data points is dictated by how well the optimization-based neural network architecture is trained.

The weights/connections in an optimization-based neural network architecture, merely play the role of knobs that adjust the N dimensional slope and axes intercepts of the N dimensional hyperplane (or its nonlinear equivalent curve) function within the N+ dimensional hyperspace domain, this is because these weights are by definition the slope variable of said N dimensional function.

Adjusting these weights in an optimization-based learning algorithm typically involves minimizing the cost function, that is itself the N dimensional hyperplane (or its nonlinear equivalent curve) function as a function of a quantitatively measured error.

The learning algorithm in error driven learning, can be visualized as playing the role of warping the N dimensional hyperplane (or its nonlinear equivalent curve) around the data points which are being fed such that it creates generalized mathematical boundaries around each cluster of data points that belong to one predefined class.

This is possible only when there is statistical significant correlation between the different quantitatively represented data points across a given class/set and happens in the training phase of the network.

The mammalian brain however, is not a quantitative machine which calculates and compares statistically significant quantitatively represented features, but rather directly deals with qualitative features and compares them qualitatively not quantitatively.

NNNs allow for this by staying true to the nature of biological network processing, and this is by using connections not as a mean to calculate and optimize but as a mean to associate qualitative elements of sensory inputs through distributed qualitative neural representations. This happens by employing one of the tenets of cognitive neuroscience which is the brain's ability to form mental representations using neurons and their associations with one another, and it is this same ability that NNNs employ when processing information about its environment.

This means, that in this architecture, an experience is represented by a collective web of associations between neurons, and the connections merely play the role of forming those webs not the role of slopes and intercepts as is the case in traditional state of the art neural network architectures that employ an optimization-based learning algorithm.

The major flaw in the thinking of most contemporary neural network engineers, is their assumption that there is a reasonable case for treating a learning problem as a quantitative problem which requires a quantitative solution as opposed to treating the problem of learning as it is in the mammalian brain, a qualitative problem that requires qualitative representation based solutions, thereby justifying to themselves turning qualitative features into quantitative features.

This research would argue that while engineers claim that neural network architectures that are based on optimization do not belong to what is commonly known as symbolic AI systems, they in fact are within the confines of symbolic AI thinking since optimization as a learning algorithm is merely the act of subjecting humans preconceived notions of mathematical thinking.

The learning algorithm we use in this architecture bases connection strength on positive and negative time dependent correlations of activations, if two neurons are active simultaneously they form a stronger excitatory connection between them with some strength value S, and if the neurons are active asynchronously (where one is active and the other is not) they form a stronger inhibitory connection with a strength value S, these strength values are not static but are rather dynamically updated throughout the life span of the network where they follow the rules of plasticity which were mentioned earlier. This is the basis of what is commonly known as Hebbian learning albeit different in the fact that we do not allow for the negative updating of weights based on time dependent correlation of activation, and we rather use a different methodology for negatively updating the weights, as well as the fact that we introduce three rather than two types of connections/weights, all as is clarified below.

We can model the aforementioned behavior of positively updating weights in a traditional Hebbian learning model as follows:

$$New Wij = Old Wij + ( Alpha * Xi * Yj * K ) \qquad ( Eq . 1 )$$

where Wij refers to the value of the weight laying between the two nodes, Xi refers to the binary activity state value of the presynaptic neuron (the predecessor node), Yj refers to the binary activity state value of the postsynaptic neuron (the successor node), Alpha is the learning rate, and K is some arbitrary constant value such that New Wij−Old Wij=K.

The first equation disregarding the K variable is known as the activity product rule, and can be used to model excitatory connections, and therefore would only model the behavior of positively updating weights for time dependent positive correlation of activity state only when the activity states of both terminal nodes is 1.

For the sake of explanation, we replace Alpha with variable r which would signify repetitive stimulation, and so the equation becomes as follows:

$$New Wij = Old Wij + ( Xi * Xj * K * r ) \qquad ( Eq . 2 )$$

We can tweak the activity product rule to generate equations for time dependent negative correlations of activity states as is clarified herein.

By following this slightly modified Hebbian rule, for normal excitatory connections and normal inhibitory connections, we ensure that the connections are modulated positively as a function of stimulation via a linear growth function, which can be modeled by the following equation:

$$New Wij = Old Wij + K * r \qquad ( Eq . 3 )$$

where New Wij is the final strength value of the connection, Old Wij is the current strength value of the connection, and constant value K is the added strength value per unit stimulation r, where K can preferably be allocate to be 10,800,000 units, such that it represents the amount of synaptic strength value added per one stimulation (r).

In this learning algorithm the connections shall also be affected negatively as a function of time through a liner decay function, which can be modeled by the following equation:

$$New Wij = Old Wij - K * tr \qquad ( Eq . 4 )$$

where t represents time measured in milliseconds, this means at t=0 milliseconds, if the strength value of Old Wij was 10800000 then the final synaptic strength value New Wij at t=10800000 milliseconds or 3 hours later would be zero. This establishes the 3-hour decay curve model we discussed earlier. These two equations constantly model and change the connection strength value for all the connections across the entire life span of the network.

This ensures that information is maintained as long as it is encountered regularly, while that which is not encountered regularly is forgotten. Recall that information in this model is represented by a web of connections and hence a strongly interconnected web of connections represents a strongly maintained piece of information and vice versa, and this is true for repetitively simultaneously encountered information as it is for repetitively asynchronously encountered information. In other words, this is true if we use both excitatory connections and inhibitory connections.

The former case is the more intuitive one, where two stimuli that are found to exist simultaneously, i.e., positively correlated, develop excitatory connections with one another allowing them to later on, aid their causal activation of one another. An example would be recollected experiences and cues, most recollected experiences are triggered by cues which cause what we later refer to as a chain reaction effect which leads to the full recollection of an experience. For example, hearing a sound segment of some previously encountered music and recollecting the experience of listening to it previously. In this scenario, the cue is the sound segment, whilst the experience that this cue where associated to, is the entire memory of the experience of the previous encounter.

In this scenario, the sound segment represented by some acoustic neurons had previously formed associations to the full experience which is represented by many other sensory neurons at the first time of encountering, and then as soon as the segment was re-played at another encountering, the neurons got activated and through their previously formed excitatory associations to the other sensory neurons, they depolarized (activated) all those neurons that had previously formed associations with that segment, and through a chain reaction effect as is clarified below, the entire experience is recollected, as in the entire web of neurons that represents the previous experience is activated.

Another example would be reading/listening to some pre learned text and recollecting/predicating an expected word before its appearance, for example if the reader was to read the following statement “O captain my______” they would probably be able to recollect and fill the blank with the word “captain”, this is because the reader might have learned/read the full statement before and formed associations between the phrase we mentioned and the following predicted word, this again is due to repetitive simultaneous encountering, where the phrase “O captain my”, and the word “captain” formed associations under experience through excitatory connections as a result of both the phrase and word being encountered correlatively in a previous instance, which allowed for associations to form due to such correlation in experience.

In the later scenario, when the first segment of the phrase was presented the neurons which represent it causally depolarize (activate) the other neurons they formed connections with in the previous encounter which are not present in the current encounter, and through a chain reaction effect they activated the neurons which represent the word “captain”. This follows the same for other examples like “traders on the stock______” which leads to the depolarization of the word “market” and the statement “fluctuations in stock______” which leads to the depolarization of the word “prices”, notice the last word “stock” is the same in both cases, yet the predicted/expected words are different and the reason for this is clarified below.

In all of the previous cases an association occurs between two frequently correlating stimuli, where such frequent correlation strengthens the connections between the two correlating stimuli, and at another encounter when one of the two correlative stimuli is activated, by virtue of the excitatory connections that are formed and depending on how strong these connections are to the other neuron/s, those other neurons can be made to be activated as well through causal activations via these same connections, in this case the connections play the role of completing the messing pieces of an experienced stimulus sort of speak, in what is usually referred to in cognitive neuroscience language as a recollection.

As was stated previously, the role of connections is to allow for the network to form distributed neural representations of external information through a web of interconnected neurons. When the connections which are formed across a particular web are weakened, the information is harder to recall and harder to use in more complex processes and vice versa (as is showcased in later sections). Therefore, the web records the information and acts as the store of such information. As soon as the web breaks where all the connections that were previously formed between the neurons drop to a strength value of zero, the information is said to be lost, and when a new web of connections between those same neurons is created new information is said to have been learned/stored.

Since the learning algorithm which governs those connections is based on the frequency of correlation, the more encountered a pair of stimulation is, the stronger the connections become and therefore the longer they last before full deterioration, this would replicate the effect where a repeated encounter of a stimulus causes a stronger and hence long lasting memory of it.

For example, say a 3*3 input grid (also referred to herein as a 3*3 kernel bound region), with a one to one connection to the first layer of the network (the second after the input layer), where the input again can only be binary, white or black and where similar to the previous example the next layer has its neurons able to form lateral connections based on correlated activations. If at one encounter the top three pixels that are activated were white and the bottom 6 where black, then in the next layer a neural representation comprised of three top “on” neurons and 6 bottom “off” neurons form lateral connections with one another creating an overall web, and this web can only last as long as the connections between these neurons can last.

If we say in our case, that those connections follow the 3 hr decay curve, this would entail that after one encounter, the newly created web which represents the stimulus can last for 3 hours before the information it represent is lost, if another encounter of that same stimulus occurs, then based on the linear growth function, the connection strength would be strengthened and on at this modified the information would be able to last 6 hours as opposed to only 3, and we say the information's memory got stronger, on the other hand if this particular stimulus wasn't re-encountered again, after 3 hours all the formed links would break off and we say the information was lost/forgotten. We discuss what we mean by the term information in details and in a different context than the one Claude Shannon illustrated in the next section when we tackle the introduction of selectivity and the feedforward connectivity structure.

By now we have clarified the role of connections in our neuromorphic architecture in the context of associative learning and contrasted it with the role of connections in traditional neural network architectures that are based on optimization. Following this paragraph we introduce an example learning algorithm used in a neuromorphic neural network architecture as outlined in the rest of this sub-section.

The example embodiment of this architecture includes a neuromorphic learning algorithm that is based on frequent correlation of activations, where excitatory connections form between neurons that are active simultaneously at positive correlation, and get strengthened by repetition, whilst inhibitory connections form between neurons that are active asynchronously, i.e., at negative correlation, and also get strengthened based on repetition. For inhibitory connections this is the case because an inactive neuron by default is at a negative resting potential, (−70 mv), and hence is treated as a hyperpolarized cell, and therefore when a presynaptic inhibitory neuron sends hyperpolarization signals to an already inactive cell, it is as though the connection successfully hyperpolarized the inactive cell, and hence GABA receptor gates develop on the dendrites of that already inactive neuron causing a strengthening of the inhibitory connection, the purpose of such inhibitory connections is clarified in subsequent sections.

This learning algorithm, which is referred to as neuromorphic learning from here onward, takes into account the temporal direction of activation while modulating the strength of the connections. Recall that for excitatory connections in the mammalian brain, the spike-time graph model shown earlier, establishes that if a pre-synaptic neuron (predecessor node) is active before a post-synaptic neuron (successor node) was active, a strengthening in the connection that exists from the pre-synaptic neuron (predecessor node) and to the post-synaptic neuron (successor node) occurs. However, if on the other hand the postsynaptic neuron (successor node) activates before the presynaptic neuron (predecessor node), i.e., the timing is switched, then a weakening occurs to the connection that exists from the presynaptic and to the postsynaptic neuron.

It is worth mentioning that we say “connections that exist from the presynaptic neuron and to the post synaptic neuron”, as opposed to saying, between the presynaptic and postsynaptic neurons, to specify the direction of the connections, since unlike connections in traditional artificial neural network architectures, these connections are unidirectional not bidirectional, and therefore information flows only in one direction per connection, as is the case in their biological counterparts.

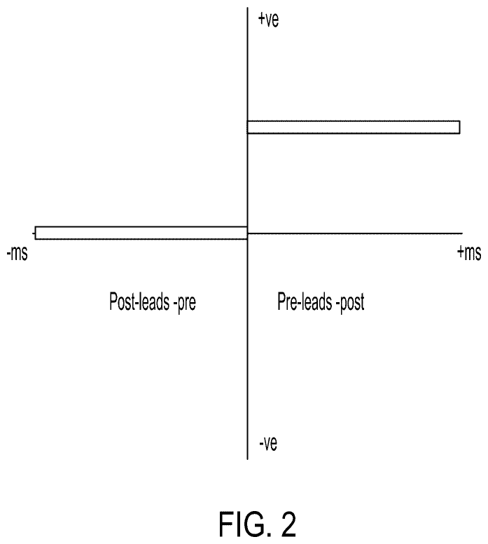

In this architecture we modify the learning algorithm such that there is no effect to the strength of the connections when the timing is switched. In other words, for excitatory connections which are the first type of connections we introduce in this architecture, if the presynaptic neuron is active while or before the postsynaptic neuron was found to be active, a strengthening in the connection that exists from the pre-synaptic neuron and to the post synaptic neuron occurs as is the case in their biological counterparts. However, if the postsynaptic neuron activates before the presynaptic neuron (i.e., the timing is switched) then no modulation effect shall be observed for the excitatory connections we introduce. This can be shown in the modified spike-time graph for emulated excitatory connections in FIG. 2.

In FIG. 2, the vertical axis represents the change in connection strength value, and the horizontal axis represents the time difference between the activation of any presynaptic-postsnyaptic neuron pair, such that the left side of the horizontal axis represents negative time difference between the activation of the presynaptic and postsynaptic nodes obtained by subtracting the latter from the former, while the right side of the horizontal axis represents positive time difference between the activation of the presynaptic and postsynaptic nodes also obtained by subtracting the latter from the former.

Also shown on FIG. 2 is the modified spike-time graph whereby for times where the postsynaptic neuron is activated before the presynaptic neuron (post-leads-pre), no net strength value changes occur to the connections as showcased by the zero valued constant curve showcased in a thick line on the left side of the vertical axis, whilst for times where the presynaptic node is activated before the postsynaptic node (pre-leads-post), a positive modulation to the connections is registered, represented by the positively valued constant curve showcased in a thick line on the right side of the vertical axis.

For inhibitory connections, we introduce two types of inhibitory connections with two different modified spike-time graphs and following two different growth functions. The first type is what we refer to as the normal inhibitory connection. In a normal inhibitory connection, if the presynaptic neuron is active while or before the postsynaptic neuron is found to be inactive, the inhibitory connection strength is increased, where the magnitude of the strengthening that occurs to said connection would be of equivalent magnitude to its counterpart normal excitatory connections and following the same linear growth function specified earlier, whilst if the presynaptic neuron was active after the postsynaptic neuron happens to be inactive (i.e., the timing is switched), no changes occur to the connection. This can be modeled by the normal inhibitory spike-time graph shown in FIG. 2.

The second type of inhibitory connections we introduce is what we refer to as a reverse inhibitory connection. In a reverse inhibitory connection, if the presynaptic neuron was found to be inactive while or before the postsynaptic neuron was found to be active, a strengthening of the connection occurs with a magnitude proportional to the current strength of the connection following an exponential growth function contrary to both normal excitatory and normal inhibitory connections which follow the linear growth function specified earlier, until a certain point at which the growth function ceases to grow exponentially and rather continues to grow linearly. In other words, the reverse inhibitory connection follows a growth function defined as a piece wide function as is clarified below.

When the presynaptic neuron is found inactive after the post synaptic neuron is found to be active, no changes occur to the connection. This modified spike-time graph for reversed inhibitory connections can be shown in FIG. 2, the purpose of the introduction of such inhibitory connections is clarified below. Notice that since the strengthening of reverse inhibitory connections follows an exponential growth function at some instances, the weakening of reverse inhibitory connections is required to follow an exponential decay function as well at these instances to ensure that the connections that are strengthened at the same time all deteriorate at the same rate, as is clarified below.

Realize that unlike excitatory and normal inhibitory connections, reverse inhibitory connections learn (i.e., get strengthened) in the opposite spatial direction of their causal influence. To clarify further, normal excitatory connections and normal inhibitory connections, get strengthened in the same spatial direction which they later on would follow while exercising causal influence on other neurons, this means that, since when a pre synaptic neuron is active and a post synaptic neuron is active/inactive (for normal excitatory/normal inhibitory, respectively) the connections get strengthened as clarified earlier, such that at a later time when the presynaptic neuron alone is active, it sends either a depolarization or a hyperpolarization signal influence (for normal excitatory or normal inhibitory connections, respectively) onto the post synaptic neuron upon said presynaptic neuron's activation, and hence following the same presynaptic to postsynaptic spatial direction.

On the other hand, for reverse inhibitory connections, while these connections get strengthened when the postsynaptic neuron is active whilst or after the presynaptic neuron is inactive, they exercise their causal influence when the presynaptic neuron is active not when the postsynaptic neuron is active, and hence when the presynaptic neuron of a reverse inhibitory connection is active it starts exercising inhibitory influence (i.e., it sends hyperpolarization signals) to its corresponding postsynaptic neuron, which is in the reverse spatial direction of its learning.

Since these connections are unidirectional and some of them learn in the reverse order of their causal influence, we chose to specify one spatial direction to be the reference by which the names presynaptic and postsynaptic refer to, and that would be the direction of the causal influence (i.e., the one adopted by the cognitive neuroscientists), this means when we say a presynaptic neuron, we mean the neuron that would send the signal, and when we say a postsynaptic neuron, we mean the neuron which would receive the signal.

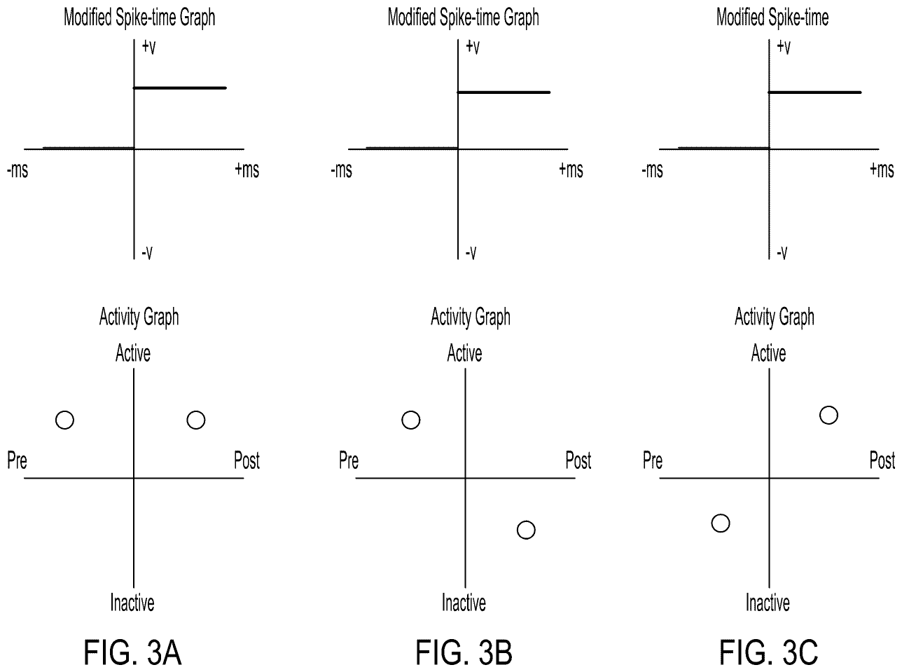

In FIGS. 3A-3C, we illustrate all three connections, and both their activity and spatial direction conditions for strengthening, where we show the activity conditions in what we refer to as the activity graphs, whilst we show the temporal direction conditions in a modified spike-time graph, where temporal direction refers to the required time sequence for a strengthening to be established. As shown in FIGS. 3A-3C, the top graphs are the spike-time graphs, which show the necessary temporal direction for a strengthening to happen for a given type of connection, this temporal direction is labeled “pre-lead-post” for times where the presynaptic neuron is active before the postsynaptic neuron, whilst “post-leads-pre” refers to the time where the postsynaptic neuron is active before the presynaptic neuron. The bold lines show the net amount of strength modulation.

The bottom three graphs, the activity graphs, show the conditions that are required regarding the pre versus post, and activation versus inactivation for each connection type, before the strengthening/modulation can occur as shown in its top counterpart spike-time graph, whose axes are binary, and the dots represent the conditions based on, whether the neuron is pre or post and whether it has to be active or inactive, and therefore they showcase the spatial direction of activation. For example, in order for a strength modulation to occur for excitatory connections, it is required that their presynaptic neurons and postsynaptic neurons both be active, whilst normal inhibitory connections are required to have their presynaptic neurons be active whilst their postsynaptic neurons be inactive and vice versa for reverse inhibitory connections, notice that time (temporal direction) is not shown in these activity graphs as they only show the spatial direction, where the temporal direction is rather shown above on their corresponding spike-time graphs.

The modified spike-time graphs are not unlike the graph shown in FIG. 2 and each is paired with an activity graph which showcases the activity state conditions of both the presynaptic and postsynaptic neurons which are to be required in order for a positive modulation to take place.

Each activity graph has a binary vertical axis which signifies either presynaptic neuron, or postsynaptic neuron, and a horizontal binary axis which signifies the activity state of said neurons which can either be active or inactive. The activity graph of FIG. 3A represents the activity graph of an excitatory connection, whereby both the pre-active and post-active quadrants are marked, showcasing that in order for an excitatory connection to experience a positive modulation it has to have its presynaptic neuron be active and its postsynaptic neuron active as well. This is paired with the spike-time graph which dictates the timing condition as stated earlier.

The activity graph of FIG. 3B represents the activity graph of a normal inhibitory connection, whereby the pre-active and post-inactive quadrants are marked, showcasing that in order for a normal inhibitory connection to experience a positive modulation it has to have its presynaptic neuron be active and its postsynaptic neuron inactive, this is also paired with the spike-time graph which dictates the timing condition as stated earlier.

The activity graph of FIG. 3C represents the activity graph of a reverse inhibitory connection, whereby both the pre-inactive and post-active quadrants are marked, showcasing that in order for a reverse inhibitory connection to experience a positive modulation it has to have its presynaptic neuron be inactive and its postsynaptic neuron active, this is paired with the spike-time graph which dictates the timing condition as stated earlier.

In summary, we introduce three types of connections, an excitatory connection which follow a modified Hebbian learning rule, under the condition that its presynaptic neuron is active while or before its postsynaptic neuron is active, and a normal inhibitory connection which also follow a modified Hebbian learning rule however, under the condition that its presynaptic neuron is active while or before its postsynaptic neuron is inactive, as well as a reverse inhibitory connection which follow a modified Anti-Hebbian learning rule under the condition that its presynaptic neuron is inactive while or before its postsynaptic neuron is active. Each of these three connections play an important role in the learning algorithm of this architecture. The word “modified” as used herein, refers to the fact that we neglect the reverse temporal direction rules in typical Hebbian and Anti-Hebbian learning rules, where no modulation effects are incurred in the reverse temporal direction of activation.

The word “before” in the phrases “while or before” is emblematic to the fact that each of these connections also have a latency variable which dictates how late the causal influence (i.e., the transmission time of the signal) as well as the learning conditions should be, before any influence to the postsynaptic neurons as well as strengthening to said connections could occur respectively, this latency variable would vary for some connections when we deal with temporality, and they would abstract the biological feature of connection length, or more accurately transmission speed. In other words, every connection holds a latency variable which dictates its transmission speed.

Below we showcase the mathematical representation of the modulation effects based solely on the activity state conditions, for all three connection types:

$$\begin{matrix}New Wij = Old Wij + ( Xi * Yj * K * r ) & ( excitatory connections ) \\ New Wij - Old Wij = K * r & ( linear growth function ) \\ New Wij = Old Wij + ( Xi * ( 1 - Yj ) * K * r ) & ( normal inhibitory connections ) \\ New Wij - Old Wij = K * r & ( linear growth function )\end{matrix} \\ \begin{matrix}New Wij = Old Wij + ( ( 1 - Xi ) * Yj * K * r ) & \begin{matrix}For r > T ( reverse \\ inhibitory connections )\end{matrix} \\ New Wij = Old Wij + ( ( 1 - Xi ) * Yj * K \hat{} r ) & For R < T\end{matrix} \\ \begin{matrix}New Wij - Old Wij = K * r & For r > T & ( linear growth function ) \\ New Wij - Old Wij = K \hat{} r & For r < T & ( exponential growth function )\end{matrix}$$

where T is what we is referred to herein as the transition point weight value, and r represents the repetitive encountering factor, since the growth functions must be a function of repetition.

Notice we also removed the learning rate since repetition serves a similar role to it albeit in a different context. We also did not add temporal direction to these equations, since they are implemented separately as is clarified below.

A second type of connection which we introduced in the learning algorithm of this architecture is a correlative type of connections, these are a type of connection which cannot directly cause any activation/suppression influence on other neurons through electrical signals, and are rather geared towards detecting positive and negative time dependent correlations of activations that happen across the terminals of said connections through messaging signals, these would come in three modes, one which detects positive correlations, for excitatory connections, and two which detect negative correlations, for normal and reverse inhibitory connections, and from here onward when we refer to a connection we begin with either the word “influencer” or the word “messenger” to signify its modal type, where “influencer” would signify causative connections which we introduced before, and “messenger” would signify correlative connections which we introduce next.

Overall this means this architecture includes 6 connections including one influencer excitatory connection, one influencer reverse inhibitory connection, one influencer normal inhibitory connection, one messenger excitatory connection, one messenger reverse inhibitory connection, and one messenger normal inhibitory connection. Every influencer connection in this learning algorithm must be paired with its counterpart messenger connection. The role of these messenger connections, is to send a message from the presynaptic neurons to the postsynaptic neurons, and only when such message is received, allow for a modulation to the strength of their counterpart influencer connections, the way this message is sent and received varies based on the type of the influencer connection.

For messenger excitatory connections, a message is only sent when the presynaptic neuron is active, and is only received when the postsynaptic neuron is also active, this means if a presynaptic neuron was active, but there weren't sufficient depolarization signals to activate the corresponding postsynaptic neuron, then the message would be sent but not received, and therefore no positive strength modulations would be executed to the corresponding influencer excitatory connection which lie between those two neurons, however if on the other hand some depolarization signal (coming from any source) was sufficient to activate said neuron then the message can be received and a positive strength modulation would commence.

For messenger normal inhibitory connections, a message is only sent when the presynaptic neuron is active, and is only received when the postsynaptic neuron is inactive, this means if a presynaptic neuron was active the normal inhibitory messenger connection sends a message, and if the postsynaptic neuron happens to be inactive it would be in the receiving state, and therefore the message would be sent and received, and hence a positive strength modulation would commence to the corresponding normal inhibitory influencer connection, otherwise if the presynaptic neuron was inactive a message wouldn't be sent in the first place, and if the postsynaptic neuron was active it would not be received either.

For messenger reverse inhibitory connections, a message is only sent when the presynaptic neuron is inactive, and is only received when the postsynaptic neuron is active, this means if a presynaptic neuron was inactive the reverse inhibitory messenger connection sends a message and if there were sufficient depolarization signals to activate the corresponding postsynaptic neuron (again from any source and not necessarily from that particular presynaptic neuron), then the message would be sent and received, and hence a positive strength modulation would commence to the corresponding reverse inhibitory influencer connection, otherwise if the presynaptic neuron was active a message wouldn't be sent in the first place, and if the postsynaptic neuron was inactive it would not be received either.

Messenger connections serve the role of making sure that modulations of influencer connections are solely based on temporal correlation of activity and not merely causation which is a subset of correlation, since the modulations would only commence if and only if a correlation was detected across the terminals of the connections, this would prove very crucial when we discuss, feedforward connections, lateral connections and generalization as well as other more complex processes of learning on subsequent sections.

The way this learning algorithm is utilized and implemented in this architecture, is made clear, as each subsequent section shows the utility of such connections in different modalities to achieve the overall end goal which is laid out, that is, performing highly efficient generalizations based on qualitative distributed neural representations of sensory information.

As should be appreciated, there are two fundamental processes which govern mammalian learning and which all mammalian intelligent behaviors are bound by, these are, recollection, which is tasked with the retention of information and its retrieval, and recognition, which is tasked with the classification of information and generalization. Previously, we touched on processes that relate to the first fundamental principle of mammalian learning, recollection, said processes are used when we describe the processes of recollection in detail below. Processes that relate to the second fundamental principle of mammalian learning, recognition, mainly the process of selectivity are also discussed further below.

### Section 2 (The Feedforward Connectivity Structure)

The mammalian neurons form what cognitive neuroscientists refer to as selectivity towards particular stimuli. For example, when an edge stimulus is projected onto a mammalian brain's primary layer of the visual cortex in the occipital lobe, it is observed that a particular neuron which belongs to the first visual area V1, activates in correlation with that specific particular edge. This selective nature of feedforward neurons is highly specific, to a degree where one feedforward neuron would be selective to a very specific edge that belongs to a specific localized region and with a specific size and orientation, as well as color and shade values.

To further clarify, the mammalian occipital lobe is divided into feedforward regions/areas beginning from the input region, which is characterized by the prevalent optic nerve terminals, then propagating deeper into the brain until it intersects with two other lobes, the parietal lobes as well as the temporal lobes, these cortical areas are labeled V1, V2, V3, V4, V5/MT, in these serial order beginning with V1 and propagating deeper into the brain until V5 which is also sometimes referred to as (MT) and which lies at the boundaries between the occipital lobe and the temporal lobe.

Each area/region contains selective neurons that respond to particular stimuli, where one selective neuron responds to one and only one highly specific stimulus. The deeper the region is, the more complex the types of stimuli which said region's selective neurons are found to be selective to. For example, region V1 tends to contain selective neurons that are selective to particular edges with particular orientations and within particular retinal regions. They are also selective to particular colors and edges moving in particular directions.

On the other hand, selective neurons in region V2 are selective to more complex structures like particular shapes found in particular retinal regions with particular sizes. This is due to the forward propagation of information from lower levels of distributed representations in V1 to higher levels of distributed representations in V2 as a result of both regions being strongly connected to one another. Similarly, deeper regions in the occipital lobe like region V5/MT are selective to even more complex stimuli like moving objects, and are directly associated with motion.

In this disclosure we refer to those highly specific selective neurons as selective specific neurons, and when we introduce the process of mammalian generalization below, we introduce another type of selectivity which leads to the introduction of another set of neurons which would be referred to as selective general neurons.

Selectivity is established when a set of neurons form feedforward connections with a neuron/a set of neurons from the relatively forward layer, these sets of early layer neurons themselves form laterally connected web of connections, where they act as a mental representation of information which are then abstracted by the relatively forward neuron/s via feedforward connections, this serves the purpose of adding diversity, as it allows different sets of neurons to be responsible in representing different sets of webs.

For example, if we assume a 3*3 retinal patch, (retinal refers to the visual sensory regions in the eyes which input stimuli are presented on when a mammalian creature perceives visual stimuli), where the 3*3 grid is composed of 9 neurons, each can hold two states, an “on” state representing white spots, and an “off” state representing dark spots, then those 9 bits can carry around 2\hat{ }9=512 possible combinations of neural representations that can be represented by this particular neural patch, these include all 9 possible vertical, horizontal and diagonal distinct edges that can be represented by a black and white input.

We divide this domain of possible inputs into two categories, structured information and unstructured information. Structured information is information that carries an anthropological meaning in its structure (as in, we humans can attribute some meaning to it), and therefore is distinguishable from noise or randomness. For example, an edge is a structure, or a particular shape is a structure, whilst unstructured information is noise or random distributions of binary activations across the patch. As is clarified later, the domain of structured information is way less than the domain of unstructured information, and the former is more commonly found when experiencing the real world.

Selectivity allows for neurons in the feedforward layer to specialize, where they can only be activated in response to one and only one particular stimulus in that space of possible structured stimuli, these could include all kinds of visual building blocks, like color, edges, shades, and even slight temporal changes of any of the previously mentioned visual features as is clarified later, and through an all or non-neural signaling process of activation, the mammalian neural network architecture can represent such information through distributed neural representations. To aid the reader in understanding how this is possible, we first briefly discuss visual processing, as we use the visual implementation of this architecture in building examples to clarify the inner workings of this architecture within the rest of this entire section as well as the subsequent sections.

The visual system in the mammalian brain, is comprised of three main structures, the sensory devices (the eyes), the LGN thalamic nuclei and the occipital lobe, specifically the visual cortex part of the occipital lobe. We focus only on two of these here, namely, the sensory devices and the occipital lobe. The sensory devices refer to the eyes in the mammalian brain which has a special structure, this structure is discussed in detail below. Based on that structure, the eyes project to the occipital lobe two types of information through two types of cells, called midget cells, on-center midget cells and off-center midget cells. In short, on-center midget cells respond to light spots which are surrounded by a dark area, and off-center midget cells respond to dark spots which are surrounded by a light area, these two distinct types of signals are projected across the primary visual cortex which is the first layer in the occipital lobe. Below, we discuss how the retinal structure leads to these two distinct types of signals, responding to two different distinct states in the retinal patches.

In the mammalian visual sensory devices (the eyes), a photoreceptor cell plays the role of a pixel, where in the mammalian system, a midget cell is a structure that is composed of one centering photoreceptor cell and a few surrounding photoreceptor cells.

The center pixel is connected to both an on and an off ganglion cell, and when it detects that the surrounding cells are light and that the center cell is dark, through a process that is out of the scope of this application, the off ganglion cell sends signals to the occipital lobe to neurons that specifically respond to (i.e., are selective to) those off ganglion cells, and when it detects that the surrounding cells are dark and that the center cell is light, the on ganglion cells send signals to the neurons that specifically respond to those on ganglion cells in the occipital lobe, this occurs specifically in the primary visual cortex where the optic nerve fibers (which project information from ganglion cells in the retina) terminate.

In other words, for every photoreceptor cell in the retina (pixel), an “on” ganglion cell would fire if that particular spot (pixel) in the retina happens to be a light (high intensity) spot surrounded by a dark (low intensity) area, and an “off” ganglion cell would fire if it happens to be a dark spot surrounded by a light area, and in turn an “on” neuron is active or an “off” neuron would be active in the primary input layer of the visual cortex. This allows the visual system to respond to both dark and light spots, by providing two types of selective specific neurons each tasked to respond to one and not the other. This means for every cell in the primary occipital lobe layer, two types of neurons can be active not just one depending on what the visual sensory devices are sensing.

In a potential visual implementation of this architecture, we replicate such structure, where for every node in the first layer of the network, two neurons are provided which both signal activation based on two different types of inputs they could receive, one signals an activation in response to a light pixel (surrounded by dark areas) and another in response to a dark pixel (surrounded by light areas), and we refer to them as “on” and “off” neurons, respectively. In other words, in the layer structure of the visual implementation every cell in that layer is composed of two selective specific neurons (nodes), each responding to one state and not the other, this is clarified further below.

In the mammalian retina, the midget cells tend to be arranged in an overlaid sideward arrangement, this arrangement allows for the detection of not only dark and light spots, but also dark and light edges of various lengths and various orientations, establishing the first biological edge detection mechanism. This is because every surrounding photoreceptor cell (pixel) of one midget cell is a center for another adjacent midget cell, hence when one center sends an “off” signal and the adjacent cell sends an “on” signal we thereby establish an on-off linear segregation across the detected line, where “on” neurons and “off” neurons form a spatial distribution of activation in correspondence to the light and dark areas relayed from the sensory device, this is further clarified below.

These distributions of “on” and “off” neurons in the first layer of the primary visual cortex are then fed forwardly to form simple neurons in the primary visual cortex V1 which can learn to be selective to particular edges with specific lengths and with particular orientations. The visual system of the network can also learn to be selective to particular colors and shades in a particular retinal patch using the same binary “on” and “off” neural representation discussed earlier.

Two types of photoreceptor cells exist in the human retina, cones and rods for, photopic (day light) and scotopic (night light) visions, respectively. Cones respond to color variations and rods respond to light intensity. There are three types of cone cells in the human retina, long, medium, and small, where long cone cells tend to pick up wavelength of light that are in the long-wavelength range of the visible light spectrum and medium and small cones pick up medium and small wavelengths, respectively. All three together allow for color vison in the deeper cortical areas of the occipital lobe.

Since neurons send discrete action potentials which follow an all-or-non activation function, encoding intensities as varying values is not an option in NNNs, therefore, the solution proposed herein is to encode such information in the ratio of the amounts of on versus off photoreceptor cells within a particular retinal region bounded by a kernel. Recall that “on” and “off” are two different states representing light and dark, respectively. This is because “on” ganglion cells encode light stimulus and “off” ganglion cells encode dark stimulus, and by varying the ratio of the “on” ganglion cells and the “off” ganglion cells, i.e., varying the ratio of light points versus dark points within a certain patch of the retinal region, we encode a large set of different varying shades of gray, the same way a painter varies the grayness of a paint by varying the ratio of white to black paint, either by blending more white to achieve lighter shades or blending more black to achieve darker shades.

Numerosity (numerous) allows for greater variations, for example, two rods can only produce three shades, namely, black (two “off” signals), white (two “on” signals), and middle gray (one “off” and one “on” signal). On the other hand, when the amount of photoreceptor cells grows, the amount of possible variations grow, for example, 5 rod cells can produce 6 shades of gray as follows: 5 “on” signals, for bright (white), one “off” and 4 “on” signals, for a darker shade, 3 “off” cells versus 2 “on” cells, for a close to middle gray shade, and all 5 “off” signals, for dark (black), etc.

The same is the case for encoding color variations, the human retina has around 1 million cone cells in the fovea region, where both red (long) and green (medium) cones are predominately found in higher ratios relative to blue (short) cones, and when in a certain retinal patch, a specific color is being projected, say a red light, the red cones are activated sending “on” signals whilst the green and blue cones would not be activated and hence would send “off” signals, and again using such binary representation, and by specifying a particular locally bound patch, the network can learn a huge amount of color variations, as explained more herein.

The more photoreceptor cells there are in a particular small region, the more possible variations of shade/color that could be perceived, and hence the more is the amount of distinctions of shades/color that would exist, however, to ensure that the information stored within a single region is not complex, since there could exist an infinite amount of possible localized configurations of “on” to “off” cells which share the same amount, i.e., 5 “on” signals on the top of the kernel, and 5 “off” signals at the bottom or vice versa, and/or ratio, i.e., 20:10, 10:5, 2:1 etc. two things shall happen.

One regarding the ratio, where the particular region of retinal receptive field should be confined, two regarding the local configuration, where the mapping from pixel HSB values (B—Brightness for artificial rods and H-Hue for artificial cones) to “on” and “off” artificial neural representations should be locally systematic and not locally randomized in distribution, so as to ensure that any particular Gray Value from the sensor's pixels correspond to only one particular localized configuration of on-off ganglion cells within a particular emulated retinal region, this configuration is clarified further below.

The size of the receptive retinal region which shall capture varying shades can't be left unbounded, locality acts as a natural limiter when it comes to processing color or shades in the world, when a huge amount of varying colors are concentrated within a very spatially small patch/region, the colors get blend together and it becomes harder to establish boundaries between them.

For example, the RGB color channels in a TV set, are too small in size to allow for a human viewer to establish spatial boundaries between the red, green and blue channels, therefore information coming from that particular pixel has all the three spatially close little channels perceived as blended information to the perceptions.

Therefore, the mammalian brain sees the variations of these different channels as one distinct color information rather than three distinguishable (red, green, and blue) hues, however when the patch of pixel region is wide enough, the effect of blending information is lost and the observer starts receiving distinct color information from different small but observable little spatially bound regions, in other words the mammalian brain's ability to distinguish and form spatial boundaries participates in the limitations of color/shade blending effect.

The general take from this brief description of the visual system is to show that a set of neurons in the first layer of the occipital lobe as well as the visual implementation of an NNN architecture, can learn to be selective to a particular binary map of neurons in the retina which can map to one particular color or shade variation as well as edges.

By now we finished clarifying briefly how the visual system can transform sensory information into binary neural representations, relying solely on two types of neurons “on” and “off” cells. The previous brief explanation was made only to aid the reader, while understanding the concepts laid in this section as well as comprehending the examples used below.

The role of selective neurons is to abstract simple sensory information and then use them as building blocks for slightly more complex information, where this slightly more complex information in turn act as building blocks for even more complex information and so on and so forth propagating forward, from low level distributed neural representations to high level distributed neural representations, those selective neurons are the counterparts of hidden layer neurons, and they play a role, similar to traditional convolutional neural network's (CNN) convolution layer neurons. The convolution layer neurons in a CNN act as quantitative representations of information that are relayed from the previous layers, and the deeper we go into the convolution layers, the more complex information the neurons of such given layer represent as the receptive field increases.

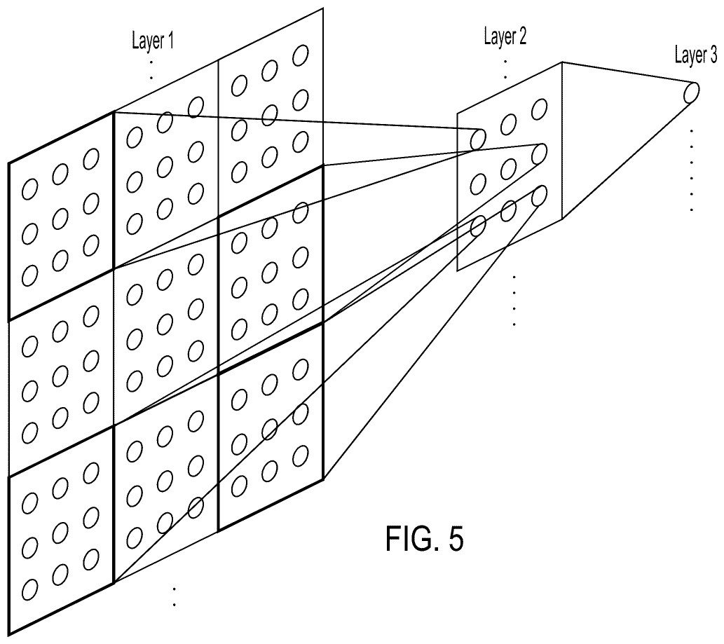

A receptive field refers to the amount of input neurons a given hidden/selective output neuron represents overall. For example, if we maintain the receptive field of any given neuron in a particular layer to be a 3*3 grid/patch of neurons from the layer directly prior to it, then neurons at layer 2 will be representing a 3*3 patch from the input layer whilst neurons at layer 3 will represent a 3*3 patch of neurons which themselves each single handedly represent a 3*3 patch, hence they overall represent a 9*9 patch from the input layer as shown in FIG. 5. As shown in the FIG., there can be 3 layers of nodes, with a 3×3 kernel size and a stride of 3 each, where layer 1 contains 9×9=81 total nodes such that each 3×3 kernel bound region containing 9 nodes is represented by one node from layer 2, and since the stride is 3, the total amount of nodes in layer 2 is 9 where each node represents one 3×3 kernel bound region from layer 1, and the same goes for layer 3 where the total amount of nodes is 1. This assumes that the stride is 3, the deeper we go in layers the greater is the receptive field of the neuron that lies in that layer, this allows deeper neurons to have the ability to represent more complex information. In this architecture each neuron of one layer, can form connections to neurons of the next layer, where the next layer neurons represent a bunch of neurons from the prior layer, this is to establish and mimic selectivity, and we discuss this in relation to the discussion on how these connections form herein.

The difference between the neurons of a convolution layer in a CNN and the selective neurons of a mammalian brain as well as NNNs, is that the role played in the latter by selective neurons is a qualitative role with no quantitative aspects, contrary to neurons in CNNs, the selective neurons merely represent webs of sensory information from the layers' behind them, and can only be active or inactive, i.e., can only be in a binary state representing a yes this information is being perceived or a no it is not, and hence, since they do not play any quantitative role, and contrary to CNNs, there are no matrix transformations implemented on NNNs layers like pooling layers or any as such.

To establish selectivity, a form of connectivity structure has to exist, the feedforward connectivity structure, this section addresses the establishment of feedforward connections in the structure of this architecture, and then the subsequent section addresses the establishment of lateral connections in the architecture. Overall the following two sections describe the different types of connectivity structures in an NNN architecture and how they process information alongside with the learning algorithm which was introduced on the previous section.

It is established in cognitive neuroscience, that the mammalian brain at early development begins with a neural network structure that is highly interconnected locally; as in neurons within one lobe or cortical region, as well as globally; as in lobes connected amongst one another, where all the different cortical regions send and receive many connections amongst one another, then over the period of development these immense connections get pruned over time, and the mammalian brain transitions gradually from one where one neuron has millions of connections directed to million other neurons from a vast range of other cortical regions, to a neural architecture where a set of neurons converge towards a specific limited amount of lesser connections to some specific cortical regions.

This gradual pruning process which occurs over the early years of development, is referred to as brain maturation, where the brain gradually transitions from an immature state to a more mature state via synaptic pruning. Synaptic pruning refers to the loss of connections that occur between a pair of presynaptic and postsynaptic junctions when they lose spines and branches that were previously present at early conception.

Similar to the mammalian brain, an NNN architecture starts fully connected, where all the connections/weights are made to be of equivalent strength magnitude at conception, as opposed to being of randomly distributed strength magnitude as is the case in traditional artificial neural nets (ANN), then over time and through direct experience, i.e., by merely the act of experiencing the environment, some of these connections would gradually weaken until they get pruned whilst others would get strengthened, and it is through these processes of strengthening and weakening under the network's direct experience of the environment, where the network would begin developing selectivity towards particular stimuli. This process is automatically driven and is only governed by the learning algorithms stated in the earlier sub-section, and the processes by which this is achieved is explained below.

In this section we introduce a feedforward connectivity structure alongside the learning algorithm established previously to replicate the processes of selectivity, where by the end of this section the specific selective nodes in the neuromorphic neural network architecture are able to dissect the perceived visual/acoustic raw data into stimuli which represent structures and sub structures of the visual/acoustic raw data via direct experience and without any data manipulation like labeling such data or otherwise, such specific selective nodes, are used in a process we refer to as qualitative generalization, which would in turn generate selective general nodes.

The processes by which this network forms feedforward connections can be divided into two, based on the stimulus being experienced by the network, spatial processes and temporal processes, where the former deals with the network's ability to establish selective neurons which respond to spatially distributed stimuli, while the latter deals with the network's ability to establish selective neurons which respond to temporally distributed stimuli.

Spatially distributed stimuli, is the term we coin to refer to visual stimuli that can be sufficiently represented within one moment in time, and tend to be distributed across the visual field through the property of extension; hence spatial. These include static shapes, static objects, and so on, whilst temporally distributed stimuli, is the term we use to refer to stimuli that are distributed across time and may or may not be distributed across space, these include sounds, and moving objects/shapes.

The following sub-sections of this section deal with spatially distributed stimuli, whilst the subsections subsequent to these deal with temporally distributed stimuli.

### Section 2-A (Feedforward Connectivity Structure for Spatially Distributed Stimuli)

Here, we introduce the feedforward connectivity structure we implement which alongside with the learning algorithm introduced previously, allows for the establishment of selectivity for non-temporal stimuli (spatial stimuli).

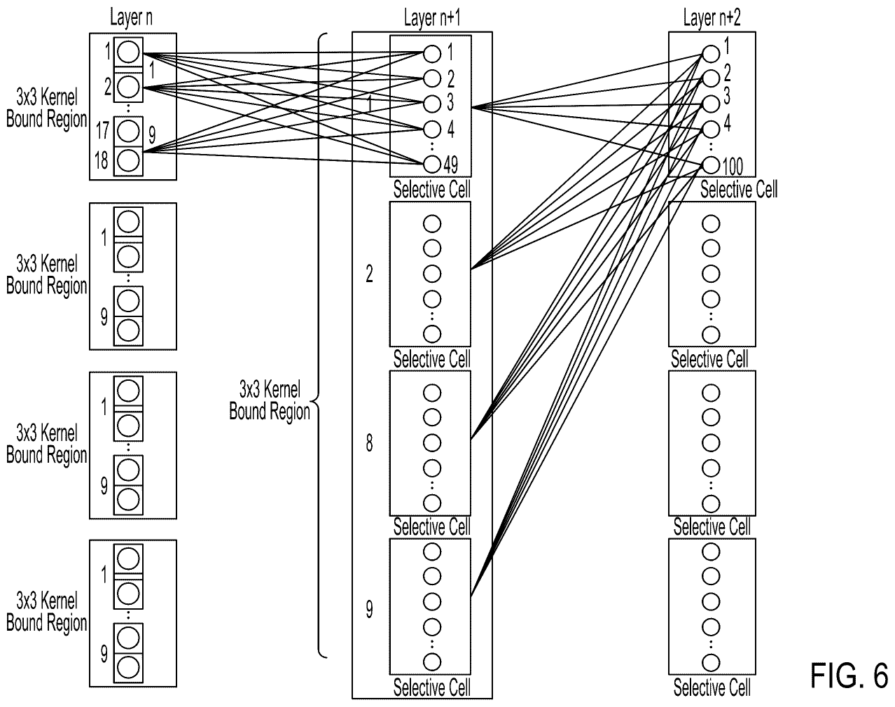

In NNNs, the structure of the feedforward layers is divided into two distinct parts, the receptive area and the selective area, the receptive area refers to a particularly defined receptive field area that encompasses a collection of input neurons, for reference, in the visual implementation, the receptive area is bound by a predefined kernel similar to the one used in the convolution layers of a traditional convolution neural network architecture (CNN), whilst the selective area refers to a greater collection of neurons from the feedforward layer/s (i.e., the layer/s that lie ahead) that is also predefined as a kernel bound region, the receptive area can take any form of inputs in the form of binary neural activations across the entire kernel bound receptive area and encode them by forming connections towards one and only one neuron from its corresponding selective area, this then propagates forward across every pair of input-output layers, where the selective area of a given layer participates in being part of the receptive area to the next layer, and so on and so forth as shown in FIG. 6.

In FIG. 6, each column represents a layer of nodes, where the first column counting from the left (i.e., Layer n) represents the first layer which contains 4 3×3 kernel bound regions each containing 9 receptive cells labeled 1 to 9, where each receptive cell contains two receptive nodes labeled 1 to 18. The second column counting from the left (i.e., Layer n+1) represents the layer directly ahead of the first layer, namely, the second layer, and it is dissected into 9 selective cells labeled from 1 to 9, each containing 49 selective nodes, labeled 1 to 49, where the aggregate of all 9 selective cells also act as one 3×3 kernel bound region relative to the layer ahead of it, and where each selective cell acts as a receptive cell, and each selective node act as a receptive node relative to the layer ahead of them. The third column counting from the left (i.e., Layer n+2) represents the layer ahead of the second layer, namely, the third layer, and it is dissected into 9 selective cells labeled from 1 to 9, each containing 100 selective nodes, labeled 1 to 100, where the aggregate of all 9 selective cells also acts as one 3×3 kernel bound region relative to the layer ahead of it, and where each selective cell acts as a receptive cell, and each selective node acts as a receptive node relative to the layer ahead of them. This structure carries on as prior layers for forward layers, the figure is only intended to show a fraction of the layer structure.

The connectivity amongst nodes between layer 1 and layer 2, follow an all receptive nodes per kernel bound region to all selective nodes per corresponding selective cell, where each kernel bound region has a corresponding selective cell region, and such that each receptive node within the kernel bound region is connected to each and every selective node from the corresponding selective cell region. This carries on the same for all subsequent layer pairs, where on the figure the connectivity structure between layer 2 and 3, are from all receptive nodes which belong to all receptive cells that belong to the entire kernel bound region shown on layer 2 all connecting to each and every node from the first selective cell shown on the top of layer 3.

Initially, every neuron from a given receptive area, has both normal excitatory connections and reverse inhibitory connections that project feedforwardly to each and every single neuron from its corresponding selective area, (we refer to the predefined kernel bound region from the selective area that corresponds to a given receptive kernel bound region as a selective pool kernel). Each selective neuron that belong to one selective pool kernel receives connections that vary in latency relative to other selective neurons that belong to the same selective pool region, as is clarified later, the variation of axon length and cross sectional area in the biological mammalian brain, allow for a variation in signal transmission, and from here onward this is logically abstracted as latency. (In this section we use the words “neuron” and “node” interchangeably, the reader should not be confused when encountering either).

At conception, i.e., at the starting condition, the reverse inhibitory connections are made weaker than the excitatory connections, in other words at the initial condition, the weight value of the reverse inhibitory connections is made lower than the weight value of the excitatory connections. Additionally, we connect every selective neuron that belongs to one selective pool kernel to every other selective neuron that belong to that same pool kernel through normal inhibitory connections that are specifically tuned to have the maximum synaptic strength value, and which are modified specifically to have no lifespan, in other words, one which retains its predefined connection strength indefinitely.

The purpose of these modified strong and strength-non-deteriorating normal inhibitory connections, is to ensure that at one particular moment, only one selective neuron per selective pool kernel bound region can be active at a time, where as soon as one neuron from a given selective pool kernel bound region is activated, all of its inhibitory connections can constantly send intense hyperpolarization signals (negative voltage values) to each and every other selective neuron which lies in the same pool, ensuring the total suppression of said neurons, until such inhibitory influence is alleviated by turning off that particularly active selective neuron. This is inspired by the fact that in the mammalian brain architecture, for every neocortical column, an excitatory neuron can activate an inhibitory neuron which itself forms many synaptic posts with other excitatory neurons which lie in the same vicinity of said excitatory neuron, and hence can shun their activations.

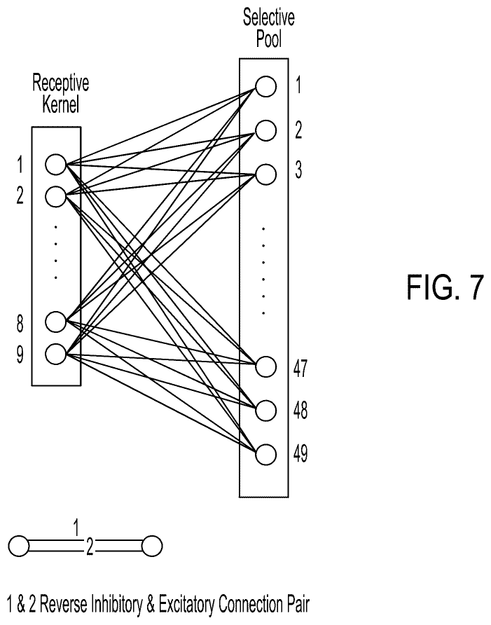

The feedforward connections from a given receptive bound region and to its corresponding selective bound region, is formed with the following three parameters. One, there must be a variation in latency between the connections that belong to a given set of neurons from the receptive field region and each single selective neuron that belongs to the corresponding selective pool region, this variation would change across layers as is explained later, however, for the sake of the current explanations we assume an allocated 1 millisecond variation. Two, every neuron in the receptive area forms two pre-allocated feedforward connections, one excitatory and one reverse inhibitory, projecting to each and every single selective neuron from its corresponding selective pool region in the feedforward layer as shown in FIG. 7. Three, the reverse inhibitory connections are initially made weaker than their counterpart excitatory connections at the initial condition.

As shown in FIG. 7, there are two columns including one representing a single receptive kernel and another representing a selective pool, also to be referred to as a selective cell. The receptive kernel contains 9 receptive cells labeled 1 to 9, and the selective pool contains 49 selective nodes labeled 1 to 49. Each and every receptive cell is connected to each and every selective node, and by extension each and every receptive node is connected to each and every selective node. The figure only shows receptive cells and not the receptive nodes per receptive cells for simplification. Each connection from a receptive cell to a selective node consists of a feedforward specialization connection pair, which is composed of an excitatory and a reverse inhibitory connection pair.

If we say that in the visual implementation, we have a pool of 50 Selective neurons in the selective pool kernel that correspond to a 3*3 receptive grid kernel, then initially, upon perceiving a visual stimulus for the first time post conception, an activation would occur in this receptive area, and as a result each and every selective neuron from its corresponding selective pool area would receive a net depolarization signal through the feedforward normal excitatory connections due to parameter three, however and based on parameter one, the first selective neuron receives a net depolarization signal from the active neurons in the receptive area and be activated 1 milliseconds later, and the second selective neuron receives a net depolarization signal from the same set of active neurons in the receptive area and should be activated 2 milliseconds later, and so on until the fiftieth neuron which would receive a net depolarization signal 50 milliseconds later and therefore should be activated 50 milliseconds later, but since as was clarified earlier, the activation of one selective neuron would suppress the rest, only one neuron is active at a time, and initially this would be the first selective neuron, which is the one with the lowest latency.

The feedforward reverse inhibitory connections serves the establishment of selectivity, and allow only one set of binary neural activations (which represent a stimulus) from the receptive region, to activate one and only one particular selective neuron from its corresponding selective pool kernel region, thereby establishing a selective neuron which would represent said stimulus.

This happens after a set of many encounters of said stimulus under a process of learning which is based upon varying the strength modulation ratio of reverse inhibitory connections to excitatory connections in correlation to the frequency of encountering the stimulus, where varying the strength modulation ratio would allow us to vary how selective a given selective neuron can be to any given stimulus as is clarified in details shortly after.

To understand the feedforward learning mechanism employed by NNNs, it is necessary to clarify that at a given time not all neurons from the receptive area are active simultaneously, for example, in the visual implementation, one cell from a 5*5 grid, can be in one of two states either in an “on” state or an “off” state representing light spots and dark spots, respectively as was clarified earlier, and when a stimulus is projected onto the primary layer, one neuron is active and the other would not be active, for example, if the cell is a white cell then the “on” neuron will be active whilst the “off” neuron will be inactive and vice versa.

Pay attention to not misconceive, that both the “on” and “off” states are represented by activations not by inactivation versus activation. In other words, in the mammalian brain as well as in this architecture, a neural inactivation does not represent “off” whilst a neural activation represents “on”, as both “on” and “off” are rather represented by activations however through different neurons that respond selectively to one state or the other (“on” neurons respond to light spots and “off” neurons respond to dark spots).

“On” and “off” are merely scientific terminologies established by neuroscientists to differentiate two types of midget cells which send the same type of activation signal through two different types of ganglion cells, and as was clarified earlier they represent cells that respond to light spots surrounded by dark areas and these send signals through “on” ganglion cells, whilst the other type responds to dark spots surrounded by light areas and these send signals through “off” ganglion cells, hence “on” and “off”.

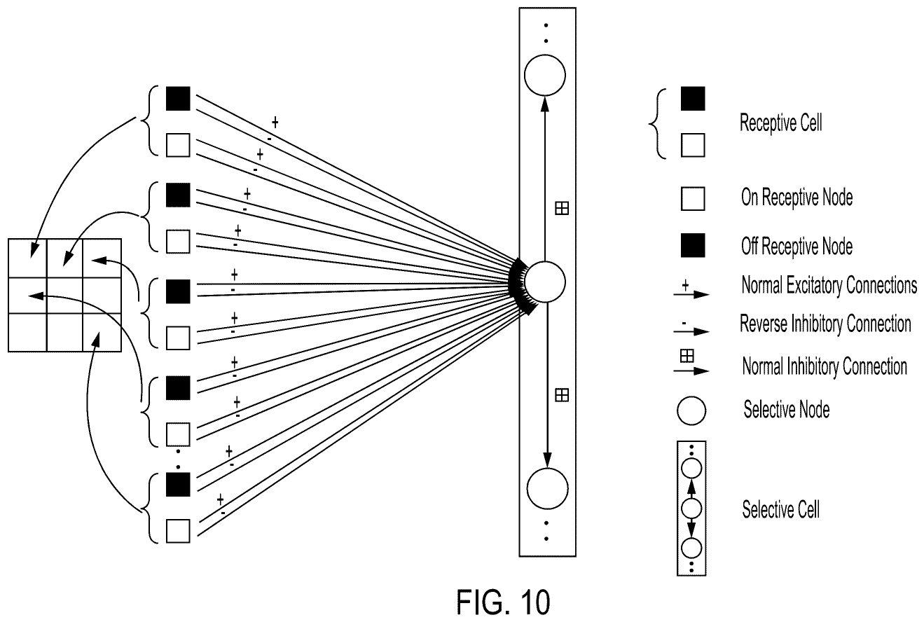

For additional clarification, FIG. 10 illustrates in detail the proposed feedforward connectivity structure, within the context of binary nodes per receptive cell for a 3×3=9 receptive cells sized grid. In FIG. 10, there is shown a receptive kernel belonging to the first layer and its corresponding selective cell, where the receptive kernel is represented by a 3×3 grid of squares, such that each square represents a receptive cell, where each receptive cell is represented by a pair of squares nodes, one shaded and another unshaded, such that the shaded square represents an “on” node and the unshaded square represents an “off” node, all represented on the first column of nodes counting from the left. Also shown is a selective cell represented by the second column counting from the right, where said selective cell is composed of a set of selective nodes represented by the circles. Each and every receptive node is connected to each and every selective node, however, to avoid clutter we only show the connections formed towards one selective node showcased on the center of the second column. Additionally, there are two connection types shown projecting from the receptive nodes and towards the selective nodes, excitatory and reverse inhibitory connections represented by a + and − label over the corresponding connections. Also shown, is a third type of connection, namely, normal inhibitory connections, which are represented by connections labeled with a + sign within a small square, where said connections project from each selective node to every other selective node that is a member of the same selective cell. On the figure and to avoid clutter we only show the normal inhibitory connections projecting from one single selective node, the center node.

In the implementation of the visual system, say a receptive area X, spanning a 3*3 grid of input cells, whereas mentioned previously these cells hold binary states where they can either send “on” signals through “on” neurons or “off” signals through “off” neurons (representing white and black, respectively), in the layer directly in front of this receptive area, there must be a selective area which can encompass 50 selective neurons, and since the grid is 3*3 and because each cell can be in only one of two binary states (pay attention that a cell represents two neurons one “on” and another “off”, and hence we only count activations not inactivations), then the amount of possible combinations of stimuli that can be represented in a 3*3 grid, is 2\hat{ }9=512 possible combinations. However, as clarified earlier, most of these combinations would represent unstructured information which represent noise, and structured information like black edges within white backgrounds with all of its possible orientations in a 3*3 grid as well as other structures like crosses and so on, would be a fraction of this amount, hence our hypothetical allocation of only 50 selective neurons.

For every possible stimulus that represents some structured information and which the network can experience within that particular receptive grid/region, we expect that one and only one selective neuron from the corresponding selective pool region would learn to be specifically selective to it, this would be possible through direct experience and under the governance of the learning algorithm mentioned in the previous section and through a learning process which is discussed shortly after.

This learning process starts when neurons in the receptive area get activated as a result of perceiving some stimulus from the external world, those active neurons from the receptive area and regardless of whether they represent “on” neurons or “off” neurons (white or black, respectively), sends net depolarization signals to the selective pool, and this as clarified earlier would cause the activation of one selective neuron from said pool, more specifically the first in the pool, (first as in, the selective neuron that is connected through the connection with the lowest latency), this neuron would suppress the rest and hence none other than it would get activated at that particular moment even though the rest would receive similar depolarization signals from the input layer, and this is due to the relatively and significantly higher hyperpolarization signals which those other neurons would receive through the modified strong and strength-non-deteriorating normal inhibitory connections as a result of the activation of the first selective neuron.

Such feedforward communication from the receptive layer and to the selective layer, based on the learning algorithm serves two modulations, first, increase the strength of the feedforward normal excitatory connections which project from the active neurons (whether those represent a white or a black cell, on or off, respectively) and to a given selective neuron, because a successful pre-post communication would have been registered where the presynaptic neuron was active and the postsynaptic neuron was also active afterwards, and second, this would also increase the strength of the feedforward reverse inhibitory connections which project from the inactive neurons (again, regardless of whether they represent a white or a black cell, on or off, respectively) to that same selective neuron, since a successful inactivation followed by activation would be registered.

This would result into a template of connections between the layers, such that the neurons that were active from a given receptive bound region in the receptive layer would form stronger normal excitatory connections with the selective neuron that happens to be active and which belongs to its corresponding selective pool region from the selective layer, whilst the neurons that where inactive at that same moment and which belong to that same receptive bound region from the receptive layer would form stronger reverse inhibitory connections with that same selective neuron.

This would mean that the connection map from the receptive region and to any particular selective neuron would be forged by the experienced stimulus, since the normal excitatory connections that project from the neurons which represent the stimulus (as in are part of it) get strengthened whilst the inhibitory connections that project from the neurons which do not represent the stimulus (as in are not part of it) get strengthened, establishing a kernel of weights (connections) from the receptive region and projecting towards that specific selective neuron, and which as is clarified shortly after, allows that particular selective neuron to be specifically tuned to one particular stimulus, as it becomes specifically responsive to it, establishing selectivity.

This means reverse inhibitory connections would act as recorders which wait to record a stimulus based on activations in the selective pool region, recall that the condition for such connections to be strengthened is that the pre synaptic neurons are inactive while or before the postsynaptic neuron is active, and hence the activation of the selective neuron in the selective pool acts as the trigger of the recorder sort of speak, since only when the selective neuron is active, would modulations commence to the reverse inhibitory connections that are connected to that selective neuron based on the learning algorithm.

Recall that the causal influence of reverse inhibitory connections, is opposite to its spatial learning direction, and hence reverse inhibitory connections exercise exactly the same influence to postsynaptic neurons as the one exercised by normal inhibitory connections, in other words, if a previously wasn't activated cell was later activated, where due to its previous inactivation had formed strong inhibitory connections to a given selective neuron, then upon its activation, an inhibitory hyperpolarizing signal would be sent to the postsynaptic selective neuron.

Therefore, by connecting negative voltage weights/connections from those neurons that were previously not active (not part of the stimulus), and positive voltage weights/connections from those neurons that were active (part of the stimulus), at another encounter after selectivity was established, if any of the non-previously active neurons from the receptive area were to be active, they would send a hyperpolarizing signal which draws the feedforward selective neuron that they had previously formed connections with, away from activation.

For example, if another stimulus B shown was to be encountered, the activation of those neurons which did not initially participate in the making of the previous stimulus A, i.e., the previously inactive neurons, causes a negative hyperpolarizing signal that would hyperpolarize selective neuron A through the reverse inhibitory connections connected to them and therefore would aid in suppressing its activation, and aid in preventing it from being activated, as the hyperpolarization signals would counter the depolarization signals being sent.

In other words, if the on-off neural activation map which represented the stimulus in the receptive region, were not the same at the other encounter due to a difference in the perceived stimulus, the particular selective neuron from the corresponding selective pool region that already learned said stimulus, does not activate because the template of the active receptive neurons would not completely match with the template of the connections connected to said selective neuron.

If such is the case, since that new stimulus B will be considered a newly not previously encountered stimulus, those same new on-off cells from the receptive region which represent said stimulus, are going to participate in modulating a new set of connections with a new different selective neuron B from that same selective pool as was the case with stimulus A, and then at another encounter, if either stimulus B or stimulus A are once again presented onto that same particular receptive kernel bound region in the receptive layer, depending on which stimulus is presented, either stimulus A or stimulus B, selective neuron A or selective neuron B from the selective pool would activate, respectively, and the particular connections which would lead to the activations of either neuron A or B will strengthen accordingly based on the learning algorithm, otherwise if neither neurons A or B are active, the stimulus is considered new and a third set of new connections with a newly third neuron from the selective pool would be established and so on and so forth.

For a full suppression of the selective neuron upon perceiving a different stimulus which it does not represent, the hyperpolarizing signals sent by the inhibitory connections and the depolarizing signals sent by the excitatory connections to the selective neuron shall at least exactly cancel one another, for example if a selective neuron has previously learned a stimulus that is composed of 9 white cells, and then at a later encounter an 8 white cells 1 black cell stimulus was encountered, the 8 white cells would send to that particular selective neuron which already learned 9 white cells previously, 8 depolarization signals, whilst the 1 black cell would send 1 hyperpolarizing signal to that same selective neuron, in such scenario, in order for the signals to cancel out, the 8 depolarizing signals have to be equivalent to that 1 hyperpolarizing signal.

Since the magnitude of a signal sent through a given connection is made to be directly proportional to the strength of said connection, by varying the connections' strength modulations for reverse inhibitory connections relative to their counterpart excitatory connections, we can tune selectivity at will, this variation can be measured by a strength modulation ratio which represents the difference in strength magnitude given to a particular feedforward reverse inhibitory connection relative to its counterpart excitatory connection, and which we refer to as the selectivity factor.

For example, in the previous scenario the strength modulation ratio given to the feedforward reverse inhibitory connections has to be 8× the amount of strength modulation given to their neighboring feedforward excitatory connections, therefore 8:1, which would mean a selectivity factor of 8, this means every time an excitatory connection is strengthened in the previous scenario, the reverse inhibitory connections which are found in the same feedforward bundle of connections has to be strengthened 8 times more.

Since the causal signal influence is made to be directly proportional to the strength of the connection transmitting said signal, keeping up with the previously mentioned selectivity factor in the previous scenario, this would mean that 8 excitatory signals made by 8 different connections at a strength value 1, would have a net depolarization signal of 8 points, whilst 1 inhibitory signal made by 1 reverse inhibitory connection at a strength value of 8, would have a net hyperpolarization signal of −8 points, hence canceling one another out, this would establish what we refer to as perfect selectivity, which is the state where one cell change in any x*x grid of x\hat{ }2 cells, say 3*3 grid of 9 cells, is sufficient to render the stimulus different than another, as was the case in the previous example, and this would mean that the network can learn to distinguish between two 3*3 grid stimuli where one and only one cell in both stimuli is different between them.

This will make it such that, at a new stimulus encounter, if the stimulus did not completely match any previous one, the reverse inhibitory connections exercise their inhibitory influence on that particular selective neuron and suppress it, hindering it unresponsive to any other stimulus that is not the one it had learned to be selective to before. This would then allow one of the other unallocated selective neurons in the selective pool to be activated milliseconds later, since first, it would not be suppressed by another member of the same pool, and second, it would receive a depolarization signal from the receptive area since all the selective neurons have pre formed excitatory connections to them projecting from their given receptive layer as clarified earlier, and then the processes repeat on and on for new stimuli.

Notice that the connections were already formed at conception, and it is the power balance shift in connection strength which would allow for selectivity to emerge, in other words the modulations in the connection strengths would render some connections stronger than others based on the stimulus being experienced as well as the learning algorithm introduced, this is because for every neuron from the input layer one reverse inhibitory connection and one excitatory connection is projected to each one of the selective neurons from its corresponding selective pool, both initially are at a low strength value level where the reverse inhibitory connections are at a lower strength level than the excitatory connections to ensure that initially, the excitatory connections are able to depolarize neurons from the selective pool as clarified earlier, however as soon as a depolarization occurs, and based on the learning algorithm, the excitatory and reverse inhibitory connections are strengthened, wherein the ratio of strengthening grows until a certain point establishing a highly selective template of connections which record a particular on-off pattern of neural activation from the input layer.

To further clarify, as was mentioned earlier, each pair of feedforward pre-post neurons (where the pre neuron resides in the receptive area and the post neuron resides in the selective area) always starts with a predefined/formed pair of connections, one excitatory and another reverse inhibitory as shown in FIG. 7. Any given pair of connections projecting from one neuron in the receptive layer to one neuron in the selective layer is referred to as a feedforward connection pathway.

When a given stimulus is projected onto the receptive area, those feedforward connection pathways from a presynaptic neuron to a postsynaptic neuron, that would register a pre activation followed by a post activation, have the excitatory connections within those particular pathways positively modulated whilst would not receive any modulation effects to the strength of the reverse inhibitory connections within those same pathways, shifting the power balance in strength between those specific feedforward pre-post feedforward pathways to excitatory connections, Similarly, those feedforward connection pathways from a presynaptic neuron to a postsynaptic neuron that would register a pre inactivation followed by a post activation, would have their reverse inhibitory connections positively modulated whilst would receive no modulation effect to the strength of the excitatory connections within those same pathways, shifting the power balance in strength for those other feedforward pathways to reverse inhibitory connections.

In the mammalian brain, a tug-of-war game sort of speak, exists between excitatory neurons and inhibitory neurons before a certain neuron develops any sort of selectivity to any particular stimulus, this happens gradually over time and not directly at a sudden, in other words selective neurons develop their selectivity towards any particular stimulus over time, and more specifically over the frequent encountering of said stimulus, similarly, in this architecture, selectivity has to be established gradually and not directly, as this would aid many dynamic learning processes which would be clarified later. To accomplish this, the selectivity factor has to grow over time based on the backlog of identical stimulus encounters, where we ensure that the more a selective neuron encounters and activates in response to a particular stimulus, the more selective it becomes towards said stimulus, until it becomes highly selective to that and only that particular stimulus.

For selectivity to gradually grow, and since it is the reverse inhibitory connections which dictate how selective a given selective neuron can be to a particular stimulus, it is essential that the reverse inhibitory connections are made to initially start with a low selectivity factor which grows over many encountering of the stimulus being learned, this is established by making the reverse inhibitory connections weaker than their counterpart excitatory connections at conception, and then allow them to grow in strength with a rate higher than their excitatory counterparts, hence the exponential growth function we introduced in the previous section.

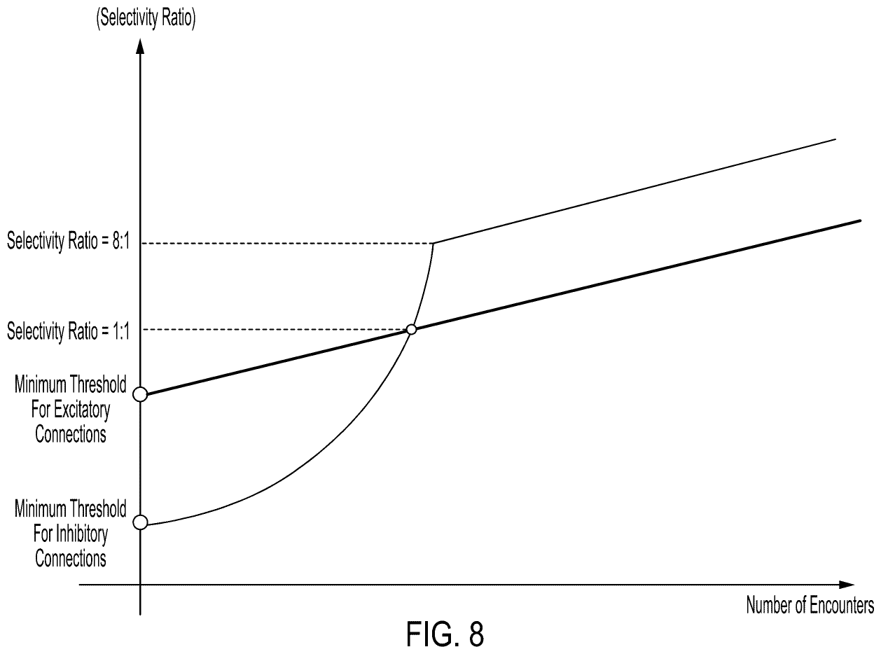

Recall that excitatory connections and normal inhibitory connections follow a linear growth function for strength modulation, whilst reverse inhibitory connections follow an exponential growth function followed by a linear growth function for strength modulation, and by setting inhibitory connections to be weaker than excitatory connections at conception, we allow selectivity to grow gradually based on the frequent encountering of said stimulus, this can be modeled in the graph as shown in FIG. 8.

In FIG. 8, the horizontal axis represents the number of stimulus encounters which corresponds to the number of pair activations which result into a positive modulation for both reverse inhibitory connections and excitatory connections alike. The vertical axis represents the selectivity ratio of a given connection type, the thicker line on the graph represents the selectivity ratio as a progression of the number of encounters/positive modulations occurring to excitatory connections, whilst the thinner line on the graph represents the selectivity ratio as a progression of the number of encounters/positive modulations occurring to the reverse inhibitory connections. The bottom most circle on the vertical axis represents the minimum threshold value for reverse inhibitory connections, whilst the circle directly above it on the vertical axis represents the minimum threshold value for excitatory connections.

The thinner lines on the graph follows an exponential growth curve and then transitions into a linear growth curve, while the thicker line on the graph merely follows a linear growth curve. The intersection point between the two graphs represents the point at which the selectivity ratio is 1:1, whilst the inflection point at which the thinner line transitions from an exponential growth curve to a linear growth curve, represents the point at which the selectivity ratio is 8:1. The thinner line and the thicker lines on the graph change over time and more specifically over the amount of successive encounters/positive modulations of the connections, showcasing the change in the selectivity ratio over time, where post the infliction point said change stops and the difference remains a constant value representing the maximum selectivity ratio achieved.

As shown in FIG. 8, the thinner line on the graph represents the strength of the reverse inhibitory connections relative to their counterpart excitatory connections which is shown by the thicker line on the graph. Initially, the strength of one reverse inhibitory connection is weaker than its excitatory counterpart, but since the former follows an exponential growth function relative to the latter which follows a linear growth function, at some point the strength modulation of one reverse inhibitory connection would be equivalent to the strength modulation of its counterpart excitatory connection, i.e., would approach a selectivity factor of 1, which is represented by the intersection point shown in the figure.

Then over time, this value would increase further, up until a certain point where it reaches a particularly defined roof limit which represents perfect selectivity, where at said point, the increase in the strength modulation of reverse inhibitory connections transitions from one which follows an exponential growth function to one which follows a linear growth function that is a constant scalar multiple of the linear growth function which excitatory connections base their modulations upon and where that constant multiple is itself the final selectivity factor achieved, this is to ensure that the selectivity factor maintains itself at a constant value from that point onward, and therefore maintain that selectivity factor.

This means up until a certain point where the selective neuron develops a high level of selectivity towards a particular stimulus, the selectivity factor stops growing and maintains itself at a constant rate, whilst the strength of the connections both excitatory and reverse inhibitory, continue to grow steadily. Recall that the selectivity factor describes the ratio in strength modulation between both type of connections, and therefore as shown in the graph, the ratio is represented by the vertical difference between the thicker and thinner curves/lines on the graph which changes over time until at some point, it maintains itself at a constant value, where that constant value is itself the highest selectivity factor achieved.

The roof limit where past its point, the reverse inhibitory connection no longer follows an exponential growth function but rather follows a linear growth function is what we refer to as the transition point weight value, and would be made such that the selectivity factor of the selective neuron that corresponds to those reverse inhibitory bundle of connections, is lower than a perfect selectivity factor, and this contributes to the network's property of malleability, as it would allow for tolerance, as is clarified in detail below.

The resultant curve shown in FIG. 8 is inspired by three aspects of biological neural networks. First, the disparity in the ratio between excitatory neurons and inhibitory neurons in the neocortex which is approximately 85:15, respectively. Second, the fact that the mammalian brain starts at conception with a highly interconnected network of excitatory connections forming thousands of synapses. Third, the limits of dendritic sprouting and the limits of the existence of axonal branches from inhibitory neurons due to their lower amounts. Recall that sprouting refers to the postsynaptic neurons ability to form dendritic branches with other presynaptic neurons.

By applying all three factors, one can deduce a graph similar to the graph showcased earlier, the disparity in ratio in the abundance of both types of neurons would describe the natural starting point where inhibitory connections would have less effect relative to excitatory connections at conception, since statistically speaking, excitatory connections from an earlier layer are more likely to project and activate excitatory neurons from a feedforward layer than project and activate inhibitory neurons from that the same layer, due to the disparity in ratio in the abundance of both types of neurons.

The disparity in growth between excitatory and inhibitory connections could be explained by the act of branching where a particular selective neuron starts to grow branches in addition to spines per branch for the inhibitory connections/axons which are projected from inhibitory neurons, up until a certain point which represents the roof, where the neuron no longer develops more branches and only continues to grow spines per branch, whilst at the same time the excitatory connections do not experience the same growth under branching due to the initial interconnectedness of said connections, recall that the brain starts initially with pre-formed branches for excitatory networks, and hence the only possible growth for these connections would be, the growth of dendritic spines.

By following the previous graph, we ensure that a neuron does not become highly selective to a particular stimulus before it accumulates a large backlog of experiences of encountering said stimulus, in other words that selectivity is progressive and gradual over time and experience.

Similarly the loss of selectivity (which would represent forgetting details as well be clarified later) has to be gradual as well, recall that as clarified earlier, these feedforward connections are given a life span, which in our preferable implementation would last for only 3 hours if the stimulus is not re-encountered within that time window, and therefore since the positive modulations of reverse inhibitory connections changes relative to its excitatory counterparts, the negative modulations of reverse inhibitory connections (deterioration) shall as well be made to follow an exponential decay function for the regions where the growth is exponential (pre selectivity) and linear for the regions where the growth is linear (post selectivity), and this is to ensure that connections which get strengthened at the same time, all deteriorate at the same rate, and also to serve the role of allowing a highly dynamic learning curve within the period at which the neuron did not yet fully develop selectivity, as is clarified in details later.

By allowing selectivity to loosen up gradually, we mimic the mammalian brain's gradual process of forgetting details, where the details of a stimulus are forgotten over time. Recall that selectivity encodes the neurons ability to differentiate one stimulus from any other stimulus, where the more selective a neuron is, the less tolerance it has for changes in the stimulus, for example, in the previous 3*3 grid example, we said that at a perfect selective state, one cell change in the input stimulus can cause a net hyperpolarizing effect that can fully counter the depolarization signals sent by the rest of the 8 unchanged neurons, 8 excitatory signals*1 depolarization point and 1 inhibitory signal*8 hyperpolarization points, where the selectivity factor is 8.

However, if that same selective neuron was at a lower selectivity state, say the selectivity factor was 2, then that same selective neuron can tolerate, 2 changes in the stimulus before a 3^{rd} cell change would render the stimulus different, since, 2 hyperpolarizing signals for 2 cell changes at a selectivity factor of 2, equates to −2*2=−4, whilst 7 depolarization signals would be sent by the remaining 7 unchanged cells, and at 1 point per signal since the selectivity ratio is 2:1, this would equate to +7*1=+7, the net result of both types of signals would be 7−4=+3, which is a net positive depolarization signal, that is sufficient to activate the selective neuron, but then if at another scenario a third cell change was introduced to the input stimulus, then the values would be −3*2=−6, and +6*1=+6, 6−6=0, a net zero depolarization signal, which would not activate the selective neuron. Therefore, the less selective a neuron becomes, the more tolerant it is to changes in the stimulus, and hence the less precise a stimulus has to be to activate the neuron, and we say the neuron began to forget the details, this is clarified in details at its proper section when we discuss memory and recognition.

Realize that the linear decay signifies the loss of longevity, i.e., how long can the neuron retain its selectivity to a particular stimulus, whilst the exponential decay signifies the loss of selectivity which translates to the loss of details mentioned previously. Pay attention that, a neuron that has been experiencing a lot of strength modulations to its connections past selectivity (i.e., after it crosses the high selectivity threshold A.K.A the transition point weight value), would retain its selectivity for as long as it would take these connections to deteriorate back to that selectivity threshold, and only then would it start losing its selectivity as it would start deteriorating exponentially, in other words, a selective neuron has to first lose its longevity before it can begin losing its selectivity.

For feedforward connections after the 3 hr life span, the connections shouldn't be broken off completely and shall rather be made to return back to their original low strength value that they initially started with at conception, and when this happens we say that the selective neuron returned back to its selective-free state, where it can learn a different stimulus by forming a different pattern of excitatory versus inhibitory connections (template). This ensures that the network is highly adaptive and malleable to the environment as is clarified below.

However, if at another time within the 3 hour window, the same specific set of “on” and “off” neurons in the exact locations, i.e., representing the same stimulus, were to be activated again, as a result of the activation of said neurons, these neurons would fire through their connected excitatory connections a depolarization signal which sum up and activate their corresponding selective neuron from the feedforward layer. As soon as the selective neuron from the second layer is active again and for the second time, modulations to both types of connections take place, since for excitatory connections, a pre activation-post activation would be registered for the neurons that were active in the receptive area, and for reverse inhibitory connections, a pre inactivation-post activation would be registered for the neurons that were inactive in the receptive area, hence and once again performing such modulations in tandem.

These modulations can accumulate unlimitedly as clarified earlier, allowing for the connections to last longer based on frequent encountering, which would translate as the selective neuron retaining its longevity for a longer time and hence preserving its selectivity.

One problem of the selectivity process mentioned previously is its serial processing nature, which leaves a lot of computational optimization in the table, another variation we offer for a parallel process of selectivity which can replace the previously mentioned process in other embodiments of this invention is to be introduced next.

To conduct a parallel variation of the neural selectively on each selective cell, we first do away with the latency variables and the minor clock cycles, and set the connection weights for both reverse inhibitory and excitatory connections to zero, and add a binary variable to each node which represents the status of the node as either unfree or free, to signify whether a node is already selective to a stimulus or not.

Then we allow for a mechanism which adds a Spontaneous activation for all free nodes (every clock cycle) while maintaining the mutual exclusive activations of the nodes for every selective cell i.e. only one node activated at a time per selective cell.

Then we allow nodes which already Learned to be selective (i.e. unfree nodes) get to be activated/inactivated aka get influenced faster than free nodes. I.e. abstracted as getting a shorter latency than unfree nodes.

This would be achieved by letting the weighted sum processing speed of a node to take two states high if net depolarization or hyper polarization i.e. signal magnitude is high or low if net depolarization or hyper polarization i.e. signal magnitude is low, low is the default timeline specified in the major clock cycle examples.

Therefore any pre-mature node activation turns off the spontaneous activation process due to the normal inhibitory conditions as they will ensure the suppression of the rest of the nodes until the major clock cycle is complete.

This way if a node was an unfree node it will have the ability to receive a signal (depolarization or hyper polarization) before any free node gets activated, and hence a reoccurring pattern if perceived gets the node that has learned it activated first, it's necessary to clarify that all unfree nodes receive the influence faster regardless if they are receiving positive influence from a matching input or negative influence from an un matching input.

On one variant the speed of activation is specified based on the nodes binary status, free/unfree. On another variation we allow for a gradual set of states of processing speeds which vary linearly proportional to the magnitude of weighted sum depolarization or hyper-polarization signal received.

Since the decay functions allow the connections to get weaker, at the end the function turns the node status from the unfree into the free status. Notice that the spontaneous activation of nodes is more in line with the biological neurons.

### Section 2-B (Spatial Segmentation)

Here we introduce segmentation, where selective nodes learn to be selective to segments and parts of stimuli as opposed to whole stimuli. In this architecture, the purpose of segmentation is to isolate independent parts of a stimulus which are found to be frequently encountered, these parts represent a set of cells that are found to be collectively encountered independent from the rest of the cells that belong to the same receptive field area, and which do not fit any predefined shape kernel boundary and can rather take multitudes of variant shape forms.

We implement segmentation in this architecture by allowing for the establishment of dynamic kernel boundaries, giving the network greater learning capability where we allow it to learn structural information that are disconnected, which could include information that have specific spatial frequencies in the static visual world. Therefore, the purpose of this subsection is to add features to the network which give selective nodes the ability to learn spatially distributed stimuli regardless of their shape and discontinuities.

Like convolution nets, information propagates forward in the layer structure of this neuromorphic neural network architecture, such that the selective nodes become the receptive nodes for the selective nodes that belong to the layer ahead and so on and so forth, but since only one node from a particular selective pool region can be active at a time, one selective pool region would act as one cell to the layer which lies ahead of it.

By arranging a kernel bound region that encompasses a set of kernel pool regions, we in turn treat one pool as one cell in the receptive kernel, this means if one pool contains 50 selective nodes, then to maintain a 3*3 grid of receptive cells and since each selective pool represents one cell, a total of 3*3=9 selective pool regions and 50*9=450 selective nodes would act as inputs to the layer which lies ahead of it, where each pool would only provide one and only one neural activation, which in turn would act as a representative of the pool that would represent the cell.

In such scenario the permutations of possible information that can be learned by the selective nodes of the layers ahead are no longer binary, since each cell can be in one of 50 possible states of activations, each selective to one stimulus/neural representation from the layer prior to it, this would require us to increase the amount of selective nodes required per one kernel bound region while propagating forward through the network, and based on this the population of nodes would increase per layer depth, as opposed to them decreasing per depth which is the case in traditional convolution neural nets.

Notice that while the stride would reduce the amount of nodes represented in the forward layers, the required increase in population would be far larger, and hence the effect of reduction in neuron population per layer depth based on a given set stride would only reduce the rate of growth in neuron populations the deeper we go, but would not stop it from growing, this is clarified in details below while explaining the visual implementation of this architecture.

Notice that one kernel bound cell would contribute one neuron activation, since only one neuron can be active at a time as a result of the constraints we made to the selective pool, where one stimulus is bound to be perceived across the entire major clock period and therefore activate one selective node from the selective pool across the entire period. As a result of said selective node's activation, the selective node shuns the activation of all other member nodes of the selective pool across the entire major clock period, and therefore only one node would represent the cell at a given major clock period.

In this next set of paragraphs, we briefly go through the process of developing selectivity for layers 2 and 3, since these layers slightly differ relative to the first two layers 1 and 2, where the receptive cells contain more than just two receptive nodes, (“on” and “off” nodes) per cell, and while the process of selectivity runs the same for all layer pairs, a slightly different behavior can be observed when receptive cells contain more than just two nodes.

To represent nodes in tables we refer to the selective nodes using numbers where we write the number of the node in replacement to the ON-NODE label, and use the label, P—the number, in replacement to the OFF-NODE label, as shown below in the table. We use this labeling technique since when modulating connections only one node's respective excitatory connection is modulated whilst all the rest of the nodes get their respective reverse inhibitory connections modulated for every iteration. However, this notation is not very accurate since the set of P—Number nodes do not necessarily share the same absolute strength values but merely share the net modulations they receive per iteration.

TABLE 1

| CELL 1 | | | | CELL 2 | | | | CELL 3 | | | |
|---|---|---|---|---|---|---|---|---|---|---|---|
| 1-NODE | | P-1-NODE | | 27-NODE | | P-27-NODE | | 1-NODE | | P-1-NODE | |
| EXC | INH | EXC | INH | EXC | INH | EXC | INH | EXC | INH | EXC | INH |
| [0058] | [0024] | [0048] | [0026] | [0058] | [0024] | [0026] | [0058] | [0024] | [0048] | [0048] | [0026] |
| CELL 4 | | | | CELL 5 | | | | CELL 6 | | | |
| 27-NODE | | P-27-NODE | | 27-NODE | | P-27-NODE | | 27-NODE | | P-27-NODE | |
| EXC | INH | EXC | INH | EXC | INH | EXC | INH | EXC | INH | EXC | INH |
| [0058] | [0024] | [0048] | [0026] | [0058] | [0024] | [0048] | [0026] | [0058] | [0024] | [0000] | [0026] |
| CELL 7 | | | | CELL 8 | | | | CELL 9 | | | |
| 1-NODE | | P-1-NODE | | 27-NODE | | P-27-NODE | | 1-NODE | | P-1-NODE | |
| EXC | INH | EXC | INH | EXC | INH | EXC | INH | EXC | INH | EXC | INH |
| [0058] | [0024] | [0048] | [0026] | [0068] | [0024] | [0048] | [0028] | [0058] | [0024] | [0048] | [0026] |

In the previous table, we showcase a stimulus which is composed of first selective nodes representing the corners of the stimulus, and the 27^{th} selective nodes per cell representing the rest of the cells. We intentionally omit tables to clarify each iteration of each example. Rather, we show simplified examples to showcase the difference between how selectivity develops for layers that contain many receptive nodes per receptive cell, and for first layers which contained only two receptive nodes per receptive cell.

Recall that all nodes project a pair of connection types, excitatory and reverse inhibitory, to selective nodes which correspond to their respective grid. If we recall, when a stimulus encounter occurred in the previous examples, excitatory connections that project from the nodes which were encountered (got activated) got modulated positively whilst its reverse inhibitory pair did not get modulated, however simultaneously the reverse inhibitory connections of the other node pair which were not encountered (did not get activated) got positively modulated whilst its excitatory pair did not get modulated.

The same goes for non-binary receptive cells, where encountered nodes which got activated get their excitatory connections positively modulated and their reverse inhibitory not affected, whilst all other nodes in the receptive cell which were not encountered and therefore did not get activated get their reverse inhibitory connections positively modulated and their excitatory connections not affected. In other words, one node (which is the one that is activated as a result of encountering a stimulus) would have excitatory connection modulations, whilst all other nodes (which are all not going to be activated at that instance, since only one node per pool can be active at any major clock period) would have reverse inhibitory modulations.

As a result, over just 10 stimulus encounters, all nodes which were never activated within each receptive pool, would have developed strong reverse inhibitory connections as a result of their inactivation, and only those nodes which were activated multiple times would have the ability to battle one another for the third layer's node's selectivity. To clarify this we take a simplified example, say that after some time has passed while the network engaged with its environment, a certain set of selective pools from layer 2 have developed selectivity towards a wide range of stimuli, such that each selective node from the selective pools which belong to the second layer learned one color variation.

Further, say that each selective pool from layer 2 learned 10 color variations, such that a selective node is responsible for one colored 3×3 receptive grid from layer 1. We assume simple stimuli which merely represent color via binary states. In this example, the reader needs to assume that a 3×3 grid of different binary states from layer 1 can represent different color variations learned by different selective nodes belonging to the grid's respective pool from layer 2.

As was the case in prior examples each 3×3 receptive grid from layer 1, is represented by its corresponding selective pool such that each grid state of binary activations can be learned by one selective node from the pool.

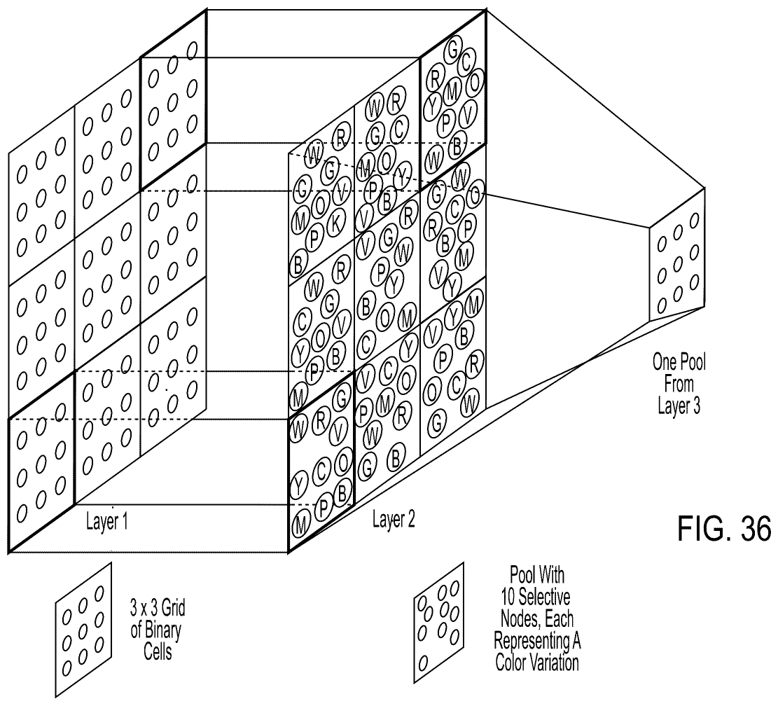

Each selective node from each pool in layer 2 acts as a receptive node of a receptive cell (where the receptive cell is the selective pool) to layer 3 which lies ahead of it, such that a collection of 9 receptive cells (selective pools) form a 3×3 kernel grid where each receptive cell (previously a selective pool) provides one receptive node (previously a selective node) to a selective node from the corresponding selective pool on layer 3. All is shown in FIG. 36. On Layer 1 of FIG. 36, there is a 9×9 grid of receptive nodes dissected into 9 3×3 grid regions. Layer 2 includes a grid of selective nodes that are also dissected into 9 selective pool regions. Each of the 9 3×3 grid regions from Layer 1 is represented by a corresponding selective pool region in Layer 2. Each selective pool region in Layer 2 includes 10 selective nodes labeled by the first letter of the color they represent. Layer 3 includes a single selective pool region including 9 selective nodes. Thus, as explained above, each selective node from each pool in Layer 2 acts as a receptive node of a receptive cell (where the receptive cell is the selective pool) to Layer 3 which lies ahead of it, such that a collection of 9 receptive cells (selective pools) form a 3×3 kernel grid where each receptive cell (previously a selective pool) provides one receptive node (previously a selective node) to a selective node from the corresponding selective pool on Layer 3.

Each receptive node which is selective to one color variation can act as input in collaboration with other receptive nodes to the selective node from Layer 3. Nodes in Layer 3 learn to be selective to a combination of active and inactive nodes from Layer 2, however this time the receptive layer contains more than just two nodes. In a given iteration, one node is what can be referred to as an ON-Node which corresponds to the perception of the stimulus said node learned to be selective for, whilst many nodes are what can be referred to as OFF-Nodes which correspond to all stimuli that were not perceived that they are selective for.

Realize that only one stimulus can be perceived at a given instance (major clock period) or else we would be violating the law of the excluded middle or the law of non contradiction, as two stimuli cannot be perceived simultaneously.

Each one of ten selective nodes can be responsible for one color, let's say nodes 1 through 10, for White, Red, Green, Yellow, Cyan, Violet, Olive, Magenta, Pink, and Black, respectively, and we can assume we are only concerned with these ten nodes. For example, we can use a cross stimulus that spans a 9×9 grid of receptive cells such that the corners vary in color for every iteration while the cross varies little. The 9×9 receptive grid of layer 1 and by extension its corresponding 3×3 receptive grid of layer 2 encounters a red cross with white corners one time, and the same red cross with a green corner another time and so on for six corner variations, as follows, White, Green, Yellow, Cyan, Violet, and Olive. While the cross color has only varied two times once Red and once Black. For the first six iterations, the corners varied according to the six colors while on the 7^{th} through 10^{th} iterations, the corners stayed white. While the color of the cross on the 1^{st} through 5^{th} iterations was red, the color of the cross on the 6^{th} through the 10^{th} iterations was black.

By the end of the first iteration (where the encountered stimulus is a red cross with white corners) for corner cells, the first selective nodes (from layer 2) and from the 1^{st}, 3^{rd}, 7^{th}, and 9^{th} selective pools, would have their excitatory connections which project towards the first selective node from the corresponding pool on the third layer, positively modulated, whilst all 9 reverse inhibitory connections projecting from nodes 2 through 10 from those same 1^{st}, 3^{rd}, 7^{th}, and 9^{th} selective pools, towards the first selective node from the corresponding pool on the third layer, would get their reverse inhibitory connections positively modulated.

On the other hand for cross cells, the second selective nodes (from layer 2) and from the 2^{nd}, 4^{th}, 5^{th}, 6^{th}, and 8^{th} selective pools, would have their excitatory connections which project towards the first selective node from the corresponding pool on the third layer, positively modulated, whilst all 9 reverse inhibitory connections projecting from nodes 1 through 10 excluding node 2 (P−2) from those same 2^{nd}, 4^{th}, 5^{th}, 6^{th} and 8^{th} selective pools, towards the first selective node from the corresponding pool on the third layer, would get their reverse inhibitory connections positively modulated.

The same goes on the next iteration for each stimulus variation, on the following table we showcase each selective node and how much excitatory and reverse inhibitory modulations it receive by the end of all 10 iterations. For simplicity we substitute each node number with the first letter of the color it represents.

TABLE 2

| | S-Node# | | | | | | | | | |
|---|---|---|---|---|---|---|---|---|---|---|
| Con-Type | W | | R | | G | | Y | | C | |
| Iteration# | EXC | INH | EXC | INH | EXC | INH | EXC | INH | EXC | INH |
| 1 | 0058 | 0024 | 0058 | 0024 | 0048 | 0026 | 0048 | 0026 | 0048 | 0026 |
| 2 | 0058 | 0026 | 0068 | 0024 | 0058 | 0026 | 0048 | 0028 | 0048 | 0028 |
| 3 | 0058 | 0028 | 0078 | 0024 | 0058 | 0028 | 0058 | 0028 | 0048 | 0032 |
| 4 | 0058 | 0032 | 0088 | 0024 | 0058 | 0032 | 0058 | 0032 | 0058 | 0032 |
| 5 | 0058 | 0040 | 0098 | 0024 | 0058 | 0040 | 0058 | 0040 | 0058 | 0040 |
| 6 | 0058 | 0056 | 0098 | 0026 | 0058 | 0056 | 0058 | 0056 | 0058 | 0056 |
| 7 | 0068 | 0056 | 0098 | 0028 | 0058 | 0088 | 0058 | 0088 | 0058 | 0088 |
| 8 | 0078 | 0056 | 0098 | 0032 | 0058 | 0152 | 0058 | 0152 | 0058 | 0152 |
| 9 | 0088 | 0056 | 0098 | 0040 | 0058 | 0280 | 0058 | 0280 | 0058 | 0280 |
| 10 | 0098 | 0056 | 0098 | 0056 | 0058 | 0536 | 0058 | 0536 | 0058 | 0536 |

TABLE 3

| | S-Node# | | | | | | | | | |
|---|---|---|---|---|---|---|---|---|---|---|
| Con-Type | V | | O | | M | | P | | B | |
| Iteration# | EXC | INH | EXC | INH | EXC | INH | EXC | INH | EXC | INH |
| 1 | 0048 | 0026 | 0048 | 0026 | 0048 | 0026 | 0048 | 0026 | 0048 | 0026 |
| 2 | 0048 | 0028 | 0048 | 0028 | 0048 | 0028 | 0048 | 0028 | 0048 | 0028 |
| 3 | 0048 | 0032 | 0048 | 0032 | 0048 | 0032 | 0048 | 0032 | 0048 | 0032 |
| 4 | 0048 | 0040 | 0048 | 0040 | 0048 | 0040 | 0048 | 0040 | 0048 | 0040 |
| 5 | 0058 | 0040 | 0048 | 0056 | 0048 | 0056 | 0048 | 0056 | 0048 | 0056 |
| 6 | 0058 | 0056 | 0058 | 0056 | 0048 | 0088 | 0048 | 0088 | 0058 | 0056 |
| 7 | 0058 | 0088 | 0058 | 0088 | 0048 | 0152 | 0048 | 0152 | 0068 | 0056 |
| 8 | 0058 | 0152 | 0058 | 0152 | 0048 | 0280 | 0048 | 0280 | 0078 | 0056 |
| 9 | 0058 | 0280 | 0058 | 0280 | 0048 | 0536 | 0048 | 0536 | 0088 | 0056 |
| 10 | 0058 | 0536 | 0058 | 0536 | 0048 | 1048 | 0048 | 1048 | 0098 | 0056 |

As can be inferred, the nodes which represent non encountered stimuli per iteration get their reverse inhibitory connections modulated repeatedly across all major clock periods where they are not encountered, and because only one stimulus can be encountered at a time, there is a disparity in the rate of modulations for reverse inhibitory connections relative to excitatory connections, because in a population of 10 receptive nodes per cell, one encounter entails 9 non-encounters.

Realize that on the prior examples laid on the previous subsections, the population of receptive nodes per cell contained only two nodes, and therefore the rate of modulations was equal for reverse inhibitory connections relative to excitatory connections per iteration, since in a population of 2 receptive nodes per cell, one encounter entails one non-encounter.

This disparity in modulation rates, artificially speeds up the learning curve such that all nodes which weren't activated (due the lack of encountering the stimulus it represents) or were activated with low frequency across the major clock periods get shunned from the process quickly via their quickly developing reverse inhibitory connections. On the previous table these would be the nodes which are labeled M and P (which were never activated), as well as nodes G, Y, C, V and O, as these nodes were only encountered once each across the entire period.

Whilst those nodes which were activated frequently (as a result of frequently encountering the stimulus it represents) across the major clock periods get to participate in the process of selectivity via its moderately developing excitatory and reverse inhibitory connections based on how persistent they are encountered across the major clock period. On the previous table these would be the nodes which are labeled W, R, and B.

Put in another way, in the earlier examples where the receptive cells contained binary nodes, i.e., “on” and “off”, the probability distribution at a random stimulus encounter, was 1:1, where there was a 50% chance the stimulus can have that particular cell get its “on” node activated and therefore 50% chance it does not, and 50% chance that same cell get its “off” node activated and therefore a 50% chance it does not. Whilst in these examples where the receptive cells can contain 10 nodes, each node gets a 10% chance to be activated, and therefore a 90% chance that it does not get activated.

We can conclude from this that the probability distribution is even on the former case but is heavily uneven on the latter case, and therefore on the latter case it is more likely that reverse inhibitory connections are modulated, relative to excitatory connections. Such imbalance (relative to the former case) would require more excitatory modulations to counter balance it, or another solution we propose is it slow down the growth of reverse inhibitory connections.

The solution would be to adjust the growth of only reverse inhibitory connections by slowing it down such that for example rather than requiring 10 reverse inhibitory connections modulation to achieve perfect selectivity, we require say for example 100 modulations for reverse inhibitory connections to achieve the same level of selectivity. This way we counter balance the effect of the imbalance laid earlier.

This adjustment should be made in proportion to the amount of selective nodes per selective pool, since the probability distribution is related to such amount, for example a pool with 2 nodes, have a 50:50=½:½ chance of activation versus inactivation, whilst a pool with 10 nodes have a 1/10: 9/10 chance of activation versus inactivation, respectively, hence in this scenario the reverse inhibitory connections which project from layer 2 to 3 shall grow with a rate of 1/10^{th} time relative to inhibitory connections which project from layer 1 to 2, and so on and so forth for any set of layer pairs based on the neuron population of the pool a given set of reverse inhibitory connections project towards.

It is worth mentioning that the mammalian brain contains kernel structures as well, and is structured in a convolution like structure of feedforward propagating layers, in fact artificial convolution neural nets were inspired by its biological counterpart, the kernels in the mammalian brain are an effect of the existing limitations of the dendritic arborizations that one single neuron can form with recipient neurons, in other words due to the limited structure of a neuron, a single neuron in a biological layer can only connect to a limited set of neurons from the relatively back layer through its limited set of dendrites and synaptic junctions, establishing a kernel like hierarchal connection structure.

However, unlike convolution nets the kernel boundaries in biological neural networks are not fixed as an X*X square grid or in any particular shape, and follow rather dynamic kernel boundaries, which we incorporate in this architecture as is clarified next in this sub-section regarding segmentation.

In the mammalian brain, the convolutional like structure, allows neurons that are deeper in the layer hierarchy the ability to learn more complex structures, since their receptive fields become wider the deeper we go into the architecture, hence neurons that are located at the deeper regions in the occipital lobe like V2 and V3 learn complex structures like shapes and objects after taking as inputs, simpler structures like edges and colors from neurons in region V1, hence allowing deeper neurons to capture more complex information.

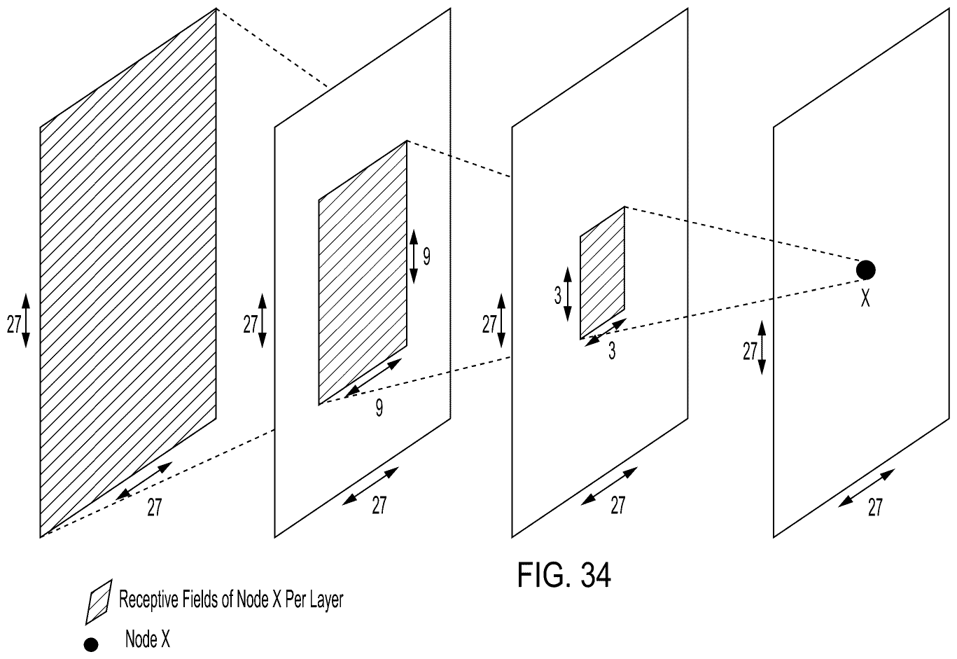

A convolution neural net like layer structure that is configured such that each layer communicates only with the layer that is directly ahead of it, adds a limitation to the extent of the segmentation that can form in the visual system due to the stride of the kernels. For example, in the visual implementation, if we say that the network has a stride of 3 and a kernel dimension of 3×3 per layer, a tripling in the receptive field dimension of nodes relative to the first input layer would occur while propagating deeper onto that network as shown in FIG. 34.

There are 4 layers of nodes shown in FIG. 34 where each layer spans 27 nodes×27 nodes. On the fourth layer laid out on the far right of the graph, there is a selective node labeled X. Said selective node X encompasses a given receptive field area showcased in a dashed area from each layer where it receives information from either directly (via residual connections) or indirectly. The selective node X encompasses a 3×3=9 nodes receptive area from layer 3, and a 9×9=27 nodes receptive area from layer 2, and a 27×27=729 nodes receptive area from layer 1.

This means when we integrate signals coming from input nodes, with others which happen to be located relatively deeper in the layer structure, to the layer ahead, the segmentation can only go as far as the boundaries created by the large receptive fields of these deeply located nodes, which means information would have to exist as multiples of the input node's receptive fields to be fully encompassed without allowing for background noise to be integrated.

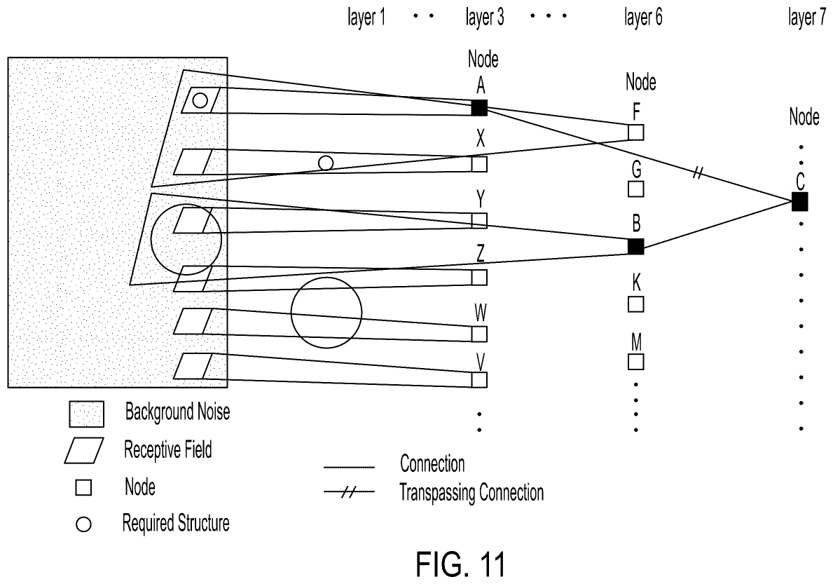

For example, let's say we want to establish segmentation boundaries in the receptive field of a deeper node, to a structure composed of two different sized circles located relatively far away from each other as shown in FIG. 11. On the left side of the figure, there is shown a canvas containing background noise represented by the dotted pattern and two structures which are the object of focus in this canvas represented by one small circle and another larger circle placed slightly farther apart. Shown on the right side of the figure, there is a set of node columns each representing a given layer, such that the first column counting from the left, represents the first layer which in this figure is intended to only show the shapes that are presented onto the receptive layer and which are to be represented by deeper nodes. The second column counting from the left, represents the second layer of selective nodes, and so is the case for the third and fourth columns each representing the sixth and the seventh layers, respectively.

The unshaded squares represent nodes which do not fully encompass the objects in question, those objects are represented by the small and large circles, whilst the shaded squares represent the nodes which fully encompass the objects in question. The extended divergent line pairs which project from the nodes and onto the canvas and which terminate with parallelogram shaped sections on the canvas, represent the total receptive fields said nodes fully encompass. The dark line represents a normal feedforward connection pair, whilst the dark line with a hash on it represents a transpassing connection. Node A fully encompasses the small circle, while only node B which is 3 layers ahead fully encompasses the larger circle. Node C takes as input both nodes A and B, thereby integrating the information they both represent and therefore node C is able to represent the required structure while disregarding the noise information between the two circles via segmentation and the use of transpassing connections.

With the current architecture it is impossible to create a segmentation boundary as the segmentation is bound to include noise information, hence would establish bad segmentation. The solution to this problem involves two parts, the first part of the solution is found in the mammalian brain architecture, where it allows some regions to have direct axonal projections (connections) to all the other regions ahead of said region and not just the region directly ahead of said region, via what is commonly known in the art of neural network engineering as residual connection. This means if a certain neuron from the earlier layers which has a lower receptive field wants to contribute its well bound information with another well bound information represented by another deeper neuron with a larger receptive field, the earlier neuron could integrate its information by transpassing said information across layers and onto the layer that it targets.

For example in FIG. 11 which show two differently sized circles, the segmentation boundary becomes possible by allowing neuron A from layer 3, which has a receptive field that fully encompasses the small circle, to be integrated with neuron B from layer 6 which fully encompasses the larger circle onto neuron C from layer 7 which has a receptive field that includes both, where neuron A transpasses layers 4, 5 and 6, and projects its connections directly onto a selective neuron from layer 7 via residual connections, whilst neuron B which lies in layer 6 projects directly to that same selective neuron from layer 7.

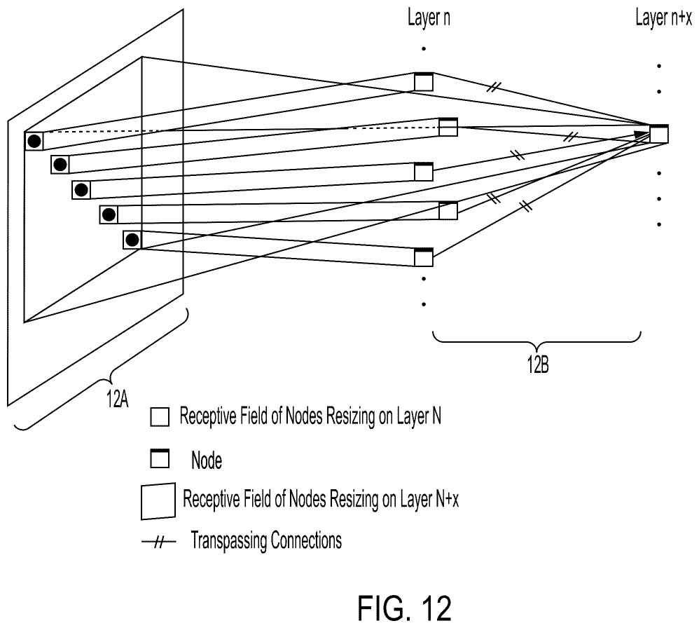

This allows for smoother kernel boundaries, giving the network an even greater learning capability because smooth kernel boundaries like these allow neurons to learn structural information that are disconnected, which could include information that have specific spatial frequencies in the static visual world, as well as temporal frequency stimuli in the acoustic world and the dynamic visual world. An example would be a group of dots spatially located as shown in FIG. 12A. As shown, a canvas contains a structure composed of a set of black dots arranged diagonally relative to the canvas, and which are the object of focus. Two node columns each representing a given layer, such that the first column counting from the left, represents a given layer n, whilst the second column counting from the left, represents layer number n+x, where x is a value greater than 1, and within said layer a set of selective nodes is present. The squares represent nodes, and is showcased on the graph the first layer nodes that are present on the figure each encompass the black dots.

To effectively learn such a pattern, small receptive field nodes from some early layer N are required to be integrated together onto a large receptive field node from a deeper layer N+X which can encompass them all, as shown in FIG. 12B. The extended divergent line pairs which project from the nodes and onto the canvas and which terminate with parallelogram shaped sections on the canvas, represent the total receptive fields said nodes fully encompass. Each dark line with a hash on it represents a transpassing connection. Each of the five nodes presented in layer n fully encompasses the dark dots, while the singular node present on the figure within layer n+x fully encompasses the entire structure. This node as shown on the figure takes in as input each of the aforementioned nodes from the earlier layer n via transpassing connections.

However, this first part of the solution alone is not sufficient to solve the problem in our case, since based on the feedforward algorithm specified in the prior sub-sections, the output/deep selective node is required to receive connections from all the regions which its receptive field encompasses, and therefore those other regions in its receptive field which do not include the segmented information being learned, would still project both reverse inhibitory connections and excitatory connections towards said selective node.

As a result, the noise around the structure in FIG. 11 still contributes information through these connections, which would project from these noise areas and onto layer 7 via the aforementioned connections. Therefore, a second part of the solution has to be introduced in order to prune all such noise connections to allow for segmentation.

In this architecture, the purpose of segmentation is to isolate independent parts of a stimulus which are found to be frequently encountered, these parts represent a set of cells that are found to be collectively encountered independent from the rest of the cells that belong to the same receptive field area, and which do not fit any predefined shape kernel boundary and can rather take multitudes of variant shape forms, and the purpose of this subsection is to give selective nodes the ability to learn such stimuli regardless of their shape and discontinuities.

To accomplish this, it is necessary to provide the network with kernel boundaries that can be fine-tuned around any segmented structure, hence another property shall be added to the processes of forming feedforward connections to establish such dynamic kernel boundaries, and would be the second necessary part of the solution to achieve segmentation, such property is referred to as targeted modulations.

Recall that initially, the nodes which belong to any given selective pool have a low selectivity threshold, and therefore can be activated by many stimuli variations up until a certain point where they become highly selective to one and only one variant of said stimuli, in other words become fine tuned to a particular stimulus.

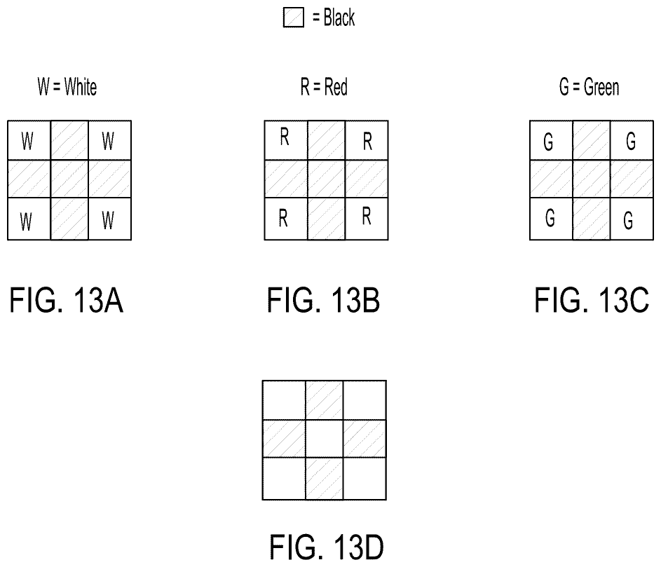

Say, for example, that a stimulus spanning a 9×9 grid, which represents a black cross surrounded by a white background (W), as shown in FIG. 13A, was encountered for the first time. At at another major clock period, the same black colored cross shape was encountered and was found located exactly where its predecessor was located in the previous iteration however, the encountered cross was surrounded by a different background, and we represent such difference with color, say red (R) instead of white as shown in FIG. 13B. Again, say that the same shape was encountered at yet another iteration but in a green background (G) as shown in FIG. 13C. There are 4 3×3 kernel grids shown in FIGS. 13A-D, representing possible receptive field regions which can be perceived by the visual implementation of the neural network. FIG. 13A represents a black cross stimulus within a white background, where letter W signifies white colored cells. FIG. 13B represents a black cross stimulus within a red background, where letter R signifies red colored cells. FIG. 13C represents a black cross stimulus within a green background, where letter G signifies white colored cells. FIG. 13D represents a black cross stimulus within any of the previously mentioned background colors, however with the middle cell being left out relative to the previously presented cross structures.

In all three scenarios, the cross is the same and is represented by the same set of selective nodes from the second layer, whilst the background is different, and therefore would be represented by different selective nodes from the second layer, and here the difference is represented by the color, but one can imagine any type of variation which could vary around the stimulus, and from here onward we call such variations noise.

Initially, a set of selective nodes that belong to the second layer which lies directly ahead of the first layer can learn to be selective to parts of the stimulus mentioned previously, and if we assume that each set of selective nodes in the second layer represent one 3×3 grid from the first layer, and since as shown in the figure the input is 9×9, this would amount to 9 selective nodes in the second layer, each responsible for one 3×3 block from the prior layer, this is of course under the assumption that the stride is 3.

In each of the three scenarios (i.e., FIGS. 13A, 13B, and 13C), the 4 selective nodes that belong to the noise and which lie in the corners of the visual scene in our example, would be different, due to the difference in the stimulus they represent since color changes in these regions that are represented by all 4 corner selective nodes, whilst at the same time the other 5 selective nodes which represent the cross would be the same, as they represent the same information which is common across all iterations mentioned previously.

If we then say that the 3×3 grid of 9 selective nodes from layer 2 also map to one selective node from layer 3, then by the transitive property, the receptive field of the nodes in layer 3 can be considered encompassing the entire 9×9 receptive grid of cells from layer 1, as they encompass their corresponding 3×3 receptive grid from layer 2, as shown in an example in FIG. 5.

Notice that in this example we are assuming that the nodes that belong to layer 2 have already learned to be highly selective to each of the variations of these segments of the larger stimulus, and that only after such is the case, do nodes from layer 3 in turn start to learn to be selective to a particular stimulus represented by the set of selective nodes from the previous layer. This is because information from earlier layers have to be learned first before they can be used as building blocks for more complex information in layers ahead, where earlier layers tend to always mature before deeper layers.

In layer 2, since the 5 selective nodes which represent the cross shape, are encountered 3 times, the connections between the first layer, and said nodes are modulated 3 times more than the connections that are formed between the first layer and the other 4 corner representing selective nodes, this is because at each iteration a different selective node which represent these corners is activated, whilst at each scene the same selective nodes in the non-corner area are activated, this creates a disparity in the connection strength between, the segmented out area (represented by the cross), and the segmented from area (represented by the noise/background/the four corners in our example), as the former is encountered more often than the latter.

The following two tables represent the two different types of nodes which represent the stimulus, and their values. However, it is necessary to remind the reader that a receptive cell on the second layer corresponds to a selective pool, and therefore each cell would contain more than just two selective nodes, “on” and “off”, as was the case in the first layer.

Again, generally we refer to the selective nodes using numbers were we write the number of the node in replacement to the ON-NODE, and use the label, P—the number, in replacement to the OFF-NODE label, as shown below in the table, and we said before we use this labeling technique since while modulating connections only one node's respective excitatory connection is modulated whilst all the rest of the nodes get their respective reverse inhibitory connections modulated for every iteration.

However, to simplify things for the reader for this particular example we assume that a selective pool contains only 10 nodes such that the nodes 1 through 26 are labeled A through Z, respectively, such that B stands for Black, R stands for Red, G stands for Green and W stands for white, and where those nodes learned a stimulus that corresponds to their letter label. Notice that to represent the three iteration examples we need to show 3 tables each showcasing the strength of its connection map set.

TABLE 4

| CELL 1 | | | | CELL 2 | | | | CELL 3 | | | |
|---|---|---|---|---|---|---|---|---|---|---|---|
| W-NODE | | P-W-NODE | | B-NODE | | P-B-NODE | | W-NODE | | P-W-NODE | |
| EXC | INH | EXC | INH | EXC | INH | EXC | INH | EXC | INH | EXC | INH |
| [0058] | [0024] | [0048] | [0026] | [0058] | [0024] | [0048] | [0026] | [0058] | [0024] | [0048] | [0026] |
| CELL 4 | | | | CELL 5 | | | | CELL 6 | | | |
| B-NODE | | P-B-NODE | | B-NODE | | P-B-NODE | | B-NODE | | P-B-NODE | |
| EXC | INH | EXC | INH | EXC | INH | EXC | INH | EXC | INH | EXC | INH |
| [0058] | [0024] | [0048] | [0026] | [0058] | [0024] | [0048] | [0026] | [0058] | [0024] | [0048] | [0026] |
| CELL 7 | | | | CELL 8 | | | | CELL 9 | | | |
| W-NODE | | P-W-NODE | | B-NODE | | P-B-NODE | | W-NODE | | P-W-NODE | |
| EXC | INH | EXC | INH | EXC | INH | EXC | INH | EXC | INH | EXC | INH |
| [0058] | [0024] | [0048] | [0026] | [0058] | [0024] | [0048] | [0026] | [0058] | [0024] | [0048] | [0026] |

TABLE 5

| CELL 1 | | | | CELL 2 | | | | CELL 3 | | | |
|---|---|---|---|---|---|---|---|---|---|---|---|
| R-NODE | | P-R-NODE | | B-NODE | | P-B-NODE | | R-NODE | | P-R-NODE | |
| EXC | INH | EXC | INH | EXC | INH | EXC | INH | EXC | INH | EXC | INH |
| [0058] | [0024] | [0048] | [0026] | [0068] | [0024] | [0048] | [0028] | [0058] | [0024] | [0048] | [0026] |
| CELL 4 | | | | CELL 5 | | | | CELL 6 | | | |
| B-NODE | | P-B-NODE | | B-NODE | | P-B-NODE | | B-NODE | | P-B-NODE | |
| EXC | INH | EXC | INH | EXC | INH | EXC | INH | EXC | INH | EXC | INH |
| [0058] | [0024] | [0048] | [0026] | [0058] | [0024] | [0048] | [0026] | [0058] | [0024] | [0048] | [0026] |
| CELL 7 | | | | CELL 8 | | | | CELL 9 | | | |
| R-NODE | | P-R-NODE | | B-NODE | | P-B-NODE | | R-NODE | | P-R-NODE | |
| EXC | INH | EXC | INH | EXC | INH | EXC | INH | EXC | INH | EXC | INH |
| [0058] | [0024] | [0048] | [0026] | [0068] | [0024] | [0048] | [0028] | [0058] | [0024] | [0048] | [0026] |

TABLE 6

| CELL 1 | | | | CELL 2 | | | | CELL 3 | | | |
|---|---|---|---|---|---|---|---|---|---|---|---|
| G-NODE | | P-G-NODE | | B-NODE | | P-B-NODE | | G-NODE | | P-G-NODE | |
| EXC | INH | EXC | INH | EXC | INH | EXC | INH | EXC | INH | EXC | INH |
| [0058] | [0024] | [0048] | [0026] | [0078] | [0024] | [0048] | [0032] | [0058] | [0024] | [0048] | [0026] |
| CELL 4 | | | | CELL 5 | | | | CELL 6 | | | |
| B-NODE | | P-B-NODE | | B-NODE | | P-B-NODE | | B-NODE | | P-B-NODE | |
| EXC | INH | EXC | INH | EXC | INH | EXC | INH | EXC | INH | EXC | INH |
| [0058] | [0024] | [0048] | [0026] | [0058] | [0024] | [0048] | [0026] | [0058] | [0024] | [0048] | [0026] |
| CELL 7 | | | | CELL 8 | | | | CELL 9 | | | |
| G-NODE | | P-G-NODE | | B-NODE | | P-B-NODE | | G-NODE | | P-G-NODE | |
| EXC | INH | EXC | INH | EXC | INH | EXC | INH | EXC | INH | EXC | INH |
| [0058] | [0024] | [0048] | [0026] | [0078] | [0024] | [0048] | [0032] | [0058] | [0024] | [0048] | [0026] |

Notice the changes in the corner cells label across the tables, which represent each noise variation for each iteration, and notice the compounded modulations in the cross representing cells due to repeated encounter. Noise/variations tend to be weaker in connection strength relative to more frequently encountered structures since they are less frequently encountered due to their higher permutation in the environment, there are far greater permutations which can represent a noise feature than there are which can represent structured features.

These changes would make it such that the nodes in the corners would send hyperpolarization signals, and the reason why the corners would send hyperpolarization signals is because the changing corners would represent a difference relative to the previous stimulus encounter, in our example white noise in the first encounter and then red noise in the second encounter, and as was clarified earlier when difference is registered the activation of the different nodes (the previously inactive nodes) send hyperpolarization signals through reverse inhibitory connections.

Disparities in connection strengths would emerge over time and experience between a repetitively encountered independent region in the stimulus (the cross) and a varying region in that same stimulus (the noise), these disparities occur and widen over time due to the nature of their experience, since as we said there could exist many forms of variations possible for noise around a particular non variant structure.

The goal of segmentation is to form kernel boundaries such that these boundaries engulf only the independent structure and neglect the variant noise, in what we refer to as dynamic kernel boundaries, this is in contrary to static predefined kernel boundaries like convolution kernels.

We achieve this by using targeted modulations, where only the cells which send depolarization signals to a particular selective node, get modulations to both their residual excitatory and reverse inhibitory connections which project from said cells to said selective node. In other words, instead of modulating all the feedforward connections that project from each and every cell in a given receptive area to a given selective node, we only target the residual connections (reverse inhibitory and normal excitatory) that project from the cells that sent depolarization signals specifically, and which also successfully activated the given selective node, hence the term targeted modulations.

Recall that a cell represents a pool of selective nodes, where the first layer of the visual implementation is exceptional since each of its selective pool kernels would have a population of only two nodes that are made to be selective to two types of ganglion signals from the sensory layer which receives information from its corresponding sensory devices as is clarified below.

However, the selective pools across the rest of the architecture would be populated with many selective nodes where each can be selective to numerous variations of stimuli perceived by the earlier layer, and by targeting modulations based on the cells which send depolarization signals, we in turn bypass modulating connections that project from those other cells which represent noise and which send the hyperpolarization signals.

By specifying the modulations to only those cells which send depolarization signals and successfully depolarize a given selective node, we isolate the independent structure, and create a dynamic kernel boundary which wraps around said structure regardless of its spatial distribution, provided that the cells belong to one receptive field area. This means the spatial distribution of the stimulus being learned by a selective node can take any form, this is true for shapes that encompass the entire X*X receptive grid or those which encompass only a segment of such grid.

Targeted modulation therefore works for both cases, whether the entire receptive grid represents a stimulus or if only part of the receptive grid represents a stimulus, in the former case all the cells would send depolarization signals and therefore all of their connection pair per cell would be modulated, where the inactive neurons of the cell would cause the strengthening of the reverse inhibitory connections, whilst the active neurons of the cell would cause the strengthening of the excitatory connections.

On the latter case, not all the cells would send depolarization signals, and therefore only those that do would have their connection pair modulated, leaving all the connection pair which project from those other cells which did not send depolarization signals not positively modulated. (connection pair refers to two types, not necessarily two connections, e.g., 1 reverse inhibitory and 1 excitatory are two connections, 9 reverse inhibitory and 1 excitatory are two types but 10 connections).

Pay attention that all the connections that project from said cells which send depolarization signals are modulated, in other words, not only the excitatory connections are modulated but also the reverse inhibitory connections which project form said cells are modulated as well, as the depolarization signals merely specify the cell boundaries of the stimulus where the modulations have to be taken within.

However, one necessary constraint for targeted modulation, would be that only residual connections can experience such targeted modulations, and the reason behind this is to ensure that we preserve a minimum size for stimuli in one hand, and on the other hand to reserve direct layer to layer successive communications for learning holistic stimuli, where any successive layer pair would be connected via direct connections rather than residual connections, since by definition, residual connections are those which communicate to other layers that are not directly ahead of the layer they project information from.

Both preserving a minimum stimulus size, and reserving selective nodes which receive information through direct successive communications across layers for holistic stimuli, can be accomplished by not allowing targeted modulations for direct layer to layer connections, whereas if we allowed for such connections to be targeted in modulation, a 3×3=9 cells sized stimulus would be able to get segmented into little 1 cell sized stimuli which is problematic since it would allow any given selective node to learn 1 cell sized stimuli, thereby destroying information through absolute reduction.

Not allowing for direct connections to be targeted in modulation also allows deeper selective nodes, to learn the whole stimuli as opposed to segmented parts of stimuli which other selective nodes would learn via residual connections, where the deeper a selective node is the greater the receptive field it represents, and since each successive set of nodes cannot accept much tolerance, deeper nodes that are connected via successive direct connections only learn full stimuli like recurring backgrounds or textures.

Notice that the selective pool of a given layer would be split between directly connected selective nodes which would be tasked for learning whole stimuli, and residually connected selective nodes which would be tasked for learning segmented parts of stimuli. Learning whole stimuli via independent selective nodes, coincidences with gestalt's principle of proximity (emergence), where mammalian brains tend to perceive groups of proximate stimuli collectively as one concept, and when proximity ceases to exist due to independent perception of each individual stimuli, (which also occurs when the gaze shifts between said stimuli if they were non proximate) each stimulus is perceived as its own independent concept.

This means, not every selective node would receive the same set of connections from the receptive field, but rather some would receive direct connections from a prior layer, whilst others would receive information through residual connections from earlier layers, and therefore the deeper a selective pool lies in the layer structure, the more selective node population there are per pool to account for all previous layer communications.

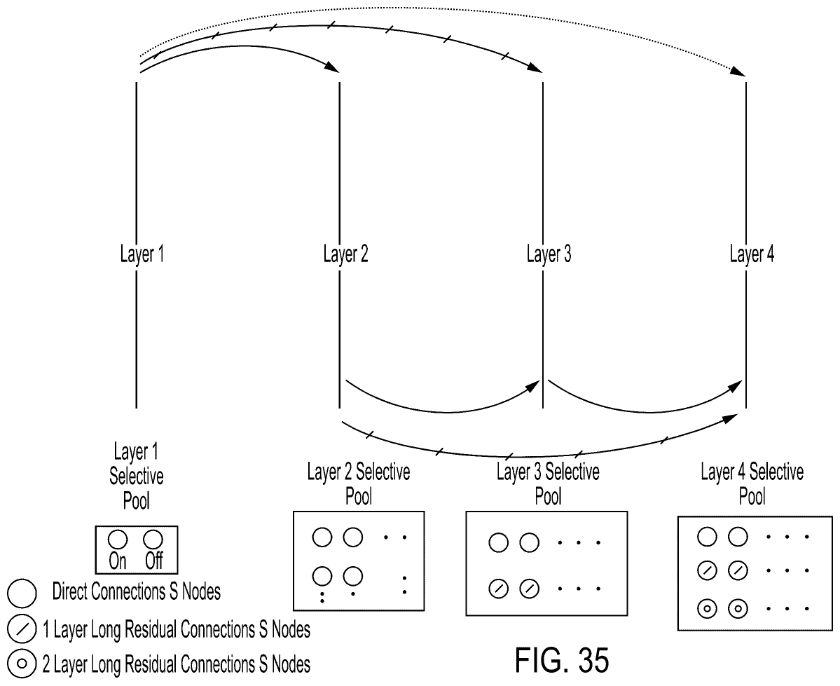

This can be shown in FIG. 35, where we illustrate a set of 4 layers laying forward to one another, and we showcase all connections, residual and direct, which project from each layer and all the sets of layers ahead of each layer, and we showcase the different connections in different formats. Under each layer we showcase the selective pool and the different types of selective nodes for deeper layer pools based on different connections which feedforward to them. Thus, Layer 1 in FIG. 35 projects connections to Layers 2, 3, and 4, such that the connections is projects to Layer 2 are direct connections whilst the connections it projects to Layers 3 and 4 are residual connections. A normal line is used to signify a direct connection. A line with interspersed dashes is used to signify a residual connection which transpassed one layer. A dotted line is used to signify a residual connection which transpassed two layers. Layer 2 projects its connections to Layers 3 and 4, through direct and residual connections, respectively. Layer 3 projects its connections to Layer 4 through a direct connection. The pool composition of each layer is provided on the bottom of FIG. 35. The plain circles represent nodes that receive information through direct connections. Dashed circles represent nodes that receive information through residual connections that transpassed one layer. Circles with an interior concentric circle represent nodes that receive information through residual connections that transpassed two layers.

To recap, we gave an example of a stimulus spanning a 9×9 grid, which represents a black cross surrounded by a white background, shown in FIG. 13A, and which was encountered for the first time, and that at another major clock period, the same black colored cross shape was encountered and was found located exactly where its predecessor was located in the previous iteration however surrounded by a different background, and we represented such difference with the color red instead of white as shown in FIG. 13B, then at a third encounter the same shape was encountered at yet another iteration but in a green background, as shown in FIG. 13C. In all three scenarios, the cross is the same and therefore is represented by the same set of selective nodes from the second layer, whilst the background (the corner pieces) is different, and therefore is represented by different selective nodes from the second layer.

Initially, a set of selective nodes that belong to the second layer which lies directly ahead of the first layer can learn to be selective to parts of the stimulus mentioned previously, and if we assume that each set of selective nodes in the second layer represents one 3×3 grid from the first layer, and since as shown in the figure the input is 9×9, this would amount to 9 selective nodes in the second layer, each responsible for one 3×3 block from the prior layer, this is of course under the assumption that the stride is 3.

In each of the three scenarios, the 4 selective nodes that belong to the noise and which lie in the corners of the visual scene in our example, would be different, due to the difference in the stimulus they represent since color changes in these regions that are represented by all 4 corner selective nodes, whilst at the same time the other 5 selective nodes which represent the cross would be the same, as they represent the same information which is common across all iterations mentioned previously.

We then ended by assuming that the 3×3 grid of 9 selective nodes from layer 2 also map to one selective node from layer 3, and therefore, the receptive field of the nodes in layer 3, can be considered encompassing the entire 9×9 receptive grid of cells from layer 1, as they encompass their corresponding 3×3 receptive grid from layer 2. This time however we also add to the assumption that those 9 selective nodes from layer 2 also map to one other selective node from layer 4 via residual connections.

We then clarified that on layer 2, since the 5 selective nodes which represent the cross shape are encountered 3 times, the connections between the first layer, and said selective nodes from layer 2 are modulated 3 times more than the connections that are formed between the first layer and the other 4 corner representing selective nodes. This is because at each iteration a different selective node which represent these corners is activated, whilst at each scene the same selective nodes in the non-corner area are activated. This creates a disparity in the connection strength between the segmented out area (represented by the cross), and the segmented from area (represented by the noise/background/the four corners in our example), as the former is encountered more often than the latter.

Now to continue with this example, across two iterations, let's say that on the first iteration the network had a first encounter of a stimulus comprised of a black cross with white corners, followed by a second encounter on the next iteration that was comprised of a black cross with red corners. Then on the second iteration we would observe that the segmented area represented by the five nodes from layer 2 which are representing the black cross, would send depolarization signals to the selective node from layer 3, while simultaneously this same selective node from layer 3 would receive hyperpolarization signals sent by the segmented out area represented by the 4 red corner nodes due to the registered difference relative to the prior iteration.

However, if said selective node which belongs to layer 3 has not yet developed perfect selectivity towards the stimulus and therefore had a low qualitative tolerance, the overall net depolarization signals received would be sufficient to activate it.

Similarly, the same set of nodes which represent the same stimulus, would also send depolarization and hyperpolarization signals, for cross belonging nodes and corner belonging nodes, respectively, to the selective node which belongs to layer 4 via the residual connections which connect layer 2 nodes and layer 4 nodes.

Notice however, that there are two notes we should pay attention to on this scenario, the first is that each of these nodes connect to a different selective node from layer 4, which represent the same stimulus presented on layer 2. This would entail that initially for this example there would exist two selective nodes on layer 3 and 4, where each represent the exact same stimulus as one receives connections directly from layer 2 and the other receives information from layer 3 which itself receive its connections from layer 2.

This would mean that on the first iteration both layer 3 and layer 4 selective nodes would learn the same exact stimulus, that is the black cross surrounded by white corners, however as is showcased next this would cease to be the case across future iterations.

The second note is that the connections received from layer 2 by that 4^{th} layer selective node are residual connections which can be affected via targeted modulations, and therefore on the second iteration if this layer 4 selective node has not yet developed perfect selectivity towards the stimulus and therefore had a low qualitative tolerance, as was the case previously, the net depolarization signals received would be sufficient to activate it, however in addition this would also be followed by a process of targeted modulations to the connection set pair which belong to the set of cross belonging cells which send said depolarization signals to the 4^{th} layer selective node.

Notice that the modulations would occur to both the excitatory and reverse inhibitory connection set that are projected from the cross representing cells. Recall that a cell on the first layer contains two nodes, “on” and “off”, whilst a cell on the second layer contains many nodes, in our example 10 in actual implementation around 50, and so on and so forth propagating forward. Therefore, for every modulation each cell would have one excitatory connection modulated and at least one reverse inhibitory connection modulated.

Therefore, we strengthen both the reverse inhibitory connections which project from the inactive nodes which belong to each of these cells (this includes the other selective nodes in each pool which were inactive) as well as the excitatory connections which project from the active nodes, one per cell for each of the five cross representing cells, creating a kernel that is bound by the spatial distribution of the cross shaped stimulus.

Notice how this process shapes the kernel's boundaries by restricting the process of positive modulations (and in turn the process of learning) to only the cells which include the segmented stimulus to be learned, whilst leaving the rest with no positive modulations and therefore the parts that did not get positively modulated are weakened over time as a result of the decay function which governs all connections.

This means that over time the segmented from area ceases to be part of what the selective node learns since the connections that project from said parts and to said selective node would no longer exist or would be too weak to have any effect relative to the segmented out area which the selective node ends up learning.

Realize that this has to happen within the duration of learning before the selective node develop a high selectivity towards the stimulus, in other words only because we allow selectivity to grow gradually does a selective node have the chance to dynamically adjust to particular segmentations of a stimulus, however as soon as the node becomes highly selective to the stimulus, its tolerance to large changes in the stimulus would drop, and therefore there would no longer be freedom for the stimulus to take any different shape, as slight changes would send high hyperpolarization signals which would suppress the selective node.

The following tables show the effects before and after targeted modulations, the following 9 tables show the targeted modulations for the residual connections between layers 2 and 4. Recall that targeted modulations should only occur for residual connections, and in this previous example the only residual connections that exist lie between layers 2 and 4. We also assume for simplicity and case of representation, that each cell on layer 2 contain 9 selective nodes rather than 10 arranged on a 3×3 grid counting 1 to 9 from left to right, top to bottom.

Those are the nodes which represent the different color stimuli and we assume that each selective node learned one of the following color set, White, Red, Green, Yellow, Cyan, Violet, Magenta, Pink, and Black, such that each node is labeled on the following tables with the first letter of the color it represents.

Since there are 9 cells in our layer 2 example where each cell has 9 selective nodes, then we have 9*9=81 nodes from layer 2 which project to a selective node from layer 4 via residual connections. Those 9×9 nodes represent 9 3×3 cells, so we use 9 tables counting from node 1 to node 81 to represent all layer 2 nodes.

On the first 9 tables we show the modulations after the first encounter, whilst on the following 9 tables we show the changes after targeted modulations were triggered on the second iteration.

TABLE 7
(Selective pool 1 to layer 1) (Receptive cell 1 to layer 2)

| | | |
|---|---|---|
| NODE 1 | NODE 2 | NODE 3 |
| W-NODE | R-NODE | G-NODE |

| | | | | | |
|---|---|---|---|---|---|
| EXC | INH | EXC | INH | EXC | INH |
| [0058] | [0024] | [0048] | [0026] | [0048] | [0026] |

| | | |
|---|---|---|
| NODE 4 | NODE 5 | NODE 6 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 7 | NODE 8 | NODE 9 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0048] | [0026] |

Notice on the following TABLE node B not node W which is part of the cross is modulated on the first iteration, since this next table represents the second cell counting from left to right top to bottom.

TABLE 8
(Selective pool 2 to layer 1) (Receptive cell 2 to layer 2)

| | | |
|---|---|---|
| NODE 10 | NODE 11 | NODE 12 |
| W-NODE | R-NODE | G-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 13 | NODE 14 | NODE 15 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 16 | NODE 17 | NODE 18 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0058] | [0024] |

TABLE 9
(Selective pool 3 to layer 1) (Receptive cell 3 to layer 2)

| | | |
|---|---|---|
| NODE 19 | NODE 20 | NODE 21 |
| W-NODE | R-NODE | G-NODE |

| | | | | | |
|---|---|---|---|---|---|
| EXC | INH | EXC | INH | EXC | INH |
| [0058] | [0024] | [0048] | [0026] | [0048] | [0026] |

| | | |
|---|---|---|
| NODE 22 | NODE 23 | NODE 24 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 25 | NODE 26 | NODE 27 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0048] | [0026] |

TABLE 10
(Selective pool 4 to layer 1) (Receptive cell 4 to layer 2)

| | | |
|---|---|---|
| NODE 28 | NODE 29 | NODE 30 |
| W-NODE | R-NODE | G-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 31 | NODE 32 | NODE 33 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 34 | NODE 35 | NODE 36 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0058] | [0024] |

TABLE 11
(Selective pool 5 to layer 1) (Receptive cell 5 to layer 2)

| | | |
|---|---|---|
| NODE 37 | NODE 38 | NODE 39 |
| W-NODE | R-NODE | G-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 40 | NODE 41 | NODE 42 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 43 | NODE 44 | NODE 45 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0058] | [0024] |

TABLE 12
(Selective pool 6 to layer 1) (Receptive cell 6 to layer 2)

| | | |
|---|---|---|
| NODE 46 | NODE 47 | NODE 48 |
| W-NODE | R-NODE | G-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 49 | NODE 50 | NODE 51 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 52 | NODE 53 | NODE 54 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0058] | [0024] |

TABLE 13
(Selective pool 7 to layer 1) (Receptive cell 7 to layer 2)

| | | |
|---|---|---|
| NODE 55 | NODE 56 | NODE 57 |
| W-NODE | R-NODE | G-NODE |

| | | | | | |
|---|---|---|---|---|---|
| EXC | INH | EXC | INH | EXC | INH |
| [0058] | [0024] | [0048] | [0026] | [0048] | [0026] |

| | | |
|---|---|---|
| NODE 58 | NODE 59 | NODE 60 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 61 | NODE 62 | NODE 63 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0048] | [0026] |

TABLE 14
(Selective pool 8 to layer 1) (Receptive cell 8 to layer 2)

| | | |
|---|---|---|
| NODE 64 | NODE 65 | NODE 66 |
| W-NODE | R-NODE | G-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 67 | NODE 68 | NODE 69 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 70 | NODE 71 | NODE 72 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0058] | [0024] |

TABLE 15
(Selective pool 9 to layer 1) (Receptive cell 9 to layer 2)

| | | |
|---|---|---|
| NODE 73 | NODE 74 | NODE 75 |
| W-NODE | R-NODE | G-NODE |

| | | | | | |
|---|---|---|---|---|---|
| EXC | INH | EXC | INH | EXC | INH |
| [0058] | [0024] | [0048] | [0026] | [0048] | [0026] |

| | | |
|---|---|---|
| NODE 76 | NODE 77 | NODE 78 |
| Y-NODE | C-NODE | V-NODE |

| | | | | | |
|---|---|---|---|---|---|
| EXC | INH | EXC | INH | EXC | INH |
| [0048] | [0026] | [0048] | [0026] | [0048] | [0026] |

| | | |
|---|---|---|
| NODE 79 | NODE 80 | NODE 81 |
| M-NODE | P-NODE | B-NODE |

| | | | | | |
|---|---|---|---|---|---|
| EXC | INH | EXC | INH | EXC | INH |
| [0048] | [0026] | [0048] | [0026] | [0048] | [0026] |

On the previous 9 tables we show the modulations that occur to all 81 residual connections which project to the selective node after encountering the first stimulus, where the cross was surrounded with a white background. In this iteration all 81 residual connections were modulated accordingly since all cells had sent depolarization signals to the selective node.

Notice however that this shall carry on for another 4 iterations because regardless of whether a difference or not was registered, due to the initial condition values which are biased towards excitatory connections, no net hyperpolarization signal are received by the selective node upon registering a difference unless excitatory connections are weaker than inhibitory connections which would only occur after 4 modulations, where at the 5th modulation the hyperpolarization influence would be net positive (i.e., depolarization would be net negative).

We therefore assume in this example that such was the case, and hence that the corner cells color changed from white to red after the equivalent of 4 modulations has occurred to reverse inhibitory connections. Notice we say the equivalent of 4 modulations rather than 4 modulations because if we recall, we have decelerated the growth of reverse inhibitory connections based on the amount of nodes a particular cell which project said connections has, and this would cover connections which project from layer 2.

In the next set of tables we showcase, targeted modulations in action after a difference was registered for a successive amount of iterations, in other words let's say that after the stimulus which was comprised of a black cross surrounded with white corners was encountered for a few iterations, another stimulus which is comprised of a black cross surrounded with red corners was encountered on the next 5 set of iterations.

Such encounter allows for targeted modulations where only the residual connections which project from the cells which represent the cross part of the stimulus would be modulated whilst the corner cells are not, as showcased on the following tables.

TABLE 16
(Selective pool 1 to layer 1) (Receptive cell 1 to layer 2)

| | | |
|---|---|---|
| NODE 1 | NODE 2 | NODE 3 |
| W-NODE | R-NODE | G-NODE |

| | | | | | |
|---|---|---|---|---|---|
| EXC | INH | EXC | INH | EXC | INH |
| [0098] | [0024] | [0048] | [0056] | [0048] | [0056] |

| | | |
|---|---|---|
| NODE 4 | NODE 5 | NODE 6 |
| Y-NODE | C-NODE | V-NODE |

| | | | | | |
|---|---|---|---|---|---|
| EXC | INH | EXC | INH | EXC | INH |
| [0048] | [0056] | [0048] | [0056] | [0048] | [0056] |

| | | |
|---|---|---|
| NODE 7 | NODE 8 | NODE 9 |
| M-NODE | P-NODE | B-NODE |

| | | | | | |
|---|---|---|---|---|---|
| EXC | INH | EXC | INH | EXC | INH |
| [0048] | [0056] | [0048] | [0056] | [0048] | [0056] |

TABLE 17
(Selective pool 2 to layer 1) (Receptive cell 2 to layer 2)

| | | |
|---|---|---|
| NODE 10 | NODE 11 | NODE 12 |
| W-NODE | R-NODE | G-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 13 | NODE 14 | NODE 15 |
| Y-NODE | C-NODE | V-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 16 | NODE 17 | NODE 18 |
| M-NODE | P-NODE | B-NODE |

| | | | | | |
|---|---|---|---|---|---|
| EXC | INH | EXC | INH | EXC | INH |
| [0048] | [1048] | [0048] | [1048] | [0148] | [0024] |

TABLE 18
(Selective pool 3 to layer 1) (Receptive cell 3 to layer 2)

| | | |
|---|---|---|
| NODE 19 | NODE 20 | NODE 21 |
| W-NODE | R-NODE | G-NODE |

| | | | | | |
|---|---|---|---|---|---|
| EXC | INH | EXC | INH | EXC | INH |
| [0098] | [0024] | [0048] | [0056] | [0048] | [0056] |

| | | |
|---|---|---|
| NODE 22 | NODE 23 | NODE 24 |
| Y-NODE | C-NODE | V-NODE |

| | | | | | |
|---|---|---|---|---|---|
| EXC | INH | EXC | INH | EXC | INH |
| [0048] | [0056] | [0048] | [0056] | [0048] | [0056] |

| | | |
|---|---|---|
| NODE 25 | NODE 26 | NODE 27 |
| M-NODE | P-NODE | B-NODE |

| | | | | | |
|---|---|---|---|---|---|
| EXC | INH | EXC | INH | EXC | INH |
| [0048] | [0056] | [0048] | [0056] | [0048] | [0056] |

TABLE 19
(Selective pool 4 to layer 1) (Receptive cell 4 to layer 2)

| | | |
|---|---|---|
| NODE 28 | NODE 29 | NODE 30 |
| W-NODE | R-NODE | G-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 31 | NODE 32 | NODE 33 |
| Y-NODE | C-NODE | V-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 34 | NODE 35 | NODE 36 |
| M-NODE | P-NODE | B-NODE |

| | | | | | |
|---|---|---|---|---|---|
| EXC | INH | EXC | INH | EXC | INH |
| [0048] | [1048] | [0048] | [1048] | [0148] | [0024] |

TABLE 20
(Selective pool 5 to layer 1) (Receptive cell 5 to layer 2)

| | | |
|---|---|---|
| NODE 37 | NODE 38 | NODE 39 |
| W-NODE | R-NODE | G-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 40 | NODE 41 | NODE 42 |
| Y-NODE | C-NODE | V-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 43 | NODE 44 | NODE 45 |
| M-NODE | P-NODE | B-NODE |

| | | | | | |
|---|---|---|---|---|---|
| EXC | INH | EXC | INH | EXC | INH |
| [0048] | [1048] | [0048] | [1048] | [0148] | [0024] |

TABLE 21
(Selective pool 6 to layer 1) (Receptive cell 6 to layer 2)

| | | |
|---|---|---|
| NODE 46 | NODE 47 | NODE 48 |
| W-NODE | R-NODE | G-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 49 | NODE 50 | NODE 51 |
| Y-NODE | C-NODE | V-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 52 | NODE 53 | NODE 54 |
| M-NODE | P-NODE | B-NODE |

| | | | | | |
|---|---|---|---|---|---|
| EXC | INH | EXC | INH | EXC | INH |
| [0048] | [1048] | [0048] | [1048] | [0148] | [0024] |

TABLE 22
(Selective pool 7 to layer 1) (Receptive cell 7 to layer 2)

| | | |
|---|---|---|
| NODE 55 | NODE 56 | NODE 57 |
| W-NODE | R-NODE | G-NODE |

| | | | | | |
|---|---|---|---|---|---|
| EXC | INH | EXC | INH | EXC | INH |
| [0098] | [0024] | [0048] | [0056] | [0048] | [0056] |

| | | |
|---|---|---|
| NODE 58 | NODE 59 | NODE 60 |
| Y-NODE | C-NODE | V-NODE |

| | | | | | |
|---|---|---|---|---|---|
| EXC | INH | EXC | INH | EXC | INH |
| [0048] | [0056] | [0048] | [0056] | [0048] | [0056] |

| | | |
|---|---|---|
| NODE 61 | NODE 62 | NODE 63 |
| M-NODE | P-NODE | B-NODE |

| | | | | | |
|---|---|---|---|---|---|
| EXC | INH | EXC | INH | EXC | INH |
| [0048] | [0056] | [0048] | [0056] | [0048] | [0056] |

TABLE 23
(Selective pool 8 to layer 1) (Receptive cell 8 to layer 2)

| | | |
|---|---|---|
| NODE 64 | NODE 65 | NODE 66 |
| W-NODE | R-NODE | G-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 67 | NODE 68 | NODE 69 |
| Y-NODE | C-NODE | V-NODE |

| | | | | | |
|---|---|---|---|---|---|
| EXC | INH | EXC | INH | EXC | INH |
| [0048] | [1048] | [0048] | [1048] | [0048] | [1048] |

| | | |
|---|---|---|
| NODE 70 | NODE 71 | NODE 72 |
| M-NODE | P-NODE | B-NODE |

| | | | | | |
|---|---|---|---|---|---|
| EXC | INH | EXC | INH | EXC | INH |
| [0048] | [1048] | [0048] | [1048] | [0148] | [0024] |

TABLE 24
(Selective pool 9 to layer 1) (Receptive cell 9 to layer 2)

| | | |
|---|---|---|
| NODE 73 | NODE 74 | NODE 75 |
| W-NODE | R-NODE | G-NODE |

| | | | | | |
|---|---|---|---|---|---|
| EXC | INH | EXC | INH | EXC | INH |
| [0098] | [0024] | [0048] | [0056] | [0048] | [0056] |

| | | |
|---|---|---|
| NODE 76 | NODE 77 | NODE 78 |
| Y-NODE | C-NODE | V-NODE |

| | | | | | |
|---|---|---|---|---|---|
| EXC | INH | EXC | INH | EXC | INH |
| [0048] | [0056] | [0048] | [0056] | [0048] | [0056] |

| | | |
|---|---|---|
| NODE 79 | NODE 80 | NODE 81 |
| M-NODE | P-NODE | B-NODE |

| | | | | | |
|---|---|---|---|---|---|
| EXC | INH | EXC | INH | EXC | INH |
| [0048] | [0056] | [0048] | [0056] | [0048] | [0056] |

As showcased on the table set, the 4 corner cells represented by tables 16, 18, 22 and 24, did not experience any modulations to its residual connections for any of its nodes, whilst the contrary can be said for the rest of the cells represented by the rest of the tables. This disparity in connection strength over time allows only the 5 cross representing cells to have a monopoly over their influence on the 4^{th} layer selective node, since depolarization and hyperpolarization signal influence is directly proportional to connection strength.

As was mentioned earlier, this process shapes the kernel's boundaries by restricting the process of positive modulations (and in turn the process of learning) to only the cells which include the segmented stimulus to be learned, whilst leaving the rest with no positive modulations and therefore the parts that did not get positively modulated are weakened over time as a result of the decay function which governs all connections.

This means that over time the segmented from area, which represents the corner cells in this example, ceases to be part of what the 4^{th} layer selective node learns since the connections that project from said cells and to said selective node no longer exist or would be too weak to have any effect relative to the segmented out area, which represent the cross cells in this example, and which the 4^{th} selective node ends up learning.

As is made clear in the section regarding the detailed implementation of this architecture, in order to achieve targeted modulations, an extra layer of receiver gates have to be introduced which would represent entire cells as opposed to only individual connections, since as clarified earlier we base the modulations specifically on those cells which send depolarization signals, and neglect other cells which do not send depolarization signals, and therefore we add to the selective neurons cell, one gate per cell, where one cell gate represents an entire cell with all the feedforward connections it projects.

These gates are Boolean variables at an initially set default state (zero), said gates would only transition to (one) if and only if they receive a depolarization signal from an electrical/influencer normal excitatory connection, and only when their state transitions to (one) and when the selective neuron is active would the individual messaging connection receiver gates which belong to said cells be transitioned to their respective receiving states, allowing only modulations to commence for connections that belong to said cells.

In other words we add an extra layer of conditioning in the form of cell gates which would allow only the connections that belong to said cells the ability to be modulated given the conditions mentioned in the previous section and this additional overall condition which is that the cell gate is itself on (one) and not off (zero), and which would only occur if these cell gates receive a depolarization signal from their respective cells.

This achieves targeted modulations as it specifically restricts modulations to only the connections which belong to the cells that sent depolarization signals at any given transmission cycle.

There is always a whole represented by a node terminating a few successive layers and then a part segmented from it and represented by a different node terminating from non-successive layers which initially learned the same identical whole but with residual connections rather than successive direct ones however got segmented into a part, therefore the process of learning via segmentation is always going to be a reduction process, which requires us to compensate for such a result by introducing many nodes per selective pool which would represent the same stimulus in order to allow for a variety of multiple segmentation of said stimulus to be learned.

The Convolution neural net like layer structure of this architecture, where the layers are segmented into kernel bound regions, and where information is dispersed across multiple feedforward layers, serves a great role in the share-ability of the segmented structures found in the external world, for example, a particular sized and localized circle in a visual scene, could be found common with another different visual scene, and since a particular deep neuron would be selective to that particular common shape, it would get equally active when either of the two scenes are re projected onto the retina, this serves the important role of sharing common independent parts across different visual scenes, where multiple visual scenes observed across different time periods could share an extensive amount of specifically selective neurons, and the more simple the structures captured by these selective neurons are, the more of these neurons that would happen to be commonly shared with many such visual scenes.

For example, edges are very simple structures and many scenes would share a large amount of edges in numerous variations with one another, hence would share a large amount of selective neurons that are selective to these edges and their numerous variations, similarly, many visual scenes would share a large amount of simple shapes and their variations, however not as many as edges since shapes are relatively more complex, on the other hand, visual scenes rarely share many complex objects with all of its variations, and this is true for all types of stimuli (visual/acoustic), and therefore, the ability to segment perceived phenomenon into their independent pieces of structure, allow the network to exploit the natural feature of commonality which all structured visual and acoustic phenomena happen to possess.

Middle/Intermediary layers are necessarily in this architecture because they allow the network's selective neuron to learn stimuli with a varying degree of receptive field sizes, where the deeper a neuron is the larger and the more complex of a stimulus said neuron would be able to learn, and while dynamic kernel boundaries would allow for a very deep neuron to learn a variety of receptive field sized stimuli, the fact that these neurons lie very deep in the architecture prevent them from integrating what they learn with other early neurons and hence would prevent them from sharing information with one another, this is why it would be a design flaw to provide only two layers, an input layer and an output selective neurons layer with a very wide receptive field spanning the entire input layer, as the output selective neurons while would possess the ability to learn all possible stimuli, wouldn't be able to share and integrate such information in a hierarchical structure where one simple stimulus becomes part of another larger and more complex stimulus.

This means both, the ability of layers to transpass information across layers and their ability to pass information in a hierarchical layer to layer manner, are equally necessary in this architecture, as the former aids in segmentation by allowing all sorts of receptive field engulfing of a stimulus while the latter aids in the hierarchical buildup of information through share-ability, from simple to complex and through an efficient build up mechanism.

To illustrate what we mean by an efficient build up mechanism, consider a traditional convolution net, typically a conventional neural network is composed of a set of convolution and pooling layers which end up connecting to a set of fully connected artificial neural net layers, in this connectivity structure a few layers of ANN are required to do an extraordinary job of training data, this is in contrast to a case where we simply connect an input layer to an output layer without intermediary layers where the performance becomes far lower in time and compute power efficiency per unit of training data, the reason for such disparity, is because the information that are used by the fully connected layers to optimize and classify data in the former case, are more complex than the information used in the latter case to do the same task.

One can make an analogy between the two previously mentioned architectures, and two human data analysts who are equally tasked to classify a set of human portraits based on the gender of the persons depicted on the portrait, the difference however, is that one data analyst is given a data sheet which lists all the pixel values of each individual portrait, while the other is given a data sheet which lists all the facial features for each individual portrait, the task is the same for both analysts but the amount of effort and time it would take each one is drastically different, since the difficulty is greater for the former relative to the latter, this is exactly what deep layers in a conventional neural network architecture serves to do, the ability to build up information from their simplest raw form at the input layer to a more complex state of features on the deeper layer through a hierarchical structure of information flow, such complex features are then fed to the fully connected ANN layers, where they can utilize by optimizing classification boundaries based on them, as opposed to being fully reliant on raw data.

NNNs do the same job, but take it rather to the next level, where we do away with optimization and quantitative distributed representations all together and rather use Qualitative neural net computation means inspired by the mammalian neural network architecture to accomplish the same task, however with greater efficiency and with less interventions, analogous to their biological counterparts, the mammalian brain neural network architecture, all as is clarified in the later sections.

### Section 2-C (The Spiking Rate and Malleability Through Tolerance)

Here, we introduce what we refer to as a tolerance rate towards selectivity, and we introduce what we later refer to as a spiking rate for selective nodes, both of which give the network higher malleability as well as higher levels of adaptation while learning any particular stimulus.

In the mammalian brain, while perceiving a steady stream of information from a given stimulus, a selective neuron is activated under a particular rate per unit duration, which is commonly referred to as the spiking rate. The spiking rate represents the frequency by which a successful communication occurs from a given set of presynaptic neurons to a particular postsynaptic neuron, where the postsynaptic neuron is the object of focus, as in, the postsynaptic neurons' spiking rate is what we are interested in here.

In the mammalian brain many factors can affect the spiking rate of a given neuron, however in this model architecture we are only concerned with two factors, one which affects the spiking rate of feedforwardly connected neurons based on absolute net signal influence, and another which affects the spiking rate of laterally connected neurons based on relative net signal influence (commonly known in cognitive neuroscience as relative balance), and since this sub-section is geared towards feedforward connections, we only focus here on the former.

For feedforwardly connected nodes, we want to implement a spiking rate that is proportional to the absolute net depolarization value received by the given node, which equates to the total depolarization signals minus the total hyperpolarization signals received by said selective node, this shall be such that, at a steady stream of perceiving the same input stimulus per unit duration, at a received zero net depolarization signal, the spiking rate shall be zero, whilst at a net positive depolarization signal, a positive spiking rate per one unit duration shall be observed form the selective node, where the stronger the net depolarization signal being received by the selective node is, the higher shall the spiking rate of said node be per unit duration and vice versa.

Similarly, at a net negative depolarization signal (i.e., net hyperpolarization signal), a negative spiking rate per one-unit duration shall be observed form the selective node, and we refer to it as a shunning rate per unit duration, where the stronger the net hyperpolarization signal being received by the selective node is, the higher shall the shunning rate of said node be per unit duration and vice versa.

Since the strength of a connection is directly proportional to the net signal magnitude, the stronger the connections that feedforward to a particular selective node are, the higher the rate of spiking/shunning said selective node shall be observed to have per one-unit duration. This shall be established by assigning a particular absolute depolarization/hyperpolarization value to a particular firing/spiking rate, where the stronger the connections get, the larger the absolute net depolarization value is received, and hence the greater the frequency of spiking said selective node would be observed to have.

For example, say the 3*3 grid of receptive cells which we used in our prior examples on the previous subsection, were to perceive the previously learned stimulus LBV, if for the sake of example this stimulus was encountered only once before, as was the case in the previous examples, and hence developed excitatory connections with a total strength of magnitude 522 points, i.e., 58 point per connection, which can have a causal influence that nets (58−24)*9=306 depolarization points (recall that we subtract inhibitory influence from excitatory influence per node hence 58−24), then if for the sake of example, a 306 points of depolarization correspond to a 10% spiking rate, this should entail that at a given duration of time, say a one second duration which equates to 1000 milliseconds and 20 major clock periods (assuming 50 millisecond long major clock periods), then the rate of spiking shall be 10% of that time uniformly distributed across that period.

This means, hypothetically, at a steady rate of communication equivalent to 1000 HZ, i.e., a processing rate of 1000 per second, for every 500 milliseconds, i.e., for every 10 major clock periods, one spike (activation) from the selective node shall be observed, where it corresponds to one successful communication between the presynaptic nodes and the postsynaptic selective node, this means for the entire one second duration where a given input stimulus is being constantly fed onto the network across the entire duration, say by staring at that stimulus for that full one second duration, the selective node shall be only successfully activated 10% of 20 major clock periods=2 clock periods, uniformly distributed across the one second duration, hence the first and 11^{th} major clock periods, respectively.

On the other hand, if at another scenario the same stimulus got its feedforward connections to the selective node strengthened to 98 points each, where the net depolarization signals it sends to that same selective node nets (98−24)*9=666 depolarization points, then a 50% spiking rate shall be observed from said selective node, therefore for every 100 milliseconds, i.e., for every 2 major clock periods, one spike (activation) from the selective node shall be observed, where it corresponds to one successful communication between the presynaptic nodes and the postsynaptic selective node, this translates to a spiking rate of 10 major clock periods per one second duration, distributed uniformly, i.e., the 1st 3rd 5^{th} 7^{th} 9th 11^{th} 13^{th} 15^{th} 17^{th} 19^{th} major clock periods, respectively.

If at a third scenario, the same stimulus got its feedforward connections to the selective node strengthened to 148 points each, where the net depolarization signals it sends to that same selective node nets (148−24)*9=1116 depolarization points, then a 100% spiking rate shall be observed from said selective node, therefore for every 50 milliseconds, i.e., for every major clock period, one spike (activation) from the selective node shall be observed, where it corresponds to one successful communication between the presynaptic nodes and the postsynaptic selective node, this translates to a spiking rate of 20 major clock periods per one second duration, distributed uniformly, i.e., all major clock periods, respectively.

Notice that in the previous examples, the increase in spiking rate is linearly proportional to the net depolarization signal received by the selective node which would exhibit such spiking behavior, notice that we also assumed that no qualitative difference were tolerated and therefore the stimulus that were perceived were identical to what was learned, such that the net depolarization signals would range from 24*9=216 to 124*9=1116, which would be 1116−216=900 net depolarization levels, and the spiking rate would range from occurring for 2 clock periods every second to 20 clock periods every second.

If a qualitative difference tolerance were to be set to a particular selective node in correspondence to a particular stimulus, the net depolarization value is expected to be lower if such cell/s difference/s were registered since such change would add hyperpolarization values which would be subtracted from the net depolarization signals sent by the other cells. Hence the spiking rate would drop in proportion to the absolute net depolarization signal received by the selective node, and therefore perceiving a stimulus the way it was learned and perceiving a stimulus that is slightly different from the one that was learned (assuming tolerance is allowed) would have different effects on the selective node which would be manifested in the difference in the spiking rate.

For example, assuming the following spiking rate to net depolarization signals map table:

TABLE 25

| Net Depolarization Signals | Spiking Rate per Second |
|---|---|
| [—00-0000] | 00 |
| [0001-0215] | 01 |
| [0216-0305] | 01 |
| [0306-0395] | 02 |
| [0396-0485] | 04 |
| [0486-0575] | 06 |
| [0576-0665] | 08 |
| [0666-0755] | 10 |
| [0756-0845] | 12 |
| [0846-0935] | 14 |
| [0936-1025] | 16 |
| [1026-1115] | 18 |
| [1116-11++] | 20 |

Where, −−00 refers to values less than 0, and 11++ refers to values greater than 1116, and each spiking value refers to how many major clock periods per one second duration of perceiving the stimulus, would have the corresponding selective node activated within.

If on a particular major clock period X, an identical stimulus to stimulus CBV were to be encountered by the receptive grid we used in our prior examples, such that the 2^{nd} selective node laid on the earlier examples which learned to represent said stimulus would get activated, assuming the connections has not deteriorated at all, then the net depolarization signal received by the selective node would be 1026 points of depolarization, since at the 2^{nd} major clock period the 2^{nd} selective node got its connections modulated 9 times, for a net excitatory connection strength of 138 each, which would equate to a (138−24=114). 9=1026 net depolarization signals received by the 2^{nd} selective node upon perceiving stimulus CBV on this second encounter. This based on the previous table shall lead to a spiking rate of 18 per second, which means that if stimulus CBV were to be encountered for an entire 1 second duration, then 18 of the total 20 major clock periods would have the 2^{nd} selective node be activated within in response to such encounter.

If on the other hand, on the following major clock period X+1, assuming no deterioration to the connections that project to the 2^{nd} selective node, the 2^{nd} selective node encounters a stimulus identical to CBV except for the 5^{th} cell, were a difference was registered, then the net depolarization signal received by the selective node would be (8·+114)+(1·−464)=448 depolarization points, where 8×114 represent all 8 identical cells and 1×464 represent the hyperpolarization influence exerted by the different cell (512−48=464). This based on the previous table shall lead to a spiking rate of 4 per second, which means that if this slightly different stimulus were to be encountered for an entire 1 second duration, then 4 of the total 20 major clock periods would have the 2^{nd} selective node be activated within in response to such encounter.

The spiking rate values we mapped are made to be related to the net modulation experienced by a particular set of connections, and by extension to the selectivity factor, and while they represent some arbitrary hyperparemeter values, we prefer to tie such mapping to the amount of modulation a set of connections has received, such that the two limits of the mapping function represent 0 modulations and 10 modulations, respectively. This would mean that once a selective node developed its highest level of selectivity, said node is expected to spike at the highest possible rate assuming perfect conditions, where a perfect condition would be that the net depolarization signals received are not counter acted by any qualitative differences, or by any changes to the secondary connectivity pair.

The secondary connectivity pair denotes the connections which we subtract from the depolarization and hyperpolarization influences of a node, for example, 138 points is the net strength magnitude of a highly developed excitatory connection, while its counterpart reverse inhibitory connection which in some cases like in the previous examples weren't developed has a net strength magnitude of 24 points, the former is what we refer to as a primary connection whilst the latter is a secondary connection, similarly, 1048 points is the net strength magnitude of a highly developed reverse inhibitory connection, while its counterpart excitatory connection which in some cases like in the previous examples were not developed has a net strength magnitude of 48 points, the former is what we refer to as a primary connection whilst the latter is a secondary connection. Both primary connections are denoted collectively as a primary connection pair, and both secondary connections are denoted collectively as a secondary connection pair.

Notice that the designations primary and secondary are relative to the stimulus being perceived, for selective nodes which are in the process of development, the nodes might learn multiple stimuli before committing to only one, and within such a phase of undecidedness the only way to designate which are primary connections and which are secondary connections would be if we based such designations on the stimulus being perceived in correspondence to its influence to the selective node. For a clear example on this refer to previous examples, specifically the 6^{th} and 7^{th} examples from the prior sub-section. Changes to secondary connections, affect the net depolarization signals received by a given selective node and hence affect the spiking rate of said selective node.

On the other side, we chose to restrict the spiking rates between multiples of 2 from 2 to 20, because we know that on average a visual system stares at a stimulus for 500 milliseconds, which is half the duration, and therefore the lowest expected persistence of any given stimulus in the visual field is around 500 milliseconds for a majority of stationary stimuli that are perceived shortly, this is clarified below. The spiking rate has only one use case which is to distinguish between perceiving a stimulus identical to what the node has learned and perceiving a similar stimulus relative to what a node has learned.

Such distinction has a significant effect on the network's ability to adapt and learn slight changes that happen to a particular stimulus it had already learned after said change encounter has been tolerated, all as is clarified after we introduce tolerance.

By introducing tolerance in the form of an error margin roof which bounds how highly selective a neuron can be to any stimulus that gets projected onto its corresponding receptive layer, we allow some normal excitatory connections which did not previously form to be added while also allow some reverse inhibitory connections which were previously formed to be subtracted, this is because since this is a qualitative computation based system, a change in the stimulus, could indicate that either neurons that were previously inactive were found active or that neurons which were previously active were later found to be inactive, or both simultaneously.

For example, in the cross shape example mentioned previously, if at another encounter one of the cells, say the center of the cross was perceived by the sensors as white instead of black, then the selective neuron from layer 2 which selectively activates in response to a black 3*3 center grid, would be inactive, let's refer to this selective neuron as Center Black, whilst the selective neuron from that same pool which activates in response to a white 3*3 grid would be activated, and let's refer to it as Center White, and hence, the selective neuron from layer 3, which previously learned a totally black cross, would register a hyperpolarization signal coming from Center White as it would have formed reverse inhibitory connections with it based on the learning algorithm, and would register no depolarization signals which it should have received from Center Black since Center Black is inactive.

If we assume that we allow a tolerance rate, that permits the selective neuron from layer 3, to accept one cell change, which in this case, is the change occurring in the center of the 3*3 grid of selective neurons which represent the stimulus in layer 2, then because the neuron in layer 3 is still activated as a result of the permitted tolerance, when perceiving said stimulus, a modulation would occur to the connections, where the previously reverse inhibitory connection which projected from Center White would not be strengthened as its presynaptic neuron (Center White) was active this time, and instead the normal excitatory connections that project from this presynaptic neuron (Center White) which used to be weak, is strengthened based on the learning algorithm since it registers a presynaptic activation followed by a postsynaptic activation. Similarly, at the same encounter, since Center black was inactive, then the normal excitatory connections that project from it also would not be modulated, whilst the reverse inhibitory connections that project from it and which were once weak are strengthened based on the learning algorithm since a presynaptic inactivity followed by a postsynaptic activity would be registered.

If this change persists in the real world, in other words if the system continues to perceive a cross with a white center and stops perceiving a cross with a black center, then over time and gradually, the connection map would adjust to the new slightly different stimulus, where, what were once normal excitatory connections and reverse inhibitory connections projecting from Center Black and Center White, respectively would decay through deterioration, whilst new normal excitatory and reverse inhibitory connections that project from Center White and Center Black, respectively would be strengthened until they fully take the place of the old connection map, pay attention that we switched the order of the cells' mention in the previous sentence, to signify a different connection map.

Usually all the connections that are created together, i.e., simultaneously, and which are strengthened together, due to simultancity, would deteriorate simultaneously, however by allowing some margin of error as in the previous case, we give some space which would allow some neurons that belong to the stimulus to not activate when they should and others to activate when they shouldn't, whilst retaining the activation of the feedforward selective neuron, this would render some connections which belong to the previous stimulus getting weaker than the rest while the other connections which belong to the slightly different stimulus getting stronger over time eventually replacing them, and this would only be the case provided that the change persists in the external world.

Notice that when a stimulus experiences a qualitative change there is always both a lost depolarization signal and a gained hyperpolarization signal, by allowing some tolerance in the form of an error margin manifested by the roof of selectivity, we allow for both, slight qualitative additions, and slight qualitative subtractions to the original stimulus, which would overall constitute a slight change to the stimulus, and if such slight change persists in the perception of the stimulus, i.e., is frequently encountered in the external world, the old connections that correspond to the old qualitative difference would deteriorate as a function of time while the new connections that correspond to the new qualitative difference get strengthened and take their place gradually, this would cause a slight change to what stimulus the selective neuron becomes gradually selective to, without necessarily having to assign a new selective neuron to learn the slightly different stimulus.

There are two types of changes that occur while perceiving the external world, small incremental changes over long periods of time, which we refer to as gradual change, and large changes over short periods of time, which we refer to as sudden change, for example, we tend not to perceive the changes corresponding to a person's face aging when they happen to be a person whom we are used to regularly encounter, this is because the regularity of encountering them allow for small incremental changes over time, and this is an example of a gradual change. However, if the same person was not being encountered regularly and we meet the person at two points in time which are temporally distant, say 20 years apart, we notice the drastic changes that occur to that person, and this is an example of a sudden change.

For example, if a stimulus is undergoing subtle changes over multiple video frames, where initially a layer of selective neurons learn frame 1, then at another encounter when frame 2 is projected, and since the change is subtle the margin of error allows each individual neuron that encodes a piece of the stimulus, to still activate and allow for the overall selective neuron to recognize (i.e., activate in response to) the stimulus in frame 2 as if it is the stimulus from frame 1, not recognizing any difference, then when frame 2 is repeatedly encountered the connections from frame 1 that are different than frame 2, deteriorate over time and are replaced by the stronger connections that were different which were introduced in frame 2, then the neuron becomes totally selective to frame 2, and then at a later encounter frame 3 which encompasses a stimulus with again subtle changes is encountered, since the changes are subtle compared to frame 2, they cross the margin, then with enough frequent encountering of frame 3, and due to the deterioration of no longer encountered connections and the strengthening of the newer connections, the neurons become perfectly selective to frame 3, and so on forth, for frames 4, 5 and so on till frame 10, until at some point in time, the difference between frame 1 and say frame 10 is drastically huge, however due to the fact that these changes happened slowly and gradually over long periods of time, we effectively allowed the same set of neurons to become selective to a totally different stimulus.

On the other hand, when the encountering of the first frame and 10^{th} frame happen at two relatively close points in time, many changes to the stimulus would have accumulated and therefore the net change would be very high and the neurons that are selective to frame 1, would reject those great sudden changes that are found in frame 10, as too much difference would be perceived and hence would cross the margin of inactivation, therefore they would get inactive and the stimulus would be considered new and would require a new selective neuron to assign to it.

Overall, this would allow the selective neurons the ability to dynamically adapt to subtle changes which occur over long periods of time but not to sudden changes which occur over small periods of time, and therefore this would allow the network to adapt to small incremental changes over long periods of time, like the long duration changes in the perception of some human's face which is regularly encountered while its aging, while would reject sudden short term changes in the perception of some human's face at temporally distant encounters, the short term here refers to memory and recollection as in this particular case, the observer recollects the old image of the person stored in their memory from the past (the first point in time) and then perceives a total different image of the same person in reality while encountering them at the present (the second point in time), this process of recollecting the past and then perceiving the present is as though the observer saw a sudden short term change like an inflation of a balloon.

Realize that since the visual layers follow a convolution like structure, in other words is sectioned into small kernels, those allowed subtle changes could be distributive, but can't be concentrated, since concertation would mean huge changes in a particular region, and therefore would suppress many selective neurons that represent said region, while distributive change mean subtle changes distributed across the entire visual area, and hence because the visual area and due to convolution is sectioned into little kernel's, if each kernel can tolerate one cell change, then the feedforward selective neuron which represents a particular stimulus can tolerate one cell change per kernel multiplied by the number of kernels that represent the entire stimulus, and hence can tolerate many changes that are distributed across said area.

For example, in the cross example mentioned previously, if the changes that occur to the original stimulus which is represented by the first layer neurons, which were 9*9=81 neurons, were concentrated in a particular region, say the first two 3*3 blocks, and since we say concentrated change, this means multiple cell changes that span the entire 2 blocks, and let's say the changes occur to around 9 different cells from the 18 cells which represent both blocks, in other words a total 5 or 4 cell changes from 9 cells per block, then in this case because both blocks experience too much change, their respective selective neurons from layer 2 which represent these blocks would be suppressed, and 2 out of the 9 selective neurons that represent the stimulus from layer 2 would be inactivated, and if we say the tolerance margin is 1 cell change then this would mean the selective neuron from layer 3 would in turn be suppressed.

On the other hand, if each block from layer 1 experiences one and only one cell change, totaling 9 changes which is the same amount of change expressed previously, because the change is distributed across all 9 blocks, as opposed to being concentrated among 2 blocks, and if again we assume a 1 cell change tolerance margin, then all the 9 selective neurons from layer 2 which represent the 9 blocks from layer 1, would be activated and hence the neuron from layer 3 would in turn be activated, even though the net change in both scenarios was the same, the distribution of the change dictates whether the change is registered or not, and this is due to the convolution structure of the layers. (Notice that when we say convolution structure we refer to the segmentation of the receptive fields of layer nodes into kernels.)

Introducing the following three factors, a margin of error, sectioning the input layers into kernels, as well as a strengthening/weakening of connections over experience and time, respectively (dynamic modulations), would yield a malleable network that can adapt over subtle incremental changes over long periods of time and which therefore cannot differentiate/distinguish the subtle distributed changes which occur to slowly deforming stimuli like aging faces, but which also can recognize large/sudden and concentrated changes that happen over short periods of time, and hence can differentiate the quick changes that occur to quickly deforming stimuli like inflating a balloon, or any action that corresponds to great changes over a short period of time, which could include motion as well as many other phenomenon.

To achieve malleability, the threshold of activation of a particular selective neuron after it has learned to be selective to a particular stimulus shall not be made very high to a point where it renders the neuron a perfectly selective one. Recall that perfect selectivity refers to the state by which a selective neuron is highly selective to a particular stimulus to a degree where one cell change from the stimulus perceived in the receptive area can be sufficient to suppress its activation, and therefore we instead introduce a margin of error, in the form of a roof at which the selectivity factor cannot grow beyond as was pinpointed in the earlier section. Where, as was mentioned earlier, reverse inhibitory connections would follow an exponential growth function followed by a linear growth function after crossing a certain roof limit, this roof limit represents and would signify the margin of error we introduce, and since we allow dynamic kernel boundaries, the roof would have to be dynamically allocated as well. Recall that the electrical normal excitatory signals dictate the modulations that occur to a dynamic kernel of connections. Similarly, the normal excitatory signals would dictate the margin of error, i.e., the roof, at which a single reverse inhibitory connection would stop growing exponentially beyond, and where it would transition to a linear growth function.

This dynamic roof would be dynamically adjusted based on the net depolarization signals a selective neuron receives divided by the median strength of the normal excitatory connections which project such depolarization signals, as this would give off the amount of cells that the selective neuron represents, recall that dynamic boundaries prohibits any specified amount of neurons to be known at the initial condition, and therefore it is necessary to resort to the net depolarization signals received as a mean of specifying the roof to be allocated. Dividing the net depolarization signal received over the median strength value of the connections which send said depolarization signals, gives approximately the amount of cells which bound and encompass the stimulus, then by allocating a fixed percentage value in the form of a percentage of the total amount of cells that represent the stimulus which shall be accepted as a margin of error, we can dynamically extract a selectivity ratio which can allow for such change based on these parameters.

To obtain the selectivity factor, we use the following formula, Selectivity Factor=(Rest Of The Cells−One Cell)/(Changed Cells Allowed+One Cell), in other words, SF=((X−10% of X)−1)/(10% of X+1), where 10% represents the pre allocate tolerance percentage ratio which is a hyper-parameter and X represents the extracted dynamic amount of cells that represent the stimulus. for example If the amount of cells were 9 then the selectivity ratio has to be 3.5:1, where changed cells allowed=1, 10% of 9, leaving the rest of the cells amounting to 8, and hence ((9−1)−1)/(1+1)=7/2=3.5, which means that at its peak, the positive modulation difference between reverse inhibitory connections and normal excitatory connections, would be 3.5:1 at which point this ratio would be maintained for any further modulations to both connections (representing the transition to a linear growth function for the reverse inhibitory connection).

This dynamic roof is adjusted and would continue to be readjusted while the neuron is still in the process of learning a particular stimulus, until the neuron becomes highly selective to a particular stimulus at which point the roof would be maintained at its last value which is tuned to the stimulus that was recently learned, until and unless the exponential decay function catches up if the stimulus wasn't persistently encountered in the environment.

Recall that, if a qualitative difference tolerance were to be set to a particular selective node in correspondence to a particular stimulus, the net depolarization value is expected to be lower if such cell/s difference/s were registered since such change would add hyperpolarization values which would be subtracted from the net depolarization signals sent by the other cells.

Hence the spiking rate would drop in proportion to the absolute net depolarization signal received by the selective node, and therefore perceiving a stimulus the way it was learned and perceiving a stimulus that is slightly different from the one that was learned (assuming tolerance is allowed) would have different effects on the selective node which would be manifested in the difference in the spiking rate.

Such difference would result into a reduction of modulations received by a given set of connections when the stimulus being perceived is slightly different, relative to when the stimulus is identical. Recall that a connections modulation is directly proportional to its spiking rate, since each spike results into one modulation, and therefore less spiking means less modulation and hence a slowdown in the learning curve.

This means that perceiving a stimulus that is not identical but qualitatively tolerable in its similarity, would lower the modulation rate for said connection set, and hence the network would more resistant to learning such slight change even though its tolerable unless it was persistent, as was clarified earlier.

### Section 2-D (Feedforward Connectivity Structure for Temporally Distributed Stimuli)

Here, we introduce the feedforward connectivity structure we implement which alongside with the learning algorithm introduced previously, allow for the establishment of selectivity for temporal stimuli.

In the prior sub-sections, we clarified how spatially distributed stimuli, which represent information that are characterized as being distributed across space and which can lie within a single temporal moment, can form feedforward connections with feedforward neurons, and establish selective neurons which respond to said stimuli, this is crucial since the mammalian brain, and specifically its visual cortex, has the ability to perceive extension (i.e., space), and static stimuli which represent one from of stimuli perceivable by the visual cortex, carry information in a distribution that spans across the visual spatial field.

These spatially distributed information which correspond to different points in the retinal surface (the sensors of the mammalian eyes), tend to be processed in parallel for static visual information, and as long as the time of signal transmission is unified across all spatial regions, throughout all the connections projecting from said regions, we can guarantee that any given information is processed in parallel due to the unification of transmission time across all connections which transmit said information from the receptive layer to any particular selective neuron from the selective layer, which ensures that all the spatially distributed activations that occur across a given receptive region are registered by any given selective neuron simultaneously.

Similarly, in the mammalian brain, in order for information to be processed in parallel, the neurons have to transmit information simultaneously and also has to have the information be received by any given selective neuron simultaneously, and in this case what determines simultaneity are biological factors which determine the latencies of information flow, these factors are abstracted in traditional neural network architectures in the form of input to output equidistant connections (i.e., equal in length connections), and which therefore transmit information that occur simultaneously across all nodes in the input layer to the forward layers at equal latencies, for analogy, this could be biologically abstracted as if the location of the spines (i.e., synaptic junctions) are found aligned across all connections, in other words that all biological axon-dendrite connections are equal in length, that is of course under the assumption that no other biological factors affect transmission time.

However, in the mammalian brain, axons and dendrites vary in length and cross sectional area, spines vary in their distributed localization along the dendrites, somatic integration in different cells vary in the time they take to integrate the graded potential signals they receive before sending action potentials, and some axons are surrounded with an insulating myelination coating, all these factors contribute in the variation of signal transmission time, and when there exists a variation in the time it takes for a set of input signals to reach one output neuron, recognizing and classifying temporal events become feasible.

Learning temporal events rely on the ability of a neuron to perceive (metaphorically speaking) a wide spectrum of timed events, and since the laws of physics state that time equals the distance traveled divided by speed, if we assume that the speed of transmission is equal across all neuronal communications, then the spatial distance traveled by the signal would be directly proportional to the temporal distance (time) of the event, therefore a long journey (i.e., a long connection) corresponds to a distant event in time, whilst a shorter journey would correspond to a closer event in time.

Therefore, by laying a structure of dendritic connections which vary in length, in other words by connecting the input neurons and the output neuron with varying lengths of connections (not equidistant connections), when all the signals reach simultaneously to the postsynaptic output neuron, a temporal representation of the events would be established, where those neurons that had shorter connections with the output neurons, would transmit signals of events that occurred closer in time while those with longer connections would transmit signals of events that occurred farther in time, establishing a temporal representation of the experienced events and which can later be classified by allocating said events to selective neurons.

In the mammalian brain, Initially, the effects caused by different timed signal transmissions are very small and are in the ranges of nano to micro seconds, because the variation in the journeys taken by the neurons in the initial sets of layers is small, and hence the information flow is treated as simultaneous, but when the network gets deeper, those biological factors mentioned previously get magnified over long distances and amidst somatic checkpoints, therefore cause large variations in the receiving time which could be measured in the multiples of seconds, hence the deeper the network is, the more temporal recognition becomes possible in those deep neurons, and while not much extensive research by the cognitive neuroscience community was made in this particular area yet, we exploit this effect in our network architecture structure.

In this architecture a neuron won't just form one singular set of equidistant electrical and messaging connections with other neurons, but rather shall always form bands of not equidistant connections (varying in length or the abstracted logical equivalent: latency), and we preferably allocate them to be 3 bands, all forming what we refer to as a connection bus, each connection in this connection bus is given a different latency value relative to the others, and this is to account for temporal information processing as is further clarified shortly after.

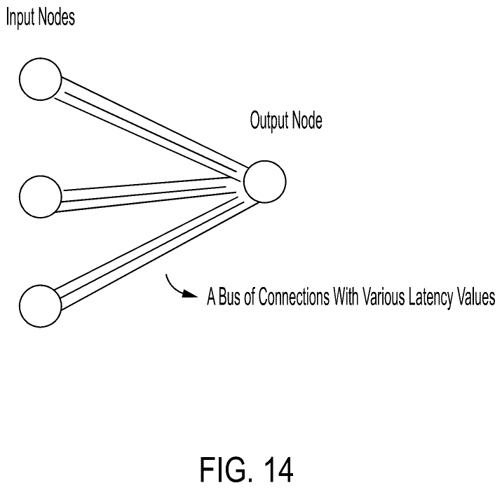

By setting a bus of latency varied connections for every pair of input-output neurons, as shown in FIG. 14, we abstract the biological factors which produce these same latency variations, and specifically the axon to dendrite length factor, let's hypothetically refer to them as non-equidistant connections, these sets of non-equidistant connections either shorten or lengthen the journey of a transmitted signal, mimicking the mammalian brain's synaptic connectivity structure and allowing for temporal integration and temporal processing. Those connections that are equal in length across different parallel connections, always produce simultaneous activations with one another, while those that are not equal in length allow for temporal recognitions of events that are relatively before or after the event transmitted by the connection in question. As shown in FIG. 14, there are 3 receptive nodes connected to a selective node, via a bus of 3 connections, each which represents one feedforward specialization connection pair, and each of which is supposed to be incorporated with a different latency value.

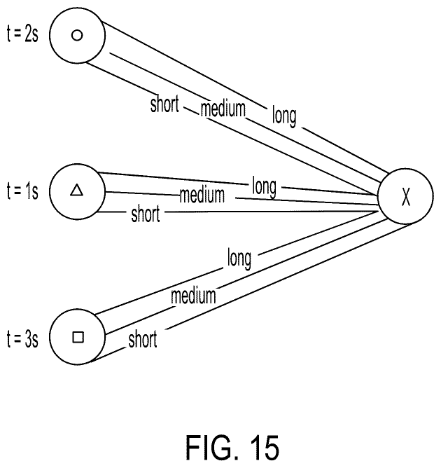

For example, let's say we have three shapes that are to be perceived by the network through its visual sensory devices, a triangle, a circle, and a square, and let's say for the sake of example that the network was slightly mature and therefore had a preconception of each of these individual shapes, where it formed three selective neurons lying in the second layer, where each learned to represent one shape (i.e., selectively activates in response to one of the shapes). Let's further assume that all three selective neurons were feedforwardly connected to one temporally selective neuron lying within layer 3 and labeled X, through a connection bus containing three varying in length connections and with the labels, Long, Medium and Short, where each of these three neurons are connected through all 9 connections, (one bus each, i.e., 3 per neuron, one of each type), to that feedforward temporal selective neuron labeled X, and let's say that the signal transmission speed is equal across each connection that share the same label and that according to their lengths, neuron X would receive stimuli from connections labeled Short after one second, and from connections labeled Medium after two seconds and from connections labeled Long after three seconds. Pay attention, that there are three connections per type, each projecting from one of the three input selective neurons, in others words, three Short connections, one per selective input neuron, three Medium connections, one per selective input neuron, and three Long connections, one per selective input neuron, all as shown in FIG. 15. As shown, there are 3 vertically arranged input selective nodes each labeled with a distinct shape top to bottom, circle, triangle, and square, respectively, such that each node is selective to its corresponding shape where upon the network's perception of any of the three shapes the corresponding node is activated. In addition to the input selective nodes, there is also one output selective node labeled X. Each of the input selective nodes is connected to the output selective node via a bus of 3 connections with varying latency values, labeled Long, Medium, and Short, respectively. On the left side of the input nodes the time at which each of the given shapes were to be perceived by the network is illustrated, where the triangle shape was perceived by the network at t=1 and therefore its corresponding selective node labeled triangle is activated at t=1, and the square shape was perceived by the network at t=2 and therefore its corresponding selective node labeled square is activated at t=2, and the circle shape was perceived by the network at t=3 and therefore its corresponding selective node labeled circle is activated at t=3.

If a fluctuating feed of temporarily distributed information consisting of the appearance of the triangle shape followed by the appearance of the circle shape then followed by the appearance of the square shape at a one second duration for each appearance was perceived by the network, then initially at t=1, neuron X receives a signal through connection Short from the selective neuron which represents the triangle shape upon its activation and does not receive other signals from any of the other selective neurons since none other would have been activated yet. Then at t=2, connection Medium projecting from the selective neuron which represents the triangle shape would be transmitting a depolarization signal to selective neuron X while simultaneously the Short connection projecting from the selective neuron which represents the circle shape would also transmit a depolarization signal to said neuron X. Lastly, at t=3 the Long connection which projects from the selective neuron which represents the triangle shape would transmit a signal this time to selective neuron X, while simultaneously the Medium connection which represents the circle shape would transmit a signal to neuron X and the Short connection projecting from the selective neuron which represents the square shape would transmit a signal to selective neuron X. In other words, at t=3, three signals from the three different input neurons each representing one of the three shapes would reach neuron X simultaneously through three different latency connections.

Therefore, overall after three seconds of elapsed time, neuron X would have recognized a temporal feed of 3 fluctuating shapes lasting 3 seconds at 1 hertz. Realize that it is at t=3, that the entire feed is recognized, as this is when the temporal selective neuron has received all signals that represent the temporal stimulus, allowing neuron X to integrate these temporally distributed information simultaneously, since only at t=3 would all the neurons have transmitted the entire temporally distributed data to the selective neuron simultaneously, and therefore from the perspective of the temporal selective neuron X, these events are registered simultaneously. However, in reality they occur at different times. In a sense, one can argue that temporal selective neuron X perceives and represent visual information in 4 dimensions, space and time.

On the other hand, if only an image of a triangle was projected onto the retinal sheets, and was to be represented by one selective neuron, then temporal selective neuron X receives a depolarization signal from the triangle image first after one second (transmitted by connections short), then after 2 seconds (transmitted by connections medium) and finally after 3 seconds (transmitted by connections long), where at t=1, neuron X receives the stimulus from connections short, then at t=2 it would receive it from connections medium, and at t=3 from connections long, and the stimulus therefore would be echoed as a temporal feed lasting 3 seconds, at a communication rate of 1 hertz, however, since the depolarization signals are transmitted one after the other, rather than simultaneously, since only one receptive neuron representing the triangle is activated in this case, selective neuron X wouldn't be activated since the net depolarization signals it receives at every given moment is only a fraction of the aggregate which is required to activate said neuron.

In other words the key take away, is that in temporal processing and specifically in a process of temporal integration, like a typical spatial integration process, all signals must reach the integrator simultaneously to register a substantial net sum and cause a postsynaptic node activation, however the difference between a spatial integration process and a temporal integration process is that in the former, the distributed set of neurons which represent a given spatial information send signals at a unified transmission time, whilst in the latter, the distributed set of neurons which represent a given temporal information send signals at varying transmission time relative to one another, allowing the former to represent spatially distributed information, whilst allowing the latter to represent temporally distributed information.

By forming a bus of connections, we allow each selective neuron, the ability to transmit a signal in a wide range of temporal coordinates measured relative to the present moment, where each connection represents information occurring at current T—the latency value specified for the connection, for example in the previous example, connections short would transmit signals in correspondence to an event that occurred 1 seconds ago, while connections medium and long would transmit signals in correspondence to events which occurred 2 seconds ago and 3 seconds ago, respectively.

The first question that has to be answered, when dealing with temporal stimuli, is what shall qualify as simultaneously occurring events and what shall qualify as non-simultaneously occurring events, for example a human conscious observer often can't recognize any temporal difference/delay between two visual events that happen within less than a 500 milliseconds (0.5 seconds) duration and perceives said events to be occurring simultaneously, this means to a conscious observer, visual events that occur within the same one single 500 millisecond duration slot are simultaneous, regardless of where (when) these events occur on that 500 millisecond duration time scale, however that same conscious observer is able to perceive acoustic events that are around 50 milliseconds apart, as the brain processes acoustic information quicker than it processes visual information, this phenomenon was tested when scientists conducted an experiment on sprinters to see if the sound from a starter pistol or a flash of light, would get them off the line faster, and while light travels faster than sound, the sprinters were faster in response to the sound because auditory signals are processed faster than visual signals.

In fact, decoding and integrating information that arrive from different senses, which are transmitted in different latencies, require time, and therefore the mammalian conscious observer only perceives events after their brain had processed and integrated said events, and this is what causes the infamous flash-lag illusion as psychologist David Eagleman showcased through his modified version of the flash-lag illusion experiment. Overall this means, in this architecture, we are required to specify a particular duration which resembles simultancity, where any set of events that occur within a temporal distance (duration) that is larger than said duration would not be considered simultaneously occurring, this duration is preferably allocated in this architecture to be 50 milliseconds across all senses, which means that the temporal world would be dissected and perceived in multiples of 50 milliseconds, where the dissected pieces of the temporal world, i.e., the 50 milliseconds threshold, would be analogous to the dissected pixel pieces of the spatial world.

In the mammalian brain, region MT/V5, which is a region that lies in the deepest areas of the occipital lobe, is motion sensitive and this could be addressed to the enlargement effect mentioned earlier, as the transmission time variations are enlarged as a function of the distance traveled by the signal, i.e., the journey it takes, on the other hand, when the variations are too small as is the case in the earlier regions v1 and v2, the variations in timing might exist due to different lengths but are relatively smaller and would not be as enlarged, and hence would be in millisecond differences, which could be perceived and sometimes processed as simultaneously occurring events when we are dealing with visual stimuli.

The seemingly random local distribution of neurons in the mammalian brain's architecture allow, for these immense variations in signal transmission due to variations in the length of the route taken by a given signal (i.e., axon and dendrite lengths), as well as factors like the time a given cell takes to perform somatic integration of signals, or the time it takes to fire action potentials, or sometimes the difference in myelination coating between different axons which affects the speed of transmission, as well as the differences in the axons' or dendrites' cross-sectional areas.

Similarity in this architecture, the variation of lengths between the different connections have to be small initially, and then has to be magnified the deeper we go into the architecture to mimic the mammalian brain, where the deeper the neurons lie in the brain the more of the biological factors mentioned earlier would have an effect over the journey of the signal being transmitted, and hence the greater are the disparities in latencies which we would observe, and therefore the greater the temporal receptive field becomes, this is what we is referred to as the temporal magnification effect, where the deeper a neuron lies in the layer structure the greater shall its temporal receptive field be observed.

This is analogous to the gradual increase in spatial receptive fields for deeper neurons which we previously referred to as the spatial magnification effect, recall that a spatial magnification effect refers to the increase in the spatial receptive field of any given neuron the deeper said neuron lies in the layer structure and relative to the input layer, for example in the spatial structure, if neurons which reside in layer 2 have a spatial receptive field of 3 cells*3 cells and a stride of 3, then neurons that reside in layer 3 would have a receptive field of 9 cells*9 cells, and neurons which reside in layer 4 would have a spatial receptive field of 27 cells*27 cells, and so on and so forth propagating deeper while following a tripling of the receptive field dimensions, realize that the “tripling” is a result of the chosen kernel stride which is three.

Similarly if we assume that a spatial cell/pixel is analogous to a temporal moment, and if we assume that the moment is a 50 millisecond duration block, then following a similar tripling effect and therefore with a temporal stride of 3, we expect that neurons which reside in layer 2 would have a temporal receptive field of 3*(50 ms)=150 ms, and neurons which reside in layer 3 would have a temporal receptive field of 9*(50 ms)=450 ms, and neurons which reside in layer 4 would have a temporal receptive field of 27*(50 ms)=1.35 seconds, and so on and so forth propagating deeper.

To accomplish this, we preferably allocate 3 non-equidistant connections per connection bus at a latency difference of X milliseconds between each connection and the one following it in hypothetical length, where the value of X magnifies, the deeper the connection lies in the layer structure, starting at 50 milliseconds for first layer connections while tripling every subsequent layer, in other words, in the first layer, the shortest connections shall transmit information at a latency of 50 milliseconds, and the medium connections shall transmit information at a latency of 100 milliseconds, while the long connections shall transmit information at a latency of 150 milliseconds, hence a 50 millisecond difference between the connections, on the next layer however, the difference shall be 150 milliseconds following the tripling effect mentioned previously, where the shortest connections projecting from layer 2, shall transmit information at a latency of 150 milliseconds, and the medium connections shall transmit information at a latency of 300 milliseconds, while long connections shall transmit information at a latency of 450 milliseconds, and so on and so forth the deeper we go into the network structure.

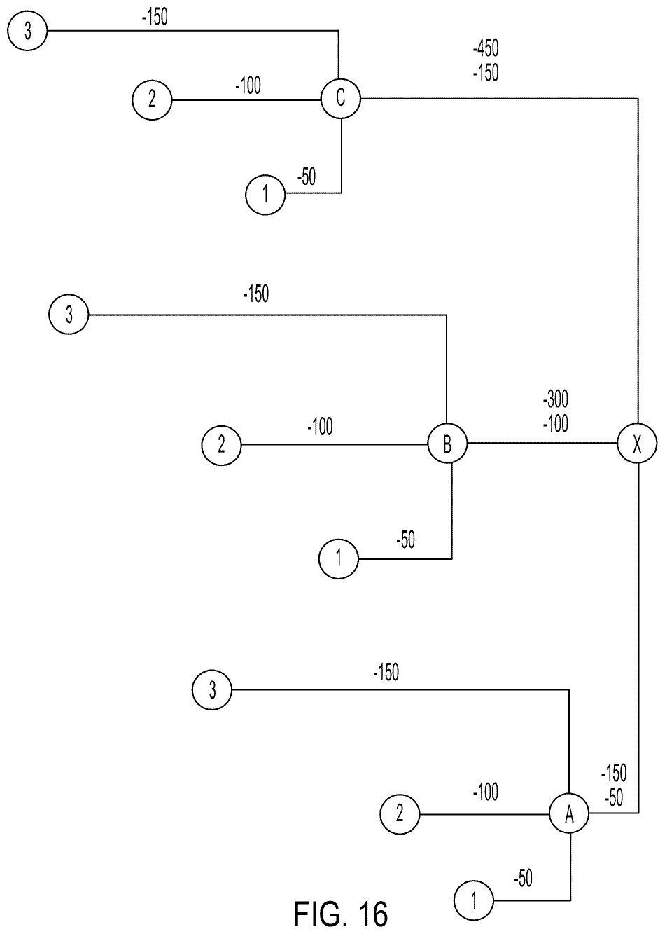

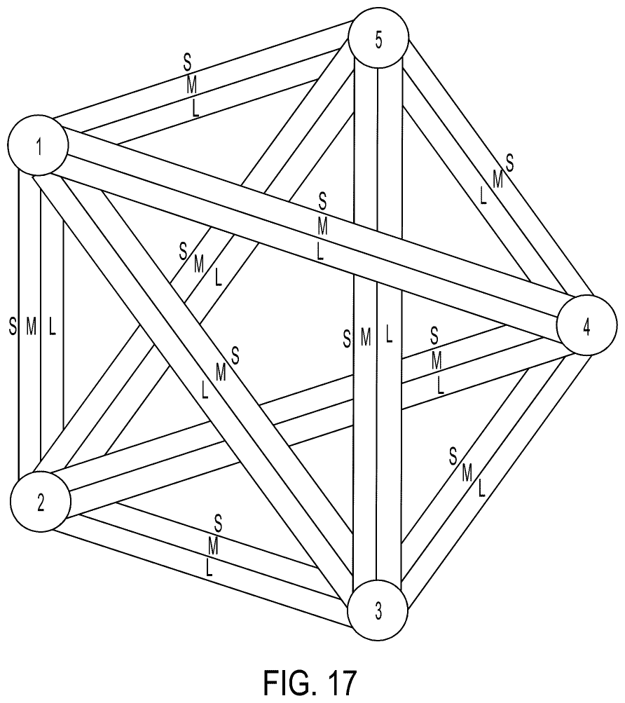

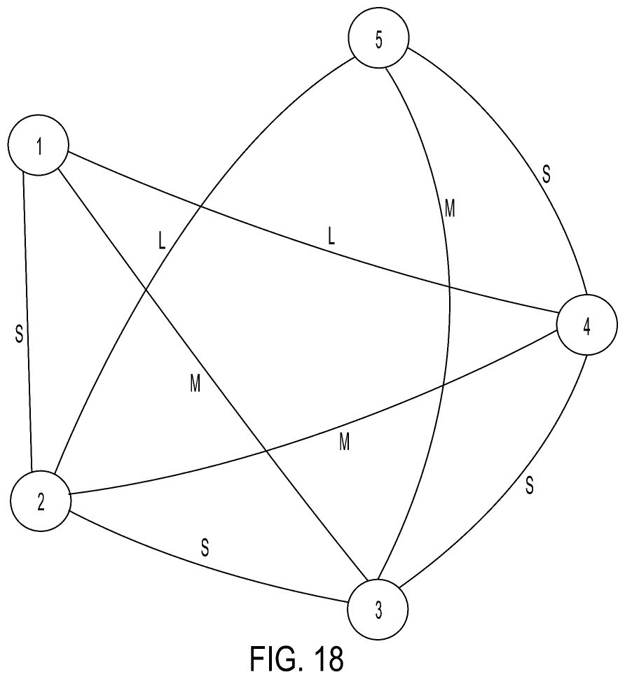

By following this temporal structure, the temporal receptive field of neurons which lie in the second layer would be 150 milliseconds, since the longest connections would be able to transmit information which were projected onto the primary layer 150 milliseconds ago, however for the subsequent layers, the analogy would break and things are going to get different as is clarified shortly after. Notice that the smallest temporal kernel is 150 milliseconds in dimension, the same way the smallest spatial kernel is 3 cells in edge dimension, and hence the neurons which lie in the second layer temporally perceive events that span 150 milliseconds, the same way the neurons which lie in the second layer spatially perceive events that span 3×3 cells, then if you recall, each of these spatial neurons in turn become input for another neuron that lie in the third layer and which takes a 3×3 grid of cells from these neurons, and since these neurons themselves perceive 3×3 cells from the layer prior to them, the neuron which lie in layer 3 spatially perceives events that occur in a total 9×9 grid of cells from the input layer, similarly one can assume that a neuron in layer 3, should temporally perceive a 450 millisecond duration relative to the input layer, however such is not the case, and to illustrate how such is not the case, consider the following diagram in FIG. 16.

FIG. 16 shows 3 layers of nodes, such that the first layer counting from the left, contains 9 nodes and the second layer counting from the left contains 3 nodes labeled A, B and C, counting from bottom to top, respectively, whilst the third layer contains one node labeled X. Each node from the second layer receives information from three nodes labeled 1, 2, and 3, and which belong to the first layer, via latency varied connections, such that they receive projections from the node labeled 1, via a 50 milliseconds latency connection, and from the node labeled 2, via a 100 milliseconds latency connection, and from the node labeled 3, via a 150 milliseconds latency connection.

Similarly, node X from layer 3 receives information from all three nodes labeled A, B and C, which belong to the second layer, and via latency varied connections, such that it receives projections from the node labeled A, via a 150 milliseconds latency connection, and from the node labeled B, via a 300 milliseconds latency connection, and from the node labeled C, via a 450 milliseconds latency connection. Under the aforementioned latency values, another set of latency values, 50, 100, and 150, respectively, are used to signify an alternative example showcased in the examples. The negative signs are only a convenient way to represent the negative relative time of the information, i.e., how far in the past the information of which the receiving node receives information about has occurred.

In FIG. 16, there is a diagram which illustrates a set of neurons arranged in a feedforward hierarchical structure, across three distinct layers, where there is an input layer which holds 9 input neurons in total, a middle layer which holds 3 neurons, and an output layer which holds a single neuron. Each neuron from the middle layer receive three connections from three distinct neurons that belong to the input layer, where each of the three connection is labelled with a different latency value, the values are in milliseconds and the negative sign indicates the temporal coordinates, or in other words, how far back in time each connection's transmission signal relate to. For example the −50 labelled connections transmit a signal from the presynaptic neuron and to the postsynaptic neuron in 50 milliseconds, and therefore the information the signals relay to the postsynaptic neuron relates to an event which occurred 50 milliseconds ago, hence −50.

The neuron labelled x from the third layer, takes as input the three neurons which lie in the middle layer, following a similar connectivity structure, however to illustrate the importance of the values we specify as latencies for any given set of connections per layer, we put two values on each connection, the same set of values 50, 100, 150, and another set values, 150, 300, 450. We can measure how long information takes to reach neuron x, from the input layers by adding up all the latency values across the three layer journey, for example, if we assume the 50, 100, 150 set of values for the connections which lie between layer 2 and 3, then neuron 3 to Neuron C takes 150 milliseconds, and neuron C to X, takes 150 milliseconds, which means the journey 3CX takes 300 milliseconds, the journey 2CX takes 250 milliseconds, and the journey 1CX takes 200 milliseconds.

Moving to the next neural set, the journey 3BX takes 250 milliseconds, the journey 2BX takes 200 milliseconds, and the journey 1BX takes 150 milliseconds. Finally for the bottom neural set, the journey 3AX takes 200 milliseconds, the journey 2AX takes 150 milliseconds, and the journey 1AX takes 100 milliseconds. As one might observe, some journeys are equal in length, like 2CX and 3BX, additionally 1CX and 2BX and 3AX, as well as 1BX and 2AX. An equal journey length signifies that information that such journey is transmitting occurred simultaneously, which means an overlap in the receptive field of the three middle layer neurons occurred, analogous to an overlap in the spatial receptive field when we decrease the stride of the kernels. In other words by using the same 50, 100, 150 latency values across all layers it is as though we kept the stride of the spatial kernels at 1, but since we do not want a temporal stride of 1 and rather we want a temporal stride of 3 to avoid any overlap in temporal receptive field regions the same way we avoided such overlap in spatial receptive field regions, the values have to increase per layer as was stated earlier, where in the previous scenario, the connections which lie between layer 2 and layer 3, shall have greater latency values to counter any overlap, which in this case would be 150, 300, and 450.

If we verify this by calculating all the corresponding journeys we would succumb to the following:
3CX: 600 milliseconds
2CX: 550 milliseconds
1CX: 500 milliseconds
3BX: 450 milliseconds
2BX: 400 milliseconds
1BX: 350 milliseconds
3AX: 300 milliseconds
2AX: 250 milliseconds
1AX: 200 milliseconds

As shown, all the journeys in this case are 50 milliseconds apart from one another, and therefore the temporal receptive fields are not overlapping, and what these values show, is that the selective neuron X which lies in layer 3, has a receptive field that spans 600−200=400 milliseconds in duration. This means that neuron X has the ability to integrate information that happened across a duration from Current T−600 milliseconds, to Current T−200 milliseconds.

As showcased by the values listed previously, the temporal receptive field of the neurons which lie in layer 3 is not 450 milliseconds, and if we reduce the magnification effect, such that the connection values between layer 2 and layer 3 are made to be say 100, 200 and 300, respectively, we would effectively cause a temporal receptive field overlap as shown by calculating the journey time, on the other hand if we increase it, we would leave temporal gaps that would be unrepresented, and therefore the prior analogy breaks here. The temporal magnification effect proves very crucial in the acoustic implementation of this architecture, as it would allow for the emergence of a sophisticated temporal lobe similar to its biological counterpart.

Before we move forward, we need to clarify how this architecture handles the process of signal transmission, since a lot of misconceptions can occur if we do not specify how information would move across the neural network from a temporal perspective. In this architecture there are two modes of implementation possible for transmission, a digital transmission mode of implementation and an analog transmission mode of implementation. In the digital transmission mode we specify a set of clock rates and clock cycles, whilst in the analog transmission mode we specify a duration window for the integration of analog signal information. The former is suitable for a software mode of implementation of the architecture, whilst the latter is suitable for a hardware mode of implementation of the architecture.

In the digital mode of implementation, the network shall operate under two predefined clock rates, one clock rate preferably 20 HZ which we refer to as, the perceptual clock rate, and another set of clock rates which vary across the layers of the network and we refer to it as the feedforward clock rates. Recall that, a set of input activations is required to relay signals throughout each and every selective neuron which belong to the corresponding receptive kernel region at different latency values, and therefore, for all the selective neurons to be given a chance to get activated, a duration is needed. The perceptual clock rate defines the time it takes for one feedforward layer to begin influencing another layer, through electrical connections and via signaling, this means for feedforward connections, a set of presynaptic nodes from one layer would change the state of a bunch of selective presynaptic nodes from a feedforward layer, within a 50 millisecond duration, in other words, level triggered (within the period that spans between a pair of rising and falling edges), and only when the 50 milliseconds duration elapses would the postsynaptic nodes that were activated within said duration in turn begin to influence the next set of neurons in a layer ahead of them, and so on and so forth.

The feedforward clock rates would govern the activation of each selective neuron within the 50 millisecond duration, for example, if we assume there are 50 selective neurons in the second layer per selective kernel, each activated 1 millisecond apart, this would mean that 50 spikes, 1 spike per neuron, has to occur within a 50 milliseconds duration, and hence the feedforward clock rate would amount to 1000 HZ. The reason the feedforward clock rate would vary across layers, is due to the fact that the population of selective neurons increases the deeper we go in the layer structure, and since based on the processes specified in the earlier sub-sections, a set of input activations is required to relay signals throughout each and every selective neuron which belong to the corresponding receptive kernel region under the obligation that they are activated apart from each other to preserve the learning processes set forth, this would entail that a larger amount of selective neurons is required to be activated serially within the same limited 50 milliseconds duration time, and therefore a higher feedforward clock rate is required to accommodate such.

Recall that we defined simultaneity to be any set of occurrences which share a 50 milliseconds duration slot, this means any pair of events that occur more than 50 milliseconds apart are treated as non-simultaneously occurring events, whilst events that occur within the same 50 milliseconds duration slot are treated as simultaneously occurring events, and therefore since we require that all selective neurons are traversed upon within the same 50 milliseconds duration slot across all layers, it is guaranteed that all activations of selective neurons would be treated as simultaneously occurring. To further clarify, this means the activation of a presynaptic selective node which share a short latency connection with a postsynaptic selective node would always be within the 50 milliseconds duration constraint.

For example, if we assume 50 selective neurons per kernel bound selective region, then for first layer to second layer connections, the connection latency would begin with, 1 milliseconds for the first selective neuron, 2 milliseconds for the next and so on until 50 milliseconds for the last selective neuron within each corresponding selective kernel bound region, whilst for the second layer assuming the population grows to 500 selective neurons per kernel bound selective region, then the latencies would be 0.1 milliseconds for the first connection, 0.2 milliseconds for the next connection and so on until 50.0 milliseconds for the 500s connection, and so on and so forth propagating forward across layers.

To add varied in latency connections, we simply connect every presynaptic node to each postsynaptic selective node through a bus of connections as was clarified earlier, where the latency would determine at which perceptual cycle would a signal be sent, for example, short connections would exercise their influence within the current perceptual clock cycle level which would span from 1 milliseconds to 50 milliseconds for first to second layer connections, whilst medium connections would exercise their influence within the next perceptual clock cycle level which would span from 51 milliseconds to 100 milliseconds for first to second layer connections, and long connections would exercise their influence within the third perceptual clock cycle level, which would span from 101 milliseconds to 150 milliseconds for first to second layer connections. As would be clarified later, part of the population growth per layer in selective neurons per kernel bound selective region, is to address temporally selective neurons, as spatially selective neurons represent merely a segmentation of temporally selective neurons, this is clarified in the subsequent sub-section.

Recall that the selective neurons spike at a rate which is directly proportional to the strength of the connections which transmit the depolarization signals, and to further clarify, the spiking rate should range from a minimum value which equivalent to the feedforward clock rate divided by the amount of selective neurons per kernel, to a maximum clock rate equivalent to the feedforward clock rate, such that said clock rate values fit a linear distribution that in proportion to a linear distribution which represents the strength of excitatory connections measured from the minimum value to the strength value of the point at which its inhibitory pair would transition from an exponential growth to a linear growth (i.e., the point at which the selective neuron develops highest selectivity). For example, layer 2 neurons, shall have a spiking rate that ranges from 20 HZ to 1000 HZ, where the spiking rate of a given selective neuron grows linearly in proportion to the linear growth of the strength of normal excitatory connections, measured from the weakest minimum value set at the initial conditions to the strength value which corresponds to the selective neuron's transition point, where it develops its highest selectivity value.

This ensures that the more selective a neuron becomes, the higher its spiking rate would be as clarified in the earlier subsections, whilst at the same time constraining the spiking rate to the feedforward clock rate, in a sense, the spiking rate would act as a scarce resource shared by all the selective neurons which are member of one kernel bound receptive region, since only one selective neuron can be activated at a time, and therefore the stronger the connections of a selective neuron are to the neural map which represents the stimulus in the receptive region, the more resources sort of speak said neuron would consume relative to the other members hence creating the natural selection effect specified earlier, until at some point only one neuron would continue to spike at the maximum feedforward clock rate, hindering non other than it selective to the corresponding stimulus. Notice that since the feedforward clock rate and the amount of neurons change across layers, the range would change, for example, if we assume that layer 3 has a population of 500 selective neurons per kernel bound receptive region, then the feedforward clock rate would be 10,000 HZ, and therefore the range would be 10,000/500=20 HZ to 10,000 HZ, as is noticeable, the lower bound of the range would always be the same, whilst the upper bound would vary across layers, since more neurons are processed within the same 50 millisecond period limit.

In the analog transmission mode of implementation, clocks and clock rates are not necessary, the implementation is similar to its digital counterpart, with the exception that each connection would have a predefined rate of spiking as specified in its equivalent in the digital implementation, the process however is made even simpler, due to the fact that we are already adopting a spike activation model analogous to traditional spiking neural networks, and since signal flow through connections is based on predefined latencies in our architecture, and analog transmission would merely be an adoption of the latency variations specified previously on the digital transmission implementation, where multiple coinciding spikes, transmitted from different input neurons via different connections would act as constructive/destructive waves which would either depolarize or hyperpolarize the corresponding output selective neurons.

The procedures by which temporal selective neurons learn a particular temporally distributed stimulus is almost identical to how spatial selective neurons learn a spatially distributed stimulus, the only difference lies in the simultaneous integration process, where spatially distributed information send a collective set of electrical/messaging signals which get collectively processed simultaneously only when said signals where sent via equidistant connections, whilst temporally distributed information send a collective set of electrical/messaging signals which get collectively processed simultaneously only when said signals where sent via non-equidistant connections. However the same hierarchical structure and learning processes as mentioned in the earlier sub-sections would be executed, the only additions would be an increase in the population of the selective neuron per kernel bound region to account for both temporal selective neurons and spatial selective neurons, as well as introducing a connection bus consisting of three latency variant connections rather than one singular connection for every presynaptic-postsynaptic pair. Notice that a connection here refers to both the electrical part and the messaging part of the connection, where both parts share the same latency.

To be accurate, in the visual implementation, a selective neuron can either be a spatial selective neuron representing a given spatial distribution of neural activations across the visual sensory devices (sensor/retina) within a given singular moment of time, or a spatiotemporal selective neuron representing a given spatial distribution of neural activations across the visual sensory devices (sensor/retina) spanning across a temporal distribution across a given duration in time. The former is merely a subset of the latter, and hence in the visual implementation, to account for this, we are required to have a large population of selective neurons per kernel bound selective region to account for variations in the whole (spatiotemporal) as well as variations in parts of that whole (spatial), all as is clarified on the subsequent sub-section.

### Section 2-E (Temporal Segmentation and Tolerance)

As was the case in spatial segmentation, a neural architecture which permits temporal segmentation can unlock a larger pool of possibilities when it comes to the set of stimuli the architecture can learn. For example, while spatial segmentation allows the network to learn spatial information that are disjointed/discontinuous across space like stimuli which are characterized by a spatial frequency of distribution, e.g., only black or only white tiles on a chess board, temporal segmentation allows the network to learn temporal information that are disjointed/discontinuous across time like stimuli which are characterized by a temporal frequency of distribution, e.g., a reoccurring sound beat in a music piece.

Recall that a temporal selective neuron represents information which are distributed across a given duration in time, and therefore for the following explanations, it helps to imagine a duration in time spatially, as in a spatial distribution along one spatial dimension, an axis of sort, or a timeline, where every pixel across said timeline represents a 50 millisecond duration. As was the case in spatial segmentation, two processes are required to achieve temporal segmentation, transpassing as well as the establishment of dynamic temporal kernel boundaries. We use spatial segmentation as a basis to draw analogies while discussing the processes of temporal segmentation.

As was clarified on spatial segmentation, transpassing refers to the ability of an earlier neuron which has a lower receptive field to contribute its well bound information with another well bound information represented by another deeper neuron with a larger receptive field, where the earlier neuron could integrate its information by transpassing it across layers and onto the layer that it requires. This feature is as important for temporal segmentation as it is important for spatial segmentation, since it alleviates any restriction imposed by the hierarchical nature of the network's layer structure. Notice that for both temporal and spatial transpassing, the amount of connection bands that transpass and transmit information onto a deep neuron that is a member of a given deep layer, shall reflect the total and maximum amount of receptive field neurons the member is able to represent based on its position in the layer hierarchy. For example, a layer 3 neuron can only allow the transpassing of input layer 1 neurons which relate to its total receptive field area relative to layer 1, in this case that would be a 9*9 grid patch of 81 cells for spatial segmentation assuming 3*3 spatial kernels and a 9*1 grid patch of 9 cells for temporal segmentation assuming 3*1 temporal kernels, in other words the bandwidth of feedforward connections sort of speak increases the deeper the given set of input neurons transpass information across the layer structure.

It is essential to clarify that transpassing connection bands which project deeper onto the layer structure shall be incorporated with a transmission time delay that is adjusted to ensure a unification of signal transmission with their counterparts connection bands which project from presynaptic nodes that lie in the layer that is directly behind the selective neuron such that both the earlier presynaptic node which project the transpassing connections and the latter presynaptic node which lie in the layer behind the selective node, project information to the selective neuron simultaneously for each corresponding band per bus.

However, as was the case in spatial segmentation, transpassing information alone is not going to be sufficient to allow for temporal segmentation, and therefore a need for a process that establishes dynamic temporal kernel boundaries is required. Similar to dynamic spatial kernel boundaries, dynamic temporal kernel boundaries rely on the network's ability to isolate independent parts of a temporal stimulus which are found to be frequently encountered, where these parts represent a set of cells that are found to be collectively encountered independent from the rest of the cells that belong to the same receptive field area, and which do not fit any predefined temporal distribution represented by some static kernel boundary and can rather take multitudes of variant temporal shape forms. Temporal shape, refers to a temporal distribution. This is achieved through targeted modulations based on the depolarization signals said independent temporal structures send through their latency varied connections.

For example, say we want to learn a temporal stimulus representing a short music piece which is composed of 3 successive beats, where in between these beats there could exist any form of noise, let's say the beats last 1 second in duration and the difference in time between two successive beats is also around 1 second in duration, therefore we have a temporal stimulus which lasts 5 seconds, beginning with a 1 second duration beat, followed by a 1 second duration of varying noise, followed by the same 1 second beat, then a 1 second duration composed of the same prior noise, and ending with that same beat once again. In other words, the network encountered the beat 3 times, at a frequency of 0.5 HZ and with some noise in between for a total duration of 5 seconds. The goal is to segment the beats out and communicate the information they carry to the selective neuron while ignoring the in between noises as if they did not exist. For the sake of example, we assume that the network encounters the temporal stimulus 5 times, where at each scenario the noise which lies in between two successive beats was variant.

This is analogous to the cross shape example we used in spatial segmentation, the noise represented the background which if you recall was signified as a color variant background in the cross shape example. For the sake of simplification, let's say the noise in the previous music piece example represents a frequency variant musical note, where at each scenario, a different musical note appears within the intermediary gab between two successive beats, such that at the first encounter a 55 HZ frequency sound representing an A1 note is observed within the duration between the two successive beats, then at the second encounter a 110 HZ frequency sound representing an A2 note is observed between the beats and so on and so forth, where we observe a 220 HZ A3 note, a 440 HZ A4 note, and an 880 HZ A5 note, on the third, fourth and fifth encounters, respectively.

Let's assume that we have one input temporal selective neuron which learned to represent the 1 second beat which would be represented by a combination of acoustic frequencies spanning a 1 second duration, and let's also assume that the selective neuron projects 5 bands of latency varied connections to one selective output neuron, let's label the connections, shortest, short, medium, long and longest, 1 through 5, respectively, where the latency of the bands are 1 second apart from each other, in other words, 1, 2, 3, 4, and 5 seconds, respectively. To effectively learn the beat while ignoring the in between noise, one might propose to sever connections 2 and 4, and only leave connections 1, 3, and 5, where the presumable beats lie, hence when the full temporal stimulus is captured at t=5, connection number 1 (shortest) would transmit the 1st beat, and connection number 3 (medium) would transmit the 2^{nd} beat, whilst connection number 5 (longest) would transmit the 3rd beat, and therefore at t=5, these signals would simultaneously reach the selective neuron, establishing a recognition of that particular stimulus with that particular temporal frequency.

This is analogous to when we severed the connections which communicated the background color noise signals from the corners of the cross shape stimulus in the spatial segmentation example, pay attention that when we say connections we refer to the normal excitatory and reverse inhibitory feedforward connection pair. If you recall, the method by which such connections were severed was using targeted modulations, and therefore the process of achieving temporal segmentation is similar to the process by which spatial segmentation was achieved, the difference however, is that in the case of a temporal segmentation the connections which would be severed through targeted modulations would be latency variant connections as opposed to equidistant connections.

Notice that in the temporal case, one selective input neuron can project many feedforward connection pairs as opposed to only one, and therefore to achieve targeted modulations, relying only on which overall cell sends a depolarization signal and which does not, is not going to be sufficient since one single neuron belonging to a single receptive cell, can sufficiently constitute the entire information of a temporally distributed stimulus as is the case in the three beats example. To further clarify, the previous example represents a stimulus which can be described using two selective input neurons, one which represents the beats, and another which represents the noise, where the former is unchanging across all five scenarios, whilst the latter is variant across all five scenarios, and where each musical note would be represented by a different selective neuron.

Like color variance in the cross shape example, frequency variance in the music piece example would be less frequently encountered relative to the main stimulus, which in the spatial example was the cross representing cells, whilst in the temporal example is the beat representing cell. Through targeted modulations the spiking rate would be higher for the selective neuron which represents the unchanging beat, relative to each and every selective neuron which represents each and every noise variation, and therefore a depolarization signal would be sent to the output selective neuron which then can trigger a targeted modulation, only targeting the cell which contains the neurons which represent the beat as they are the ones that would send the depolarization signals, to visualize this one must think strictly from the perspective of a temporal kernel and not conflicting it with a spatiotemporal representation in their mind, and since the reader might find it difficult to strictly visualize temporal information in their purest form without spatiotemporal suppositions, we give a brief and simplistic description of the acoustic implementation to use as a basis for the current explanations, as we did in the earlier sub-sections regarding spatial processing, where we gave a brief description of the visual implementation.

The starting point in the processes that are involved in distinguishing pitch for both the mammalian brain architecture, specifically the auditory cortex and the implementation of such using NNNs, is the acoustic receptors of the mammalian ears (hair cells) which are analogous to photoreceptor cells in the visual system, recall that a photoreceptor cell is analogous to a pixel, where the activation of a single photopic photoreceptor cell (i.e., a cone cell), can signify information relating to the visual surround, which include at what frequency a given light ray is travelling, representing color, and at what intensity that given light ray was observed, representing brightness. Similarly, the activation of a set of hair cells can signify information relating to the acoustic surround, which include at what frequency a given sound wave is travelling, representing pitch, and at what intensity that given sound wave was observed, representing volume.

For the sake of simplifying the examples, we ignore intensity and only focus on the pitch of a sound, i.e., its frequency spectrum. The mammalian acoustic system, is comprised of three main structures, the sensory device (the cars), the MGN thalamic nuclei and the Temporal lobe, specifically the auditory cortex part of the temporal lobe, we are only concerned with two of these in this patent application, which are the sensory device and the Temporal lobe. The sensory devices refer to the cars in the mammalian brain, and which contain the cochlea, the cochlea in the ears is analogous to the retina in the eyes, where both structures carry the receptor cells which respond to their respective stimulus type, photoreceptor cells for light, and hair cells for sound. Each cochlea contains a large amount of length varied hair cells which respond to a variety of sound frequencies, kind of like, each retina containing a large amount of type varied cone cells, recall that in the human retina there exists 3 types of cone cells each responding to three types of visible light wavelengths/frequencies, long, medium and short, Red, Green, and Blue, respectively. Similarly in the human cochlea there exists a set of hair cells each responding to a set of sound wave frequencies, ranging from 20 HZ to 20,000 HZ.

To simplify our explanations even further, since we are only concerned currently with the temporal aspects of a sound stimulus, we assume that every hair cell in some emulated version of the human cochlea maps to one single frequency sound, in other words, we assume that we have an emulated cochlea which contains 19,980 hair cells, where each cell activates only in response to one designated frequency sound, ranging from 20 HZ, for cell number 1, then 21 HZ for cell number 2 and so on, up until 20,000 HZ, for cell number 19,980. As was illustrated by the work of Joseph Fourier any complex sound wave in the time domain can be decomposed into a set of simpler sinusoidal wave frequencies in the frequency domain, for example, determining what component frequencies are present in a musical note could be achieved by computing the Fourier Transform of a temporal sample for the note, one can then resynthesize that same musical note by generating those same frequency sound components through an inverse Fourier Transform, creating a Fourier series which would collectively sound identical to the original sample.

The human cochlea acts as a Fourier Transform computing machine, which takes in as inputs a sampled sound wave in the time domain, and then represents it in the frequency domain via hair receptor cells, which themselves can later encode such information through distinct electrical signals projecting to the primary layer of the auditory cortex M1. In this example we are going to assume many simple parameters because our goal is not to explain the acoustic system in details. These parameters include, first and foremost, that every hair cell represents and therefore responds to one and only one frequency component, second, that the sample rate is 20 HZ and hence the sample duration is 50 milliseconds. In other words, the acoustic duration at which the emulated cochlea would sample a complex sound wave and then map it to a set of hair receptor cells, is 50 milliseconds. This is because 20 HZ which is the pre allocated and presumable minimum frequency detectable by our hypothetical device, requires a duration equivalent to 1/20^{th} of a second which amounts to 50 milliseconds to detect, whilst the presumable maximum frequency detectable by the device which is 20,000 HZ only requires 1/20,000 seconds which amounts to 50 microseconds, a mere fraction of the sample duration.

A third assumption is that each hair cell would map to one input layer selective neuron, which only activates in response to that given hair cell, and finally our forth assumption is that the input layer is composed of 19,980 selective neurons, each representing one and only one hair cell. Similar to the visual system the layer structure of the acoustic system would include an ever growing amount of selective neurons per layer, albeit different in the fact that a layer would be composed of a single selective kernel region, as opposed to being dissected into multiple smaller kernels, and a forward propagating layer structure would be necessary to account for share-ability. Each input selective neuron would be connected through a bus of latency varied connection set, 3 bands per bus, 50, 100, and 150 milliseconds for the first connection layer, then 150, 300 and 450 milliseconds for the second connection layer, and so on and so forth as was discussed previously regarding temporal connectivity on our visual examples.

Every selective neuron from the second layer would represent a combination of frequencies spanning across a 150 milliseconds duration in time and hence would represent a temporal distribution of a set of sound frequencies, the information that relate to the frequencies would be supplied by the corresponding input selective neurons, whilst the information that relate to the temporal distribution of said frequencies would be supplied by the latency varied connections. As was the case in the visual implementation, each and every input neuron is connected to each and every selective neuron from the corresponding selective kernel region, and since there is only one selective kernel region, this would mean that each and every input neuron would be connected to each and every selective neuron from the layer ahead, and this would be the case for all subsequent layers propagating forward, kind of like the layer structure of a traditional artificial neural network. These second layer selective neurons, can learn a variety of temporally distributed combinations of the input neurons (which represent different frequency components), where such temporal distribution spans 150 milliseconds, and then these can become inputs to a more complex and temporally wider distribution of information to a wider variety of selective neurons from the third layer, and so on and so forth, in a forward propagation of information from simple to complex, or in other words, from lower levels of distributed representations to higher levels of distributed representations.

Since there is only one selective cell per layer in a purely temporal implementation of this architecture, one can now clearly see why the spatial form of targeted modulations cannot be of any use in the establishment of dynamic temporal kernel boundaries, and therefore a different process of targeted modulation that exclusively deals with temporally distributed stimuli is required. Targeted modulation for temporally distributed stimuli hinges on the network's ability to sever latency varied connections, since these connections constitute the entirety of what a purely temporal kernel is. If we observe the acoustic implementation laid out previously, we can see that the same narrowly defined constituents of a sound information, which are the 19980 input neurons, is used to represent a wide variety of information that can be distributed temporally in a variety of different ways, the same way in a visual space, the same narrowly defined constituents of a visual information, which are the three cone cell types, R, G, B, is used to represent a wide variety of information that can be distributed spatially in a variety of different ways.

Therefore, what bounds the spatial distribution which is a spatial kernel, is different than what bounds the temporal distribution which is a temporal kernel, as the former relies on singular equidistant connections supplied across multi-inputs, where singular equidistant connections refer to a single temporal distribution of transmitted information and multi-inputs refer to a wide spatial distribution of a patch of photoreceptor cells, whilst the latter relies on multi latency variant connections supplied across a single-input, where multi latency variant connections refer to a wide temporal distribution of transmitted information and single-input refers to a single spatial distribution of a patch of hair receptor cells. What dictates the kernel boundaries is the wide distribution feature of a kernel and not the singular information relay feature of a kernel, this would be multi-inputs for spatial kernels and multi latency variant connections for temporal kernels.

This previous passage, was written to showcase the object of focus when it comes to temporal distribution of information, which is not the inputs as was the case for a spatial distribution of information, but rather the multi latency variant connections which bound the temporal distribution of such information. This is why targeted modulation in temporal segmentation is concerned with severing connections which share the same bus, since it is the bus that carries the distribution of temporal information not the inputs.

Getting back to our earlier example, the musical piece example which contained three beats separated by noise, we can easily determine where the modulations should occur to render such information as well bounded information. Here, the disjointed/discontinuous beat sounds can be well bounded by severing connections short (i.e., the 2^{nd} connection) and long (i.e., the 4^{th} connection) as clarified earlier, while retaining the 1st, 3rd and 5^{th} connections as they would carry the beats information. This makes temporal targeted modulations very straightforward, where those connection pathways that sent the depolarization signals and caused the output selective neuron to get activated, would have their connection pair modulated, therefore similar to the cells in spatial targeted modulations, each variant connection per bus, has to have an extra layer of receiver gates which can only be turned on when a depolarization signal trigger them.

Notice that we said the connection pair, recall that in spatial segmentations, the cells which belonged to a given kernel boundary contained many selective neurons, where each and every selective neuron that belongs to such cell could be a representative of the cell, and when one representative was activated it got its normal excitatory connection positively modulated whilst the rest of the group that belonged to the same cell, had their reverse inhibitory connection positively modulated, all which projected towards the same selective output neuron. To further clarify, in the cross shape example, in the cells which bounded the cross shape, since each cell was formed by a group of 2 nodes, the black nodes formed the normal excitatory connections whilst the white nodes formed the reverse inhibitory connections, since the experience elicited the activation of the black nodes in the black cross shape example, and not the white nodes at the time the stimulus was being learned, and both connections were positively modulated based on the learning algorithm, what did not experience any positive modulations were the connection pairs projecting from all the cells which were not bound by the dynamic kernel, the corner cells.

Similarly, in temporal targeted modulations a pair of normal excitatory and reverse inhibitory connections are positively modulated, where all the connections that share the same latency to the connection projecting from all selective input nodes and to a single output selective node, act as the reverse inhibitory pair which gets positively modulated alongside with the normal excitatory connection which projects from the selective input node, remember, it is the latency variant connections which are the object of focus for temporally distributed information, as opposed to the multi-input cells for spatially distributed information, and therefore what constitutes as a connection pair in a temporally distributed stimulus is any connection which shares the same latency value regardless of where it projects from, which is in contrast to what constituted as a connection pair in a spatially distributed stimulus, which was any connection which shared the same multi-input kernel region (a cell) regardless of connection latency variations. (While such latency variations do not exist for static visual stimuli they do exist for dynamic visual stimuli.).

In other words, in temporal segmentation, all the connections which convey information that share the same temporal slice, i.e., moment in time (moment here refers to a 50 milliseconds duration, the minimum perceivable duration), are treated as one group, which is analogous to its equivalent in spatial segmentation, where all the connections which conveyed information that shared the same spatial slice, i.e., a kernel bound region, were treated as one group. In other words, whereas a cell in spatial segmentation represented a group of selective neurons which shared the same spatial region which they equally represent from the input layer, a cell in temporal segmentation represents a group of selective neurons which share the same temporal slice which they equally represent from the input layer.

As was the case for spatial segmentation, wherein all the members of the same cell group had one of them as a representative of the group which would get its normal excitatory connection positively modulated whilst the rest of the members of that group had their reverse inhibitory connections positively modulated, in temporal segmentation, all the members of the same cell group would have only one of them acting as a representative of the group and which would get its normal excitatory connection positively modulated, whilst the rest of the members which in this case constitute those neurons that project connections that share the same latency value, would get their corresponding reverse inhibitory connections positively modulated.

This ensures that selectivity wraps around the stimulus for temporally distributed stimuli as it did with spatially distributed stimuli, where qualitative changes are registered, as they can cause a hyperpolarization effect which signifies a change in the stimulus being perceived relative to a prior encountered and learned conception.

Spatiotemporal segmentation is the resultant of the execution of both spatial segmentation processes and temporal segmentation processes simultaneously, which allows for the segmentation of spatiotemporal stimuli like dynamic visuals, and the end result of such could be described as a 4 dimensional neural representation of information across space and time. Visualizing such 4 dimensional neural representation is not required to understand the rest of this architecture, however if one needs to wrap their mind around such visualization, one can imagine a video feed, where each frame conveys information across 2D space within the 2D frame bound inner field (let's assume each frame information is printed across the face of a card), whilst a linear succession of the frames laid sideways (like a deck of cards), represents the successive progression of time in a one dimensional spatial representation of a timeline. A 4 dimensional neural representation refers to the volume of such 3D object (the deck of cards), which contains both spatial information alongside its X-Y axes (the face of a single card) and temporal information alongside its Z axis (the height of the deck). Performing a spatiotemporal segmentation is analogous to the process of cutting through the object's volume and extracting some different 3D or 2D shape out of the original object, kind of like sculpting.

Because any spatiotemporal representation of information, say a dynamic visual feed, contains both spatial and temporal information, one can infer that a static visual information is merely a sliced temporal segmentation of a dynamic visual feed, where the slice was too narrow to include just a single 50 millisecond duration feed (a single frame) which is analogous to a cutting out from our hypothetical 3D object, the thinnest possible 2D slice. Recall that the network perceives information in real time while navigating its surroundings, and therefore to the network a 4 dimensional representation of visuals is the norm, whilst a 3D representation of visuals where the stimulus is static, represents an exception to the norm which is facilitated by the process of temporal segmentation, since if you recall, a temporal segmentation occurs when a stimulus is found to be independently encountered relative to its background, for example, if the network were to be navigating its surround, it would definitely be moving, and therefore all what it would be perceiving at such state through its visual system would be dynamic visuals, however while the network is navigating the surround, a statically positioned object, might reoccur on its visual feed, i.e., be re-encountered at a different setting (background), and due to such encountering the object would gain its independence as a result of it being encountered in a different background, as encountering it in a different setting/background leads to the identification of what constitutes as part of the object and what constitutes as not, creating a segregation boundary that identifies the object.

Adding temporal tolerance allows the network to be malleable when perceiving temporally distributed information, and therefore like the previously introduced spatial tolerance, we introduce a temporal tolerance, which is identical to its counterpart. In other words every temporal kernel would have a preferable 10% error margin, this means for, hierarchical layers, which got a temporal kernel with dimensions 3*1=3 cell sized kernel, 10%×3=0.3, which would be rounded to zero cell tolerance. However, for transpassed kernels which would be larger, say a kernel size of 9*1, for a set of 1st to 3rd layer transpassed connections, which would result into a 1 cell change tolerance, or a kernel size of 27*1 for a set of 1st to 4^{th} layer transpassed connections, which would result into a 3 cell change tolerance, and so on and so forth.

### Section 3 (The Lateral Connectivity Structure)

Neurons in the mammalian brain are not only found to exhibit a feedforward connectivity structure but are rather found to form connections that are structured laterally as well, as neurons in the mammalian brain can and do form synaptic connections laterally within any given layer.

As was mentioned earlier, the mammalian brain directly deals with qualitative features and compares them qualitatively not quantitatively, by using lateral connections as a means to associate qualitative elements of sensory inputs represented by selective neurons through distributed qualitative neural representations.

This is one of the tenets of cognitive neuroscience, which is the brain's ability to form mental representations using neurons and their associations with one another, and it is this same feature which we implement throughout this architecture, and which we dedicate this section for its discussion. In this section we replicate lateral connectivity amongst nodes to achieve a set of features which relate to memory and the retention of information, e.g., the process of recollection.

In this architecture, an experience is represented by a collective web of associations formed between selective neurons, and lateral connections is what we refer to the set of connections which play the role of forming those webs. Recall that the mammalian neural network architecture, employs an association based on repetition learning model, where information in a mammalian neural network architecture is represented through the formation of associations which occur between a set of distributed binary selective neurons, and is retained through the modulation of said associations based on the frequency of appearance of such information, this means that overall, information is stored, maintained and modulated through webs of connections under the influence of direct experience and based on the persistence of such information in the environment.

If you recall, we used an example of a visual scene which can only be represented by black pixels and white pixels, where each input cell contained only two nodes, “on” and “off”, such that, for each and every cell, on nodes would only respond to white pixels and off nodes would only respond to black pixels, we also assumed that the connections between the input layer (layer zero) and the first layer were one to one, where every input node was connected to one node directly in front of it from the layer next to it (layer 1), as was shown in FIG. 4A. We also assumed that the nodes of the first layer were laterally connected (i.e., connected to neurons that belong to the same layer) and that a node in this layer was able to connect laterally to a patch of nine nodes surrounding it as was shown in FIG. 4B.

Then we assumed that a stimulus projected onto the input layer, represented two parallel black lines in a particular orientation within a white background as was shown in FIG. 4C, and we said that as a result of projecting said stimulus, for every cell in layer 1, the on nodes would respond to the particular white background spots, whilst the off nodes would respond to the spots that represent the black lines, retaining the same spatial distribution represented by the stimulus.

By basing the formation of connections between those laterally placed neurons from the first layer, on the simultaneous activation of those neurons through implementing a lateral web of normal excitatory connections with a latency delay of zero milliseconds, we ended up with a web of lateral connections formed in the next layer which connects all the on-off selective nodes that were activated simultaneously as a result of projecting the stimulus, forming what neuroscientists call, a mental representation of the external stimulus, this happens through a web of lateral connections, where this web of interconnected neurons act as a qualitative representation of the external stimulus, as it recorded the stimulus through collective distributed representation manifested in the collective group of interconnected selective neurons which represent the input stimulus.

Since, the learning algorithm of this architecture bases connection strength on time dependent positive and negative correlations of activation, if two given neurons were found active simultaneously they form a stronger excitatory connection between them, whilst if the neurons were active asynchronously (where one is active and the other is not) they form a stronger inhibitory connection between them, and since the strength of these connections is updated constantly throughout the life span of the network where they follow the rules of plasticity which we mentioned earlier, the learning algorithm ensures that information is maintained as long as it is encountered regularly, while that which is not encountered regularly is forgotten, where a strongly interconnected web of connections represents a strongly maintained information and vice versa.

As was mentioned earlier, when two stimuli that are found to exist simultaneously, i.e., positively correlated, they develop strong normal excitatory connections with one another allowing them to later on, aid their causal activation of one another, if you recall, an example we used before was recollected experiences and cues, most recollected experiences are triggered by cues which cause what we is soon after referred to as a chain reaction effect, which leads to the full recollection of an experience, an example we used earlier, was hearing a sound segment of some previously encountered music and recollecting the experience of listening to it previously, where the cue is the sound segment, whilst the experience that this cue is associated to, is the entire memory of the experience of the previous encounter represented by a large web of associations.

To further clarify, the sound segment represented by some acoustic selective neurons had previously formed associations to the full experience which is represented by many other multi-sensory selective neurons at the first time of encountering, and then as soon as the segment was re-played at another encountering, the selective neurons which correspond to the segment got activated and through their previously formed normal excitatory associations to the other multi-sensory selective neurons, they depolarized all those neurons that had previously formed associations with the neurons which represented said segment, and through a chain reaction effect as is clarified later, the result was that the entire experience is recollected, as in the entire web of selective neurons that represents the full previous experience is activated.

Another example we mentioned earlier was the process of reading/listening to some pre learned text and recollecting/predicating an expected word before its appearance, as was mentioned earlier, if the reader were to read the following statement “O captain my______” they would probably be able to recollect and fill the blank with the word “Captain”, this is because the reader might have learned/read the full statement before and formed associations between the phrase we mentioned and the following predicted word, this again is due frequent simultaneous encountering where the phrase “O captain my” and the word “captain” formed associations upon experience via excitatory connections and due to their persistent correlative presence which allowed for associations to form due to such correlation in experience, and then in a later scenario when the first segment of the phrase was presented, the selective neurons which represent it causally depolarize the other neurons they formed connections with in the previous encounter which were not present on the current encounter, and through a chain reaction effect they cause the recollection of the set of selective neurons which represent the word captain.

In all of the previous cases an association occurs between two repetitively correlating parts of a stimulus/a set of stimuli, where such frequent correlations strengthen the connections between the two correlating stimulus parts/stimuli, and at another encounter when one of the two correlative parts of a stimulus/stimuli is activated, by virtue of the excitatory connections that are formed and depending on how strong these connections are to the other selective neuron/s, those other selective neurons can be made to be activated as well through causal activations via these same connections, if you recall we metaphorically said that these lateral connections play the role of completing the missing pieces of an experienced stimulus in what is usually called a memory recollection.

As was stated previously, the role of lateral connections is to allow for the network to form distributed neural representations of external information through a web of interconnected neurons, and when the connections which are formed across a particular web are weakened, the information is harder to recall and harder to use in more complex processes and vice versa, and therefore the web records the information and acts as the store of such information, as soon as the web breaks, where all the lateral connections that were previously formed between the selective neurons drop to a strength value of zero, the information is said to be lost, and when a new web of connections between those same neurons is created, new information is said to have been learned/stored, and since the learning algorithm which governs those connections is based on frequent correlations, the more encountered a pair of stimulation is, the stronger the connections become and therefore the longer they last before full deterioration, this would replicate the effect where a frequent encounter of a stimulus causes a stronger and hence long lasting memory of it.

We gave an example, where we assumed a 3*3 input grid where the selective neurons were given the ability to form lateral connections based on correlated activations, and we said that If at one encounter the top three pixels that are activated were white and the bottom 6 where black, then the selective layer would contain a neural representation comprised of three top “on” selective nodes and 6 bottom “off” selective nodes all forming lateral connections with one another creating an overall web, this web can only last as long as the lateral connections between these selective neurons can last, and if for the sake of example these connections follow a negative modulation function which lasts 3 hours per stimulation, this means after one encounter this newly created web which represents the stimulus can last for 3 hours before it is lost. If another encounter of that same stimulus occurs then based on the linear growth function, the connection strength would be strengthened and this time the information would be able to last 6 hours as opposed to only 3, and we say the information's memory got stronger. On the other hand, if this particular stimulus was not re-encountered again, after 3 hours all the formed links would break off and we say the information was lost/forgotten.

To wrap things up on this introduction, whereas the job of a feedforward connection was to propagate information across layers for the purpose of representations through selective neurons, as each selective neuron represents information that were propagated to it through such feedforward connections projecting from earlier layers, the job of lateral connections is to allow for the formation of associations among all the selective neurons which represent said information, in other words, lateral connections are responsible for the process of creating those interconnected web representations in the form of associations made between selective neurons, where such associations are facilitated by these lateral connections, another point of analogy is that, selective neurons are responsible for the process of classifying the information through the feedforward connectivity structure, whilst the lateral connectivity structure is where the distributed memory representation of such information is held.

### Section 3-A (Forming Laterally Connected Web Structures)

Here, we introduce the lateral connectivity structure we implement which alongside with the learning algorithm and the processes of selectivity introduced previously, allow for the establishment of web structures for both spatial and temporal stimuli via two types of web structures, spatial and temporal.

Neural webs refer to a set of selective neurons forming a lateral network structure, where every/some selective neurons which belong to a single receptive cell kernel region are laterally connected to every/some of the other selective neurons which belong to other receptive cell kernel regions which lie in the same layer, hence the word “lateral”. Notice the difference here between each single selective neuron from a given cell kernel region connecting to all the selective neurons which belong to the same cell region, and connecting to all/some of the selective neurons which belong to other cell regions, the former was established to maintain selectivity through normal inhibitory connections, whilst the latter is what our object of focus is on right here and for this section. The web holds pieces of a stimulus that are distributed across either the spatial domain or the temporal domain or both, where each selective neuron represents a piece of the stimulus and the entire web of selective neurons represent the entire stimulus.

Lateral connections can only come in two forms, excitatory connections and normal inhibitory connections, and as was the case for feedforward connections, lateral connections can vary in their transmission time journey, which allows for time delay through late weighed sum integrations, and whether the selective neurons which represent a particular set of distributed parts of some external stimulus, are laterally connected with one another through equidistant lateral connections or non-equidistant lateral connections, dictates which type of stimuli said neural web records and learns. A web that is consisted of lateral connections that share equidistant connections with one another (as in with equivalent latency values) is addressed herein as a spatial web. Whilst a web that is consisted of lateral connections that share non-equidistant connections with one another (as in with non-equivalent latency values) are addressed herein as a temporal web.

In other words, a spatial web refers to a web of selective neurons which share connections that have the same signal transmission latency, and an example of such web, would be any web that represents a static visual stimulus, where information is distributed across extension but not across temporality, whilst a temporal web, refers to a web of selective neurons which share connections that vary in signal transmission latency, allowing them to capture and record temporally distributed information, and an example of such web, would be any web that represents a dynamic stimulus, where information is distributed across temporality, like video feeds for visuals, and sound pieces for acoustics.

The process of learning both spatially and temporally distributed stimuli, by forming and strengthening spatial and temporal web networks which represent said stimuli, respectively, begins with a specific set of initial conditions, i.e., hyperparemeters, which are inspired by the mammalian brain's lateral connectivity structure.

It is established in cognitive neuroscience, that the mammalian brain at its early development phase begins with a neural network structure which is highly interconnected locally as well as globally, where over the period of the mammalian brain's development, these immense connections get pruned over time, and the mammalian brain transitions gradually from a structure where one neuron had a vast amount of connections directed to and from a vast amount of neurons, to a neural architecture, were neurons converge towards forming a specific limited amount of lesser connections to and from a specific limited amount of neurons, this gradual process which occurs over the early years of development, is referred to as brain maturation, where the brain gradually transitions from an immature state to a more mature state via synaptic pruning.

Synaptic pruning refers to the loss of connections that occur between a presynaptic and a postsynaptic neuron pair, where the postsynaptic neuron loses spines across the dendritic regions which used to communicate with the presynaptic neuron's axon terminals. To establish an understanding of how the mammalian brain forms lateral webs via lateral connections, it is essential to visualize how a neocortical column is structured in the mammalian brain, and how connections are structured within a neuron's vicinity.

Recall that, the modulations of excitatory connections in the mammalian brain behave in what is referred to as the spike-time synaptic modulation graph, which states that neurons that spike (get activated) at relatively a few milliseconds within each other develop synaptic potentiation or depression based on the sequence of the presynaptic and postsynaptic activations, where if the postsynaptic neuron activates within 20 milliseconds after the presynaptic neuron, a synaptic potentiation is established which causes a positive modulation to the strength of the excitatory connection, and when the postsynaptic neuron fires/activates within a similar period after the presynaptic neuron, a synaptic depression is established causing a negative modulation to the strength of such excitatory connection.

Initially at conception, a neocortical column is full of highly interconnected neurons, and when a given cortical column patch receives over time some spatially distributed stimulus consistently, where all the elements of said stimulus are distributed among a set of selective neurons which are connected laterally via excitatory connections, if the stimulus is a spatially distributed stimulus and possess no temporal distribution, the selective neurons which represent elements of the entire stimulus would always get activated in synchrony, and as a result the lateral excitatory connections between the neurons that make up the spatially distributed stimulus which happen to be equidistant would be strengthened creating a disparity in connection strength, where those equidistant connections that form that particular network of selective neurons, become stronger relative to all the connection formats in that same vicinity.

To observe how such would be the case, we can observe what happens in the example showcased in FIG. 17. In this figure, there are 5 nodes labeled 1 to 5, each forming a bus of three connections with all the other nodes, where the connections per bus, are labeled s, m and L, for short, medium and long, respectively, such that s labeled connections represent connections which are incorporated with a low latency value, m labeled connections represent connections which are incorporated with a relatively medium latency value, and L labeled connections represent connections which are incorporated with a relatively high latency value. In FIG. 17, 5 selective neurons are interconnected through equidistant excitatory lateral connections, where each neuron is connected to its other 4 neighboring neurons through a set of 3 connection bands per each input-output neuron pair, and where the connection bands are labeled short (50 milliseconds), medium 100 milliseconds) and long (150 milliseconds), s, m, and l in short, for three different transmission latencies per presynaptic and postsynaptic neuron pair. If say such neural patch encountered some spatially distributed stimulus which happens to be consisted of 5 elements that are represented by all 5 of the selective neurons, each of the 5 selective neurons would be activated together in synchrony, and each active neuron would send a signal through all of its three channels to all of its 4 neighboring active selective neurons. Since the 5 neurons are active simultaneously as the stimulus is spatially distributed, their signals reach one another through all of the three channels simultaneously per channel.

If we observe one channel say connections short, for all the signals that are sent through said channel which transmits signals at a low latency, the signals would reach their destinations simultaneously, and assuming that events which occur within 50 milliseconds are treated as simultaneous by the network, based on the learning algorithm explored earlier herein, all the connections which form this web of 5 selective neurons, would get strengthened, since the presynaptic and the postsynaptic nodes are activated simultaneously, which would cause a positive modulation to the corresponding excitatory connections, similarly, the other channels/(connection bands) also send signals simultaneously, and would be strengthened as well as long as the neurons are all active simultaneously. The end result would be a set of multichannel strengthened connections forming what we call a spatial web between all the five neurons which represent the spatially distributed stimulus. On the other hand, if that same neural web patch were to be exposed to a consistently encountered temporally distributed stimulus, a process of synaptic pruning to some of these connections would begin.

For example, using the 5 selective neurons mentioned in the previous example, if a temporally distributed stimulus that is consisted of all five elements which were represented by all 5 selective neurons previously was encountered such that said elements were distributed across time rather than space, and where the elements that are being represented are activated in sequence from 1 to 5 with a 50 milliseconds delay between each neuron's activation, The only way by which all five neurons, would collectively send and receive signals in synchrony, is if neuron 1 was connected to neurons 2, 3, and 4, via its short, medium and long connections, respectively, and neuron 2 was connected to neurons 3, 4, and 5 via its short, medium and long connections, respectively, and neurons 3 connect to neurons 4 and 5 via its short and medium connections, respectively, and neuron 4 connects to neuron 5 via it's short connection, whilst pruning all the rest of the connections.

If we analyze the previous connection topology, we would notice that it would be the natural end result of experiencing such temporally distributed stimulus, where the second neuron would be active amidst perception exactly when the messaging information sent by the first neuron would reach it via the short connections, hence positively modulating it, similarly for all the previously mentioned connections, whilst those that were not included in the previous description are not going to be abiding by the natural activation timings of the elements of the stimulus and therefore wouldn't be positively modulated, an example of these would be connection medium projecting from neuron 1 and to neuron 2, this condition takes 100 milliseconds to transmit the messaging signal, but the natural temporal distance between neuron 1 and 2, is 50 milliseconds, and therefore the signal would be sent but not received, and no modulation would commence.

For clarification, the following lists all the possible connections in the previous example, and in bold all the specific connections which would get positively modulated as a result of perceiving the temporally distributed stimulus mentioned.
Neuron 1, short, medium, long, Neuron 2
Neuron 1, short, medium, long, Neuron 3
Neuron 1, short, medium, long, Neuron 4
Neuron 1, short, medium, long, Neuron 5
Neuron 2, short, medium, long, Neuron 1
Neuron 2, short, medium, long, Neuron 3
Neuron 2, short, medium, long, Neuron 4
Neuron 2, short, medium, long, Neuron 5
Neuron 3, short, medium, long, Neuron 1
Neuron 3, short, medium, long, Neuron 2
Neuron 3, short, medium, long, Neuron 4
Neuron 3, short, medium, long, Neuron 5
Neuron 4, short, medium, long, Neuron 1
Neuron 4, short, medium, long, Neuron 2
Neuron 4, short, medium, long, Neuron 3
Neuron 4, short, medium, long, Neuron 5
Neuron 5, short, medium, long, Neuron 1
Neuron 5, short, medium, long, Neuron 2
Neuron 5, short, medium, long, Neuron 3
Neuron 5, short, medium, long, Neuron 4
   Notice only 9 connections were positively modulated, amidst 20 buses, 3 bands per bus, in other words amidst 60 connections in total.

Those connections which corresponded to the stimulus being perceived were positively modulated whilst the rest would not and hence a strong web network would emerge wrapping all 5 selective neurons representing what we would refer to as a temporal web. Notice this process is sort of crafting/sculpting a web based on the experienced stimulus. As long as this particular patch receives a particular stimulus for a certain period of time, eventually all the non-utilized set of connections would be pruned out due to the negative modulation function which governs all connections, and the only set of connections that would be left would be those that correspond to that temporal stimulus, and would look like the web showcased in FIG. 18, where the only remaining set of connections within the web vary in latency. Realize that all the possible combinations of temporally distributing all 5 selective neurons can be accounted for using the 60 connections listed previously, effectively allowing for a wide variety of learn-able temporal webs.

In FIG. 18, the remaining connections amongst each pair combination of nodes after pruning is as follows; nodes 5 and 4 only share a short connection, nodes 5 and 3 share a medium connection, nodes 5 and 2 share a long connection, and nodes 5 and 1 share no connections, nodes 4 and 3 share a short connection, nodes 4 and 2 share a medium connection, and nodes 4 and 1 share a long connection, nodes 3 and 2 share a short connection, and nodes 3 and 1 share a medium connection, nodes 2 and 1 share a short connection.

Another mode of implementation would be to incorporate Anti-connections, if one were to analyze the previous example, one can notice that the connections that formed such temporal web were always unidirectional, along the positive axis of time, and this makes sense due to factors, the first one is the fact that all the stimuli we would perceive across the temporal dimension would always follow the positive direction of the arrow of time, since the external world follows the second law of thermodynamics, and the second factor is the fact that the learning direction of excitatory connections are made to also follow the arrow of time, in other words, the postsynaptic node has to be activated after the presynaptic node in order for a positive modulation to commence, however if one recalls, there is a set of connections which learns in the opposite temporal direction of their causal influence, i.e., in the direction of negative time, anti-connections, which can allow connections in the web to form between selective neurons that activate in the reverse order.

This means in the previous example, not only neuron 1 would connect to neuron 2 via connection short, but neuron 2 can also connect to neuron 1 via Anti-connection short, recall that Anti-connections learn in negative latency sort of speak, effectively reversing the arrow of time. To further clarify, we list all the possible connections of the previous example including anti-connections, and as before using the bold notation, specify those that would respond in correspondence to the previous stimulus.
Neuron 1, short, medium, long, Neuron 2
Neuron 1, short, medium, long, Neuron 3
Neuron 1, short, medium, long, Neuron 4
Neuron 1, short, medium, long, Neuron 5
Neuron 1, Anti-short, Anti-medium, Anti-long, Neuron 2
Neuron 1, Anti-short, Anti-medium, Anti-long, Neuron 3
Neuron 1, Anti-short, Anti-medium, Anti-long, Neuron 4
Neuron 1, Anti-short, Anti-medium, Anti-long, Neuron 5
Neuron 2, short, medium, long, Neuron 1
Neuron 2, short, medium, long, Neuron 3
Neuron 2, short, medium, long, Neuron 4
Neuron 2, short, medium, long, Neuron 5
Neuron 2, Anti-short, Anti-medium, Anti-long, Neuron 1
Neuron 2, Anti-short, Anti-medium, Anti-long, Neuron 3
Neuron 2, Anti-short, Anti-medium, Anti-long, Neuron 4
Neuron 2, Anti-short, Anti-medium, Anti-long, Neuron 5
Neuron 3, short, medium, long, Neuron 1
Neuron 3, short, medium, long, Neuron 2
Neuron 3, short, medium, long, Neuron 4
Neuron 3, short, medium, long, Neuron 5
Neuron 3, Anti-short, Anti-medium, Anti-long, Neuron 1
Neuron 3, Anti-short, Anti-medium, Anti-long, Neuron 2
Neuron 3, Anti-short, Anti-medium, Anti-long, Neuron 4
Neuron 3, Anti-short, Anti-medium, Anti-long, Neuron 5
Neuron 4, short, medium, long, Neuron 1
Neuron 4, short, medium, long, Neuron 2
Neuron 4, short, medium, long, Neuron 3
Neuron 4, short, medium, long, Neuron 5
Neuron 4, Anti-short, Anti-medium, Anti-long, Neuron 1
Neuron 4, Anti-short, Anti-medium, Anti-long, Neuron 2
Neuron 4, Anti-short, Anti-medium, Anti-long, Neuron 3
Neuron 4, Anti-short, Anti-medium, Anti-long, Neuron 5
Neuron 5, short, medium, long, Neuron 1
Neuron 5, short, medium, long, Neuron 2
Neuron 5, short, medium, long, Neuron 3
Neuron 5, short, medium, long, Neuron 4
Neuron 5, Anti-short, Anti-medium, Anti-long, Neuron 1
Neuron 5, Anti-short, Anti-medium, Anti-long, Neuron 2
Neuron 5, Anti-short, Anti-medium, Anti-long, Neuron 3
Neuron 5, Anti-short, Anti-medium, Anti-long, Neuron 4
   18 connections amidst a total of 120 connections, would respond to the temporally distributed stimulus mentioned in the previous example.

Neural webs represent a snapshot in time capturing a particular set of neurons forming a particular set of lateral connections with one another, the reason we refer to it as a snapshot in time, is because the mammalian neural network architecture at its development phase, is highly dynamic, where if we were to observe any region in the cortical column structure of mammalian cortical networks at one particular time, we would see a neural network structure which would be different than the neural network structure we would observe a few days or months later in that same particular region in the cortex (depending on the types of stimuli experienced by the creature and their variance across said duration of time), this is due to the fact that the mammalian neural network architecture learn constantly over its life span in what cognitive neuroscientists refer to as neuroplasticity, which occurs as a result of the constant relay of experiences that are fed through the senses and relayed onto the network.

Recall that, the modulations of inhibitory connections in the mammalian brain behaves such that, if the postsynaptic neuron were to be found inactive within 20 milliseconds after the presynaptic neuron was found active, a synaptic potentiation is established which causes a positive modulation to the strength of the inhibitory connection. This means an inhibitory connection follows a time-dependent negative correlation of activity, and therefore neurons that activate asynchronously experience a positive modulation provided that their activation follows a positive temporal direction dictated by the latency value of the given connection.

This allows for the formation of negative webs, a negative web is formed when a set of selective neurons were found to be active at some point whilst a set of other surrounding selective neurons where found to be in-active, where the active neurons form strong inhibitory connections with the in-active neurons. These are formed via normal inhibitory connections, and allow the active neurons to have a suppressive influence over other selective neurons. Similar to positive webs, the formation of negative webs is a crafting process which occurs as a direct result of the persistent experience of a particular neural patch. The processes are identical, the only difference is the activity state which is conditioned for a positive modulation to commence, which is negative correlation.

An example of a negative web, would be if a neural patch were to be exposed to two mutually exclusive stimuli persistently, where only one of these stimuli can be perceived at a given moment, say for example the front of a 3 dimensional cube, and the back of said cube, one never perceives both the front and the back of a single 3 dimensional cube simultaneously, and rather perceives one or the other at any given moment. If we assume that two sets of selective neurons where to represent one of the two sides of a single cube, the activation of both sets of neurons would be mutually exclusive, where only one of the sets would be activated at a time, this would cause a strengthening to the normal inhibitory connections which they share, as they would satisfy the connections' activity condition.

### Section 3-B (Collective Excitation and Collective Inhibition)

Here, we showcase the collective behavior of nodes that form web structures amongst each other, and how the set of nodes collectively influence one another positively (excitation) and negatively (inhibition) to allow for features related to the retrieval of learned information such as the process of recollection.

Collective excitation refers to the process by which a collective set of neurons representing a web/a network, influence one another collectively via normal excitatory connections, whilst collective inhibition refers to the process by which a collective set of neurons representing a web/a network, influence one another collectively via normal inhibitory connections. We begin with the process of collective excitation as it is more intuitive than the latter, and then we move onto the process of collective inhibition.

Web structures allow for what we refer to as a chain reaction activation through collective excitation, a chain reaction activation through collective excitation, occurs when a bunch of neurons that are interconnected with one another through lateral connections, activate in response to each others' activation, which means if only a handful amount of these highly interconnected neurons in a given web were to be active, a chain reaction of activation would propagate throughout the rest of the other neurons which belong to that same web, and therefore as a result, these previously inactive neuron members would in turn also get activated.

The goal of collective excitation via chain reaction, is to allow some/every member of a particular web to participate in causing the activation of other members of said web through lateral excitatory connections, this would only be possible if the aggregate of all the signals transmitted by a handful of these already active selective neurons, are integrated simultaneously for each receiving member selective neuron of the web which is not active yet, such integration need to be simultaneous to ensure a weighted sum integration of signals which can cause a sufficient net depolarization signal which can cross a certain threshold of activation, such would only be the case for static visual stimuli, if and only if, the web of selective neurons that represent each element of a given stimulus, are laterally connected through equidistant lateral excitatory connections.

To illustrate with an example, let's consider a static visual stimulus in the form of a photograph of some vase. Each part of the spatially distributed vase figure would be represented by its own designated feedforward selective neuron, from layer 1, (the figure resides on the input layer numbered zero, and layer 1 is forward to it) such that each 3*3 patch from the input layer activate a certain selective neuron from the first layer, let's assume that the vase figure alone, i.e., neglecting the background, is represented by 15 selective neurons which are distributed spatially across layer 1 in correspondence to the spatial distribution of the vase figure that is projected onto the input layer. Let's also assume that these 15 selective neurons form a spatial web network through equidistant lateral excitatory connections.

If we assume that each member neuron of that web is connected laterally to each and every other member neuron of that same web, then each selective neuron that represents part of the vase stimulus would have a depolarization influence over every other selective neuron which represent other parts of this vase stimulus, and therefore if a handful amount of the selective neurons were to be activated, each can send a depolarization signal to those other selective neurons which are not active yet, increasing the likelihood of their activation. One can observe that in our previous example, the more of these selective neurons were to be found active, the greater the aggregate of the signals which are registered by the other inactive selective neuron members would be, and therefore the greater would the likelihood of their activation be.

Chain reaction, refers to the fact that such lateral connectivity structure causes a positive feedback loop of activation, since as soon as one selective neuron is caused to be activated, it in turn would increase the likelihood of other selective neurons to be activated, which if and once they are activated, they themselves in turn would further increase the likelihood of other selective neurons to be activated, and so on and so forth, like a chain reaction effect in some unstable nuclear fission reactor. Recall that we previously specified that simultancity in this network architecture, would refer to a 50 milliseconds duration of time, and therefore, as is clarified in a later sub-section, chain reaction effects in spatial webs, would realize over said 50 millisecond duration, and not literally simultaneously, otherwise there would be no point in referring to it as a “chain” reaction, and the reasons behind this would be clarified in details on said later sub-section.

For spatial webs, which represent spatially distributed stimuli, another mode of connectivity would be, to not allow each and every neuron the ability to connect to each and every neuron that belong to the same web, but rather allow them to only connect to a handful amount of other selective neuron members of the web, and specifically for spatially distributed information, a given selective neuron shall connect to a handful of selective neuron members that are most proximate to said selective neuron, in others words, an each to some, rather than an each to all connectivity structure, notice that the previous notation is from the perspective of an individual member neuron, on the other hand from the web's perspective we would call it, an every to some, rather than an every to every connectivity structure. This is inspired by the fact that a given neuron in a given cortical column is spatially limited when it comes to the dendrites arborizations as well as the axonal branches it can form with other neurons within its proximate vicinity.

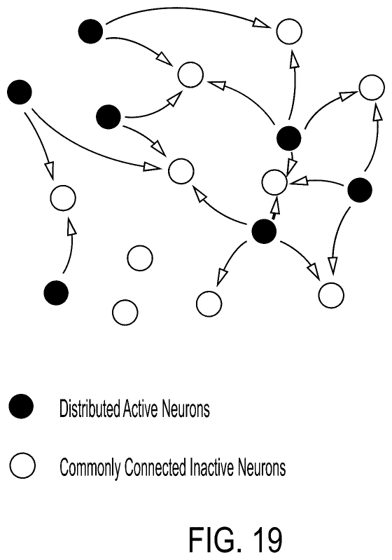

Such mode of connectivity, can ensure that spatially distributed activations are more likely to cause a chain reaction activation, while spatially non-distributive activations (i.e., activations that are highly concentrated within one particular region of the web), are less likely to cause a chain reaction, this is because since each neuron within a particular web is entangled with all the neurons that are around it which belong to that web, as shown in FIG. 19, when a set of distributed member neurons get activated and start depolarizing the other non-active neuron members of the web, because the activated neurons are distributed, there would exist many non-active neurons that are commonly connected with many active neurons, and therefore a depolarization of these neurons is more likely since they would receive much more depolarization signals from different active neurons, and when they themselves get activated they trigger the chain reaction effect mentioned previously, where more common non-active neurons are depolarized until the entire web is active. At this point a feedforward output neuron, which takes the member neurons which constitute the lateral web as its set of input neurons, receives from all these neurons enough signal which causes it to be activated.

As shown in FIG. 19, there is a set of sparsely distributed nodes represented by little circles, such that shaded circles represent currently activated nodes, whilst unshaded circles represent currently inactive nodes. Also shown on the figure are connection arrows which represent the set of nodes a given node has influence over and the direction of said influence is represented by the pointing arrow head. On the figure, the active nodes are distributed across the node group.

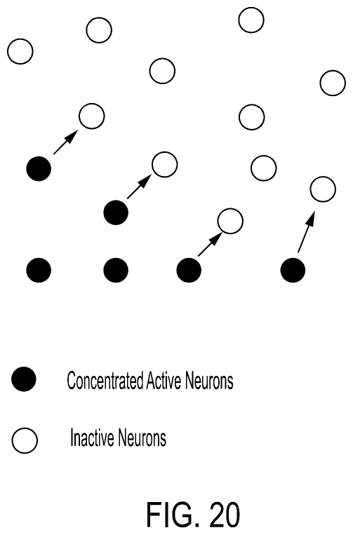

On the other hand, if the activations are not distributed and are rather concentrated within a small region of the web, less non active common neurons would receive an aggregate sum of signals as shown in FIG. 20. Therefore, rather than triggering a chain reaction, only a small region around the concentrated activation of neurons would be active, and the feedforward output neuron which receives input from all the member neurons of the web would not be active as it would not receive a sufficient amount of activation that could cross its threshold for activation. Notice the implication here, because we use proximity as a means to limit the lateral depolarization influence of member neurons that belong to a single web that represents some stimulus, the distribution of such activation becomes mandatory if we want the entire web to get collectively activated through a chain reaction propagation of activation, and if such web acted as a stimulus that is bound through a dynamic kernel boundary, a selective feedforward neuron can be activated or not activated depending on whether the entire web is active or not, more on the relationship between lateral connectivity and feedforward connectivity is clarified below.

In FIG. 20, there is a set of sparsely distributed nodes represented by little circles, such that shaded circles represent currently activated nodes, whilst unshaded circles represent currently inactive nodes. Also shown on the figure are connection arrows which represent the set of nodes a given node has influence over and the direction of said influence is represented by the pointing arrow head. On the figure, the active nodes are concentrated within the bottom left side of the node group.

The mammalian brain is capable of recognizing a certain shape, even if a great amount of distributed blocking of said shape occurs in a given visual scene, while if the blocking is non distributed, a mammalian brain would find it hard to recognize the shape, this is possible due to the spatial limitations of lateral connections. Since repeatedly encountered neurons connect laterally together via lateral connections and since a repeated encountering of the same set of input neurons that make up the shape due to repeatedly encountering the shape, causes a strengthening of these lateral excitatory connections, a web of strongly connected lateral connections, is formed over time, and when at a later time, a sufficient distributed amount of these lateral neurons are active, they depolarize their neighboring non-active neurons and allow for a chain reaction activating the entire web that constitutes the shape, and therefore activate the feedforward output neuron that they have feedforward connections with, hence allowing information to propagate forward across the network.

It is the nature of the distribution of those active neurons which dictates whether an incomplete image could be recognizable or not. Neurons in a mammalian spatial web, connect to a few handful amount of other neurons that are the most proximate to them, since a neuron's axon is spatially limited, where it cannot be longer than a particular length (generally around 650 microns) and the same goes for a neuron's dendritic arborizations, similarly a biological neuron is limited when it comes to the amount of neurons it can receive connections from, as it cannot form an infinite amount of dendritic arborizations, in other words, there are a set of biological limits for a biological neuron, which cause limitations that mimic the previously mentioned lateral connectivity structure.

Similarly, when the distribution of the active neurons is too wide, in other words the active neurons are too far apart, the mammalian brain would also find it difficult to recognize the given spatial stimulus, and this again is due to the dendrites arborization limit for biological neurons, as the majority of neurons form synaptic connections with neurons around them and not very far away from them, therefore when the active neurons are far apart, there are a lesser amount of common inactive neurons between them and therefore less simultaneous common depolarization of inactive neurons, hence a chain reaction of activation does not kick in. In other words, there exists a certain sweet spot, where neurons are neither too far apart (widely distributed) nor too close apart (very concentrated), in order for a chain reaction to effectively realize. In this architecture, such sweet spot is governed by a set of hyperparemeters which are pre-set at the initial condition and based on the desired implementation.

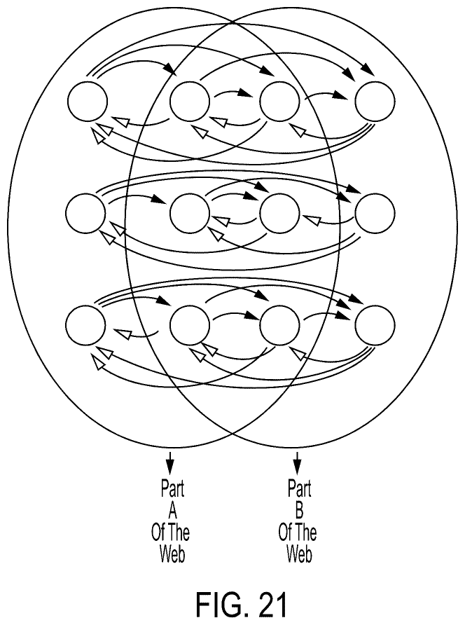

In the feedforward structure, all the connections shared one direction of electrical signal flow from one layer and to the forward layers, on the other hand, the lateral connectivity in this architecture shall be structured in a multi-directional connectivity structure, where the direction of lateral neural connectivity is randomly allocated at conception, this is while ensuring that every pair of neurons follow only one direction of lateral connectivity, from a source to a sink, i.e., from an input to an output, and prohibiting such pair to possess more than one direction of lateral connectivity (except in rare cases). However, at the same time we allow a set of selective neurons to be multi-directionally connected at a global level, where some of the neurons from part A of the web are connected to part B in the web and other different set of neurons from part B of the web connect to neurons from part A in the web as shown in FIG. 21, but this is not exclusive to two directions and is rather distributed along all possible directions, the distribution of directions is random but has to ensure a uniform ratio between all possible directions.

In FIG. 21, there is a set of 10 nodes represented by little circles, such that shaded circles represent currently activated nodes, whilst unshaded circles represent currently inactive nodes. Also shown on the figure, are connection arrows which represent the set of nodes a given node has influence over and the direction of said influence is represented by the pointing arrow head. The 12 nodes are arranged in a 3×4 grid, such that the first 3 columns represent what is referred to as part A of the web, and the last 3 columns represent what is referred to as part B of the web, and where the 2 middle columns represent an intersection between both parts A and B of the web. In the figure, there is only two directions of activation influence, whereas the connection arrows either point towards part B of the web or towards part A of the web.

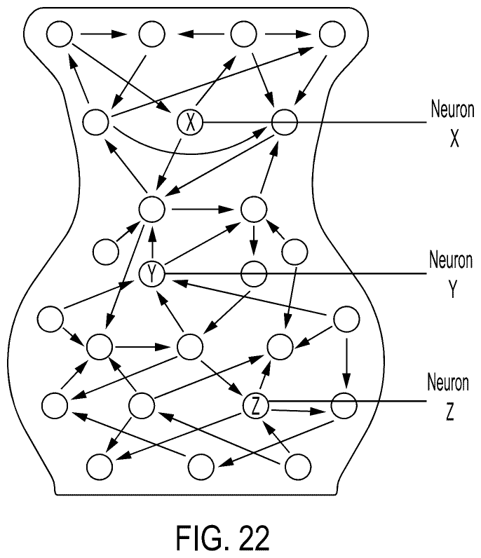

In the example shown in FIG. 22, there is a picture of a vase that is represented by a set of neurons forming a web, where each neuron is connected to the neighboring neuron that belongs to the web which it is a member of. However, some neurons project connections to neuron X and others receive projections from neuron X, the same goes for neurons Y, and Z. As is shown, these neurons do not share an identical set of projections to and projections from connections, and they differ in the ratio of projections from to projections to, as well as where they are distributed along one cell, this is to ensure that when a significantly large part of the vase image, say at the bottom right and the top left corners of the image, are projected onto the retina, both sets of neurons that make up these projected parts send depolarization signals to the middle missing parts which are not projected onto the retina, where the top left corner sends depolarization signals in the direction downwards towards the middle part of the figure, and the right bottom corner sends depolarization signals as well upwards towards that same middle part.

In FIG. 22, there is a set of distributed nodes located within a receptive patch which takes the form of a vase, whereas the collective nodes represent a single web, and where the nodes are represented by little circles on the figure. Also shown on the figure are connection arrows which represent the set of nodes a given node has influence over and the direction of said influence is represented by the pointing arrow head. Unlike the prior figure (i.e., FIG. 21), on this figure the direction of activation influence showcased by the arrows is not restricted to only two directions, but are rather sparsely and randomly distributed across all possible directions on the two dimensional plane. As shown on the figure, there are three nodes labeled X, Y, and Z, located in different parts of the web.

Realize that the flow of activation from a corner to the middle for example, is random and takes many different paths and not a single directional path, this way we maintain that a chain reaction of activation is possible regardless of where the activation is distributed. The directions of lateral connections are randomly allocated (as a hyperparameter) and It is essential that once these randomly allocated directions are set they remain unchanged, therefore they are only allocated once as an initialization of the neural network. This is analogous to initializing weight values randomly but instead of initializing values we initialize directions of lateral connectivity per layer, it is also essential to ensure that the ratio between all possible directions is equal over a relatively large neural patch, and this is to ensure that there is no bias towards a certain location of distributed activation.

For example, in a particular neural patch, the neurons that have a left to right directed projections are five times more than those that are from right to left, now if image X was projected onto this particular retinal patch, the retinal patch would be five times more sensitive to activations in the left section of the image as compared to activations in the right side of that image, this means when a large set of neurons are active corresponding to the left image, these neurons are five times more likely to cause a chain reaction activation to those missing neurons corresponding to the right side of the image, than if the projected activation was switched to the other side, and therefore it would require five times less distributed amount of neurons from the left side to trigger a chain reaction compared to the right side.

This previous example is assuming only two directions of activations, in other words it is assuming the flow of activation takes only two directions one from left to right and the other from right to left, and also is assuming the flow takes a straight path, where in reality all directions of activations should be possible and the flow should not be only restricted to two directions, and that paths are typically non-straight, as shown in FIG. 22, and this is to ensure that all possible variations of activation flows are equally possible, and for this to be possible it is essential that when the connection directions are initialized randomly the distribution is of equal ratio for all the possible variations in direction across the lateral plane.

Recall that if a set of neurons in a given neuro-cortical column were to be perceived from the plan view, in other words if we were to only project an x-y cross-section of the column, the dendritic arborization and the axonal branches of a single neuron would seem overlapped, and we end up with a structure of a neuron that has a set of projections—to and projections—from connections, where the projections—to represent axonal branches, and the projections—from represent the dendritic branches, and what is important to note here, is that these branches, axonal or dendritic, extend across all the possible planer directions within the neuron's vicinity, and are not restricted to any particular direction, but are rather distributed randomly and uniformly across all possible directions, in other words the introduced multi-directionality of lateral connections is inspired by what is found within the biological cortical columns, and which are a direct result of the messy interconnectedness of pyramidal cells that are proximate to one another.

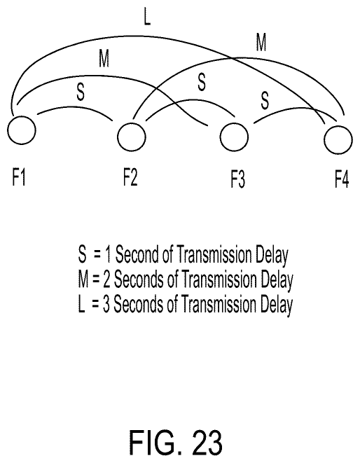

Collective excitation can also occur when a set of selective neurons are connected through non-equidistant lateral connections, where such connectivity structure ensures that when an aggregate net sum depolarization occurs, it is only registered simultaneously if the stimulus itself was temporally distributed. For example, as shown in FIG. 23, there are 4 nodes represented by small circles and labeled F1, F2, F3, and F4, respectively, counting from the left, such that F1 projects 3 connections labeled S, M, and L, towards nodes F2, F3, and F4, respectively, and F2 projects 2 connections labeled S and M towards nodes F3 and F4, respectively, whilst node F3 projects a single connection labeled S towards node F4. S, M, and L labels signify, short, medium, and long connections, respectively, which are emblematic to their latency corresponding latency variations such that, connections labeled S have a transmission time delay equivalent to 1 second, and connections labeled M have a transmission time delay equivalent to 2 seconds, while connections labeled L have a transmission time delay equivalent to 3 seconds. In the FIG., the four selective neurons are connected laterally with a set of connections that vary in latency, in other words, which vary in transmission time. Each connection is labeled with its transmission latency, and each neuron is responsible for capturing one frame from a set of 4 frames which represent a 4 second long video clip which films a triangle's motion at a one FPS frame rate, each neuron is labeled F1, F2, F3, and F4 for frames 1, 2, 3, and 4, respectively.

If we assume that a lateral temporal web was established representing the previously mentioned stimulus, and that at some encounter, a member selective neuron F1 is activated as a result of perceiving the first frame of the video clip, and then one second later F2 were to be also active as a result of perceiving the second frame, F3 is depolarized by both F1 and F2 simultaneously, as F1's signal reaches F3 after two seconds from when F1 was found to be active (based on the transmission time), and F2's signal reaches F3 after one second from when F2 was found to be active. This means that at t=2, F3 would receive a simultaneous signal from both neurons F1 and F2, and as a result their signals would be summed up and a net large depolarization signal corresponding to the summed signals increases the likelihood of F3 getting activated, as opposed to if each signal, from F1 and F2, were to reach F3 at different times and not simultaneously. In such a case, each signal would singlehandedly cause a lower net depolarization influence to F3 neuron, rendering it less likely to be activated as a result.

One second after F3 gets activated, F4 receives three simultaneous signals from F1, F2, and F3, which adds up and greatly depolarize F4 neuron, rendering it more likely to activate, and so on and so forth perpetuating the process causing a chain reaction that activates all the member neurons of the temporal web. On the other hand, if F1 and F2 were not initially activated across a temporal distribution (i.e., at different timings) but were rather activated simultaneously, which means in other words, assuming that the stimulus comes in the form of two superimposed triangles with different local positions perceived simultaneously, due to the transmission latency, F3 would not receive signals from F1 and F2 simultaneously, but would rather receive a signal from F2 first then a signal from F1. Therefore, since the signals would not add up, a depolarization would be less likely, and F3 would not activate, and therefore the chain reaction would be broken, as F3 would not contribute to F4 and therefore the entire web would be less likely to be activated, this means by varying connection latency, we establish a web that only recognizes and records temporal information and not spatial ones.

Temporal webs participate in the processes of filling incomplete temporal information as spatial webs do, for example, a mammalian brain tends to recognize a sound piece even if it misses a handful amount of notes, the mammalian brain fills the gaps in through temporal chain reactions, the same way incomplete visual scenes tend to be recognized due to chain reactions within spatial webs.

By exploiting the fact that selective neurons can connect through excitatory connections laterally within any given layer as well as exploiting the spike-time graph which models such connection, neurons can form excitatory connections with one another in a given layer as long as one selective neuron activates after another selective neuron for latency varied connections based on their latency value. Temporally distributed stimuli tend to be perceived in the form of a sequence of neural activations, and since neurons that activate after each other can form excitatory connections with one another, a lateral temporal web of connected selective neurons can begin to emerge due to the nature of the perceived sequential information, this is not only limited to visual information but it includes auditory sequential information, a matter of fact, the mammalian temporal lobe, is so adapt to learn sequential information based on emergent lateral temporal web, due to the fact that the main sensory information that projects information to it, are acoustic information received by the auditory cortex, which are characterized as being temporally structured by nature.

As was the case for spatial webs, in a temporal web, there shall exist a temporal limit which governs how far a neuron can link to other neurons, where two selective neurons have to be temporally proximate for them to be linked together through latency variant connections, neurons that are active farther away in time should not form said connections to ensure that a particular neuron can only link to a limited set of other neurons that are active in a relatively proximate time relative to the time of activation of the particular neuron in question. This means the same way in a preferable implementation of a lateral connectivity structure for spatial webs, a spatial limit exists which poses restrictions to selective neurons, where they could only project their axons to a fairly limited amount of surrounding neurons, in a preferable implementation of the lateral connectivity structure of temporal webs, selective neurons in temporal webs, shall possess a temporal limit as well, where they should only project their axons to a fairly limited amount of temporally proximate selective neuron members.

When encountering an incomplete stimulus represented by a temporal web, contrary to the case in spatially distributed stimuli that are represented by spatial webs, the less distributed, i.e., the more concentrated the given active neurons of a stimulus are, the more likely it is that a given temporally distributed stimulus is going to be recognized, because more inactive neurons would be found common between said active neurons, and therefore the likelihood of these inactive neurons to get activated would increase, whilst the more distributed the active neurons are, the less common inactive neurons between those active neurons would exist, and therefore the inactive neurons would be less likely to receive simultaneous depolarization signals.

For example, if stimulus X, is represented by 16 distinct sequentially arranged selective neurons (sequenced across temporality), from neuron 1 to neuron 16, in other words let's assume each neuron is active from 1 to 16 in a temporal sequential order and every neuron activates within a distinct unit time interval, say 50 milliseconds, let's also assume that a neuron can temporally connect to neurons that are 4 units in time ahead of it, i.e., 200 milliseconds ahead, realize that it has to be ahead of it and not prior to it in time since the spike-time graph which governs excitatory connections clearly shows that potentiation can only happen when the presynaptic neurons are active before the postsynaptic neurons were found active if the latency value is positive (which is the default state of such latency values), and not the other way around.

If say neuron 1 connects to neurons 2, 3, 4, and 5, neuron 2 connects to neurons 3, 4, 5, and 6, neuron 3 connects to neurons 4, 5, 6, and 7, and neuron 4 connects to neurons 5, 6, 7, and 8, and so on and so forth for the rest, in other words, assuming that neuron 4 would be receiving three inputs from three neurons 1, 2, and 3, and neuron 5 would receive three inputs from three neurons 2, 4, and 5, and so on and so forth for all the rest of the selective neurons. When neurons 1, 2, and 3 are active in the right sequential order (since the connections are temporal), neuron 4 is guaranteed to receive a huge depolarization signal equivalent to the sum of all these three neurons sending such signals integrated simultaneously, and hence would be activated as a result, and then when neurons 2, 3, and 4 are active they send to neuron 5 a great integrated sum of their depolarization signals, causing its activation as well, this perpetuates in a sequential order while propagating forward in time, until the entire sequence of 16 selective neurons representing the temporal web, get activated through to a chain reaction of activation following their proper temporal sequential order.

The act of propagating activation through a sequence is addressed in this application as the chain propagation effect, since when a concentrated few set of neurons are active they tend to effectively depolarize other neurons that are temporally close to them, which therefore depolarize the ones they are temporally close to and so on in a chained event until the entire sequence is activated, where when the entire sequence of neurons are active the feedforward output temporal selective neuron corresponding to that particular temporal sequence gets activated and the temporally distributed stimulus is said to have been recognized. An example of this would be hearing a segment of a musical piece, and then recollecting the entire musical piece in its proper sequential order, hearing it internally as an car warm, or humming it externally through the vocal cords.

On the other hand, if the neurons that were active were not concentrated as in the previous case for selective neurons, 1, 2, and 3, and were rather distributed, say for example the active neurons where 1, 5, and 11, neurons 1 and 5 would not share any common neurons, and therefore no simultaneous signals would be sent to it, kind of like when far apart selective neurons in a spatially distributed stimulus get activated, no common neurons in between exist to facilitate a chain reaction effect. The same would go for neurons 5 and 11, in other words, if the activation of a temporally distributed stimulus were too distributed temporally, the stimulus wouldn't be recognized as the neurons would be considered too distributed and not concentrated enough to cause any chain reaction.

In other words, when the active neurons are distributed far apart spatially and temporally a chain reaction activation which activates the entire web members, is not possible for each respective web type, on the other hand, when the active neurons are relatively concentrated in one area, a chain effect is possible, with the exception that if such concentration was high for spatial webs, i.e., far below a certain sweet spot, such case would also deem it improbable for a chain reaction to take place, this however is not the case for temporal webs. The reason temporal webs encounter such an effect while spatial webs do not is due to the nature of the stimulus, where neurons that belong to a temporal web reserves all their dendritic connections to neurons that are proximate in time to them which means to other neurons that are active immediately after them, on the other hand neurons that belong to spatial webs distribute their reserve of connections sort of speak to neurons that are spatially proximate surrounding their vicinity, and therefore since the spatial world is three dimensional and the temporal world is one dimensional, more connections to more common neurons are reserved per neuron in a temporal web, than connections to common neurons per neuron in a spatial web.

A propagating chain effect in a spatial web is possible but is less likely than its counterpart temporal webs due to the nature of the stimulus as mentioned previously, however, if a specific set of spatially connected neurons, were specifically encountered in a visual sequential manner, it is possible that a spatial propagation chain effect would occur. An example which showcases why the nature of the stimulus dictates the propagation scheme of depolarization, would be visually experiencing a long word, like the word simultaneously, one might assume that it is possible to recognize that the sub section simult—is part of the word simultaneous, by simply connecting all neurons in the letters s, i, m, u, l, t to all the other letters of the sub word aneous, and when the neurons corresponding to the sequence of letters that make up the sub word simult are active, they depolarize the inactive but common neurons that they link to which form the letters ane then those would depolarize ous, establishing a propagating and directed chain reaction effect comparable to the one observed in temporally distributed stimuli, however this is not true because the elements of the word simultaneous are encountered simultaneously, (pun unintended) and therefore the depolarization propagation is guaranteed to be simultaneous and not chained because of the natural way by which we tend to experience visual words, this is contrary to auditory stimuli, which are experienced temporally by nature.

Recall that one possible implementation of a temporal web, include Anti-connections, however a problem of using Anti-connections in chain reaction activation, is that it would allow for the recollection of temporal information in the reverse order of their experience, since by incorporating such connections, we allow the chain reaction to flow both ways, positively in the direction of positive time, and negatively in the direction of negative time, where the latter would allow for the recollection of events in the reverse order of their experience, however merely resorting to normal connections and neglecting Anti-connections would restrict the flow of recollection to only one side, for example, if the network were to encounter a sound segment of a musical piece that lies at the end of the piece, the only side of the musical piece which would be recollected is the part that lies ahead of the sound segment, whilst information that lie behind the sound segment would be neglected, rendering the majority of the musical piece un-recollected.

Collective excitation allows for the existence of what we refer to as a recollected expectation, these come in two types, temporally distributed recollected expectations, and spatially distributed recollected expectations, the former is the most intuitive one, as the word expectation accurately describes them. A temporally distributed expectation refers to the recollection of a short term predicted outcome, an example would be recollecting the future sequence of a pre learned event, like listening to a segment of some musical piece and expecting the next sequence of musical notes, or listening to the first segment of a pre learned sentence and predicting or reciting the next word, etc. These are all examples of temporally distributed expectations which are a natural result of the process of recollection via collective excitation, where recollection refers to the process of depolarizing inactive selective neurons due to the activation of a set of selective neurons which are activated a result of witnessing a portion of a stimulus which is represented by a web, such that said web encompasses both the inactive and the active selective neurons, and where the depolarization occurs via a chain reaction activation.

It is worth noting that temporally distributed collective excitations aid in a more sophisticated cognitive process which we refer to as the temporal flow of thoughts, where a set of general concepts represented by a set of general selective neurons, are chained successively across the positive direction of time, creating a set of general concepts which flow in a particular direction, however, we deem any detailed elaborations regarding said process to be out of the scope of this application, and we only touch on this briefly at the end of the subsequent section regarding generalization.

Spatially distributed expectations, refer to real-time assumptions made by the network regarding its spatial surround, they occur in real-time because the recollections of spatially distributed stimuli which are represented by spatial webs, realize over a relatively short period of time, and specifically in our network that period would be 50 milliseconds in duration, and therefore they seem simultaneously occurring relative to the network's perceptions. An example of a real-time visual assumption would be the majority of static optical illusions, one of such illusions is shown in FIG. 31, which illustrates three Pac-man shaped figures that are oriented in a way such that they create the illusion of some existing white triangle within their bounds. The Pac-man shaped figures P1, P2, and P3 are arranged such that the center of each figure represents one vertex of the non-existent white triangle between them. Although such a triangle does not exist in reality, it is rather the byproduct of collective excitation performed in action.

Each shape that constitute the open mouth of the Pac-man figures is identical to the shape of the angles of a triangle, and due to the persistent encounter of humans to triangles in their daily life, a spatial web which represent triangles formed in our heads, and therefore once distributed portions of a triangle is perceived, a collective excitation causes a chain reaction activation which leads to the activation of the entire web of neurons which represent said triangle, forcing the network to perceive what is not actually there, hence drawing an assumption, and in this case it is a false one and it is the false assumption of the existence of a white triangle.

Expectations provide the network's perceptions with fillers which fill its perceptions according to the network's experiences, and the stronger the connections are, the more intense these fillers are at filling the perceptions. This can be quantified through the spiking rate of the recollected stimulus, where the stronger a collective set of connections are the higher the net depolarization signals would be received by the in-active neurons and therefore the higher their spiking rate would be. A higher spiking rate is a measure of the qualitative vividness of an experience, where the higher the spiking rate, the more vivid the recollected experience would be.

It is necessary to clarify that predictions and assumptions are merely a subset of recollected stimuli, not all recollections are assumptions or predictions, some recollections are merely memories. We define two types of memories, namely, general memories and specific memories. While both assumptions and predictions are forms of general memories, there exists an entire category of recollections which are neither assumptions nor predictions, which are specific memories.

Web structures also allow for what we refer to as a chain reaction inactivation through collective inhibition, these allow for distinctive web activations as is clarified below. Collective inhibition occurs when a group of active selective neurons which belong to one or many positive webs, initiate a collective suppressive influence over every other non-member selective neuron of said web/s, this creates a sort of hive behavior effect, where a group of neural activation collectively suppresses the activation of other group of neurons which are not supposed to be active at the moment of the former group's activation.

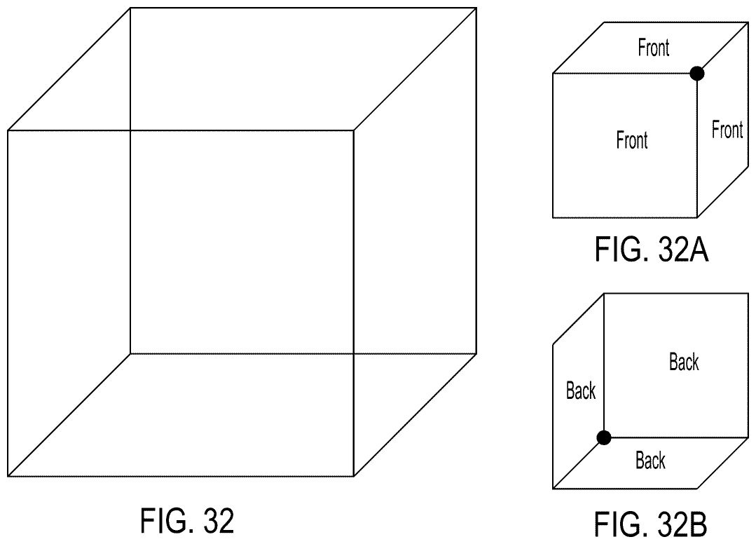

To observe how such would be the case, take the example of the 3 dimensional cube mentioned in the previous sub-section, recall that the front and the back of a 3 dimensional cube is naturally perceived in a mutually exclusive manner. Taking this as a premise, we gave an example of such cube being represented by two sets of selective neurons, each set representing one of the two perspectives of the cube. We now elaborate on this example and assume that the front of the cube is viewed from the perspective of an upper vertex which intersects three faces of the cube such that, only these three faces of the cube are visible from that vantage point, where each are labeled “front” as shown in FIG. 32A. We further assume that the back of the cube is viewed from the perspective of a lower vertex which intersects the other three sides of the cube such that, only those three faces of the cube are visible from that vantage point, where each face is labeled “back” as shown in FIG. 32B. Thus, FIG. 32A represents a perspective of the Necker cube of FIG. 32 that is mentally conjured up once a viewer looks at the cube on the left from the perspective of the upper right vertex shaded in FIG. 32A. Similarly, FIG. 32B represents a perspective of the Necker cube of FIG. 32 that is mentally conjured up once a viewer looks at the cube on the left from the perspective of the lower left vertex shaded on FIG. 32B.

Assume that each set of selective neurons which represent one of the two perspectives shown in FIGS. 32A and 32B, was consisted of 3 selective neurons, each representing one face from the cube. Since the activation of both sets is mutually exclusive, it follows that the activation of one selective neuron which belongs to one set and another selective neuron which belongs to the other set, is mutually exclusive as well. As a result of the neural patch consistently perceiving one perspective XOR (i.e., one or the other but not both simultaneously) the other at any given moment, a set of inhibitory connections forming between the two sets, becomes strengthened over the frequency of encountering such mutually exclusive events. If at one point the set representing the front perspective were to be activated, they would collectively send a suppressive inhibitory signal towards all the other neurons which represent the other perspective, hindering those selective neurons even less likely to get activated than if they had not such inhibitory influence over them. This is what we refer to as collective inhibition, and the previous example also happens to be the solution to the Necker cube illusion problem.

The Necker cube illusion is a solid example of the process of collective inhibition working in real-time. To further clarify, the Necker cube illusion is a 2 dimensional optical illusion, where a 3 dimensional cube is illustrated on a 2 dimensional canvas/medium, and it can be viewed from a particular perspective, which causes the viewer to switch back and forth in their interpretation of said cube's orientation, specifically whether the cube is facing front or back. Because the human brain perceives space in 3 dimensions, it is accustomed to perceive certain information in certain ways due to the limitations of its visual system. One such limitation of the human visual system is its limited spatial field view, which prevents it from simultaneously perceiving information of the front and the back of certain objects when viewed from certain perspectives, like the cube example mentioned previously. Such limitations allow for certain events to always be mutually exclusive when the human brain encounters them, and therefore, through inhibitory connections such events form strong suppressive influence to one another as dictated by the positive modulation effects which govern such connections under the condition of asynchronous activity across said connections' terminals. Collective inhibition explains why the viewer tends to shift in the perceptual perspective of the cube but never integrates said perspectives to perceive a superposition form of them.

The suppressive influence mediated by collective inhibition is very useful in the process of re-correcting a perceived stimulus, since if two mutually exclusive events are naturally perceived as such consistently, then it follows that a deviation from such mutual exclusivity of encountering said stimuli represents a sort of fluke, or a mistake conducted by the perceptions which need to be re-corrected by suppressing the activation of one of the two stimuli which should not be activated in direct proportion to the strength of these inhibitory connections, which themselves are directly proportional to the unlikelihood of such event occurring based on the network's experience. Recall that the connection strength is proportional to the frequency of stimulation, and for normal inhibitory connections specifically, it would be proportional to the frequency of asynchronous activation, i.e., the negative correlation registered across the terminals of said connection, and therefore the less likely two events represented by two selective neurons which lie across said terminals are, the stronger said connection would get, and therefore one can infer that such connection strength is proportional to the unlikelihood of both selective neurons being activated simultaneously, since the more said neurons are encountered asynchronously, the stronger said connections get.

Any set of selective neurons which are suppressed as a result of collective inhibitions are an example of what we call a negative expectation, and it comes in two forms, a spatially distributed form, representing negative expectations, and a temporally distributed form, representing negative predictions. A negative expectation refers to a sort of blind spot in perceptual awareness, a prediction that something is not going to occur for temporally distributed stimuli, and an assumption that something is not the case for spatially distributed stimuli. This is contrary to positive expectations which included positive predictions and positive assumptions, both of which represent the recollection of the occurrence of something, i.e., the positive affirmation of its existence. To use Jean Paul Sartre's words, negative expectations represent the perception of what he coined as the “lack of existence”, i.e., negation or nonexistence. Negative assumptions cause what we refer to as a negative perception, where something is being suppressed from the perceptions although it exists out there externally, optical illusions again are good examples of such.

A negative prediction refers to a temporally distributed collective inhibition, and is not as intuitive as a positive prediction, since by definition it represents that which is not going to happen, and we humans tend to concern ourselves with what may happen as opposed to what may not, as the former is limited in possibilities relative to the latter. An example of a negative prediction would be the last word in the following sentence, “all men are mortal, Johnson is a man, therefore Johnson are mortal”. If a listener were to listen to this statement and had it paused after “therefore Johnson”, they would formulate a positive prediction in the form of recollecting the word “is” followed by the word mortal, however, if the recited audio had not been paused, once the listener hears the word “are”, they would instantly register it as a mistake, as the word “are” in this context, is a negative prediction, since mentioning it in that particular context constitutes a violation of the rules of grammar.

In the previous example, collective inhibition is generated by the set of active neurons which make up the word Johnson, where they influence the inactive selective neuron which represents the word “are” negatively via the inhibition rendering them less likely to get activated, whilst collective excitation which is also generated by the same set of selective neurons which represent the word Johnson, and they influence the inactive selective neuron which represents the word “is” positively via excitatory connections, rendering them more likely to get activated. The same way stronger excitatory connections cause a stronger collective excitation and therefore increase the likelihood of a set of inactive neurons they influence to get activated, which can be measured by an increase in the spiking rate of said inactive selective neurons, stronger inhibitory connections cause stronger collective inhibitions and therefore decrease the likelihood of a set of inactive neurons they influence to get activated, and which can also be measured by an increase in the shunning rate of said inactive selective neurons.

This is because as was clarified earlier, the higher the frequency of asynchronous activity a pair of stimuli are found to be, the stronger the inhibitory connections they share become, and therefore the higher the hyperpolarization influence of one would be on the other, in the previous example, this would be the consistent asynchronous activation of both the words Johnson and the word are, since the noun “Johnson” or any preconceived and known singular name is never associated to the verb “are”, and hence the pair are never or very unlikely to be encountered simultaneously in the cognition of the reader. On the other hand if we used a noun which can be grammatically used correctly before either verbs, say the word “Crates”, both verbs would be likely encountered in association with said noun, and therefore both of the selective neurons which would represent each verb, forms excitatory connections to the word as a result of frequent synchronous activations, and hence they wouldn't form any strong inhibitory connections with the word, and hence they are not expected to be suppressed from the network's perceptions. Notice the previous example is simplistic as it does not yet account for generalization and general selective neurons, as they would be introduced on the subsequent section.

Negative expectations therefore act as filters of perceptual and cognitive experiences, as they filter out stimuli that are unlikely to occur/be (predictions/assumptions, respectively) from the network's perceptions and cognition, in direct proportion to the network's subjective experience of any given stimulus's unlikelihood of activation in a particular context, where the context and the stimulus are events that are persistently encountered by the network to be mutually exclusive. This is in contrast to Positive expectations which act as fillers of perceptual and cognitive experiences, as they fill in stimuli that are likely to occur/be (predictions/assumptions, respectively), in direct proportion to the network's subjective experience of a given stimulus's likelihood of activation in a particular context, where the context and the stimulus are events that are persistently encountered by the network to be mutually inclusive. Therefore, one can conclude that collective excitations and collective inhibitions provide guidelines to sensory perceptions based on the network's subjective experiences.

One can notice how there are always more ways to violate an agreed upon structure of conceptual/perceptual knowledge, than there are ways to affirm it, in other words, in our earlier example regarding the statement which contained the noun “Johnson”, there are more possible ways to violate the structural flow of the statement using unpredictable flows (negative predictions) than there are ways to provide the flow with positive predictions which affirm said structural flow. The reason mammalian brain's evolved to only account for positive predictions and describe them as they are elicited, whilst neglect's describing negative predictions as they are suppressed, is strictly due to the fact that this arrangement provides an adaptive advantage to the creature, as it can be of utility to the creature's survival, for example, it's more useful to know what a possible consequence of some event would be, like a probable snake bite in the event that the creature approached a venomous python, than all the improbable/impossible set of consequences of that same event, like an improbable friendly encounter with said python, or the impossible event of said python deciphering Quantum Chromodynamics in a friendly conversation with the creature.

Mental representations require both collective excitation and collective inhibition alike for precise recollections to occur. Web excitations can be treated as disturbances in the field of the entire network grid, where such disturbances are caused by external and internal elicitations of said grid, mediated by sensory devices for the former and cognitive processes for the latter, whilst web inhibitions can be described as suppressive influences across the grid which provide confinements to such disturbances, where they provide focus to the network by suppressing what is not the object of focus, a sort of noise cancellation device.

When cognitive neuroscientists observe the electrical excitations of the various regions of the brain of a mammalian infant, they notice that many regions of the mammalian network experience a vast sum of distributed excitations which are distributed across a vast region of the infant's mammalian network, the entire brain lets up sort of speak, however over development and the older the mammalian brain becomes, less and less distributed excitations are observed and rather what cognitive neuroscientists observe is that the excitations get more localized over the initial phase of the brain's development. This entire phenomenon can be explained by collective excitation, collective inhibition, as well as the fact that the ratio between the abundance of excitatory neurons relative to inhibitory neurons is disproportionate and is biased towards excitatory neurons, where the ratio is around 85:15 (Excitatory neurons:Inhibitory neurons, respectively).

Due to the abundance of excitatory neurons relative to inhibitory neurons, we can expect that at the initial condition, more excitatory electrical influences would occur relative to inhibitory electrical influences, this would cause the existence of many excitatory disturbances in the network field relative to inhibitory suppressions of said disturbances, therefore providing net high positive excitatory disturbances in the network field, however once the network matures, a lot of these excitatory connections are pruned and more inhibitory connections are strengthened, shifting the power balance towards collective inhibitory influences, allowing the process to suppress much more of these excitatory disturbances in the network's field, which therefore would only permit very strong disturbances to remain active whilst suppressing all the weaker disturbances.

This is similar to when selectivity was developed gradually over the network's experience as the network learns to suppress a certain stimulus over time and its experience of encountering said stimulus, in this case however, the network learns to suppress activations which shouldn't occur where they are deemed unfitting based on the network's experiences. By adding to this the fact that most of the excitatory connections are pruned over time via maturation, where the network's interconnectedness drops over development, we end up with localized disturbances in the network field that correspond only to specific externally elicited and internally elicited stimulations.

To further clarify, as a result of the hyper interconnectedness of the mammalian neural network architecture at its initial phase, little excitations can create a wide chain reaction activation which spans across the entire network field, and only when the network matures, by pruning much of these interconnectedness does it gradually confine towards localized web structures each representing one and only one stimulus, where one external elicitation, i.e., a stimulus, activates one representative web, or in other words one stimulus causes one particular localized disturbance in the network field, on the other hand, prior maturation, one external elicitation would cause not only the activation of a representative web, but the web would unintentionally cause the activation of other webs that happen to share common connections with it, causing a chain reaction of disturbances across a vast region of the network field, to combat this, the mammalian brain evolved both a pruning process and a collective inhibition process, where the former reduces such interconnectedness based on the network's experiences, whilst the latter aids the network in suppressing unintended disturbances also based on the network's experiences. The previous passages are clarified with further detailed explanations below.

Before we move forward we will be Introducing the ability of our network to have Multiple Specific Selective Nodes Which Correspond to The Same Input Stimulus to Allow Multiplicity of Meaning Based on Context, in what we refer to as our selective Attention Mechanism.

This is the most important aspect of what consider to be our selective attention mechanism, which is the ability to have a stimulus be represented by different nodes each activating in response to a different context to represent different meanings.

For example, the word mole can be used to signify multiple different signifiers, either the chemical term for one mole of substance, or the counter intelligence term for a spy, or originally the animal species which digs into the ground. The goal is to ensure that multiple different meanings for one input stimulus (in this case a word) can be represented by different specific selective nodes, such that the correct specific selective node (meaning) activates based on the proper context it lies within through collective excitation.

To achieve this, a few conditions must occur. First, each selective cell will contain sub cells, such that each sub cell contains multiple specific selective nodes. The sub cells nodes move in the same sequential form as originally in the regular cell mode, where one specific selective sub node is associated to one and only particular stimulus alongside a particular context represented by the lateral connections it receives from all other cells.

Each sub node of a sub cell represents different meanings of the same input stimulus, such that the context represented by lateral influence specifies which meaning a particular sub node represents. For example, a particular word mole which can represent say possible meanings in this example, should be able to activate three different specific selective nodes which lie in a sub cell. Based on the input alone which is the word mole, all three nodes should have equal activation chance where only one can be active at a time, however the context represented by the other words in a given sentence, can collectively influence the activation of one node over the other two, and ideally also suppress the other two nodes.

To further clarify, let's say we have the following possible sentences: 1. There is a mole in the department of defense based on our intelligence report conducted by the NSA. 2. To calculate the number of particles in 5 moles of substance we multiply Avogadro's number with 5. 3. There is a mole in our backyard, look at all these holes in the dirt.

The words: Intelligence report, NSA, department of defense. All collectively participate in activating the first meaning of the word mole represented by the first specific selective sub node in the sub cell. Alternatively, the words: calculate, particles, Avogadro. All collectively participate in activating the second meaning of the word mole represented by the second specific selective sub node in the sub cell. Finally, the words: backyard, dirt, holes. All collectively participate in activating the third meaning of the word mole represented by the third specific selective sub node in the sub cell.

Based on which sentence input (which contains the word+other words as context) the network activates the correct sub node for the word based on collective excitation from the context nodes. The correct meaning is therefore realized. However, notice how we are looking at it from a very tunnel focus perspective, all the words are subjects and context words simultaneously.

In other words, the influence does not affect one particular node, but all nodes influence each other to collectively bring up the activation of all the correct meanings which correspond to the totality of the context. In other words, many input feature pieces can realize their correct meanings simultaneously based on the overall context. Put in another way, the word Mole is going to influence the word Avogadro as much as Avogadro influences the word Mole. After all Avogadro can have multiple meanings as well, is it the scientist or the number?

Notice what the overall network achieves now with this augmentation. A particular stimulus which can represent different meanings can now be associated to different general selective nodes to classify different stimuli, based on the context which informs which node from a plurality of sub nodes, each representing a different meaning and each connecting to different general selective nodes, should be activated through collective excitation.

For example: let's refine the three sentences from the previous examples and try to classify whether a given sentence belongs to either, a chemistry article, a biology article or a spy novel.

The sentences are: 1. James bond claims that there is a mole in the DOD based on his intelligence gathering from his sources in the NSA. 2. To calculate the number of particles in 5 moles of substance we multiply Avogadro's number with 5. 3. A Mole is small mammal adapted to a subterranean lifestyle, capable of digging complex networks of tunnels and hole in the dirt.

For now, let's only focus on one subject word, mole. The following words will be the context words for each sentence respectively. 1. James Bond, DOD, intelligence, NSA 2. Calculate, Particles, 5, Avogadro, number 3. Mammal, subterranean, digging, holes, tunnels, dirt

If we assume that the word mole can be represented by three specific selective sub nodes, such that each is connected to one of the three general selective nodes. If context is not present, any of the three specific nodes can be active and therefore any of the corresponding three general nodes could be activated. However, because we use context to inform our decision, the context words will suppress the nodes that do not relate to them only activate the proper specific node which in turn would help activate the proper general node. whilst the other suppressed nodes won't be able to activate the other improper general nodes.

To put in a layman's term, context allows for the network to assume features that did not exist and suppress unlikely features, like humans the model is given the ability to assume what was meant by drawing this arch or that arch etc.

A feature might exist in multiple classes, and be differentiating in both classes equally, like the top loop which can exist in both the classes of 9 and 8, and the bottom loop which can exist in both classes 8 and 6.

The solution to this problem in the simpler model which lacked attention (or learning from context in general) was to allow for multiple top frequency comparisons in our differentiability extraction policy, where we would compare not only the difference between the frequency of the top two counter values in the array of counter values, but instead allow for also the comparison of the next top pairs, i.e. the second and third, to ensure we allow the node to be able communicate to both classes.

This is because if we only compared the top 2 in this case, the difference will be low, since the feature would highly frequent in both classes, however if then check for the next pairs, the second and third values, we would register differentiability as the difference would be great. However, this seemed more like a patch to the problem which can't scale indefinitely, as the more we allow for comparisons down the sorted array list, the more we lose the feature's differentiability potential.

And here comes the importance of context learning. In this new selective attention variant of the model, the previous patch up is no longer necessary, as context can now inform which feature meaning should be activated. Since each input feature is allowed to be expressed through multiple meanings, each meaning represented by its own specific selective node, then the top loop for example can be represented by two different nodes, such that each represent a different meaning of the loop, either an 8's top loop, or a 9's top loop, where the exact meaning is informed by the context which in this case would represent the bottom part of the input.

If the bottom part of the input turned out to be a bottom loop then the set of context features (which would represent the bottom input set of node activations) would amplify the activation of the 8's meaning specific selective node from the sub cells through collective excitation, while simultaneously suppress the activation of the 9's meaning specific selective node from the sub cells through collective inhibition, allowing for decisive general node activation.

Additionally, since we allow for multiple meanings represented by multiple nodes for each feature, then each meaning can be a class differentiating despite the feature itself not being as such. This is because each feature meaning can be only connected (i.e. to positively communicate with) the class it belongs to, e.g. the 8's meaning node to the 8's general node class, and 9's meaning node to the 9's general node class.

The 9,6,8 problem showcases a simple example of context learning in computer vision throughout a simple classification task which is classifying MNIST. Using our selective attention mechanism on the MNIST would allow for an increase in accuracy, since context will improve results. However, we believe that the model would be more cost effective when used on more complex and rich data sets, like the CIFAR-10 class, where we believe greater accuracy result difference will be noticed between the two models, when there is more context information to learn from in the data set.

In a visual system this means collective excitation and inhibition behaviors will ensure the proper activation of all member nodes such that they all represent the true contextual meaning of the scene and suppress those meanings elicited which are out of context, to achieve a more decisive activation pattern, where not only the correct web of stimuli features is activated but also the correct meaning of each of these features is activated to inform an accurate decision.

We allow for subcells as well indicated on the segmentation section, however these additional sub cells in this variant are not used for residual connections but instead each is connected with both the input and the surrounding nodes which share the same layer but not the same selective cell.

Lateral connection pairs are composed of the excitatory and normal inhibitory connection pairs, which can be modeled with the following two equations respectively:

$$New Wij = Old {W}_{ij} + ( {X}_{in} \times {x}_{im} \times K \times r ) \qquad ( Eq . 5 )$$

$$New {W}_{ij} = Old {W}_{ij} + ( {X}_{in} \times ( 1 - {x}_{im} ) \times K \times r ) \qquad ( Eq . 6 )$$

where n≠m but can be abstracted with a single connection which follow both equations simultaneously as follows.

$$New {W}_{ij} = Old {W}_{ij} + ( {X}_{in} \times {x}_{im} \times K \times r ) \qquad ( Eq . 7 )$$

$$and$$

$$New {W}_{ij} = Old {W}_{ij} - ( {X}_{in} \times ( 1 - {x}_{im} ) \times K \times r ) \qquad ( Eq . 8 )$$

where n≠m.

Additionally, we allow for a window of influence which does not allow output nodes to perceive the input binary map state results before such window's termination to ensure that the collective excitation and inhibition behaviors complete their intra-layer influences on all layer nodes.

The strong normal inhibitory connection's which lie between the nodes of a given selective cell to ensure mutual exclusion should have its strength be equivalent to the highest possible collective strength of all connections received from the given input kernel bound patch. This ensures that the only way to deactivate such inhibition is through additional collective excitation received from intra-layer nodes.

In the parallel variation the spontaneous spike should be induced by suddenly incrementing the weighted sum variable of a randomly chosen free node with a net value equivalent to or less than the highest possible collective depolarization of all connections it could receive from the given input kernel bound patch. Additionally, in the parallel variant we do away with The strong normal inhibitory connection's which lie between the nodes of a given selective cell.

This is for two reasons, both hyperpolarization and depolarization received by a given selective node from the input should be counter actable by their antagonist influences from intra-layer nodes via collective excitation and inhibition behaviors, to allow for the suppression of out of context features and the activation of context augmenting features.

The lateral connections have to have a substantially stronger connection baseline and linear strengthening factor relative to feedforward connections to ensure that they can suppress and bring up whatever nodes they want regardless of feedforward connection influence post first activation which was induced by said feedforward connections.

This way we ensure the battle for activation is set between and ultimately dictated by only the hyper-polarization and depolarization of the lateral web structures amongst each other.

The activation of all the sub cells happens simultaneously for all sub nodes which share the stimulus but can have different meanings hence all connections are strengthened simultaneously if any one node was active from the sub cell. while the only difference is that different contexts strengthen their own different interlayer connections and suppress hence allow for other in line to activate.

The number of nodes per sub cells equal the number of categories we are trying to categorize. So in theory we have different meanings based contexts as much as categories we got at most. In supervised learning we set the subcell node to always be active per category the same way we do for the output node per category. This way we ensure each meaning learns the same context of the its same category, categorical context.

The process happens as follows:

An input is perceived by the set of parallel layers each with its designated kernel size. Simultaneously the output node corresponding to the sample class and each subcells corresponding context class node are made active while perceiving said input. The connection pairs set between the memorization and input layer pairs and the connection set between the generalization layer and memorization layer are modified accordingly.

All context nodes are modified simultaneously as along as just any one node from the sub cell got activated regardless of their activity state, so modification for input to sub cell nodes is collectively carried equally if only one node from the sub cell meet the pair connection modification activation criteria. However this collective modification behavior only carries with feedforward connections, while with lateral connections the modifications are independent for each node per sub cell.

Overtime strong lateral connections will form between nodes of features that occur frequently together on a given training set, and form a web of connections which share the same context nodes. We distribute the frequency counter values across the context nodes accordingly, such that each context node has the frequency of the class it appears at most frequently.

Only nodes which follow the two selection policies activate once a test sample is perceived. Once a sample is perceived initially the node with the highest frequency from the subcells is activated assuming the sub cell receives the required activation signal, through collective excitation and inhibition the correct nodes per subcell is activated and the rest deactivated.

Using frequency would ensure that statistically speaking the majority of the correct nodes will be activated, while the nodes which share multiple classes and hence have multiple high frequencies would be resolved through collective excitation and inhibition behaviors.

Later when a set of features which belong to a certain web is perceived in a test sample and hence are activated, webs of nodes collectively depolarize their members and hyper-polarize non members until one web is fully activated and all other smaller webs are suppressed. This happens in a duration where the output nodes are not yet allowed to receive information from the previous layer. Once the duration passes and the web activation pattern settles the general nodes receive depolarization and hyper-polarization signals from all parallel layers.

### Section 3-C(Relative Balance)

Here, we introduce an element to the lateral connectivity structure of this architecture which allows the positive and negative influence of a given set of selective nodes in a particular web structure to be proportional to the amount of nodes present within said web structure.

Laterally connected Neurons in this architecture shall be caused to be activated through these lateral connections, with a spiking rate that's in proportion to the ratio of (the net excitation/net inhibition signals) received at any given moment −1, ((Exc/Inh)−1). This means the rate by which the selective neurons get activated per a unit duration would be based on the ratio of the net inhibitory and excitatory signals said neuron is receiving, this is to replicate an effect in the mammalian brain which aids this network's ability to dynamically allocate the activation thresholds which both collective excitations and collective inhibitions would be based upon.

For example, say a 3*3 grid of selective neurons forming a spatial web represent a previously learned stimulus, since the signals transmitted by the connections are made to be proportional to the strength of said connections, if for the sake of example each cell's normal inhibitory and normal excitatory connections were of equivalent magnitude at the initial condition, then a qualitative change in the stimulus that spans 4 cells out of the 9 cells that represent the stimulus from the input layer shall cause an absolute net depolarization difference of 5−4=1 positive depolarization points (5 excitatory signals and 4 inhibitory signal for four cell difference), and a spiking rate of (5/4−1)=25% success rate of communication, this means the rate of activation shall be ¼ of the times that the neurons receives said signals.

Recall that a spiking rate refers to the rate of activation and is modeled by a graph which spans 1 second in duration, where said graph shows the proportion of a postsynaptic neuron's successful activation relative to the total amount of communication attempts made by a set of presynaptic neurons, and which shows the rate of spiking per said duration in the form of a frequency of spiking, for example in the previous example a 25% success rate of communication within a span of a one second duration, would mean that given a steady rate of communication attempts, the selective neurons shall be caused to activate ¼^{th} of said time duration at a frequency of ¼^{th} the frequency of the communication rate.

A 25% spiking rate in the previous example, makes sense as it reflects the fact that the signals are skewed towards depolarization as opposed to hyperpolarization and hence, the likelihood of activation shall be existent albeit low, If at another example, both the depolarization and hyperpolarization signals where of equivalent magnitude say 5 (for 5 inhibitory connections) and 5 (for 5 excitatory connections), the spiking rate would be 5/5=1−1=0%, which again makes sense as it reflects the fact that both the depolarization and hyperpolarization signals in this case, perfectly cancel one another. If the excitatory signals are lower than the inhibitory signals, then the spiking rate would end up negative, which again makes sense, as it reflects the fact that in such a scenario the signals are skewed towards hyperpolarization.

Notice that in the examples used in this subsection, we are only focused on the depolarization signals that are caused by collective excitations via lateral connections made by all the members of a given web and the hyperpolarization signals that are caused by collective inhibitions via lateral connections also made by all the members of a given web, and we are neglecting the effect of signals caused by feedforward connections, where a single in-active neuron in these examples receives both types of signals simultaneously at any given moment, however in different magnitudes based on the external and/or internal elicitations caused by perceiving the external world through sensory devices and the internal world through cognitive processes, respectively.

In our previous example, the remaining two possible scenarios, would be when one signal type is disproportionately larger than the other, which would translate to either a high to guaranteed spiking rate (rate of activation), or a high to guaranteed rate of inactivation, which if you recall we refer to as a shunning rate, those would occur when one of the two signal types is overwhelming the other in terms of its causal influence on a given selective neuron, for example, a net 8 points of hyperpolarization signals and a one point of depolarization signal, would give off a spiking rate of ((⅛)−1)=−87.5%, which guarantees a steady stream of inactivation/shunning at the highest possible frequency rate, and the contrary to this example would be a net 8 points of depolarization signals and a one point of hyperpolarization signal, giving off a spiking rate of ((8/1)−1)=700%, which guarantees a steady stream of activation/spikes at the highest possible frequency rate.

By proportioning the probability distribution to the ratio as opposed to the net difference between inhibitory and excitatory signals, we add an important feature to the activation of selective neurons via lateral connections, which is commonly known in the cognitive neuroscience literature as relative balance, the ability to activate neurons based on relative values as opposed to absolute values while crossing an activation threshold, in the previous example a selective neuron from an early layer which only receives 9 input cells, where 5 neurons send depolarization signals and 4 send a hyperpolarization signals, would give off a 25% probability of successful activation, if we assume the signals are being constantly fed at a frequency of 100 HZ, this shall mean that for every 1 second duration of perceiving said input stimulus, the selective neuron shall spike (i.e., get activated) 25 times out of all 100 attempts.

On the other hand, if a different selective neuron member which belongs to a larger web consisted of a 9*9 grid of 81 selective neurons, where a stimulus under similar conditions like previously, were to cause said selective neuron member to receive a net 44 excitatory signals for 44 points through collective excitation and a net 37 inhibitory signals for 37 points through collective inhibition, the ratio of successful activation rate per selective neuron member shall be (45/36)−1=0.25, 25% of the times, exactly the same rate as was in the previous case, although the absolute net depolarization signal difference, in the previous example was 5−4=1 point, whilst in this example is 45−36=9 points.

By aligning the spiking rate to the relative difference as opposed to the absolute difference between the excitatory and inhibitory signals received by the selective neuron, we ensure that a certain lateral web structure is not bound by any particular size, since the threshold by which a collective excitation and a collective inhibition can influence a member of said web is relative to the size of the web, as opposed to a fixed threshold which would impose restrictions governing the size at which a collective set of neurons can influence said member. This allows for the existence of dynamic lateral web structures, kind of similar to dynamic kernel boundaries in the feedforward connectivity structure.

### Section 3-D (Maturation & Branching)

In this sub-section we showcase the process of learning both spatially and temporally distributed stimuli, by forming and strengthening spatial and temporal web networks which represent said stimuli, respectively, via two methods that are inspired by the mammalian brain's lateral connectivity structure, Maturation and Branching.

There are two processes by which this network architecture, can base its process of forming lateral connections, both of which are inspired by certain features of the mammalian brain, and each of which is suitable for one of the two modes of implementation for this network architecture, these are maturation which is suitable for the hardware mode of implementation of this architecture, and branching which is suitable for the software mode of implementation of this architecture. Before we dive deep into these processes we introduce the relationship between the feedforward connectivity structure and the lateral connectivity structure, to clarify a set of important features that relate to the overall neural network architecture.

As was clarified on the previous section, this neural network architecture is layered in structure, where each layer feed information forwardly to the layer next to it via feedforward connections, these layers would vary across different sensory implementations, for example the visual system implementation of this architecture is expected to encompass 5 layers representing V1, V2, V3, V4 and V5/MT, whilst the acoustic implementation is expected to encompass 3 layers, A1, A2 and A3, the core, the belt and the parabelt, respectively. For each layer of this architecture a set of selective neurons are present, and which can also communicate information with one another via lateral connections forming a web network structure as was clarified on this section. A web structure consisted of a set of selective neurons and formed within a single layer acts as an input to a single selective neuron which lies in a layer ahead of its layer, where the members of the web can form feedforward connections with said output selective neuron.

This is facilitated by the dynamic kernel boundaries and the segmentation processes mentioned on the prior section, which allows for any set of selective neurons which follow any form of spatial and temporal distribution to act as an independent group bound by a dynamic kernel and represented by a feedforward selective neuron. In other words, a single group of selective neurons can independently and collectively connect both laterally and feedforwardly. In addition to this, a lateral connectivity structure is not necessarily confined to a 2D layered structure, where a web of selective neurons can only form between selective neurons which belong to the same layer, but rather, one key feature of lateral connectivity which were not yet specified for the sake of simplifying the explanations up until this point, is that such lateral connections transcend the layer structure of this architecture, where lateral connections can form between selective neurons which do not necessarily belong to the same layer.

This means a selective neuron that represents a stimulus from one layer can form a lateral connection with a neuron that belongs to a layer ahead, this is because a selective neuron is merely a representation of a part of some stimulus, and whether the part represented by a single neuron is smaller or larger that the part represented by another, such difference in receptive field sizes shall not prohibit these neurons from becoming members of the same web, for example, say we got a visual stimulus which represents a set of 5 circles, each sized different than the others, in others words, where the circles come in 5 varying sizes, let's also assume that each circle can be fully encompassed by the receptive field of a selective neuron that belong to a given layer, such that one circle is fully encompassed by one of the five layers of the visual system, where the largest circle is represented by a neuron which lies in layer 5, which has the largest receptive field, and the next in size while descending, is represented by a selective neuron which lies in layer 4, and so on, until the last circle, which is smallest in size, is represented by a selective neuron which lies in the first layer, which has the smallest receptive field.

This means that the stimulus in this example, has its parts distributed across all five layers of the visual structure, where each circle is represented by a selective neuron distributed across the five layers, such that a layer contains one and only one selective neuron, which represents one of the five circles which make up the stimulus. In order for said stimulus to be represented by a web of selective neurons, the selective neurons which make up said stimulus, are required to be able to form associations with one another via lateral connections, hence the necessity for a lateral connectivity structure which transcends the network's layer structure. A feedforward selective neuron would still be able to represent a web that is distributed across multiple layers, provided that all the selective neurons which make up said web structure lie within the bounds of said feedforward selective neuron's receptive field. This is facilitated by a process we mentioned in the previous section, which we referred to as transpassing, where transpassing allows for the unbounded layer distribution of selective input neurons.

As is clarified previously, the feedforward connectivity structure is responsible for the classification of information, and represents the recognition ability of the network, whilst the lateral connectivity structure is responsible for the association of information, and represents the recollection ability of the network, both of which are aspects of this network's short term memory.

Recall that the mammalian brain at its early development phase begins with a neural network structure which is highly interconnected locally as well as globally, and over the period of the mammalian brain's development, a vast chunk of these immense connections are pruned over time, where the mammalian brain transitions gradually from a structure where one neuron had a vast amount of connections directed to and from a vast amount of neurons, to a neural architecture, were neurons converge towards forming a specific limited amount of lesser connections to and from a specific limited amount of neurons, this gradual process which occurs over the early years of development, is referred to as brain maturation, where the brain gradually transitions from an immature state to a more mature state via synaptic pruning.

Recall that synaptic pruning refers to the loss of connections that occur between a presynaptic and a postsynaptic neuron pair, where the postsynaptic neuron loses spines across the dendritic regions which used to communicate with the presynaptic neuron's axon terminals. To illustrate how an implementation of maturation would work, let's analyze the following thought experiment.

Imagine a neural architecture consisted of one billion neurons representing the occipital lobe, where at conception every single neuron is laterally connected to every other neuron in that lobe, this means the amount of lateral connections possible in such an architectural system is 1 billion*1 billion, which is 10\hat{ }18 lateral connections, to add temporality, let's assume in our thought experiment that every neuron connects to every other neuron through a bus which contains 20 channels/bands of connections each 50 milliseconds' apart in latency, for a total temporal receptive field of one second, this would in turn mean that the total amount of lateral connections in our example would rise to 20*10\hat{ }18=2*10\hat{ }19 possible latency variant lateral connections.

Let's specify a layer of 1 million neurons out of the 1 billion neurons that make up this architecture, which would represent the input layer and which would directly receive visual information from 1 million optic nerve fibers, where each fiber can transmit a binary signal from one photoreceptor cell representing a single monochromatic pixel it is allocated for, where all these fibers receive their input from a camera sensor, which is one megapixel in size, representing a fovea region. Let's assume the architecture follows the learning algorithms stated previously, such that a single patch can either converge towards forming a spatial web, representing a spatially distributed stimulus, or a temporal web representing a temporally distributed stimulus, each represented by a specific selective neuron from a feedforward layer.

Recall that the former is established by strengthening the equidistant connections (that share the same latency values) which exist between the set of selective neurons which represent the spatially distributed parts of the stimulus, under the condition that said neurons are activated simultaneously, establishing a spatial web, whilst the latter is established by strengthening the non-equidistant connections (that share the different latency values) which exist between the set of selective neurons which represent the temporally distributed parts of the stimulus, under the condition that said neurons are activated temporally, whilst also pruning the rest of the un utilized connection channels as a function of time and via the negative modulation function which naturally governs all connections, all in all establishing a temporal web.

For every strongly interconnected web structure established over the frequent encountering of a particular stimulus, one feedforward web selective neuron is established which is selective to said web, and is active whenever all the members of said web is active, realize that the entire members of the web could be active through chain reactions if a missing part of the stimulus was not perceived by the perceptions as explained in the earlier sections, this is however conditioned upon the existence of a weak collective inhibitory force or the lack of said force entirely, such that no strong hyperpolarizing counter balance to the collective excitation force is found.

Assume that this highly interconnected neural architecture which contains 2*10\hat{ }19 lateral connections, is exploring the visual world over a long period of time, where it experiences the visual world both spatially and temporally, with a spatial limit of 1 million pixels, and a temporal limit of 1 second, assuming that the visual world this architecture perceives is a binary world for the sake of simplifying the example, this architecture can only learn edges and shapes of varying complexity, where at any given time all the one million pixels are active either activating “on” neurons or activating “off” neurons from layer 1, for light and dark, respectively.

Since every sensory neuron from layer 1 initially connects to (a billion −1) other neurons (minus 1 as in assuming we exclude its connection to itself) and via 20 channels of connections per input-out neuron pair, if we assume a software implementation of this architecture, this would mean that initially every neuron would require around 20 gigaflops to send signals to all the other neurons, and 400 gigaflops to send a signal within a 1/20^{th} of a second, the clock cycle of the system, multiply this by around 1 million active neurons at a time, and this would be equivalent to 400 petaflops of processing power to send all these signals, in real-time.

Over time however, the web structure has a vast amount of its connections undergo pruning and others getting strengthened according to the learning algorithm and based on the network's experiences of the external world which it explores, where webs of connections that do not correspond to frequently encountered stimuli or that are barely encountered, will be disposed of, whilst those that correspond to frequently encountered stimuli would get strengthened, rendering them long lasting, eventually all 2*10\hat{ }19 possible connections would be reduced to a certain set of learned webs over the maturation of the architecture, and eventually the architecture would have learned a large set of webs encompassing the structure of the visual world it explored.

In essence the process of maturation resembles a sculpting process, where the experiences perceived by the network while it naturally explores the external world and governed by the learning algorithms mentioned previously, craft web structures onto the architecture and form the commonly frequently encountered visual structure that constitute the building blocks of the visual world explored by the network. If we were to assume the entire network architecture with its highly interconnected neurons resemble a giant solid wooden cube, the process of maturation would resemble a craftsman performing craftsmanship work, where they extract a set of small pieces of wooden work each resembling an independent little object with its own independent identity, in this analogy these little isolated pieces of wooden work are analogous to the little web structures which form and learn to independently respond to individual stimuli.

For a second analogy, one can compare this highly interconnected network at its inception to a Quantum field, where neural excitations in the network are analogous to a disturbance in the field, however unlike quantum fields, the initial state of these disturbances across the field is an entanglement state, where all the neurons in the network are entangled at the initial condition, in other words, due to the highly interconnected nature of the network, the default state of the neural field is entanglement, and as a result of this entanglement one single excitation found within any region can propagate throughout the entire network field creating a state at which there exists only one excitation mode which is the state at which the entire network is excited regardless of where and what stimulus initiated such excitation. The process of maturation acts as an untangling process, which reduces this oneness of excitation into multiple small excitations distributed across the network field, each representing and responding to a different external stimulus, kind of like the reverse process of quantum entanglement.

After dissecting the visual world into its small constituents of visual structures each represented by a small web structure in the network, every time one of these learned structures is projected onto the sensors, the web corresponding to that particular structured stimulus would be activated and the feedforward neuron corresponding to that particular web would get activated as well, establishing a recognition, in other words by learning these visual structures the architecture is effectively translating visual experiences into cognitive neurological activation patterns, which could later on be recognized.

Over time, billions of connections would undergo pruning, laying the foundation of the formation of a vast amount of spatial and temporal webs which would represent a vast amount of spatial and temporal stimuli, respectively, and with the decrease in connections, there will be a proportional decrease in processing power, since lesser transmission buses for signals would mean lesser signals to transmit, and hence over time and experience the architecture would be confined to a specific set of visual structures it learned, which to the architecture represents the building blocks of the visual world, as these would include edges, common shapes, etc.

To further clarify, due to the structure of the visual world, the frequent encountering of stimuli is bound to exist, a vertical edge in a particular retinal region is encountered many millions if not billion times over the life time of a mammalian brain, similarly a circular shape with a particular size within a particular retinal region is bound to be experienced hundreds if not thousands of times as well, however the more complex a particular stimulus is, the less frequent it might be encountered, and the less probable it is that it would constitute some common structure shared between multiple different visual scenes.

For example, a vertical edge in the exact center of the fovea retinal region, could be considered a highly common stimulus, found common within many million different shapes that could have been projected over the life time of a mammalian brain within the center of that visual field, it could have a commonality with a book representing one of the edges of the book, or could have a commonality with a smart phone's edge or a laptop's, a tv's, a cardboard's and many millions of possible objects, therefore an edge is bound to be encountered repeatedly with a very high frequency, and because the learning algorithm follows a frequency of encountering based strengthening function, this frequent encountering leads to a strong synaptic connection between that particular vertical edge and its particular selective neuron which it formed connections with from the layer next to it.

A more complex structure like a particular sized circle centered in the retina within a region referred to as a fovea region, also can find a lot of commonality with an extensive amount of varying objects, it would be less common than a simple edge but common enough to be learned and maintained as information that represents a circle of this particular size, this time and also because the learning algorithm follows a frequency of encountering based strengthening function, its frequent encountering leads to a strong synaptic connection between that the set of selective neurons which make up the web structure which represent said shape. Very complex structures like objects, would be less common yet, and therefore would take longer time to be learned since generally speaking, more time is required to experience naturally uncommon information. This is accelerated by the fact that the mammalian brain encounters visual information in motion. To clarify what is meant by this we briefly explore the concept of perspectives and how NNNs learn them as a consequence of experiencing a moving world, rather than a static one.

In this application any specific relative orientation, size, relative retinal location (bound by fovea visual field region), color as well as shading of a particular visual stimulus (e.g., object) is addressed as one perspective of that stimulus, for example a written text could have many possible locations within the fovea region, i.e., relative to it, therefore its said to have many local perspectives, similarly that same text could possess a large amount of possible font colors, and is said to possess many color perspectives, and so on for the rest of the properties like shading which describes the stimulus undergoing different lightning condition, or size which describes the stimulus undergoing different sizing either relative to the fovea and regardless of the background, in other words an object that is perceived farther away is said to be smaller in relative size, than an object that is close to the eyes, or actual changes in size which tend to be relative to the background and other objects around it.

Similarly, this includes color and shading, where color could either change relative to the surrounding color changes due to lightning conditions or actual changes in the color of the stimulus, for example if an apple drawing within a certain image is perceived gray in color it could either be that the entire image is gray scaled or that the apple itself is colored gray intentionally by the artist, another example would be lightning conditions, a stimulus might appear in different colors due to a difference in the lightning conditions, or it may appear in different colors because the stimulus itself actually changed in color.

A stimulus can also take many different orientations, for example an edge of size 3 pixels bound within a 3*3 kernel could be perceived in 4 different possible orientations relative to the center of the grid, therefore it is said to possess 4 different orientation perspectives, each of these perspectives is learned by one selective specific neuron, orientation could also be relative to the visual field or relative to the background around it, when a mammalian creature tilts its head the background and all objects within it, which the mammalian brain perceives through its vision is perceived oriented, but as color in different lightning conditions, shapes in different head orientations, lead to changes in orientation across the entire elements of the background, similarly an object could also have undergone an orientation itself and not due to any tilting of the head, therefore it becomes the only object that undergone a change in orientation relative to all the other elements of the background.

Regardless of what caused the element's properties to change, a selective specific neuron cannot tell the difference and perceives both as being equally the same, this means that motion which leads to different localizations and different orientations as well as different sizing is a very helpful tool to learn many perspectives of one particular stimulus without requiring the stimulus (stimulus as in the external object being observed) itself to move, and a mammalian child that can grab objects and explore them could add even more learned perspectives by also moving the stimulus being observed.

Selective specific neurons capture visual stimuli at one particular perspective, and therefore over extended periods of real-time experiencing the visual world, neurons develop specific selectivity to each of these perspectives and strengthen their connections to those that are frequently encountered, and due to motion it becomes even easier and quicker to develop many selective specific neurons that capture and learn all those perspectives, since they become more frequently encountered. One of the goals of a developing mammalian brain is to establish a way to unify all the varying perspectives of one complex shape or object and create a selective general neuron that is selective to the class of all perspectives that represent that shape/object, as is clarified in the next section. The take away from this brief introduction, is that motion can exacerbate the process of learning visual stimuli.

The underlying principle of NNN's inner workings is its ability to receive real-time sensory information, and then gradually confine to the visual/auditory structures fed into it from real time experiences, i.e., learning like a mammalian child via long durations of experiences, years and years of real time fed sensory experiences, what is meant by confining to the visual/auditory structures of the world is developing neurons and web structures in the network which act as mental representations for all sorts of shapes and objects with all their possible varying sizes, color textures, and localizations, and unlike the false presumption that one might make, the amount of possible shapes and objects that would be accounted for as selective neurons in the occipital lobe is not equivalent to the permutation of all the possible shapes and objects or sounds and phonemes that could exist in the entire universe, and this is due to five main factors.

The first factor involves the limit of information, as was mentioned in the previous sections, the information propagated from the visual sensory relays and to the first input layer in the primary visual cortex are characterized as being binary, either “on” or “off” signals, unlike traditional artificial neural networks which receive pixel values that are gradient, and as was clarified previously, one pixel in this model (an artificial photoreceptor cell) can either send an “on” signal through its “on” ganglion cells, or an “off” signal through its “off” ganglion cells, and it is the specific combinations of these input neurons that encode the gradient intensity values as was briefly clarified before.

Since the input neurons can only be binary, a selective neuron from a deep layer with a receptive field area that encompasses the entire fovea region (which is a region which encompasses 50% of visual processing in the mammalian brain), such that we assume that the receptive field area of said feedforward selective neuron would be equivalent to the entire fovea region, then that receptive field would encompass around 1 million cone photoreceptor cells (pixels), and in this case the permutations of all the possible unique stimuli that can be represented with just 1 million cones (pixels) where cones are either sending “on” or “off” signals (binary information), amounts to around 2\hat{ }1,000,000 possible configurations, which is a number that has 30,1030 decimal digits, constituting all possible unstructured visual stimuli that can ever be formed within the fovea region.

This means to learn all the possible unstructured stimuli that could ever be formed in this small region of 1 million cones, it would take an amount of selective specific neurons that is equivalent to around 1500 times the amount of all stars that exist in the entire observable universe, this is an astronomically huge number, which brings us to the second limiting factor, the limit of structure.

The second limit is the limit of the structured world, lucky for the mammalian brain, the world is not totally unstructured and is rather found to encompass structure, and the amount of possible structured stimulus experienced within the creature's life span is drastically far less, for example in the context of edge detection, a 5*5 sized kernel can contain less than 30 possible edges (which are meaningful structures), while at the same time it could contain around 2\hat{ }25=33,554,432 possible unstructured combinations of “on” and “off” ganglion signals (which are non-repeatedly encountered structures).

This is a ratio of one to one million, this ratio drastically decreases while comparing the structured world of a high receptive field area and the unstructured world of that same area, for example, if we take a one-megapixel image, with a 1:1 scale, 1024*1024, there are a quintillion times more ways to arrange these pixels in an unstructured non meaningful image (noise image), than there are ways to arrange those same pixels into a structured meaningful image, in other worlds there are far more unstructured configurations in large receptive field to structured configurations than there are unstructured configurations in small receptive fields to structured configurations. This takes us to the third limiting factor which is synaptic plasticity.

The third limiting factor which is the limit of plasticity is a limit that occurs due to the nature of the brain's dynamic synapses (the constant process of creation and elimination). This Factor involves the neuroplasticity of the network, which allow for a dynamic change in synaptic modulations, constant forces of elimination and recreation of spines which govern the constant elimination and recreation of synaptic connections, this dynamic modulation allows the mammalian brain to confine its networks only to learn structures in the world that are repetitive and forget (i.e., eliminate) those that are encountered in very low frequencies.

Due to the deterioration of dendritic spines as a function of time, as much as there are many selective neurons that form new connections, there exists many other selective neurons that lose their connections, in what could be referred to as the constant rate of creation and elimination of selective neurons, these two opposite processes balance each other out at some specific amount, this amount depends heavily on the nature of the experiences fed to the network, too little frequently encountered experiences and the amount of selective specific neurons developed might be very little, too much frequently encountered experiences and the amount would be very much.

The constant process of creation and elimination which is driven by the positive and negative modulation rules in the learning algorithm, governs the overall malleability of the network and its ability to only confine to structured information whilst neglecting unstructured information, where unstructured information by virtue of them being less frequently encountered in the natural world, are eliminated, i.e., forgotten, while structured information which govern the structured world are kept and strengthened by virtue of them being frequently encountered.

For example, the scrambled letters in the following word, omkgfdet, are not considered part of a frequently encountered stimulus to the human cognition, and therefore are not linked to any recognizable meaningful word, while the differently scrambled letters in the following word, Intelligence, are linked to a recognizable meaningful word to the human cognition by virtue of the fact that the word was frequently encountered by our human cognition, from a human's perspective the word omkgfdet represents an unstructured random distribution of English letters, while the word intelligence represents a structured ordered distribution of English letters which corresponds to a meaning, however the only true difference between the two words is that our human cognition was frequently exposed to the latter distribution and unfrequently or never exposed to the former distribution, hence recognizing the latter and not recognizing the former, as the latter is mentally represented by a set of selective neurons in our brains while the former is not.

In the context of input stimuli that are presented as edges and shapes, i.e., “on” and “off” ganglion cells, a single kernel bound retinal region (retinal patch), would only project a few set of possible learnable structured configurations over a very long duration of sensory experiences, since there could exist only a few possible distinct edges with distinct orientations and lengths, to use the same example for a 5*5 sized region, there could be in the range around 30 possible straight edge configurations that might be frequently experienced over the entire life time of a mammalian brain, in the figure-signs represents off ganglion cells and + signs for on ganglion cells. On the other hand, the range of all unstructured possible configurations in a kernel cell containing 25 neurons is equivalent to 2\hat{ }25 (2 for binary, “on” and “off” ganglion cells) which is around 33,554,432 possible configurations, that is the ratio between the amount of configurations a visually (edges only) structured world contains to the ratio of an all possible configurations that exists (unstructured) world.

It is due to the constant elimination and creation of newly developed selective neurons, that the amount of selective neurons required to learn information from that particular retinal region is reduced where the selective neurons that initially learned an unstructured stimulus would eventually unlearn the structure due to the infrequent encountering of that unstructured stimuli and therefore the network is said to have forgotten the stimulus (forgets by breaking connections and therefore reserves the neuron to learn another stimulus), eventually over a relatively not so long duration of experiencing the visual world, the selective neurons as well as the web structures formed by associating said neurons confine to only frequently occurring structures which are necessary for later processes of concept creation as is explained in the following section.

The constant forces of elimination and creation, which are modeled by the two modulation functions that govern the connection strength, dictate not only what information is learned but also how long it is maintained, when the linear growth rate and the liner decay rate create a net change in synaptic strength equivalent to zero, the information is said to be held in an equilibrium state, where it is maintained forever at whatever its current strength value is so long as the net change does not skew to the side of the decay function.

In other words as long as the frequency of encountering a given information does not suddenly drop below its equilibrium, information can be maintained, otherwise if the frequency of encountering said information drops, the connections experience net negative change and hence over time they get weakened and break off (which is translated to a weak or zero valued connection strength in our model), which would yield a loss of the information in question. Simple edges, colors, and the building blocks of the visual and acoustic world are labeled as highly frequently encountered information, and hence they only get stronger over time, and are never going to be lost, however the more complex a structure is across any particular sense, visual or acoustic, the less frequent it is observed to be found and hence the more susceptible it is to be lost, if not regularly encountered.

The forth limiting factor is commonality, which implies that most structured complex stimuli share many simple structured stimuli, and therefore those shared structured stimuli are encountered much repetitively, and this is due to the fact that most complex shapes, objects, sounds, etc. share a lot of common simple shapes, simple sound bits, etc. with each other, and due to the nature of the forward complex propagating hierarchy of neurons, in other words the propagation of input to output neurons from simplest at the early layers and complex at the later layers, much of those neurons in the deep layers share a lot of common simple neurons from the layers that are relatively earlier, therefore aiding the third factor regarding neuroplasticity which play its strong role of strengthening the synaptic connections of those stimuli that are most repetitive, since commonality implies repetitive-hood, for example, if a picture of a book and a picture of a box were projected onto the same retinal region, the neurons responsible for the common vertical and horizontal edges in both pictures are stimulated twice, hence develop strong synaptic connections and therefore stand out (stand out as in the selective neuron develops strong connections to its recipient neurons which form the stimulus).

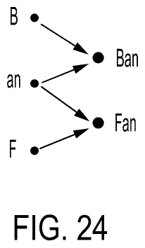

This is why the mammalian brain is structured in a feedforward manner, the purpose of deep layers is to allow for common simple information to be shared within other more complex information, as it is necessary for the building blocks of complex information to be shareable. In the mammalian brain, the feedforward nature of connections ensures that such is the case, for example, the syllable “an” could be found common in many English words like “fan, ban, tan etc.” For complex words like these to be learned, the simpler syllable “an” must be sharable by all of them, hence a feedforward structure like the one shown in FIG. 24, allows for those learned simple information to be sharable across many other complex information. As shown in FIG. 24, there are two short English words, the word “Ban” and the word “Fan” that are divided into their constituent syllables. Dots represent nodes which represent specific syllables, whilst the arrow connections signify composition. On the figure, the syllables are distributed within a first layer, and their composites are distributed in the second layer, whereas the syllable “an” is shared across the two composite words, showcasing a simple example of share-ability across a basic layered neural network structure. A more sophisticated example would be a simple visual shape being shared by a variety of complex objects, like spherical shapes being shared with all types of balls, basketballs, footballs, balling balls, etc.

The fifth and last but most important factor involves the fact that NNN's or mammalian brain's networks receive data in the form of experiences, which are limited by the life span of the creature, therefore there is always a limit to the amount of visual/auditory stimuli experienced within their life span. To put this into context, if we assume that the visual frame rate of our visual perception is 20 frames per second, and assuming that every frame encompasses a fully unique and distinct stimulus, then to learn all these unique stimuli manifested in every single distinct frame and for a life span of 6 years, we would need around 4 billion selective neurons.

However, assuming that every frame is a unique distinct stimulus is incompatible with the nature of perceived experiences (by intelligent creatures) as well as is incompatible with the learning algorithm itself which necessities frequency of encountering, the former is apparent when you observe just the amount of time where the mammalian creature could be just standing still and therefore perceiving the same stimulus for long durations of time, or the amount of identically perceived frames due to the creature's confinement to certain locations making it experience the same rooms, walls, etc., repetitively, on the other hand the latter is apparent by the fact that commonality is bound to exist as mentioned previously, as well as the immense amount of repeated stimulus we encounter regularly.

This means 4 billion neurons for 6 years is a far stretch, and the number could be reduced by a factor of a 100 or even a 1000 if we want to be realistic, however if we pay a close look to the amount of neurons there exists in the mammalian neocortex, we find that the neuro cortex contains around 16 billion neurons, and therefore if we assumed the previous calculations then there should be plenty of neurons for a life span measured in the decades of experiences. The amount of overall neurons that are utilized are hyperparemeters that are based on the specific implementations of each sensory lobe structure, the intention of this paragraph is only to clarify that the amount of necessary selective neurons can be further limited based on the life span we specify for the network.

It is due to these five factors that we can end up with a network architecture that can learn all the possible states of the structured world (in all five senses, not only vision) that a regular mammalian creature can learn and only using a few 10s of billions of neurons as the mammalian brain.

It is worth noting that the space of possible web structures constituted from 1 million sensory neurons, is equivalent to 1 million raised to 1 million, which is an astronomical value, and as clarified in the previously is far more than what a single human experiences/encounters over his/her life span and encompasses both the structured and the unstructured visual world, where the ratio between the unstructured visual world to the structured visual world is itself astronomically large.

By connecting every neuron from every cortical region to every other neuron from all other cortical regions, we can bypass the necessity of knowing the accurate connection set up which billions of years of evolutions crafted onto the mammalian brain. The current focus of cognitive neuroscientists and what they mainly pursue, is understanding the mapping of these exact sets of connections, in what is known as the connectome, in order to get an accurate understanding of the different interactions which occur between all the different cortical regions.

This pursuit is based on a theory of the evolution of the human brain which hypothesizes that over millions of years of evolution, a living creature's brain evolved to adapt a set of different connections between the different cortical regions establishing a specific cortical connectivity layout that is efficient at integrating multiple information represented within different cortical regions which receive inputs relayed from multiple sensory organs, this efficient connectivity layout evolved alongside the creature's experience of the physical world, which means how the sensory organs and the physical phenomenon of the world integrate efficiently had to be learned over millions of years of evolutionary pressures where a set of evolving species experiencing the physical world as it is.

This efficient set of connectivity layout which produces an efficient integration of sensory information comparable to a mammalian brain's is an important goal to cognitive neuroscientists, however by employing an all to all connectivity structure it is possible to bypass the necessity of physically mapping this efficient connectivity structure through the mere experimentation and studying of mammalian brains and rather learn them by exploiting a property which a mammalian brain did not get the luxury to possess, which is the digital possibility of connecting every neuron to all the other neurons architecture wise, the drawback would be the immense processing power over long durations of times (a few years of time) required to eventually end up with the right connection layout which is efficient to integrate experienced phenomenon.

Learning by maturation, is more suitable for a hardware implementation of the architecture, where a high degree of parallelism in processing is required, more than what GPU's can naturally handle, this can be established by using hardware connections similar to what those that were introduced previously, and connecting said connections in a hardware circuit design. By employing a hardware implementation of this architecture, we can efficiently use the massive parallelism of the maturation process to the network's advantage allowing for real-time learning comparable to the mammalian brain.

From an engineering point of view, a software implementation of the process of maturation for a neural network structure which is similar to the mammalian brain involving 16 billion neurons across many neocortical lobes, and with its already pre structured connectivity layout which involves a great deal of connections with complex interconnectedness, is going to be computationally heavy, and this is after it has already undergone an initial phase of pruning, where a specific structural connectivity layout has presumably been crafted through billions of years of evolution and is stored in the genetic code of any given mammalian species. If we want to begin the lateral connectivity structure with an every neuron to every neuron connectivity structure which not only spans across a limited amount of layers per cortical lobe, but rather across all regions from all emulated cortical lobes that belong to an emulation of the entire neocortex, and conduct a maturation process at such point, we would be initiating the maturation process from an earlier point of immaturation which is far less pruned compared to the mammalian brain's already pruned by evolution connectivity layout map, and therefore this would exacerbate the already computationally heavy processing of the network.

Therefore, since GPUs cannot send as many thousands of quintillions of signals per second yet, it is ineffective to emulate the maturation process of learning in a software setting, and hence we propose to use a more computationally efficient model for the formation of lateral connectivity which would theoretically mimic the same achieved results of mammalian brain leaning through maturation but without the drawbacks of calculating as many signal transmissions over short periods of time, such process is what we would refer to as branching.

Branching is what we refer to the process by which selective neurons form associations through lateral connections based on the recorded time of their activation under the condition that said selective neuron pair have not already formed said connection between them, in other words in this process the table is turned on its head, where rather than the connections spontaneously emerging by pruning an already highly interconnected neural structure, effectively crafting this architecture into the structure of the visual world, branching refers to the process of creating connections from thin air based on the recorded time at which a given set of selective neurons were found to be active.

Notice that, branching must only happen when the two selective neurons are determined to not have said connection already formed between them, where if a connection was determined to exist between a neuron pair, a registered activation across the terminals of said connection shall serve the modulation of said connections based on the learning algorithm, in other words branching concerns itself only to the process of forming lateral connections but not the modulation of said connections.

It is worth mentioning that the mammalian brain incorporates branching as well, and does not only confine itself to the process of maturation, in other words the mammalian brain does not do one or the other, but contrary, the mammalian brain while initially starts with a highly interconnected set of connections, which get pruned over maturation at the brain early development phase, it also undergoes a process of branching where a set of neural activations that are observed to occur synchronously and frequently over time are observed to have new connection branches forming across them as well, however the process of maturation is faster than the process of branching biologically speaking, which roughly explains why children learn faster than adults.

A likely reason for why the mammalian brain adapted such learning strategy over the course of its evolution, where learning is heavily based on maturation at its early development phase and then based on what we refer to as branching in its later adult phase, is because the amount of newly perceived structure of the world a mammalian child is bombarded with is very huge, compared to the amount they experience at adulthood, since at adulthood there is little new structures to learn, little as in compared to initially when the child first opens their eyes for the first time, when they are a blank slate, in other words evolutionary wise it is advantages to the creature, that the first years of learning are processed quickly and efficiently to ensure the survival of the creature which has to quickly adapt to the structure of the world it finds itself existing within, learning all the common edges, simple shapes, colors, and many other low level stimuli, which act as constituents for the more complex structures like objects, and scenes which make up its visual surround.

While it would be inefficient to use GPU power in a software implementation of the process of maturation, we can still have an efficient learning process comparable to a young mammalian brain in a software setting by the means of branching, and this is through exploiting the digital capabilities of current software technologies. For the network to learn using branching there must be a way to record not only the activation state of selective neurons that happen to be active simultaneously for the formation and positive modulation of equidistant lateral connections, but also we need to record the activation state of selective neurons that happen to have been active for an elapsed duration in time for the formation and positive modulation of non-equidistant lateral connections, said elapsed duration might be as long as 5 seconds depending on sensory implementation.

Each group of selective neurons which were active at the same 50 millisecond duration cycle are grouped into a single set after they were determined to have satisfied the condition stated earlier (where the node pair does not already have lateral connections between them), and with a temporal limit of 50 milliseconds, we could expect about as much as 5*20=100 sets recording information about the state of all selective neurons, such that via branching we associate all the neurons that are found to have a simultaneous active state and which belong to one set and which do not violate the condition, through equidistant lateral excitatory connections (i.e., sharing the same latency value), while also associate all the neurons that are found to have an asynchronous activity state and which belong to one set and also which do not violate said condition, through equidistant lateral inhibitory connections. Similarly, we associate every selective neuron which belongs to one set with another neuron from the other sets via non-equidistant lateral connections (i.e., different latency) depending on the set's relative time difference, which would dictate the connection's latency, and the activity state, which would dictate the connection's type, and similarly this is under the condition that no such connections already exist.

Notice that what determines which neurons shall be associated with what connections is the neuron's state of activity not its state of inactivity, since both excitatory and inhibitory connections require at least of one of their two terminals be a selective neuron that is in an active state. Therefore, in order to effectively execute the process of branching, the process shall begin by first determining the neurons that happen to be in an active state per set, and then traverse across all the connections said neuron is allowed to have across its vicinity and form excitatory/inhibitory and equidistant/non-equidistant connections based on the activity state and relative position in the sets, respectively (relative to said selective neuron).

This process of branching is analogous to a traditional neural network training process, and therefore could occur independent to the real-time experience of the network, this is possible by dividing the network's day into two sections, an experience & interaction period and a sleeping & training period provided that while the network experiences the world it stores a record of all the activity sates of all selective neurons per duration of experience & interaction (say the 12 hour daytime period) then using these data, in the sleeping period (the other 12 hour nighttime period) force the network to be in a dormant state (sleep mode) and execute the process of branching to sort of learn the experiences of the day, and so on and so forth for every day cycle while the network grows. However, notice that the network's process of learning is split in this case, between the sleeping period where only new connections form based on branching, and the waking period where already formed connections are positively and negatively modulated based on the learning algorithm.

In order for such a process to work on a long duration of stored data, the data which specify the set of neurons that satisfy the condition for branching should be stored in the sequence of its experience, in others in its proper temporal order, where a chain of activation map sets, each representing a 50 millisecond duration from the 12 hour long sequence of data gathered in the period of experience, are stored in sequence, such that a temporal slide which takes the size of the temporal limit in temporal units, i.e., 100 sets for 5 seconds, act as kernel which slides across the long data sequence and perform the branching process (either forming new connections or positively modulating existing connections) as explained previously, until said slide is said to have traversed across the entire 12 hour timeline of stored data, where at this point the data is no longer needed and can be released from memory (erased). Then another process also needs to traverse across all the connections which exist, to execute the negative modulation function based on the elapsed time.

To summarize, there are two modes of implementation for the formation and modulation of this network's lateral connectivity structure. Maturation, which requires an initial state of interconnectedness at conception followed by a long term process of pruning at development, this requires a very high degree of parallelism, and is executed in real-time, and therefore is more suitable for a hardware implementation of this architecture. Branching, which does not require an initial state of interconnectedness at conception (a blank slate), and is followed by a process of connecting various selective neurons based on the recorded data gathered while the network was in its waking state, this requires software overhead in terms of memory and processing (for gathering data and performing a temporal slide over said data, respectively) which can be distributed across the duration of time at which the network is set to be dormant (asleep), it requires less parallelism relative to the previous method, and therefore is suitable for a software implementation of the architecture. The hardware implementation is more energy efficient and computationally light compared to the software implementation which is less energy efficient and is computationally heavy.

### Section 4 (Qualitative Generalization)

We previously addressed the processes by which an NNN architecture developed what we refer to as selective specific neurons, where selective specific neurons refer to neurons which are selective to specific features of the sensory world, like specific edges with specific orientations and sizes, etc.

This section is devoted to the introduction of the processes used by this architecture to develop what we would refer to as selective general neurons, which are neurons that are selective to a set of sensory stimuli that belong to a specific class, for example a neuron that is selective to cars regardless of what shape or form the car takes, or where the car is presented in the visual field or what color it is etc.

In other words, this section covers the generalization processes of this network architecture, and to fully understand the mechanisms laid out on this section, an understanding of the main concepts introduced in all the previous sections is required, as this section is built upon all the previous sections.

We classify two types of generalizations, quantitative-based generalizations and qualitative-based generalizations, the former is utilized in all currently known traditional state of the art artificial neural network architectures, whilst the latter we introduce in this section, and forms the basis by which both the mammalian brain and NNN architectures perform a generalization process. Quantitative-based generalization processes are based on an optimization of numerical data points which represent the features the data, and which are performed across a wide class of training data, whilst qualitative-based generalization processes are based on the frequent activation of qualitative commonalities represented by specific selective neurons across a wide class of experienced stimuli which share the commonalities, and bound within at least two feedforward layers of selective neurons.

Here, we also showcase how quantitative-based neural network and optimization-based algorithms which tend to do a decent job recognizing qualitative features of some qualitative experience, say, for example, a convolution neural net that is trained on an immense amount of labeled training data, are inefficient relative to qualitative generalization-based architectures like NNNs as well as the mammalian brain.

This is due to the fact that traditional neural net models that are based on quantitative generalization via optimization, require an extensive amount of data to do the same task that can be accomplished by a mammalian brain or a qualitative generalization based NNN architecture for that matter, where in NNNs we use a fraction of a fraction of the training data and with almost no external interference to get the same accuracy and precision results, as showcased below.

Here, we also showcase the fact that NNNs do not exhibit any adversarial attack problems the like of which is found on traditional neural network architectures, and we clarify why such is the case, and the reason behind its existence within optimization-based neural networks and the lack of it within neuromorphic learning-based networks like NNNs.

We introduce two processes for qualitative generalization, the first process we address as the process of sensory abstraction, and the second is addressed as the process of associative commonality, and we classify qualitative generalization into two levels based on these two processes, low level generalizations which are solely based on the process of sensory abstraction, and high level generalizations which are based on both processes, associative commonality and sensory abstractions.

Before we deep dive into explaining the process of qualitative generalization, we first introduce a set of concepts which are necessary to facilitate understanding the process, and then we move onto the process after. Herein, any mental representation of a stimulus is referred to as a thought, in other words, a neural web of interconnected selective neurons which collectively respond to a specific stimulus, say a specific shape with a specific orientation and within a specific retinal region, is said to be a thought which represents the stimulus.

A mental representation of a stimulus as described herein can be referred to as a thought, or a neural web of interconnected selective neurons that collectively respond to a specific stimulus. A specific shape or a specific orientation and within a specific retinal region is said to be a thought which represents the stimulus. Thoughts on this application, can be arranged in a spectrum that varies between two extremes, Tightly Specific and Abstractly General, for example, a specific edge with its specific orientation, retinal location and color as well as size, is considered a tightly specific thought, let's say we refer to this edge example as thought A. On the other hand, the concept of a general edge stimulus regardless of what orientation, location, size or color it might take, is a general thought, and let's say we refer to this other edge example as thought B. Tightly specific thoughts contain one and only one information in their class. General thoughts contain many tightly specific thoughts within their class, for example, there is only one specific stimulus that has the properties mentioned for thought A, however, there could exist many stimuli that commonly share the identification of an edge which thought B encompasses, and therefore thought B would include thought A, since thought A belongs to a large class of edges represented by thought B.

General thoughts can vary from being not so general to being abstractly general. For example, the concept of a Toyota vehicle, is a general concept, since the class of things that could be considered Toyota vehicles includes many cars, vans, mini vans, with many different possible color variations, different models, and different sizes etc. On the other hand, the concept of a white Toyota Camry model car is a more specific concept than a Toyota vehicle, as it restricts the class to a specific brand, color, model and type of vehicle (a car), which means the class becomes less general and a little more specific, moving slightly towards the tightly specific extreme of the spectrum. Similarly, the concept of a vehicle is a more general concept than a Toyota vehicle, since it removes a restriction to the previous class by removing the specific brand of the vehicle, and as a result widens the amount of possible elements that could belong to this newly unrestricted class, where it includes all possible brands of vehicles, which means the class becomes less specific and therefore more general, moving slightly towards the abstractly general extreme of the spectrum.

We divide thoughts into two categories, vertical and horizontal, where vertical thoughts are thoughts that have their constituents distributed within a singular moment in time (a 50 millisecond duration in our implementation refers to said moment), for example a shape, where all the elements of the shape can be perceived simultaneously in one singular frozen moment in time, a horizontal thought on the other hand is a thought that has its constituents distributed within a temporal span, for example a certain music piece or a video clip. A horizontal thought is composed of many vertical thoughts that are temporally arranged, for example in a video clip, each frame could be considered a vertical thought containing spatially distributed information which share a singular moment in time, whilst the entire video clip represents a horizontal thought which is composed of a temporal distribution of said frames.

We further divide horizontal thoughts into two sub-categories sequential and non-sequential, sequential horizontal thoughts are thoughts that are arranged in a specific sequential distribution (i.e., sequence), an example would be a music clip, where if the notes of a particular music clip were randomly re-distributed and did not not follow the specific temporal sequence they originally are composed in, such music clip becomes unrecognizable. Non-sequential thoughts are thoughts that can be recognized regardless of their temporal sequential arrangement, in other words are independent of sequence, for example a language, a person can recognize a language from the set of phonemes which make up that language regardless of what sequential distribution these phonemes take, and therefore regardless of what specific word/sentence is spoken.

Non-sequential horizontal thoughts tend to be general thoughts, and they encompass a wide variation of different sequential horizontal thoughts which are specific thoughts, where in the previous example the general class contains all possible sequential variations of phoneme distributions within a specific temporal span, where the general selective neuron becomes selective to any possible combination of phonemes that were experienced by the network, and learns the more general concept.

Vertical thoughts are also subdivided into two sub categories, patterned vertical thoughts and non-patterned vertical thoughts, patterned thoughts are thoughts that are arranged in a specific distribution for example in visual stimuli that would be a specific spatial distribution, an example would be a specific written word, e.g., intelligence, where the spatial distribution of the letters of this word are arranged in a specific spatial distribution, and any different random distribution of those letters which make up this word either address a different word or some unrecognizable meaningless distribution of letters, e.g., tegenlcilien.

Non-patterned vertical thoughts are those that can be recognized regardless of their distribution, in other words are independent of any specific distribution, for example objects, objects are recognizable regardless of where they belong in the visual field, or what orientation they take (notice that the property of extension is by definition a distribution of local positions taken by the object). Non-patterned vertical thoughts tend to be general thoughts, and they encompass a variation of different patterned vertical thoughts, where in the previous example the general class contains all possible spatial variation of the object's distribution within a specific spatial region (fovea region), where the general selective neuron becomes selective to any possible localization of the given object that were experienced by the network, and learns the more general concept.

Recall that any specific relative orientation, size, relative retinal location (bound by fovea visual field region), color as well as shading of a particular visual stimulus (e.g., object) is addressed as one perspective of that object, for example a written text could have many possible locations within the fovea region, i.e., relative to it, therefore its said to have many local perspectives, similarly the same text could possess a large amount of possible font colors, and is said to possess many color perspectives, and so on for the rest of the properties like shading which describes the stimulus undergoing different lightning condition, or size which describes the stimulus undergoing different sizing either relative to the fovea and regardless of the background, in other words an object that is perceived farther away is said to be smaller in relative size, than an object that is close to the eyes, or actual changes in size which tend to be relative to the background and other objects around it.

Similarly color and shading could also change either relative to the surrounding where color changes due to lightning conditions or relative to the actual changes in the color of the stimulus, for example if an apple drawing within a certain image is perceived gray in color it could either be that the entire image is gray scaled or that the apple itself is colored gray intentionally by the artist, another example would be lightning conditions, a stimulus might appear in different colors due to a difference in the lightning conditions, or it may appear in different colors because the stimulus itself actually changed in color.

A stimulus can also take many different orientations, for example an edge of size 3 pixels bound within a 3*3 kernel could be perceived in 4 different possible orientations relative to the center of the grid, therefore it is said to possess 4 different orientation perspectives, each of these perspectives can learned by a single selective specific neuron. Orientation can also be relative to the visual field or relative to the background around it, when a mammalian creature tilts its head the background and all objects within it, which the mammalian brain perceives through its vision is perceived oriented, but as color in different lightning conditions, in different head orientations the network experiences a change in orientation across the entire elements of the background, similarly an object could also have undergone an orientation itself and not due to any tilting of the head, therefore it becomes the only object that undergone a change in orientation relative to all the other elements of the background.

Therefore any specific relative orientation, relative size, relative retinal location (bound by fovea visual field region), color as well as shading of a particular visual stimulus (e.g., object) is addressed as one perspective of that visual object, and the same goes for acoustics as well, where a different volume of a sound piece is one perspective of said stimulus. A perspective therefore is defined as one state of a perceived general stimulus, for example a particular square shaped area, with a particular position in the fovea, and a particular color, as well as a particular orientation and a particular size is said to capture one perspective of that square. Size, position and orientation are what we refer to as fovea relative properties of the visual stimulus, and this is because each of these three properties can be relative to the observer's fovea as clarified previously, where if the observer tilts their head the orientation of a stimulus changes relative to the fovea, and if they were to move closer or farther away from the object, the size of the perceived stimulus changes relative to the fovea, and if they were to change the center of the fovea (via gaze shifting), the location of the object would change relative to the fovea.

Selective specific neurons capture stimuli at one particular perspective, and therefore over extended periods of experiencing the world in real-time, neurons develop specific selectivity to each of these perspectives and strengthen both the lateral connections and the feedforward connections which represent their representative web structures and selective neurons, respectively, based on their persistence in the environment, i.e., the frequency of encountering them, and due to motion it becomes even easier and quicker to develop many selective specific neurons that capture and learn all visual perspectives, since they become more frequently encountered. One of the goals of a developing mammalian brain is to establish a way to unify all the varying perspectives of one complex stimulus and establish a selective general neuron that is selective to the class of all perspectives that represent said stimulus.

We introduce two processes for qualitative generalization, the first process we address as the process of sensory abstraction, and the second is addressed as the process of associative commonality, and we classify qualitative generalization into two levels based on these two processes, low level generalizations which are solely based on the process of sensory abstraction, and high level generalizations which are based on both processes, associative commonality and sensory abstractions. We begin this section with the process of sensory abstraction and then move on to the process of associative commonality, and end the section with the entire process of qualitative generalization.

### Section 4-A (Class Definition Subtraction via Sensory Abstraction)

Here, we introduce a method of generalization that is based on the deterioration (weakening) of connection strength as a function of time based on the low frequency of encountering certain structures and sub structures which constitute pieces of a complex set of stimuli and relative to frequently encountered other structures and sub structures which constitute pieces of the same complex set of stimuli, in what we refer to as the process of sensory abstraction.

The process of sensory abstraction in this application, refers to the network's ability to disproportionately represent information, by retaining parts of the information which are found common across a class of similar stimuli, and dispose of parts of the information which are found to be not commonly shared across that same class. Quantitative generalization processes heavily rely on this process as it is the sole mechanism used by optimization processes and which they mostly revolve around, this is because cost minimization acts as a means to remove a feature from the domain space of possible inclusion by a certain mathematical function which represents the boundaries of such inclusion in a numerical representation of the data. Where positive modulations of connection weights act as the retainer of such information, whilst negative modulations of connection weights via a cost function act as the disposing mechanism of such information. Recall that on this application, the positive modulation function is based on the frequent encountering of said information, whilst the negative modulation function is based on a natural decay that is a function of time, similar to the mammalian memory.

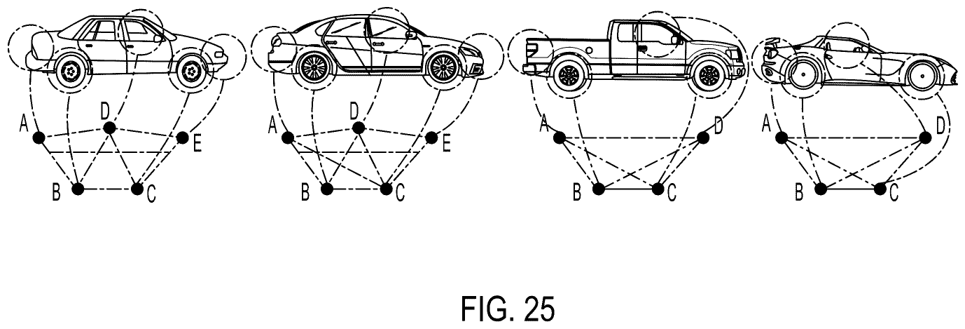

Low level generalizations are based on the process of sensory abstraction, and this can be shown in FIG. 25. FIG. 25 shows different illustrations of vehicles that share a few common features that look identical, where said features are represented by a set of selective nodes in a web structure presented under each vehicle illustration. The selective nodes are labeled A, B, C, D, and E. Four of the features are found common across all four illustrations, and therefore their corresponding selective nodes which represent them are also found common across all the corresponding web structures. Although each vehicle shown in the figure is unique, in essence all the vehicles share some common features (e.g., A, B, C, and D). Each vehicle is represented by a feedforward selective neuron which represents a web of selective neurons representing those features.

When the network perceives each of the vehicles, the network frequently perceives the common features that are shared by all vehicles 4 times. Therefore, due to the learning algorithm these common features eventually form a strong web with one another, where they would form strong lateral connections as a result of the frequency of encountering such features. Because dynamic kernel boundaries extract information that are independently and collectively activated together, we would expect that eventually the web is going to be associated to one feedforward selective neuron via feedforward connections, and would also be modulated a few times. Said selective neuron is said to be a general neuron that holds an abstraction of all the specific vehicles.

It is essential to clarify that the same way the common features form a web of connections amongst each other, the neurons that make up each vehicle (including the common features) form a lateral web as well as would be associated to a feedforward selective specific neuron. The only difference between the associated feedforward selective specific neuron of each specific car and the associated feedforward selective general neuron which represents the web of common features is that, first, the strength between the lateral connections of the members, of the latter would be 5 times stronger compared to the former. Second, the members of the latter are a subset of the total members of each of the former's web. In this case, we say that the selective general neuron abstracted the five selective specific neurons, hence abstraction.

Realize that this means that the web that triggers a selective general neuron is always bound to be stronger than the web which triggers a selective specific neuron, because a general neuron is only formed by a web of common features found between multiple specific stimuli, and hence are always be more frequently encountered than the stimuli they are a subset of. If we later on independently present any of the vehicle stimuli onto the perceptions of the network, the general selective neuron which abstracted the vehicle stimuli showcased in the previous example are active regardless of which of the stimuli was presented. Hence, we say the neuron is generally selective as it generalized over the samples, and this is due to the fact that any of the stimuli contains the common features that make up the web which activates said general selective neuron. The more vehicle stimuli the network feeds on, the more abstraction is provided.

However in this case, and with abstraction alone, the learning algorithm of the network can only subtract those features that are uncommon across all the data set, and therefore the criteria of classification becomes highly restricted by the common features found in the first few stimuli a general selective neuron learned to be selective to. This restriction is what makes a generalization method based on abstraction alone a low level generalization process. To clarify further, a class that represents a group of similar objects, is defined by the elements which are common across all the members of said class, any object that does not fit the class definition is an object that shares no common elements with the members of the class. In other words, a new member vehicle that lacks one of the common elements that are present across all other vehicles which satisfy the class definition would be considered not belonging to the class definition, since not all elements which are common across all the members of said class are present in that new member.

Sensory abstraction allows the network to extract an independent group of sensory features represented by selective neurons that are found common across two or more stimuli by retaining those common features and disposing of uncommon features. The problem is that once a selective general neuron learns those specific group of features, it becomes only selective to said group, and therefore the class becomes statically defined as, that which shares those common features and none other. The goal of generalization is to allow for a dynamic class definition which can subtract as well as add features from the class definition, and this is where the second process of generalization is required.

### Section 4-B (Class Definition Addition via Associative Commonality)

Here, we introduce the most important feature of this architecture (and our breakthrough in the field of cognitive neuroscience), high level generalizations via associative commonality. Associative commonality is a term we coin for the process by which this neuromorphic neural network architecture classifies stimuli represented by selective specific nodes into generalized classes of stimuli represented by selective general nodes, where a selective node learns to be selective to a wide variety of stimuli which share a common class, e.g., a class of dog photos or a class of cat images, a class of music sounds or a class of speech sounds, etc.

To illustrate with an example, if say we had a set of 9 car illustrations, where each has some common features with one another however unlike the previous example in FIG. 25, the common features are not necessarily found in every member of the class, but are spread rather across many of them such that, members 1, 2, and 3, share a set of 4 common features as shown, whilst members 4, 5, and 6, share a set of different common features, and members 7, 8, and 9, also share a third set of common features with one another. Each set out of the three feature sets would have its elements form a lateral connectivity structure with one another as result of them being encountered simultaneously.

The process of associative commonality shall allow all the sets of common features which are shared by some of the members of the class to equally have an activation influence over a single general selective neuron, where said neuron encompasses all the frequently encountered sets of features found across the 9 members of the class, and therefore the goal is to learn the features that are most repetitive across all the data sets even if many members of the data set did not even contain those features, this means learning all the common feature sets that were associated to this class of 9 cars such that said set of features can equally activate the general selective neuron.

To accomplish this each lateral web, representing each set of common features, shall have the ability to influence the same general selective neuron, such that the general selective neuron becomes equally elicited if any single one of the 3 feature sets were to be encountered again, for this to be possible and executed autonomously, there has to be a way which clarifies to the network that all the car samples belong to the same one large class represented by the general selective neuron, and this can be achieved via associative commonality.

Associative commonality, states that a set of stimuli can only be grouped under one large class if an only if they share at least one common stimulus across all and every single data member of the class. A very familiar example of this process in action, is language, language is one of the greatest tools for mammalian generalization, and performs one form of associative commonality, which we address as associative linguistic commonality, an associated linguistic commonality to a thought is a fancy term for a “word”. An associated commonality is a stimulus which acts as a label which is found to be associated to each and every member of a data set, and represents the large class which encompass all said data sets.

When a young human child observes the visual stimuli presented around them they tend to hear associated sounds, i.e., spoken words, repetitively associated to these stimuli. Over time, these words form associations to the stimulus via lateral connections as a result of the stimuli being encountered in tandem, and in our example that would be hearing the word car spoken by the child's parent, which becomes the associated commonality which is associated to every single car stimulus the child observes. For the sake of simplifying the explanations we assume that the spoken word “car” is replaced by a written word form of it “car” which for simplification is observed in one and only one singular perspective across all the associated members of the class. In other words, we assume that every car stimulus the network perceives is always perceived in association to this written visual word “car” in one particular perspective, which therefore would be represented by a single specific selective neuron.

The reason we mention this is because in reality, the commonly associated spoken word, is itself represented by a general selective neuron since it can be perceived through many perspectives, representing different ways the word could be spoken through different vocal cords or at different volumes. Despite this we figured that although language is a relatively complex type of associative commonality it is still a relatively simple introductory example for the process of commonality since humans are familiar with it, however the reader must pay attention to the fact that the examples are based on restricted assumptions and that there is more to associative commonality via language if we were to alleviate said restrictive assumptions.

Based on our previous assumption, this written word car is associated to its own selective specific neuron which activates whenever that singular perspective of this word is visually encountered, and since as we assumed previously, this particular word in that particular perspective is made to be encountered by the network in association to every car stimulus experienced by the network from the example, then it follows that, every visual stimulus of a car represented by its own specific selective neuron is going to be activated in association to this particular common selective specific neuron.

If the selective specific neuron which represents the associated commonality, happens to exist in a layer forward to the layers which encompass all the web structures which represent the common features of each set, such that all the three web structures happen to be within said specific selective neuron's receptive field bound, based on the learning algorithm as well as the feedforward and lateral connectivity structures mentioned, said specific selective neuron would accomplish exactly the task of a general selective neuron where it would only activates in response to each and every set from the three feature sets represented by all three webs of common features. This is because every time one car stimulus from the 9 car set activates in association to the associated commonality, i.e., the word, a feedforward set of connections is established between the web of features representing the car member stimulus and the feedforward selective specific neuron which represents the associated commonality, the word.

Therefore, each web structure would be independently connected to the same selective specific neuron (the associated commonality) and hence, that particular selective specific neuron becomes a general selective neuron, which generally activates in response to any of the members of the large class. Notice that the associated commonality is both a specific selective neuron which represents a word in a particular perspective, and a general selective neuron which represents the class of stimuli which were encountered in association with that word in the network's experience, but this is not merely memorization, since each set of common features are extracted from all these members via sensory abstraction as was clarified in the earlier sub-section.

Both generalization processes are showcased in FIGS. 44, 45, and 46. In FIG. 44 we showcase two layers of circles representing receptive nodes numbered from 1 to 18 top to bottom, the first layer represents a first encounter of a car photo representation, we refer to it as “car photo 1”, the second layer represents a different encounter after the first encounter of a different car photo representation, we refer to it as “car photo 2”. On both layers we have the same associated common label “CAR” represented by the same shaded circle nodes 8 and 9. The car photos representing nodes are different across the two layers since they represent two dissimilar cars.

We use six shaded nodes to represent each car photo per layer. On layer 1, nodes 3, 4, 6, 10, 12, and 13 represent the first car photo, whilst on layer 2, nodes 1, 2, 5, 11, 14, and 16 represent the second car photo. Notice that both layers are one on the same, we just showcase different iterations, and this is why the nodes which represent different stimuli (car photos) are different whilst the two nodes which represent the associative common are the same in both iterations. In the figure, we showcase 6 thin connections and 2 thick connections projecting from the photo representing nodes and the associative common representing nodes, respectively.

In the first iteration, car photo 1 was encountered in association to the word “CAR” and as a result the one specific selective node which represents the label “CAR” on the forward layer became associated to the 6 car photo representing nodes (3, 4, 6, 10, 12, and 13) from the earlier layer. Similarly, in the second iteration, car photo 2 was encountered in association to the word “CAR” and as a result that same one specific selective node which represents the label “CAR” on the forward layer became associated to the other 6 car photo representing nodes (1, 2, 5, 11, 14, and 16) from the earlier layer.

At this point the selective node has memorized the entire representation of two car photos, and therefore if either set of 6 nodes were to be active the selective node would be active in response to it.

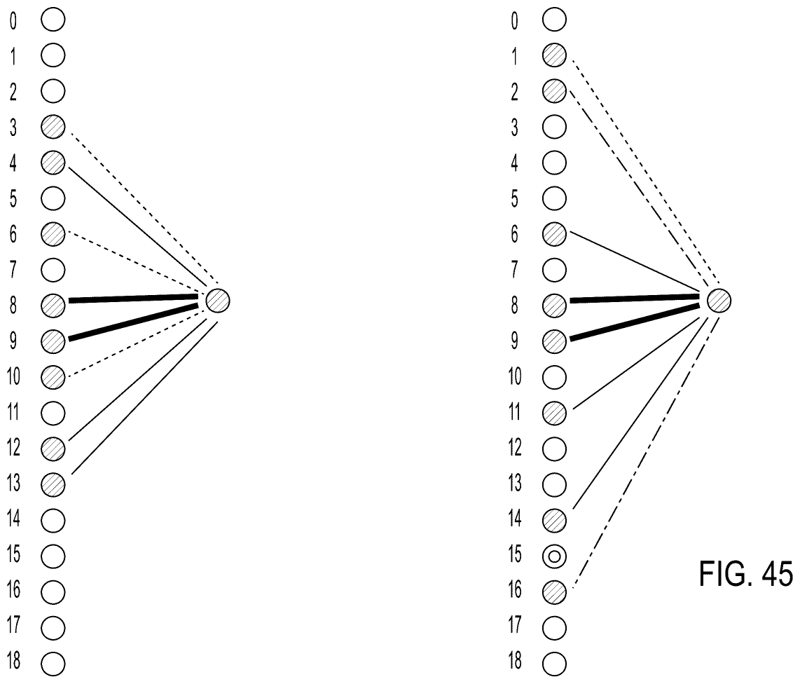

In FIG. 45, we showcase the process of sensory abstraction on a next iteration, where not all 6 car representing nodes are being encountered regularly across a class of car photos. We assume that only nodes 4, 12, and 13 as a set and nodes 5, 11, and 14 as another set are common features found across many car photos the network has encountered, whilst the rest of the nodes from either set of 6 nodes, represent non common features but rather distinct features which identify each car photo. We showcase how as a result of the aforementioned node's infrequent existence across a set, their connections towards the selective node would deteriorate over time as showcased through the dashed connections.

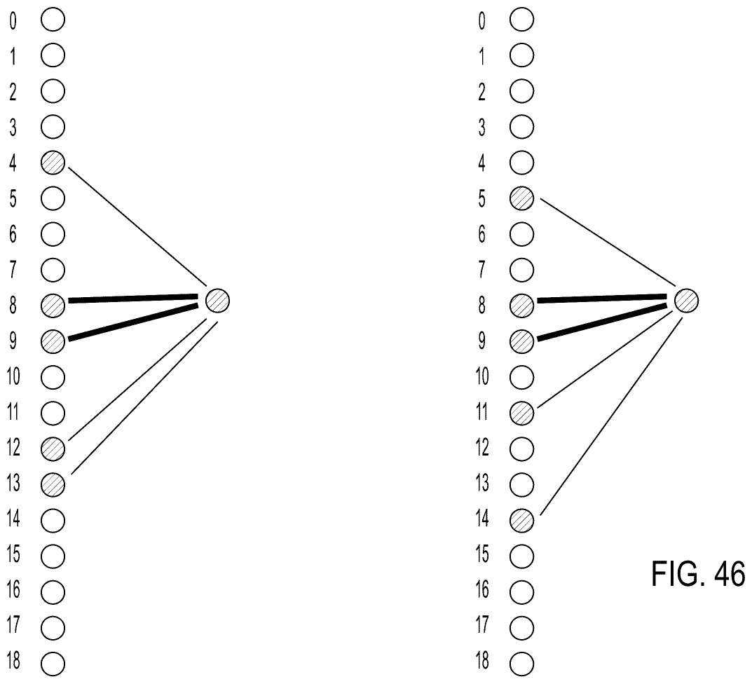

In FIG. 46, we showcase another iteration where all weak connections completely break off, and only strong features from the set of car photos representing features remain connected to the selective node as a result of their frequent presence across the set of all car photos the network has encountered. In FIG. 46, we showcase that either sets of strong features can independently activate the selective node, and here we can say that the selective node generalized over the knowledge it had previously memorized.

Realize that a combination of the feature nodes of both feature sets can also active the general selective node, for example, nodes 4 and 12 from set 1, and nodes 5 and 11 from set 2, together as one set combination (4, 5, 11, and 12) and should have the ability to activate the general selective node. In fact this case is most common case where a network encounters a new car photo which shares a combination of features found across multiple different sets of similar car photos (e.g., different car sets for a different feature set, each having similar car photos sharing common identical features).

Associative commonality alone would represent memorization where all stimuli with their full sensory representation (i.e., the set of all features which represent a given stimulus) which are encountered in association with the associated commonality (the word) are added to the class. It is the process of sensory abstraction, on top of associative commonality which allows the selective general neuron to turn from memorizing all stimuli with the set of all features which represent each stimulus, to memorizing only the highly frequent and common features that are present across many stimuli for all stimuli. This is the definition of generalization, which is to only learn what is common across a class data set.

Therefore, the class is defined by the associated commonality which itself becomes the general selective neuron which actives in response to the conglomeration of repetitively encountered common features shared by the members of the large class. This establishes a dynamic class definition since any set of newly encountered stimuli which happen to be associated in tandem with the associated commonality, can have its features added to the definition of the class, where the class thereby grows over time, however this does not mean that such feature additions to the class definition is boundless, since the process of abstraction acts as the counterforce process which removes features from the class definition via memory deterioration.

Recall that the learning algorithm is based on the frequency of encountering a particular stimulus, and therefore a process of refinement is bound to exist as a result, where the definition of the class would be refined over the network's experiences such that both associative commonality and the positive modulation function provide additions to the class definition whilst sensory abstraction and the negative modulation function provide subtraction to the class definition, and the more experience the network has for a particular class of data, the more refined its class definition becomes. Notice that the associated commonality can be distributed across many feedforward selective neurons and does not necessarily have to be a singular selective neuron, we only used singular feedforward selective neurons in our explanations for simplification. For example let's say we use 1 associated commonality web which represents the written word “car” on layer 2, and 9 feature webs representing the 9 different car examples on layer 1, we assume that the webs in layer 1 are within the receptive field bounds of the total selective neurons that represent the commonality web on layer 2.

Every time the network experiences a car stimulus in tandem with the written word “car” both the car web which contains the features that represent the car and the feedforward web of selective neurons which represent the written word, would be activated in tandem at the same brief time interval, and therefore feedforward connections would form between the former web and the latter web, this would traverse across all the car stimuli which are experienced in the similar fashion, i.e., in tandem with the associated commonality, where each car web would form feedforward connections with said associated commonality's web of distributed feedforward selective neurons. Over time and across a large amount of data, sensory abstraction would make it such that only the frequently occurring sensory features which are encountered in tandem with the associated commonality, have their feedforward connections towards said commonality strengthened, whilst the rest of the feedforward connections which project from the infrequently encountered other sensory features would get weakened over time.

Recall that the network forms 4 dimensional representation of information since it experiences a 4 dimensional world, where the set of stimuli it perceives are both distributed across the 3 spatial dimensions as well as the single temporal dimension, and so far we only tackled spatially distributed information, and a misconception one might make is to assume that the network's representation of a dynamic stimulus, say a dynamic visual like the rotation of a cup of coffee, is represented in the form of a temporal succession of a set of static frames such that each frame represents a single selective neuron and then assume that the network builds its representation of the world upwards by combining the selective neurons which represent the frames to form a video, however, this is a misconception derived from our preconceived notions of how movie clips work, because in reality the network represents the entire 4 dimensional chunk (the video) at once.

In other words the information a mammalian network or an NNN network perceives is not divided into distinct frames, but is rather divided into distinct video clips upon perception. Recall the solid piece of wooden cube analogy, where we said the network crafts wooden pieces out of the wooden block, there is absolutely no reason to assume that such wooden pieces are only spatially distributed, i.e., exhibit no temporal dimension, it's only our primitive form of spatial thinking which we humans inherited from the cultural narratives in the form of preconceived notions which makes us think spatially rather than temporally. Nevertheless, because each web structure represents a spatially and temporally distributed representation of some perceived stimulus, it is wrong to think in what we referred to as perspectives earlier.

Recall that we define a perspective as one state of a stimulus, however for a stimulus to exhibit only one state, it can either be an unchanging stimulus, or non-temporally represented stimulus, the world however is always changing due to the second law of thermodynamics, and when a 4 dimensional web structure which represents a given stimulus undergoes change, said structure encompasses many states/perspectives, for example, a rotating cup encompasses hundreds of edges exhibiting many different orientational or/and positional states/perspectives, all of which are represented by a single 4 dimensional web, which can be represented by a single feedforward selective neuron.

Previously we used language to give an example of a relatively complex version of associative commonality, which we referred to as associative linguistic commonality, and we did this to give an intuitive introduction of the process to the reader, here we introduce the simplest version of associative commonality which we refer to as associative sensory commonality. As one might infer by analogy, associative sensory commonality is the process by which a qualitative generalization can be established between a set of stimuli provided that all the members of the set share one associated commonality, in the form of sensory information. Where sensory information refers to the smallest building block of any sensory perception observed from a single perspective, e.g., an edge in a particular orientation within a particular location and in a particular color configuration, or a particular phoneme in a particular sound volume, etc.

In other words rather than having a linguistic signifier such as a spoken or written word or phrase that acts as the associated commonality for a given class of stimuli, a group of simple sensory information, like edges, color textures, simple shapes, phonemes or a combination of all, act as the commonality which is shared across a group of stimuli, and this is due to the fact that a set of perceptually similar stimuli are fundamentally bound to share a set of identical sensory information.

Perceptually similar stimuli refer to a similarity in perceptual experience, like a pair of socks of the same type, or two smartphone with the same color and brand, which is different than conceptually similar stimuli which refer to a similarity in conceptual connotation or denotation, like a sofa and a wooden chair, both the sofa and the wooden chair look perceptually dissimilar, whilst they share the concept of “being able to sit on one” which makes them conceptually similar.

Associative sensory commonality is what sensory abstraction was all about, where the associated commonalities were a set of selective neurons representing a set of sensory information which happened to be common across a set of perceptually similar stimuli. If we take the example of a spoken word, there are many perspectives which said word can be observed at, however by definition two similarly sounding words are bound to share some identical constituents of the sound, these could be identical frequency sounds in their frequency spectrum, this is because a word is made up of phonemes which are sound bits that has a particular frequency spectrum, and two adults pronouncing the same phonemes are bound to elicit the activation of an identical set of frequencies, even if some of these frequency sounds' intensities might differ as a result of differences in their voice, since no two humans share the same vocal tracts. Recall that a set of sound frequencies are represented by a set of hair cells in the cochlea which are then represented by a set of selective neurons.

When the network encounters a particular word, spoken by two different humans, once the network captures and represents each stimulus using a spatially and temporally distributed web, each web are bound to share a set of common identical sensory features, in the form of a set of frequency sounds activating the same set of selective neurons, not all of the members of each web would be identical to one another, but many are due to the fact that both words “sound” similar since they are same word spoken by two different people. This would create a third web structure which encompasses said common sensory features, and this web would be represented by a general selective neuron, and since one word always shares similar features with all the variations of it being spoken through different mediums, i.e., vocal cords, i.e., different people, those similar features become the associated sensory commonality which defines the class of all sounds that resemble said word, where the class would be defined by those set of identical features shared across all the members of the class, and would be refined over time.

This general selective neuron which resembles said word can then itself become an associated linguistic commonality to the set of all stimuli which are associated to said word. In other words we can replace the written word “car” in the earlier example which was represented by a specific selective neuron with the spoken word “car” which is represented by a general selective neuron formed via sensory abstraction, and then imagine the exact same processes explained earlier taking place. In the case where the commonality is linguistic, i.e., is a word we say the data set was labeled through a linguistic common association, realize that this labeling happens autonomously and not via some external interference like some data scientist labeling data sets in a traditional artificial neural network architecture. In other words it just so happens that the child is hearing a frequent association between a word and the visual stimuli they perceive.

The feedforward general selective neuron is said to have abstracted the 9 car stimuli based on the other general selective neuron which acted as the associated commonality of all 9 car stimuli, and we can assume that the greater the data set is the more common features that would be abstracted and be frequently encountered and the larger the class definition would become (as in it would grow), eventually capturing all the common sensory features that are frequently encountered across all experienced car stimuli the network has experienced which are associated to the commonality, and since this network's learning process is dynamic, this class definition of said general selective neuron is bound to be dynamic, and therefore would change based on a change of the experiences of the web.

This means that general selective neurons themselves become the associated commonalities of any given class, and therefore allowing the network to possess the ability to build up complex generalizations via a hierarchy of generalization, such complex generalizations includes linguistic based generalizations, which paves the way for the emergence of conceptualization. This is because in essence human language chops up the visual and acoustic world into pieces and associates to these chopped up pieces certain signs/symbols manifested in the form of signifiers (words), and once the network encounters throughout a long duration of time, a vast amount of stimuli that are classified according to said signifiers, it undergoes a process of refinement based on both the positive and negative modulation functions introduced in the learning algorithm, such that over time a given class of stimuli which share the same associated linguistic commonality in the form of a signifier, is abstracted and represented by a single or a set of general selective neuron/s, forming a general concept, or what philosophers and logicians refer to as a universal concept.

A general selective neuron that is selective to a wide variety of general features is said to have learned to recognize a concept. It is essential to highlight that the web is dynamic in size, and that it can decrease in size as well and the links could easily be broken as long as the frequency of encountering the concepts is reduced, and similarly the web can change dynamically where the concept that it sets to describe gradually changes over time, the same way selective specific neurons as explained previously can gradually change the stimulus that they are selective to provided that the stimulus changes gradually ever so slightly.

In fact, there is an even more sophisticated form of generalization that starts to take effect once the network matures a little bit, where encountering similar stimuli and regardless of the network's encounter of the associated commonality, would reinforce the definition of the class automatically, this is possible because every time a similar stimulus say a new car stimulus is newly perceived, it can cause an activation to the feedforward general selective neuron due to a set of common features which it shares with the class represented by said general selective neuron, which would establish a recognition, and as a result of the pair's activation, the new car stimulus with all of its features would form new feedforward connections to said selective general neuron regardless of the existence of the associated commonality, adding to the definition of the class it represents even if no associative commonality process took place in the first place, thereby establishing a positive reinforcing feedback loop, where the more stimuli the network experiences which happen to be similar enough to establish a recognition, the better the network would generalize over the given data set.

Recall that this network architecture is layered in structure, and this is to allow for shareability, and shareability is only possible if there are commonalities between stimuli, and the more deep a layer is in the network, the more we would expect the presence of such common and shareable features. This would entail that the amount of selective general neurons would increase the deeper we go onto the network structure, and serves another reason for the necessity of a layer structure in this artificial neural network architecture. For example, a 10 layer deep selective general neuron is more capable of classifying both a sofa and a wooden chair as similar relative to a 3 layer deep general selective neuron, because the concept of “taking a seat” is more likely found on a layer deeper than 3, where the concept of “taking a seat” acts as the associative commonality to both objects.

In other words, the distribution of general selective neurons that would naturally emerge within the confines of both layer structures is not going to be proportional across the layers of the network, where deeper layers would contain more general selective neurons relative to earlier layers. This explains why the prefrontal cortex in the mammalian brain is composed of neural representations which are characterized to be responsive to information which are highly abstract.

The hyperparemeters which dictate how well the network generalizes would be those that affect both processes, sensory abstraction and associative commonality. Sensory abstraction is reliant on the decay function, the slower the decay function is, the slower the network is to forget and therefore the slower it is to abstract and vice versa. Faster abstraction yields faster generalization, since it is the process of abstraction which transitions knowledge from its memorized form to a generalized form as clarified earlier. However, too much forgetting can yield difficulty in learning or even not learning anything at all, as observed in an Alzheimer's patient.

On the other hand, associative commonality is reliant on the growth function, the faster the growth function the quicker the network is to form associations with the general selective node, and hence the quicker it is to memorize and vice versa.

If the network is able to memorize much faster than it is to forget/abstract, the network becomes slower at generalizing over its acquired knowledge. However, if it were to be able to forget faster than it is to memorize, the network becomes unable to acquire said knowledge in the first place. Too much memorization is akin to overfitting whilst too much abstraction is akin to underfitting. A sweet spot between overfitting the data and underfitting the data is required to achieve generalization. This can be achieved by balancing the network's ability to memorize and the network's ability to forget, which is achieved by tuning the network's growth and decay functions, respectively, as clarified below in the section regarding network implementation.

Notice a key difference here between traditional neural networks and NNNs is that in neuromorphic learning overfitting is not dependent on training epochs and is rather dependent on a hyperparemeter which is the ratio between the growth function and the decay function. On the other hand, optimization-based neural networks can overfit data when training on them for too many epochs, causing an overtraining problem, whereas in neuromorphic learning there is no such thing as overtraining a network. Implying that a network can overtrain is implying that a given network is overlearning, which is counterintuitive to our notion of mammalian learning, as there is no such thing as overlearning in the context of mammalian learning.

Qualitative generalization, is an emergent property of the network as it is the byproduct of both the process of sensory abstraction and the process of associative commonality, which are both byproducts of the lateral connectivity structure, the feedforward connectivity structure and the learning algorithm stated on this application, and it might be worth to mention that qualitative generalization alone is what the experts in the field refer to as the holy grail of Artificial Intelligence, as it not only solves the century long cognitive neuroscience problem of mammalian generalization, but it also showcases the first implementation of a generalization process that is equivalent to the mammalian brain, and therefore singlehandedly acts as a corner stone for Artificial General Intelligence, solving one of the most important AI problems of the 21st century.

### Section 4-C(One Possible Implementation of Qualitative Generalization)

In this short subsection we explore, a primitive implementation of this qualitative generalization based neuromorphic neural network architecture, such application is what we refer to as the MSVRSTI algorithm, which is short for the (most sophisticated video recommender system there is), and the reason why we chose this to be the name of this little application of this network architecture is clarified below.

Video clips are a good example of a highly compacted and dense source of information there is, this is because in a video clip, one can extract, visual and acoustic information of different and complex varieties, like real footage, animated footage, voices, musical pieces, etc. Normally using traditional neural network architecture-based recommender systems, this type of information is turned into quantitative representations which are then classified using quantitative-based comparisons and quantitative-based optimization techniques, and while such recommender systems are mostly good at doing said task, they are not efficient nor sophisticated relative to a human brain doing similar recommendation tasks. These traditional systems are not efficient because they require so much data to be trained on, in order for them to perform their task, and they are not sophisticated because once information is transformed from its natural qualitative representation into a quantitative representation form, a lot of crucial information is lost as a result of the transformation.

Once the network is already mature and had been fed some video clips, by reversing the process of qualitative generalization explained on this section, one observes results that are equivalent to the results achieved by the most efficient and sophisticated recommender system known to mankind, the human brain, as for the first time in history, an artificial system can analyze a set of data based on their qualitative features, both specific and abstract qualitative features, and not based on quantitative features, allow for accurate classification of information and thereby accurate recommendations, and by the word accurate here, we mean accurate relative to human judgment which is usually the metric by a which a typical video recommender system's efficiency is typically measured. It is worth mentioning that human judgments for video information is based on qualitative features and not some RGB matrix of integers.

To further elaborate, while quantitative-based neural network and optimization-based algorithms tend to do a decent job recognizing qualitative features of some qualitative experience, say, for example, a convolution neural net that is trained on immense labeled visual data, they are required to first be trained to recognize all these various qualitative visual features before they can even begin learning to use these recognized features as a means to classify more complex information like video clips, this is why recommender systems that are based on quantitative and optimization means generally require an extensive amount of data to do the same task that can be accomplished by a mammalian brain or a qualitative generalization-based NNN architecture for that matter using a fraction amount of data and with almost no external interference (alluding to the labeling task required in traditional convolution neural nets, which is considered an external interference to the system).

### Section 5 (Detailed Implementation Of Example Embodiments)

Here, we showcase both a possible software and a hardware implementation of the neuromorphic neural network architecture.

### Section 5-A (A Software Implementation)

In this section we only describe the software implementation of this architecture. The software implementation of this architecture is divided into two parts, one which deals with the elements of the architecture and another which deals with the connectivity structure of this architecture, and we begin with the former, then move onto the latter.

In the software implementation of the architecture, a neuron is represented by a node, where each and every node shall be able to hold 12 variables representing a state, a weighted sum accumulator, a pair of net positive signal accumulators (one for positive signals received via lateral connections and another for positive signals received via feedforward connections), a pair of net negative signal accumulators (one for negative signals received via lateral connections and another for negative signals received via feedforward connections), a quotient variable, an array of cell gates, a list of feedforward connection pairs, a list of lateral connection pairs, a list of feedforward modulation gates and a list of lateral modulation gates, and the node shall also be able to execute 8 functions; an influence function, a positive modulation function (a growth function), a negative modulation function (a decay function), a message sender function, an absolute balance operator function, a relative balance operator function, a feedforward node spiking function and a lateral node spiking function.

We can represent a node class and its constituents from attributes and methods using the following simplified class diagram:

Node: Node

State: bool
WeightedSum: int
LPositiveAccumulator: int
LNegativeAccumulator: int
FPositiveAccumulator: int
FNegativeAccumulator: int
Quotient: float
ArrayOfCellGates[ ]: bool
ArrayOfConnectionPairs1[ ][ ]: FconnectionPairs
ArrayOfConnectionPairs2[ ][ ]: LconnectionPairs
ArrayOfModulationGates1[ ][ ]: FmodulationGates
ArrayOfModulationGates2[ ][ ]: LmodulationGates
influence( ): void
positiveModulation( ): void
negativeModulation( ): void
messageSender( ): void
relativeBalanceOperator( ): void
absoluteBalanceOperator( ): void
fSpiker( ): void
lSpiker( ): void

The state variable stores a representation of the state of the node (0,1), the weightedSum variable stores a value which represents the net depolarization/hyperpolarization signals received from other nodes via their feedforward connections at a given cycle, this is a value obtained via the absoluteBalanceOperator( ) function, the lateral and feedforward positive and negative accumulator variables store values which represent the total depolarization signals and total hyperpolarization signals, respectively, which were received from other nodes via their lateral and feedforward connections, respectively, at a given cycle, the quotient variable stores a value which is obtained from executing the relativeBalanceOperator( ) function, the array of cell gates stores values which represent the a given selective node's receivability of message signals from incoming feedforward connection pairs projecting from a given receptive cell, it mediates all incoming feedforward connections' modulation gates, as was clarified on the feedforward connectivity section.

The ArrayOfConnectionPairs1, represents an array of connection objects instantiated from a connection class referred to as the feedforward connection class, each object represents one element from a pair of feedforward connections which are composed of an excitatory and a reverse inhibitory connection, each composed of their respective pair of an influencer and a messenger connection, each object therefore can be one of 4 connections, either one of the two influencer connections or one of the two messenger connections, all of which share some property values but also carry some other different property values.

We should emphasize the following; first, a specialization band is identified by the pair of presynaptic and postsynaptic neurons which lie across their constituents connections' terminals, second, the node which represents the presynaptic neuron (the one which the direction of influence begins at) stores the array list which represents all the outgoing connections and which specifically shares the same presynaptic terminal. Notice that in this architecture there could be only one connection object which shares the same presynaptic neuron and postsynaptic neuron pair alongside an identical latency value, mode and type.

The attributes of a feedforward connection class include, connection type which signifies whether the connection object is a reverse inhibitory connection or an excitatory connection, connection mode which signifies whether the connection object is an influencer connection or a messenger connection, a postsynaptic node, which identifies which postsynaptic node does said connection interact with, and a latency variable which would be different between influencer connections and messenger connections. All the previously mentioned are shared properties/attributes which all connection objects would share, since a feedforward connection has to be of one of the two types, one of the two modes, has a latency value and shares one postsynaptic node which it would interact with.

Another attribute which is only specific to influencer connections is a connection's strength variable, and which would be different between excitatory and reverse inhibitory connections, since for reverse inhibitory connections the incrementing and decrementing of the values of its weight values would follow a piecewise function around a particular weight value, which we refer to as the transitioning point of selectivity value, as opposed to the case in excitatory connections which would take a linear growth function as was clarified on the previous sections.

The array list of feedforward connections shall always carry four objects, such that the 1st and 2^{nd} columns of the array carry the excitatory and reverse inhibitory influencer connection objects, respectively, whilst the 3rd and 4^{th} columns of the array carry the excitatory and reverse inhibitory messenger connection objects, respectively, wherein each row in the array list represents the 2 connection objects pairs and where each object carries information about the connection's sub properties.

Recall however, that any given node forms a set of bands of feedforward connections, overall representing what we referred to as a connection bus, where each band has different latency values, also recall that a node connects to a various amount of selective nodes from the layers ahead such that also there exists latency differences amongst connections which project from the same node but towards different nodes which belong to one selective cell. Recall that the amount of nodes per selective cell changes the deeper a cell lies within the layer structure, which would therefore entail an increase in the amount of bands projected to selective nodes. Lastly, recall that we introduced what we refer to as transpassing connections, which project deeper in the layer structure and therefore as a result increase the amount of bands projecting from a given node in proportion to how deep they project their connections.

In this part we focus on a single pair of layer communications and we clarify details on the second part when we disclose the software implementation of the connectivity structure of this architecture, right now we assume that we are only concerned with nodes which lie on the first layer, and assume that we have 49 nodes per selective cell from the second layer, this would therefore mean that we would need to have 3 bands per bus and 49 rows of connections for the nodes which lie on the first layer to project to each and every node per selective cell from the second layer, and therefore each row shall contain 4 elements, representing one feedforward connection pair band multiplied by 3 bands per bus which would equate to 12 columns multiplied by 49 rows to represent 49 nodes per selective cell, such that each 4 connection element group representing one band has a latency value ranging from 1 milliseconds to 147 milliseconds, at 1 millisecond difference, for a total of 3×49=147 bands connected from one node from the first layer to 49 nodes from its corresponding selective cell in the second layer.

Each group of 4 elements together make up what we refer to hereinafter as a single feedforward specialization band, whilst a set of 3 element groups that are 49 milliseconds apart would make up what we refer to as a feedforward specialization bus, for example, a group that has a 1 milliseconds latency value, and a second group that has a 50 milliseconds latency value, and a third group that has a 99 milliseconds latency value, all together constitute the first connection bus projecting from a given receptive node to the 1st selective node from the corresponding selective cell, whilst another set of groups with latency values, 2 milliseconds, 51 milliseconds, and 100 milliseconds, respectively, would constitute the second connection bus which projects from the same node, but to the 2^{nd} selective node from the same corresponding selective cell, and so on and so forth for all 49 selective nodes.

Notice that this would be different for nodes in layer 2, which would project to more selective nodes per selective cell, and therefore the parameters of the array list would change, for nodes which lie in different layers. For example, if we assume that layer 2 contains 49 nodes per selective cell, and layer 3 contains 100 nodes per selective cell, then the array list stored in the node which belongs to layer 2, shall be 100 rows long rather than 49 rows long, and at the same time to preserve temporality, the latency values would range from 0.0 milliseconds, 0.49 milliseconds, 0.98 milliseconds . . . to 49.0 milliseconds, for a 0.49 milliseconds difference between the connection bands, in terms of total connection bus that would be from 0.0 to 147.0, also for 0.49 milliseconds difference, to account for 3 bands per bus, where a bus would still have its bands be around 50 milliseconds apart. This shall carry on for other nodes which lie in deeper layers.

To account for transpassing connections, each node shall store multiple array lists to account for transpassing connections which would have more array rows and with different latency parameters, since they project to more nodes per cell, this is clarified in the second part of this sub-section when we lay out the details of the software implementation of the connectivity structure of this architecture.

The ArrayOfConnectionPairs2, represents an array of connection objects instantiated from a connection class referred to as the lateral connection class. Each object represents a pair of lateral connections composed of an excitatory and a normal inhibitory connection, each composed of their respective pair of an influencer and a messenger connection, and as was the case previously each object therefore can be one of 4 connections, either one of two influencer connections or one of two messenger connections, all of which share the same set of property values as in their feedforward connections counterparts, and also carry some other different property values.

The attributes of a lateral connection class therefore include, connection type which signifies whether the connection object is a normal inhibitory connection or an excitatory connection, connection mode which signifies whether the connection object is an influencer connection or a messenger connection, a postsynaptic node pointer variable which identifies which postsynaptic node the connection interacts with and gives the connections access to the data members of the node, and a latency which would be different between influencer connections and messenger connections, where all the previously mentioned are shared properties/attributes which all connection objects would share, as a lateral connection has to be of one of the two types, one of the two modes, has a latency value and shares one postsynaptic node which it would interact with.

Another attribute which is only specific to influencer connections is a connection's strength variable, which unlike in feedforward connections would be identical between excitatory and normal inhibitory connections, since both of which take a linear growth function as was clarified on the previous sections.

As was the case in the previous array list, the array list of lateral connections shall also carry four objects, such that the 1st and 2^{nd} columns of the array carry the excitatory and normal inhibitory influencer connection objects, respectively, whilst the 3rd and 4th columns of the array carry the excitatory and normal inhibitory messenger connection objects, respectively, wherein each row in the array list represents the 2 connection objects pairs and where each object carries information about the connection's sub properties. In this software implementation example we assume that we have 100 bands per bus of lateral connections, and therefore each row contains 4 elements×100 bands=400 columns, to mimic 100 bands per bus, whereas each group of 4 elements together make up what we refer to hereinafter as a single lateral specialization band each 50 milliseconds apart, and where all 400 elements make up an entire lateral specialization bus.

Notice however that lateral connections could be dynamic in their formation especially if we use the method of Branching which was introduced earlier, and therefore the amount of rows per array list would also be dynamically allocated, based on the Branching function which is clarified at the second part of this section.

The ArrayOfModulationGates1 is an array of gate objects instantiated from a gate class referred to as the feedforward modulation gate class, each object represents a pair of variables which represent each incoming feedforward messenger connection pair (excitatory and reverse inhibitory) which the node receives from other nodes, one variable per connection type, and as the name suggests, each variable would represent a gate which either allows or prohibits the node's ability to receive a message from the messenger connections of each type. These variables can be found in three states: a modulating state, −1; a receiving state, 1; and a non-receiving state 0, where the non-receiving state is set to be the default state, and wherein the default state is zero when the node is inactive for gates which represent excitatory connections and reverse inhibitory connections.

The ArrayOfModulationGates2 is an array of gate objects instantiated from a gate class referred to as the lateral modulation gate class, each object represents a pair of variables which represent each incoming lateral connection pair (excitatory and normal inhibitory) which the node receives from other nodes, one variable per connection type, and as in their prior counterparts, each variable would represent a gate which either allows or prohibits the node's ability to receive a message from the messenger connections of each type. These variables are also found in three states: a modulating state, −1; a receiving state, 1 or 0 (depending on the connection type and the neuron activity); and a non-receiving state, also 1 or 0 (depending on the connection type and the neuron activity). As previously the non-receiving state is set to be the default state, and is set to be zero when the neuron is inactive for gates which represent excitatory connections and zero when the neuron is active for gates which represent normal inhibitory connections.

The modulation gate variables are only influenced by the messenger connections under certain conditions based on the connection mode. The default state for each connection mode is what we refer to as the non-receiving state, whilst the other binary state is what we refer to as the receiving state and the messaging connections would only interact with these modulation receiver gate variables, this would be by sending signals to these gates which would transition the state of these gates into the modulation state provided that they were in the receiving state at the time the message was transmitted. In other words, messenger connections would be similar to electrical connections sharing the same properties except for the strength value and the fact that they influence the receiving gate variable which correspond to each electrical connection as opposed to the accumulator variable of the postsynaptic node.

If a postsynaptic node is determined to be in the active state, all the modulation variables shift from their default state, i.e., the non-receiving state, to the receiving state, and when such is the case, if a sending node sends a message, it becomes receivable by the receiving node, and a message would be simply abstracted as a signal which transitions the state of the receiver gate from the receiving state to the third state, i.e., the modulating state −1, and when such is the case, the positive modulation function can be called and be executed for the corresponding influencer connection, then the receiver gate transitions back into its default state, i.e., the non-receiving state, and so on and so forth for every transmission cycle.

For example, if the connection was an excitatory type, then in order for the connection to be modulated, the postsynaptic node has to be active to transition this particular connection's gate from the default state, i.e., the non-receiving state, which is zero for excitatory connections, to one, i.e., the receiving state, and simultaneously its presynaptic node has to be active in order for a message to be sent through the messaging connection. When such is the case the message is sent and becomes receivable, and when received it transitions the gate from the receiving state to the modulating state which would execute the positive modulation function then back to the default state, and so on and so forth for every transmission cycle.

However, since the temporal direction matters as well, and not just the activity state, all sent messages shall be incorporated with a latency/delay which corresponds to each messaging connection's latency property. This means the nodes have to coordinate when a messenger connection shall send its message after the node has been activated, each messenger connection based on its proper latency value. On the other hand, a receiver gate is immediately transitioned into the receiving state upon the node's activation. This means for excitatory connections, the activation of the presynaptic node (which is the sender of the message in this case) has to precede the activation of the postsynaptic node (which is the receiver of the message in this case) by exactly the delay/latency margin in order for the message to be sent and received, thereby adding the element of temporal direction.

On the other hand, if the connection was a reverse inhibitory mode, then in order for the connection to be modulated, the postsynaptic neuron has to be active to transition this particular connection's gate from the default state, i.e., the non-receiving state, which is also zero for reverse inhibitory connections, to one, i.e., the receiving state, and simultaneously its presynaptic neuron has to be inactive in order for a message to be sent through the messaging connection. When such is the case the message is sent and becomes receivable, and when received it transitions the gate from the receiving state to the modulating state which would execute a modulation function then back to the default state, and so on and so forth for every transmission cycle.

Similar to before, to account for the temporal direction, all sent messages would be incorporated with a delay corresponding to each connection's latency value, and by doing this we ensure that the positive modulation function is only called when the presynaptic node (which is the sender of the message in this case) precedes in its inactivation, the postsynaptic node's activation by exactly the delay/latency margin, where only then the message would have been sent and received.

In the case that the connection was a normal inhibitory mode, then in order for the connection to be modulated, the postsynaptic neuron has to be inactive to transition this particular connection's gate from the non-receiving state, which is zero for normal inhibitory connections, to one, the receiving state, and simultaneously its presynaptic neuron has to be active in order for a message to be sent through the messaging connection. When such is the case the message is sent and becomes receivable, and when received it transitions the gate from the receiving state to the modulating state which would execute a modulation function then back to the default state, and so on and so forth for every transmission cycle. Pay attention to the difference here, where in this case the gates are at the default state (zero) when the neuron is active, and transition to one when the neuron becomes inactive, contrary to the previous cases where the gates were at the default state (zero) when the neuron was inactive and transitions to one when the neuron becomes active. Temporality shall be accounted for as in the previous cases.

The Influence( ) function, influences the positive and negative accumulator variables of all postsynaptic nodes which the node connects to, based on the specialization of the connections, the type of the connections and the strength of the connections, where signals received via inhibitory connections, lateral and feedforward, i.e., normal and reverse, increment the lateral and feedforward net negative accumulator variables, respectively, and according to the connections' strength value stored in the strength variable, whilst signals received via excitatory connections, lateral and feedforward, increment the lateral and feedforward net positive accumulator variables, respectively, and according to the connections' strength value stored in the strength variable.

This function is called whenever the state of the node is active, at which point the function traverses across the entire array of connection objects stored in the node, and starts performing its task for all the postsynaptic nodes the node has influencer connections with, and based on the parameters stored in both connection arrays.

To give an example, if the first object in the list is an excitatory feedforward influencer connection, then once the node state is found to be active, the influence function is called, and while traversing across the connection objects array list, upon iterating over the first connection object in the list, the influence function accesses the postsynaptic node's feedforward positive accumulator variable via the postsynaptic pointer stored in the connection object, then based on the latency value stored in the connection object waits a certain amount of time, then once the time has elapsed increments said feedforward positive accumulator variable in proportion to the strength value stored in the connection object, and so on and so forth for other connection objects in the array list.

The message sender function, also executes whenever the node's state is active, and iterates over messenger connections as opposed to influencer connections, however rather than accessing the accumulator variables of the corresponding postsynaptic nodes, the function accesses the modulation gate which corresponds to each messenger connection object, this function is executed differently depending on which array of connections specialization is being traversed across.

For feedforward connections, two checks are made before a message is sent, the first is whether the corresponding cell gate variable inside said postsynaptic node (the one which represents the receptive cell which contains the presynaptic node that projects said connection) is in the receiving state, and the second is whether the corresponding modulation gate variable was also in the receiving state, if both conditions where true, then after a time period equivalent to the latency value stored in the connection object elapses, the corresponding modulation receiver gate briefly transitions from the receiving state into the modulating state, then into the non-receiving state, all within one clock period.

For lateral connections, only one check is made which is whether the modulation gates are in the receiving state or not, and likewise when such is found to be the case, then after a time period equivalent to the latency value stored in the connection object elapses, the corresponding modulation receiver gate briefly transitions from the receiving state into the modulating state, then into the non-receiving state.

The positive modulation function, is called when any correlation is detected across the terminals of a connection pair by the messenger connection, to increment the strength values stored in the strength variable of the corresponding influencer connection, this function is called every time the corresponding modulation gate is found to be in the modulating state, and its executed differently between reverse inhibitory connections, and other connection types, since the reverse inhibitory connections follow an exponential growth function until a specific weight value which is predefined at conception, then follows a linear growth function after crossing said threshold until it reaches a certain maximum value also predefined at conception, all as was clarified on earlier sections.

The negative modulation function, is consistently called at a particular clock rate to add a consistent decay to the values stored in the strength variables of each influencer connection, and it also executes differently between reverse inhibitory connections and other connection types, since reverse inhibitory connections follow a linear decay function until they reached the specific weight value, at which point an exponential decay function is executed until it reaches a certain minimum value predefined at conception, as was clarified on earlier sections.

In short, a feedforward specialization band shall has its influencer connections be able to affect the feedforward positive and negative accumulator variables of their designated postsynaptic node such that the reverse inhibitory influencer connections increments the postsynaptic node's feedforward negative accumulator variable, and the excitatory influencer connections increment the postsynaptic node's feedforward positive accumulator variable, both of which shall be executed by calling the influence ( ) function once the presynaptic node's state was determined to be active.

A feedforward specialization band shall also has its messenger connections be able to affect their corresponding modulation gate from the first array of modulation gates stored in the postsynaptic node, such that both the excitatory and reverse inhibitory connections transition their respective modulation gate from their receiving state to their modulating state, under two conditions, that first the corresponding cell gate in the postsynaptic node is in the receiving state, and second that their corresponding modulation gate were at the receiving state, after the transmission time delay specified for each connection elapses, if the conditions are satisfied, the modulation gates transition from the receiving state to the modulating state, initiating a call of the positive modulation function, then they transition into the non-receiving state until the next cycle.

Likewise a lateral specialization band shall has its influencer connections be able to affect the lateral positive and negative accumulator variables of their designated postsynaptic node such that the normal inhibitory influencer connections increments the postsynaptic node's lateral negative accumulator variable, and the excitatory influencer connections increment the postsynaptic node's lateral positive accumulator variable, both of which shall be executed by calling the influence ( ) function once the presynaptic node's state was determined to be active.

Likewise a lateral specialization band shall also has its messenger connections be able to affect their corresponding modulation gate from the second array of modulation gates stored in the postsynaptic node, such that both the excitatory and normal inhibitory connections transition their respective modulation gate from their receiving state to their modulating state, under one condition, which is that their corresponding modulation gates were at the receiving state, after the transmission time delay specified for each connection elapses, if the condition is satisfied, the modulation gates transition from the receiving state to the modulating state, initiating a call of the positive modulation function, then they transition into the non-receiving state until the next cycle.

Since the job of an influencer connection is merely to influence the state of the postsynaptic node it connects to, and since all connections are made to be unidirectional, from the presynaptic node and onto the postsynaptic node, a directed graph connectivity structure is deemed to be preferable, where every presynaptic node stores pointers of, and therefore has access to, all the postsynaptic nodes (neighbors) which it directly connects to, thereby giving said node the ability to traverse over every postsynaptic nodes' accumulator variables and increment/decrement them through the influence function based on each connection's variables data via a breadth first traversal approach.

The cell gates would transition from the non-receiving which is the default state, to the receiving state, if the node receives at least one excitatory signal from the receptive cell said gate represents, this can be achieved by allowing all excitatory connections which belong to a given receptive cell the ability to change the cell gate's state from the non-receiving state to the receiving state, this could be executed using an overloaded message sender function, which executes exclusively for feedforward excitatory connections.

The absoluteBalanceOperator( ) function computes the total net depolarization/hyperpolarization signals received from other neurons by subtracting the value stored in the feedforward positive accumulator variable from the value stored in the feedforward negative accumulator variable, and storing the result in the weighted sum variable.

The relativeBalanceOperator( ) function computes the resultant of dividing the value stored in the lateral positive accumulator variable over the value stored in the lateral negative accumulator variable then subtracting 1 from the result, and stores said resultant in the quotient variable.

The Fspiker function takes as input the net sum value stored in the weighted sum variable and generates a spiking rate response which the node's activity state would exhibit across the next 50 millisecond duration period and until the next transmission cycle, such that the rate of activation is directly proportional to any positive values stored in the weighted sum variable, and is inversely proportional to any negative values stored in the weighted sum variable, where the negative and positive limits of the range are the negative and positive equivalent values of the transition point weight value of reverse inhibitory connections, respectively.

First, we specify a transition point value for reverse inhibitory connections in this implementation example, let's assume 1024 units, where one encounter increments the value stored in the strength variables of reverse inhibitory connections by 2 folds every encounter following a 2\hat{ }x exponential growth function prior hitting the 1024 units, this means a total of 10 encounters is needed for maximum selectivity to be achieved. We assume that the minimum allocated strength values for reverse inhibitory connections at conception is 24 units, whilst for feedforward excitatory connections also at conception is 48 units.

For the linear growth function, we assume a 10·X linear growth function, which means after 10 encounters the value stored in the strength variables of the feedforward excitatory connections would be 10×10=100 units, however we also add the minimum starting value which is 48 units and therefore the total value would be 148 units after 10 encounters, this would mean the ratio between values stored in the reverse inhibitory connections and excitatory connections would be 1024:148=7:1, respectively, which means a selectivity ratio that permits a one cell change qualitative tolerance as was clarified on earlier sections.

After the strength value crosses 1024 units for reverse inhibitory connections, it follows a linear growth function equivalent to its excitatory counterpart, which is 10·X, for all values greater than 1024. We also define a specific maximum activation rate in this implementation example to be 1000 HZ, which means a node transitions from an active state to an inactive state 1000 times a second for a maximum rate of node activation, which would be equivalent to 50 times every 50 milliseconds, this is specific only to nodes which lie on the first layer, because for deeper layers the value should be adjusted as was clarified in the previous sections, here we are only focused on a single pair of receptive-selective layers, layer 1 and layer 2, respectively.

The values stored in the weighted sum variable are divided by the amount of reverse inhibitory or excitatory connections projecting to the given node and are mapped to the rate of node activation/inactivation as follows:
A) For resulting values that are less than-1024 units, a negative rate of activation, a shunning rate, equivalent to 1000 shuns per second is allocated, this means the node stays inactive for the entire next 50 milliseconds duration period.
B) For resulting values that are equal to −1024 units, a negative rate of activation, a shunning rate, equivalent to 1000 shuns per second is allocated, again this means the node stays inactive for the entire 50 milliseconds duration period.
C) For resulting values between −1024 and zero, a negative rate of activation, a shunning rate, which is a fraction of 1000 shuns per second and which is directly proportional to the resulting values is allocated, in this example we assume an almost 1:1 ratio between the value and the rate of shunning per second, and therefore a −1023 value should correspond to 999 shuns per second while a −1004 value should correspond to a 980 shuns per second which is equivalent to 49 shuns per the next 50 milliseconds duration, this we continue until the value is equivalent to −24 at which point, the shunning would be 0 per second.
D) For resulting values equal to zero, the activation rate would be zero.
E) For resulting values between zero and +1024, a positive rate of activation, a spiking rate, which is a fraction of 1000 spikes per second and which is directly proportional to the resulting values is allocated, in this example we also assume a 1:1 ratio between the value and the rate of spiking per second, and therefore a +25 value should correspond to 1 spike per second while a +44 value should correspond to a 20 spikes per second which is equivalent to 1 spike per the next 50 milliseconds duration, this we continue until the value is equivalent to +1024 at which point, the spiking would be 1000 spikes per second, or 50 spikes per 50 milliseconds, this means the node stays active the entire duration.
F) For resulting values equal to +1024 weight value, a positive rate of activation, a spiking rate, equivalent to 1000 spikes per second is allocated.
G) For resulting values greater than +1024, a positive rate of activation, a spiking rate, equivalent to the 1000 spikes per second is allocated.

The Lspiker function takes as input the value stored in the Quotient variable and generates a spiking rate response which the node's activity state would exhibit across the next 50 milliseconds duration period and until the next transmission cycle, such that the rate by which a transition of the activity state into activation occurs, is directly proportional to the positive values stored in the quotient variable, and is inversely proportional to the negative values stored in the quotient variable, where the negative and positive limits of the range are −1 and +1, respectively, and where the values stored within the quotient variable map to the rate of node activation/inactivation as follows:
A) For values stored that are less than −1, a negative rate of activation equivalent to 1000 shuns per second is allocated.
B) For values stored that are equal to −1, a negative rate of activation equivalent to 1000 shuns per second is allocated.
C) For values stored between −1 and zero, a negative rate of activation which is a fraction of 1000 shuns per second and which is directly proportional to the values is allocated, here as well we assume a 1:1 ratio for values between −1 to zero at a fractional increment of 0.001, this means a value of −0.999 shall be mapped to a shun response equivalent to 999 shuns per second, this continues until a value of −0.0001 shall map to 1 shuns per second.
D) For values stored equal to zero, an activation rate of zero is allocated.
E) For values stored between zero and +1, a positive rate of activation which is a fraction of 1000 spikes per second and which is directly proportional to the values is allocated, here as well we assume a 1:1 ratio for values between zero and +1 at a fractional increment of 0.001, this means a value of +0.0001 shall be mapped to a spike response equivalent to 1 spike per second, this continues until a value of +0.999 maps to 999 spikes per second.
F) For values stored equal to +1, a positive rate of activation equivalent to 1000 spikes per second.
G) For values stored greater than +1, a positive rate of activation equivalent to the equivalent to 1000 spikes per second.

It is essential to clarify that an x shunning rate is not equivalent to a zero spiking rate despite the fact that since we use binary nodes, the result would seem the same, as in the node's activity state would be zero across the period pertaining both a shunning and a zero spiking, this is because a zero spiking rate implies that the node is not experiencing either a positive/negative activation/suppression influence, and therefore the node is susceptible to positive influence, on the other hand a shunning rate implies a suppressive influence over the node's activity state, and therefore the node becomes less susceptible to positive influence as a result of such suppressive influence, a newly introduced spike on a node that's being suppressed would be less likely to positively influence the node's activity state relative to another node which is not experiencing any such suppressive influence (introducing both positive and negative accumulator variables ensures such is always be the case).

Overall, the presynaptic node, stores a state, a set of accumulator variables, and a pair of connections' list (analogous to biological axons), one messenger connection paired with its corresponding influencer connection per cell, as well as all their sub data attributes which include these connections' type, mode, postsynaptic neuron, latency and strength value for influencer connections, and also shall be able to call the influence function and a sender function, while the postsynaptic node stores a state, a set of accumulator variables, and the receiving gates for all the corresponding connections (analogous to biological dendrites), and shall be able to call both the positive and negative modulation functions.

Notice that since in a chain of connections, a postsynaptic neuron is typically a presynaptic neuron to another, then every node would typically hold the combined share of all variables and be able to call all functions, whereas a node would sometimes behave as a presynaptic node and other times would behave as a postsynaptic node, this is clarified in the subsequent part of this section.

Notice that in order to preserve timing, the latency of the messenger connections shall be synchronized with the latency of the influencer connections, with a slight increase in latency for messenger connections to account for an amount of time, so as to ensure that the presynaptic nodes are given their chance to influence the activity/inactivity of the postsynaptic nodes before the correlative connections can register any correlations across the terminals. This can either be implemented by storing two different variables one for influencer connections and another for messenger connections, or by simply storing one variable storing one value (preferably the influencer connection's latency value) and calculate the second value based on a known specified difference in value specified at conception.

To showcase a possible software embodiment of both the lateral and feedforward connectivity structures, we adopt an adjacency list notation of a graph data structure with a slight modification to showcase temporality, and we define new notations for the various elements which make up the architecture, which include, receptive kernels, receptive cells, receptive nodes, selective cells and selective nodes, as well as other notations to signify absolute layer number, and relative layer number (for transpassing connections).

We assume the following parameters for this example embodiment of the architecture: 5 receptive layers and 5 selective layers, in other words 6 layers in total, where the first layer is only receptive and the final layer is only selective, whilst all 4 layers in between are both receptive relative to the layers ahead of them, and selective relative to the layers behind them. For selective layers we assume each layer is dissected into selective cells with the following amount of nodes per a given layer; 49 nodes per selective cell on layer 2, 100 nodes per selective cell on layer 3, 196 nodes per selective cell on layer 4, 400 nodes per selective cell on layer 5, and 676 nodes per selective cell on layer 6. This means the selective cell of layer 2, spans a grid of 7×7 nodes, on layer 3, spans a grid of 10×10 nodes, on layer 4, spans a grid of 14×14 nodes, on layer 5, spans a grid of 20×20 nodes, and on layer 6, spans a grid of 26×26 nodes. For receptive kernels, we assume a constant 3×3 grid of receptive cells, across all receptive layers, however for receptive cells, we assume an initial 2 receptive node per receptive cell for the first layer, but since each selective cell is a receptive cell to the layer ahead of it then based on the numbers laid previously, the following amount of nodes per receptive cell take place per a given layer; 49 nodes per receptive cell on layer 2, 100 nodes per receptive cell on layer 3, 196 nodes per receptive cell on layer 4, and 400 nodes per receptive cell on layer 5. This means, with a constant receptive kernel size of 3×3 across all 5 receptive layers, the total amount of nodes per kernel per layer would be as follows; 18 nodes per kernel on layer 1, 441 nodes per kernel on layer 2, 900 nodes per kernel on layer 3, 1764 nodes per kernel on layer 4, 3600 nodes per kernel on layer 5. While the 3×3 kernel grid size of receptive cells is maintained across all receptive layers, this is only the case for receptive layers which are directly behind selective cells, however for receptive layers which lie further behind relative to a given selective cell, the kernel grid size is assumed to increase the further backward a receptive layer lies relative to a given selective cell, whereas a selective cell that lies on layer 6, shall make a 3×3 kernel boundary size with receptive layer 5, while also make a 9×9 kernel boundary size with receptive layer 4, a 27×27 kernel grid with receptive layer 3, an 81×81 kernel grid with receptive layer 2, and a 243×243 kernel grid with receptive layer 1. The same goes for selective cells across all other selective layers. This is to account for the fact that we introduced transpassing connections which can bypass layers that are directly ahead of the layer they project from, or even many layers ahead of them, where they directly feed onto layers deeper in the network structure.

We use numbers 1-59049 to Express a position of a receptive cell in a given layer, and A through F to Express a position of a receptive cell across the layers, for example, receptive node 1A lies at the top most position of layer 1, and receptive cell 59049A lies at the bottom most position of layer 1, however receptive cell 59049E lies at the bottom most position of layer 5, and so on and so forth.

We use a double digit permutation of alphabets to denote a particular selective node per selective cell, for example, aa denotes the first node in a given selective cell, whilst ab denotes the second node in a given selective cell, ba denotes the 27^{th} node, bw denotes the 49^{th}, and zz denotes the 676^{th} node in a given selective cell.

The double digit permutation of alphabets includes a number to signify which layer a given set of selective nodes belongs to, 1 through 6, for example, selective node aa in a particular selective cell that belongs to layer 2, is represented as aa2 whilst selective node aa in a particular selective cell which belongs to layer 3 is represented as aa3.

Since a selective cell to a relatively backward layer is simultaneously a receptive cell to a relatively forward layer, each set of double digit permutations of alphabets which represent a set of nodes belonging to a single selective cell, can be abstracted as a number proceeded with a letter representing a receptive cell notation.

In this embodiment we would assume a total of 59,049 total cells in layer 1, 6561 cells in layer 2, 729 cells in layer 3, 81 cells in layer 4, 9 cells in layer 5, and 1 cell in layer 6. Notice that these are the total amount of cells per layer and not the amount of nodes per layer, to account for nodes we multiply the amount of cells per layer, with the amount of selective nodes per cell mentioned previously, this means layer 1 would contain a total of 2×59,049=118,098 nodes, layer 2 would contain 49×6561=321,489 nodes, layer 3 would contain 100×729=79,200 nodes, layer 4 would contain 81×196=15,876, layer 5 would contain 9×400=3600 nodes, and layer 6 would contain 1×676=676 nodes.

In order to simplify the process of explaining the complex graph data structure which encompasses the entire neural network's connectivity structure, we dissect the data structure into multiple examples, and for the feedforward connectivity structure we create three examples, whereas for each following example we add more features relative to the preceded example to showcase a more complex version of the feedforward connectivity graph structure, until the final example encompasses all the elements of the data structure and showcases the full complex data structure as a whole.

The simplest example form of the feedforward connectivity structure, would encompass a single 3×3 receptive kernel from layer 1, connected to a single 7×7 selective cell region, such that each and every receptive cell from said receptive kernel is connected to each and every node from the selective cell, through a bus of connections, where each bus is composed of 3 latency varied bands of feedforward specialization connection pair, such that the first band has a transmission time of 50 milliseconds, the second band has a transmission time of 100 milliseconds, and the third band has a transmission time of 150 milliseconds.

To represent the receptive cells of a 3×3 receptive kernel, we use numbers 1 through 9, and to signify that these receptive cells belong to layer 1, we use letter A following the numbers, and therefore the 9 receptive cells which belong to layer 1 in our first example, are labeled, 1A, 2A, 3A, . . . , 9A. Notice that in layer 1, each receptive cell is composed of two receptive nodes, and therefore 1A represents two nodes let's refer to them as, a and b, and the same goes for the rest of the receptive cells 2A through 9A.

To represent the selective nodes of a 7×7 selective cell, we use the double digit permutations of alphabets, such that nodes 1 through 49, are represented by aa through bw, respectively, and we add the layer number after the alphabets to showcase the layer said selective nodes belong to. Overall this would mean that the adjacency list which can represent said connectivity structure could be written as follows:

| { | |
|---|---|
| 1A : [aa2] 001ms, | |
| 1A : [ab2] 002ms, | |
| 1A : [ac2] 003ms, | |
| • | • |
| • | • |
| 1A : [bw2] 049ms, | |
| 1A : [aa2] 051ms, | |
| 1A : [ab2] 052ms, | |
| 1A : [aa2] 053ms, | |
| • | • |
| • | • |
| 1A : [bw2] 099ms, | |
| 1A : [aa2] 101ms, | |
| 1A : [ab2] 102ms, | |
| 1A : [ac2] 103ms, | |
| • | • |
| • | • |
| 1A : [bw2] 149ms, | |
| ● | |
| ● | |
| 9A : [aa2] 001ms, | |
| 9A : [ab2] 002ms, | |
| 9A : [ac2] 003ms, | |
| • | • |
| • | • |
| 9A : [bw2] 049ms, | |
| 9A : [aa2] 051ms, | |
| 9A : [ab2] 052ms, | |
| 9A : [aa2] 053ms, | |
| • | • |
| • | • |
| 9A : [bw2] 099ms, | |
| 9A : [aa2] 101ms, | |
| 9A : [ab2] 102ms, | |
| 9A : [ac2] 103ms, | |
| • | • |
| • | • |

9A : [bw2] 149ms
}

Notice we have added to the regular adjacency list notation, a parameter which specifies the transmission time delay, this is because each edge 1A: [aa . . . bw] is unique as a result of it possessing a different transmission time delay relative to other connections projecting to other neighbors, in addition to this, overall, there are three connection bands, which explains why the same list is repeated 3 times, however technically there is no reason to delineate between the three bands in the modified adjacency list notation, since we can simply represent it as follows:

| 1A : [aa2] 001ms, | |
|---|---|
| 1A : [ab2] 002ms, | |
| 1A : [ac2] 003ms, | |
| • | • |
| • | • |

1A : [bv2] 148ms,
1A : [bw2] 149ms,

To fully represent the structure of this example, we need to also add the normal inhibitory connections found among the selective nodes per selective cell, this can be represented as follows:

| { | |
|---|---|
| aa2 : [ab2, ac2,ad2, ....., bw2] 001ms, | |
| • | • |
| • | • |

bw2 : [aa2, aa2, ac2, ....., bv2] 001ms,
}

Notice that the connections used in this data structure graph are different than the ones used on the previous one, wherein the former we used a feedforward specialization connection pair which is composed of one excitatory connection pair and one reverse inhibitory connection pair, whilst in the latter we use a single normal inhibitory connection. This concludes our data structure graph representation of the first example.

In the next example, we add more complexity to the feedforward connectivity structure and include all the receptive-selective layer pairs, beginning from the first layer and ending with the last layer, however we only focus on the sections of each layer which recursively connect to the initial 3×3 kernel receptive layer. In other words, we focus on the sections of the feedforward layers which trace back in connectivity to that particular 3×3 kernel receptive layer.

Recall that we use a number proceeded by a letter to signify a particular receptive node which belongs to a particular receptive layer, where the number signifies the node in the layer, and the letter signifies the layer it belongs to, and we use a double digit permutation of alphabets to signify a particular selective node in a given layer, proceeded with a number to signify which layer the selective nodes belong to. By adding all the receptive-selective pairs (that are dependent on each other) across the 6 layers, we end up with an adjacency list as follows:

| { | |
|---|---|
| 1A : [aa2] 001ms, | |
| • | • |
| • | • |
| 9A : [bw2] 149ms, | |
| 1B : [aa3] 001ms, | |
| • | • |
| • | • |
| 9B : [dv3] 149ms, | |
| ● | |
| ● | |
| ● | |
| 1E : [aa6] 001ms, | |
| • | • |
| • | • |

9E : [zz6] 149ms
}

Notice the changes in the alphabet permutation range across each layer, since as was clarified earlier the amount of selective nodes per selective cell increases the deeper the layer a given selective cell belongs to, and therefore since layer 3 selective cells contain 100 nodes then the range shall be from [aa] to [dv] and the same goes for deeper layers until on the final layer a selective cell contains 676 selective nodes and therefore the range would be from [aa] to [zz].

To fully represent the structure we also need to add the adjacency list for the normal inhibitory connectivity among the selective cell members and across each selective cell, these would be as follows:

| { | |
|---|---|
| aa2 : [ab2, ac2,ad2, ....., bw2] 001ms, | |
| • | • |
| • | • |
| bw2 : [aa2, aa2, ac2, ....., bv2] 001ms, | |
| aa3 : [ab3, ac3, ad3, ....., dv3] 001ms, | |
| • | • |
| • | • |
| dv3 : [aa3, aa3, ac3, ....., du3] 001ms, | |
| ● | |
| ● | |
| ● | |
| aa6 : [ab6, ac6,ad6, ....., zz6] 001ms, | |
| • | • |
| • | • |

zz6 : [aa2, aa2, ac2, ....., zy6] 001ms,
}

In this next example, we add additional complexity to the feedforward connectivity structure and consider adding transpassing connections to the adjacency list, in other words we assume that a single receptive kernel projects feedforward specialization connection pairs not only towards the selective cell that lies directly ahead of it, but also towards all other selective cells which lie in layers ahead of it, whilst preserving the designated boundaries of receptive kernel regions for each selective cell.

Recall that since a selective cell to a relatively backward layer is simultaneously a receptive cell to a relatively forward layer, each set of double digit permutations of alphabets which represent a set of nodes belonging to a single selective cell, can be abstracted as a number proceeded with a letter representing a receptive cell notation, and therefore a set of selective nodes aa through bw can be all abstracted as 1B, where B denotes the fact that the receptive cell (which was a selective cell) lies on layer 2, and 1 specifies one of 9 receptive cells (which were selective cells) from layer 2. Therefore the adjacency list in this example would look as follows:

| { | |
|---|---|
| 1A : [aa2] 001ms, | |
| • | • |
| • | • |
| 9A : [bw2] 149ms, | |
| 1A : [aa3] 001ms, | |
| • | • |
| • | • |
| 9A : [dv3] 149ms, | |
| ● | |
| ● | |
| ● | |
| 1A : [aa6] 001ms, | |
| • | • |
| • | • |
| 9A : [zz6] 149ms, | |
| 1B : [aa3] 001ms, | |
| • | • |
| • | • |
| 9B : [dv3] 149ms, | |
| 1B : [aa4] 001ms, | |
| • | • |
| • | • |
| 9B : [hn4] 149ms, | |
| ● | |
| ● | |
| ● | |
| 1B : [aa6] 001ms, | |
| • | • |
| • | • |
| 9B : [zz6] 149ms, | |
| ● | |
| ● | |
| ● | |
| 1E : [aa6] 001ms, | |
| • | • |
| • | • |

9E : [zz6] 149ms
}

Notice that each receptive node projects to one selective cell across each layer. To complete the data structure we also need to add the same adjacency list that represents the connections amongst each selective cell, which was used in the prior example.

| { | |
|---|---|
| aa2 : [ab2, ac2,ad2, ....., bw2] 001ms, | |
| • | • |
| • | • |
| bw2 : [aa2, aa2, ac2, ....., bv2] 001ms, | |
| aa3 : [ab3, ac3,ad3, ....., dv3] 001ms, | |
| • | • |
| • | • |
| dv3 : [aa3, aa3, ac3, ....., du3] 001ms, | |
| ● | |
| ● | |
| ● | |
| aa6 : [ab6, ac6,ad6, ....., zz6] 001ms, | |
| • | • |
| • | • |

zz6 : [aa2, aa2, ac2, ....., zy6] 001ms,
}

For the last example which would wrap up the full data structure of the feedforward connectivity structure of this neural architecture, we add the final feature to this data structure, which is a graph data structure which represents not only receptive-selective cells which has dependency on one another, but which rather represents the entire feedforward connectivity structure.

As was the case in the previous examples we use the numbers proceeded with letters to represent one single receptive cell, however this time rather than confining the set of receptive cells to only 9 cells, we represent the entire set of receptive cells per a given layer, recall that we assumed a total of 59,049 total cells in layer 1, 6561 cells in layer 2, 729 cells in layer 3, 81 cells in layer 4, 9 cells in layer 5, and 1 cell in layer 6. We also add to the selective node notation (the double digit permutation of alphabets proceeded with a number) a preceding number to represent the position of the selective cell which said node belongs to within a given layer.

Since all the selective cells of layer 2 are receptive cells to layer 3, then we got around 6561 receptive and selective cells in layer 2, to represent each cell we can use 1B through 6561B to represent all selective and receptive cells, and to represent each node per cell we use 1-6561 to specify which cell the node belongs to in a given layer, followed by the double digit permutations of alphabets to specify which node it is per cell, then followed by the number 2 to specify that the nodes belong to layer 2. For example, a set of nodes that lie in the first cell in layer 2, would be represented as [laa2 . . . lbw2] whilst a set of nodes which lie in the last cell in layer 5, would be represented as [9aa5 . . . 9pj5], realize that there are only 9 cells in layer 5, each containing 400 nodes per cell. The adjacency list therefore shall look as follows:

{
00001A : [1aa2] 001ms,

| | |
|---|---|
| • | • |
| • | • |

00009A : [1bw2] 149ms,
// This above represents the first 3x3 kernel region from layer 1 [1A ....
9A] connected to the nodes found within the first selective cell from layer
2 [1aa2 .... 1bw2]. \\
00010A : [2aa2] 001ms,

| | |
|---|---|
| • | • |
| • | • |

```
00018A : [2bw2] 149ms,
// This above represents the second 3x3 kernel region from layer 1 [10A
.... 18A] connected to the nodes found within the second selective cell
from layer 2 [2aa2 .... 2bw2]. \\
      ●
      ●
59041A : [6561aa2] 001ms,
```

| | |
|---|---|
| • | • |
| • | • |

59049A : [6561bw2] 149ms,
// This above represents the 6561's 3x3 kernel region from layer 1
[59041A .... 59049A] connected to the nodes found within the 6561's
selective cell from layer 2 [6561aa2 .... 6561bw2]. \\
00001A : [1aa3] 001ms,

| | |
|---|---|
| • | • |
| • | • |

00081A : [1dv3] 449ms,
00082A : [2aa3] 001ms,

| | |
|---|---|
| • | • |
| • | • |

```
00162A : [2dv3] 449ms,
      ●
      ●
58968A : [729aa3] 001ms,
```

| | |
|---|---|
| • | • |
| • | • |

```
59049A : [729dv3] 449ms,
// These above represent the transpassing connections that project from
layer 1 which transpass layer 2 and then feed onto layer 3's selective cells,
notice that layer 3 only contains 729 selective cells, and that the nodes per
selective cell range from aa to dv. Notice also the change in the spatial
receptive kernel size from a 3x3 = 9 grid of receptive cells to a 9 x 9 = 81
grid of receptive cells as well as a change in the temporal receptive kernel
size from a 3(50ms) x 1 = 150 ms temporal duration to a 9(50ms) x 1 =
450 ms temporal duration, since transpassing information requires an
increase in the spatial as well as temporal bandwidth based on the relative
layer depth. \\
    ●
    ●
    ●
    ●
    ●
    ●
1E : [aa6] 001ms,
```

| | |
|---|---|
| • | • |
| • | • |

9E : [zz6] 149ms
// This shall follow similarly for connections projecting from layer B to C,
D and E, and C to D, E and F, and D to E and F, until E to F. \\
}

Notice that in the temporal bandwidth increase showcased in this example, each selective cell in layer 3 gets the same 50 millisecond period, within which the nodes shall share a piece of that period while iterating across all the 100 nodes, and therefore each node would be 0.5 milliseconds apart from the member next to it in line, to account for 100 nodes in 50 milliseconds, the 450 ms bandwidth reflects rather, the fact that the amount of connection bands per bus that project from layer 1 to layer 3 are 9 bands per bus as opposed to the usual layer-to-layer amount of 3 bands per bus.

To represent the entire feedforward connectivity graph data structure of this example we need not forget adding the adjacency list that represents the connections amongst each selective cell, however this time for the entire set of selective cells.

| 1aa2 : [1ab2, 1ac2, 1ad2, ....., 1bw2] 001ms, | |
|---|---|
| • | • |
| • | • |
| 1bw2 : [1aa2, 1aa2, 1ac2, ....., 1bv2] 001ms, | |
| ● | |
| ● | |
| 6561aa2 : [6561ab2, 6561ac2, 6561ad2, ....., 6561bw2] 001ms, | |
| • | • |
| • | • |
| 6561bw2 : [6561aa2, 6561aa2, 6561ac2, ....., 6561bv2] 001ms, | |
| 1aa3 : [1ab3, 1ac3, 1ad3, ....., 1dv3] 001ms, | |
| • | • |
| • | • |
| 1dv3 : [1aa3, 1aa3, 1ac3, ....., 1du3] 001ms, | |
| ● | |
| ● | |
| 729aa3 : [729ab3, 729ac3, 729ad3, ....., 729dv3] 001ms, | |
| • | • |
| • | • |
| 729dv3 : [729aa3, 729aa3, 729ac3, ...... 729du3] 001ms, | |
| ● | |
| ● | |
| ● | |
| ● | |
| 1aa6 : [1ab6, 1ac6, 1ad6, ....., 1zz6] 001ms, | |
| • | • |
| • | • |

1zz6 : [1aa2, 1aa2, 1ac2, ....., 1zy6] 001ms
}

By now we conclude the graph data structure which represents one possible implementation of the feedforward connectivity structure in a software mode of implementation, and therefore we shall move on to describe the graph data structure which would represent the lateral connectivity structure of this neuromorphic neural network architecture.

We use the same example previously and with identical parameters to illustrate a graph data structure implementation of the lateral connectivity structure. In lateral connectivity there are two possible ways to implementation said connectivity structure, the all to all connectivity structure, and the one to many connectivity structure, we would preferably refer to the later as the one to some connectivity structure as this would describe it more accurately. We begin with an all to all connectivity structure as the connectivity structure would be relatively simpler in software implementation.

We use the same notations clarified earlier to navigate through the different elements of the architecture, however it is necessarily to clarify that the connections used in this connectivity structure are different than the ones used in the previous connectivity structure, where on this structure we use a lateral connection pair specialization (which is composed of an excitatory and normal inhibitory connection pair) for lateral connectivity, whilst in the former we used both a feedforward connection pair specialization (which is composed of an excitatory and a reverse inhibitory connection pair) for the feedforward connectivity, and a modified single normal inhibitory connection for connectivity among selective cell members.

An all to all connectivity structure is straightforward, whereas the name suggests all the nodes of the architecture are effectively connected to all other nodes of that architecture via a bus of lateral connection specialization pair, the bus consists of bands which are incorporated with different transmission time delays to account for temporality. This while not efficient for a software implementation of the architecture, it would be more efficient for a hardware implementation, and while this part is dedicated for exploring a possible software implementation of the architecture, we have determined that it would be useful to showcase an implementation of an all to all connectivity structure in a software setting. The adjacency list of such connectivity structure would look as follows:

{
00001A : [2A,3A,....... ,59049A, 1B,2B,.....,6561B, .......9E,1F] 50ms,
00002A : [1A,3A,....... ,59049A, 1B,2B,.....,6561B, .......9E,1F] 50ms,

| | |
|---|---|
| • | • |
| • | • |

59049A : [2A,3A,....... ,59048A, 1B,2B,.....,6561B, .......9E,1F] 50ms,
00001B : [2A,3A,....... ,59049A, 1B,2B,.....,6561B, .......9E,1F] 50ms,
00002B : [2A,3A,....... ,59049A, 1B,2B,.....,6561B, .......9E,1F] 50ms,

| | |
|---|---|
| • | • |
| • | • |

06561B : [2A,3A,....... ,59049A, 1B,2B,.....,6561B, .......9E,1F] 50ms,

| | |
|---|---|
| ● | ● |
| ● | ● |
| ● | ● |

00009E : [2A,3A,....... ,59049A, 1B,2B,.....,6561B, .......9E,1F] 50ms,
00001F : [2A,3A,....... ,59049A, 1B,2B,.....,6561B, .......9E,1F] 50ms
}

Notice that, a cell contains many nodes and therefore, when we say 1A connects to 2A we effectively mean that all the nodes from cell 1A would form lateral connections with all the nodes in cell 2A, lateral connectivity must be between nodes that exist within different cells but not between nodes within the same cell, since a cell has only one node representative of it at any given time, which is as a result of the single normal inhibitory connections that are found among nodes that share the same cell, and this as was clarified earlier in the previous section and subsections is to achieve selectivity. The zeros on the left of numbers are merely for formatting purposes.

A one to some connectivity structure, is the most optimal connectivity structure for a software implementation of lateral connectivity in this neuromorphic neural network architecture, optimal as it reduces the intensive processing power costs, in a one to some connectivity structure, a node is connected to only a handful of other nodes around it at conception, however there is an important feature that arises from implement a lateral connectivity structure using a one to some model, which is the dynamic nature of the formation of these connections.

To further elaborate, in such model, and as was clarified in the previous sub-section, there are two ways a set of connections can be made to connect to other nodes, one way, the maturation way, assumes an initial condition where all the nodes are web-connected to all other nodes in the architecture at conception, i.e., at the initial condition, and then over time and experience and based on the learning algorithm stated on the first section, the strength of these connections is modulated dynamically in what we refer to as the process of maturation, in this case the formation of the connections is static and only the modulation of said connections is dynamic, and therefore it's possible in this scenario to represent the connectivity structure using a graph data structure, since it captures said connectivity structure at all states of the architecture throughout its lifespan.

On the other hand, we have also introduced a second way, by which nodes are made to connect with one another, the Branching way, which does not assume an initial condition where all the nodes are pre-connected, but rather allows for the formation of these connections on run time sort of speak, i.e., post conception and throughout the network's lifespan, this is typically handled by a process which records all the nodes that happened to be activated in positive or negative correlation, and based on which initiates the formation of either excitatory connections or normal inhibitory connections between said nodes, notice that once the connections are formed the process no longer cares about the status of these nodes, since the modulation of said connections is handled by the learning algorithm and not said process. Using the data structure notations we used before for a dynamically allocated connectivity structure would not be feasible unless we add additional notations to create what we refer to as a generic graph data structure notation.

In the generic data structure notation, we represent receptive cells in a generic way, such that a symbol would denote any cell element that belongs to a given predefined set, the symbol would be capital letter X preceded by a 3D coordinate notation to represent its relative position in a particular layer, and proceeded by a capital letter which denotes its layer position in the layer structure, the middle symbol X would denote the fact that these cells are generic cells, in other words they represent any element that belongs to a predefined set of receptive cells. For example when we say XA connects to (1,1,1) XA, such that XA is a cell element that belongs to [1A through 9A], then what we mean by this is that each any every element from the set 1A through 9A is connected to the node which lies in the position one unit leftward and one unit upward and one unit ahead relative to it.

We define X as a generic cell which represents any particular element that belongs to the set of all receptive cells, this means [1A through 1F]. We also use n to denote a range of integer values [−1,1], and this would be used to fill the coordinates with a range of values, and would represent how far a node is allowed to connect relative to its position. An adjacency list notation which would represent a one to some lateral connectivity structure, would look as follows:

{
X : [ (n,n,n)X] 50 ms,
X : [ (n,n,n)X] 100 ms,
X : [ (n,n,n)X] 150 ms
}

This previous graph structure means, that any cell is allowed to form 3 bands of latency varied connections to any other cell that is at most one node away relative to it from all directions. If we increase the range of n, we increase how close or far a connection is allowed to form.

We might also need to add a limit specifying the maximum amount of connections that can be present at any time, we do this by writing the number of bands per connection bus multiplied by the total amount of connections we want to allow, here we assume 100 bands per bus in this software implementation example, the limit shall be written at the end of the modified adjacency list, as follows:

| { | |
|---|---|
| X : [ (n,n,n)X] 50 ms, | |
| X : [ (n,n,n)X] 100 ms, | |
| X : [ (n,n,n)X] 150 ms, | |
| X : [ (n,n,n)X] 200 ms, | |
| X : [ (n,n,n)X] 250 ms, | |
| X : [ (n,n,n)X] 300 ms, | |
| X : [ (n,n,n)X] 350 ms, | |
| X : [ (n,n,n)X] 400 ms, | |
| X : [ (n,n,n)X] 450 ms, | |
| X : [ (n,n,n)X] 500 ms, | |
| X : [ (n,n,n)X] 550 ms, | |
| X : [ (n,n,n)X] 600 ms, | |
| X : [ (n,n,n)X] 650 ms, | |
| X : [ (n,n,n)X] 700 ms, | |
| X : [ (n,n,n)X] 750 ms, | |
| X : [ (n,n,n)X] 800 ms, | |
| X : [ (n,n,n)X] 850 ms, | |
| X : [ (n,n,n)X] 900 ms, | |
| X : [ (n,n,n)X] 950 ms, | |
| X : [ (n,n,n)X] 1000 ms, | |
| • | • |
| • | • |

X : [ (n,n,n)X] 5000 ms
10010,000
}

The process of branching is executed by a system function which monitors the activity state of all the nodes in the structure and then initiates the process of forming lateral connections between said nodes. This function is divided into two sub functions, one which is responsible for recording the set of all active and inactive nodes at a given set of moments, and another which is responsible for iterating over the data stored to form either excitatory or normal inhibitory connections between any given pair of node, based on their correlation sign.

There are two ways this can be executed, either using a gradual method of branching and a direct method of branching, in a gradual method the first sub function stores a backlog of activity states for any given pair of nodes, and gradually forms a pair of lateral connection between them based on the amount of time the pair of node where found active synchronously or asynchronously, the backlog shall be short, not more than 10 encounters of said node pair's activation, and the initial strength of the connection pairs shall be a reflection of the amount of times both nodes were found to be active synchronously, for excitatory connections, and asynchronously for normal inhibitory connections. This can help weed out random activation patterns which occur by mere chance and which do not necessarily resemble some actual existing correlation happening in the external world, however it costs additional memory as well as processing power since it requires more data to be stored per any given pair of node synchronous/asynchronous activations.

The direct method of execution however, does not store a backlog, but rather directly forms the connections immediately after the first encounter of two node's asynchronous/synchronous activation, this saves memory and processing power in the short term, but can be a waste of processing power in the long term since there is no pre judgment which can weed out random activation patterns that do not correspond to any actual correlation exhibited by the stimuli being perceived from the external world.

The first sub system function which we refer to as the ActivityStateCollector( ) is responsible for recording all nodes which were active and inactive in the past 5 seconds, to account for 100 bands of connections.

The second sub function is what we refer to as, the Associator( ) function, which takes as input these set of active/inactive map of node states across the past 5 second duration, and traverses across each one of them to form associations between them via lateral specialization connections and based on the whether a given pair of nodes' activity states where positively or negatively correlated.

By now we conclude one possible software implementation for this neuromorphic neural network architecture, notice that this software model of implementation is merely one example of a software implementation for the learning algorithm of this architecture, the purpose of which is only to show one possible software implementation of the architecture and which is subject to the broader disclosure and claims listed herein.

### Section 5-B (A Hardware Implementation)

Next, we go through a hardware implementation of the neuromorphic neural network architecture.

We can use alternative components to implement this neuromorphic neural network architecture in a hardware setting using hardware components which can be alternatively used to substitute their counterparts' architectural component laid in this software embodiment. To showcase this we build upon the embodiment explained earlier, while using analogies to clarify what some components used in the software setting would be replaced by which components in the hardware setting to achieve another implementation of this architecture which serves the same functional aspects of this neuromorphic neural network architecture. However, it is necessary to clarify that this part does not constitute a full embodiment of this architecture in a hardware setting, since this example lacks some hardware components which would be necessary to achieve a full hardware design of this neuromorphic neural network architecture.

The purpose of this part of this section is not to showcase a full embodiment of the implementation of this neuromorphic neural network architecture in a hardware setting, but rather to showcase the feasibility of such architectural implementation once certain missing hardware components were to be found to aid in completing said design, as well as to showcase that if a set of hardware components where to be arranged in a manner such that they achieve the functionalities of the aggregate architecture described and specified both in the specification section as well as within the claim section which showcases a broad definition of this neuromorphic neural network architecture, then said hardware implementation shall be subject to these broader claims.

In this part we showcase a set of alternative components that can replace their counterparts laid in the previous software embodiment of this architecture, and we begin by laying out the class diagram we used in the previous embodiment which summarizes the set of all functional components relating to this neuromorphic neural network architecture implemented in the software setting showcased previously, then we showcase the set of alternative hardware components which can achieve the same architectural design in a hardware mode of implementation.

Node: Node
------------------------------------------------------------
State: bool
WeightedSum: int
LPositiveAccumulator: int
LNegativeAccumulator: int
FPositiveAccumulator: int
FNegativeAccumulator: int
Quotient: float
ArrayOfCellGates: bool
ArrayOfConnectionPairs1: FconnectionPairs
ArrayOfConnectionPairs2: LconnectionPairs
ArrayOfModulationGates1: FmodulationGates
ArrayOfModulationGates2: LmodulationGates
-----------------------------------------------------------
influence( ): void
positiveModulation( ): void
negativeModulation( ): void
messageSender( ): void
relativeBalanceOperator( ): void
absoluteBalanceOperator( ): void
fSpiker( ): void
lSpiker( ): void
------------------------------------------------------------

Here, we show a class diagram for the connection objects which is handy when explaining the learning algorithm part of this architecture implemented in a hardware setting.

### FconnectionPairs: ArrayOfConnectionPairs1

------------------------------------------------------------
Type: Enum
Mode:Enum
PostsynapticNode: Node
ILatency : int
MLatency: int
Strength: int
-----------------------------------------------------------
positiveModulation( ): void (Implemented differently for reverse
inhibitory connections)
negativeModulation( ): void (Implemented differently for reverse
inhibitory connections)
messageSender( ): void (Implemented differently to account for cell gate
condition)
------------------------------------------------------------
LconnectionPairs : ArrayOfConnectionPairs2
------------------------------------------------------------
Type: Enum
Mode:Enum
PostsynapticNode: Node
ILatency : int
MLatency: int
Strength: int
-----------------------------------------------------------
positiveModulation( ): void (Default Implementation)
negativeModulation( ): void (Default Implementation)
messageSender( ): void (Default Implementation)
------------------------------------------------------------

In the hardware implementation an electrical circuit can be alternatively used to represent the nodes, where between these nodes, another electrical circuit connected to any form of resistive memory hardware technology, a memristors in this example, can alternatively represent the influencer connection, while a third electrical circuit which contains two transistor gates, one representing what we would call the sender gate and another representing the receiver gate, would be configured across the resistive memory technology hardware such that said circuit can cause a negative electric potential difference across the terminals of the electrical connection which holds the memristor provided that both transistor gates are turned on.

The transistor receiver gate would be the alternative hardware component which could represent the modulation gates, which can only be turned “on” or “off” by the postsynaptic node, while the transistor sender gate would be the alternative hardware component which could represent the process of sending a message where it would only be turned “on” by the presynaptic node after a given interval of time measured from its last activation, where the time interval would be achieved by incorporating a delay through a delay component, say for example a little RC circuit component as is clarified later. In addition to what was mentioned prior, we can also add, 2 positive signals current accumulator components (one feedforward and another lateral), 2 negative signals current accumulator components (one feedforward and another lateral), and a weighted sum of all feedforward signals accumulator component as well as a signal divider component (for lateral signals), each to serve their appropriate roles as is clarified shortly after.

To fully elaborate, in this part of this section we are going to tackle each circuit alone then show the aggregate implementation of all three circuits combined, then we introduce the previously mentioned set of hardware components to the aggregate version of the circuits to represent additional features needed to complete this architectural design.

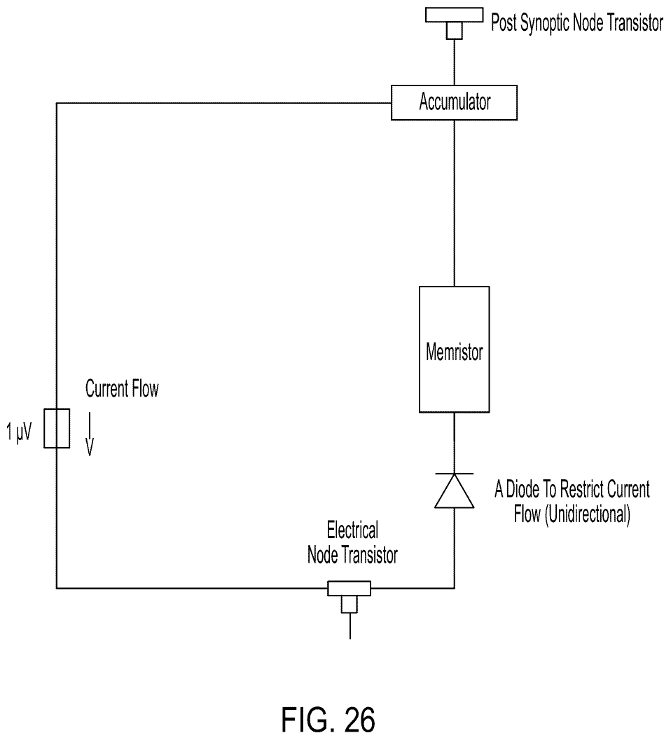

As shown in FIG. 26, there can be a transistor in an electric circuit with current flowing in the positive direction and which contains a diode, a memristor and an accumulator as well as a small voltage supplier, all participating in the formation of what we refer to as the influencer circuit, which would represent the influencer connection. The memristor can serve the job of storing a particular ohmic value in memory. This ohmic value, which can be changed as is clarified later, would preserve a particular conductivity state for the electrical connection, mimicking a particular strength value of a connection. This is the case since what we traditionally refer to as connection strength in biological and artificial synapses, is a signal transmission magnitude, which translates to a conductance weight value. The example shown in FIG. 26 is an example implementation of an excitatory influencer connection, using a transistor in an electric circuit with current flowing in the positive direction, a diode, a memristor, an accumulator as well as a small voltage supplier, all present on the circuit.

If the connection type is an excitatory type then the current flow shall be positive, (following a conventional current standard) as shown on the figure, and if the connection type is an inhibitory type then the current flow shall be negative and hence the diode would have to be reversed in direction. The positive current connections can be connected to a positive accumulator component whilst the negative current connections can be connected to a negative accumulator component. In FIG. 26 we show an example of an excitatory connection.

The diode would ensure that the current flows unidirectionally, the accumulator (positive or negative depending on connection type) would register the aggregate amount of net current flow, after integrating all incoming signals from other electrical connections which share the same connection type. Then, based on which specialization said connections belong to, either affect the weighted sum accumulator by adding the values stored in both the first set of positive and negative accumulators and achieve a weighted sum stored in the weighted sum accumulator thereby executing what we refer to as an absolute balance operation, and this would be in the case of a feedforward specialization, or divide the net current stored in the 2^{nd} positive accumulator by the net current stored in the 2^{nd} negative accumulator and subtracting 1 from the total, then storing the result in the signal quotient component thereby executing what we refer to as a relative balance operation, and this would be in the case of a lateral specialization.

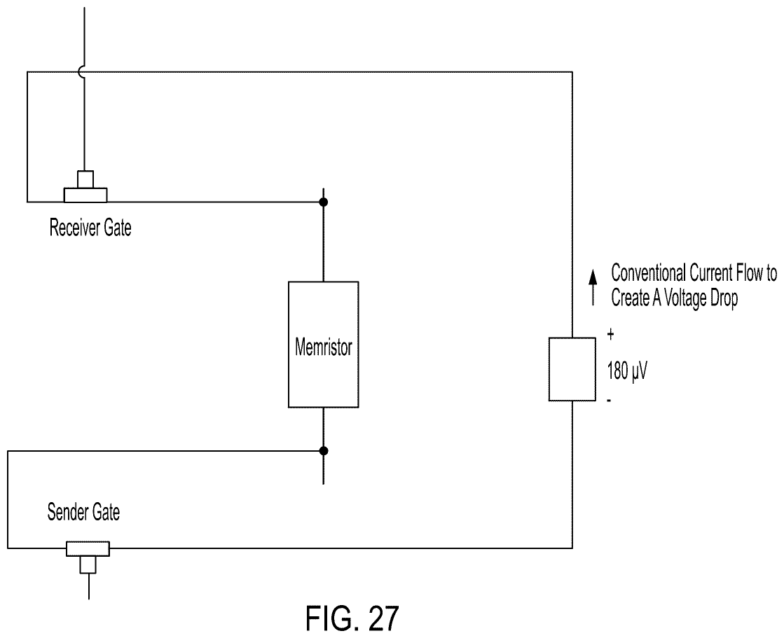

For messaging connections we can alternatively use a messaging circuit as shown in FIG. 27. In FIG. 27, there is an example implementation of an excitatory messenger connection, an electrical circuit which connects to the terminals of the memristor from the previous circuit in FIG. 26, where the circuit is characterized by two transistor gates, as well as a negative voltage supplier. As shown in FIG. 27, a messaging circuit is an electrical circuit which connects to the terminals of the memristor, and which is characterized by two transistor gates, one we refer to as the sender gate, and another which we refer to as the receiver gate, as well as a relatively large negative voltage supplier. As can be inferred from the circuit, both sender and receiver gates need to be switched on to allow for current flow, and when such is the case a relatively high negative potential difference would exist across the terminals of the memristor causing a negative change in its ohmic value, which means the resistance would decrease and the conductance would therefore increase, this would then be maintained and thereby would represent a new strength value to the electrical connection. This means it is the memristor's dynamically allocated conductivity value which would alternatively represent the influencer connection's strength value.

The negative potential difference supplied by the messaging circuit has to be relatively larger than the one supplied by the electrical circuit to ensure that the change that occurs to the memristor by the messaging circuit which represents a synaptic positive modulation is significantly large compared to the change which would inevitably occur by having an electric current flowing through the electrical circuit. Sender transistor gates would have their control wire be activated after a delay which would represent the given latency of the connection, this delay can be incorporated using an RC circuit component, however receiver gates would have their control wires activated immediately as soon as the postsynaptic node is activated.

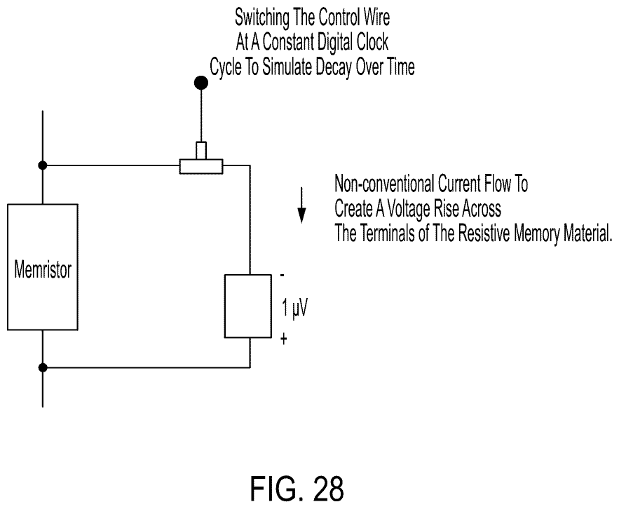

To provide a consistent decay to the strength of the connections, we introduce another circuit which we refer to as the decay circuit, as shown in FIG. 28. In the figure, the depicted circuit is connected to a memristor and has a current that runs in the opposite direction relative to the current flow from the circuit shown in FIG. 27, and with a relatively small voltage supplier relative to the voltage supplier from the circuit in FIG. 27, all connected to a transistor gate which connects to a digital clock, such that for every clock cycle the gate is turned on then off. When the gate is turned on, a small positive current flow runs across the circuit causing the memristor to slightly increase its ohmic value, which in turn decreases its conductance overall mimicking the decay of a connection strength over time.

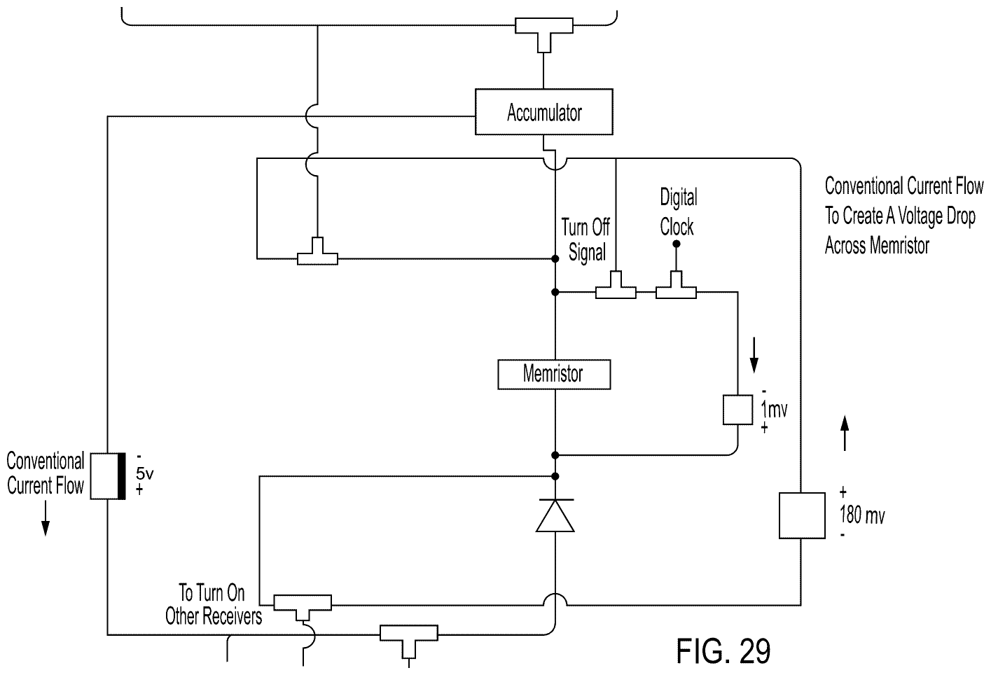

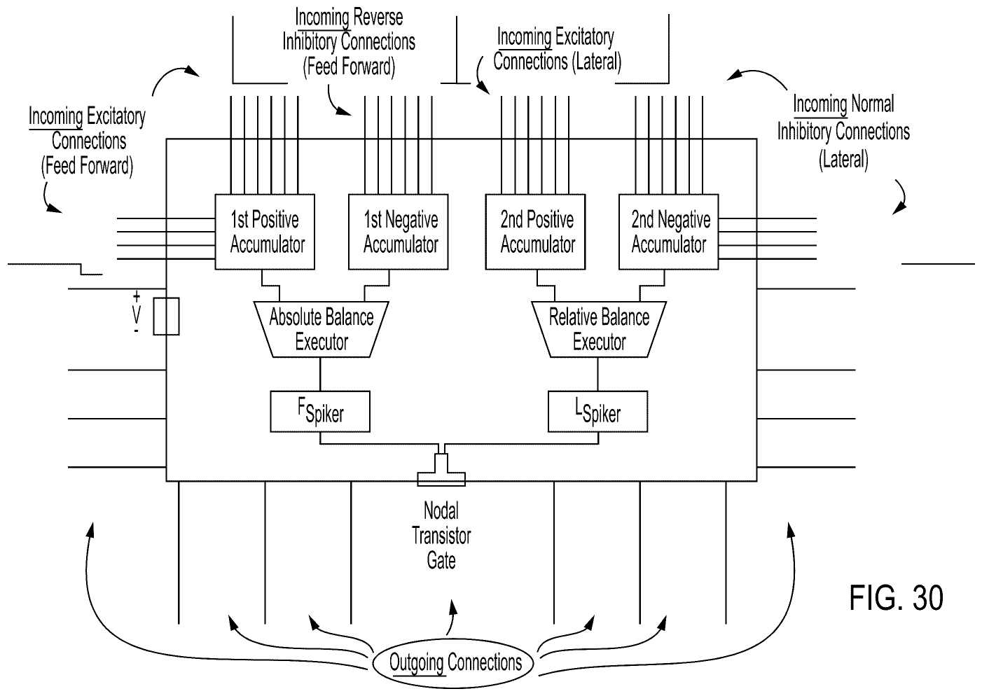

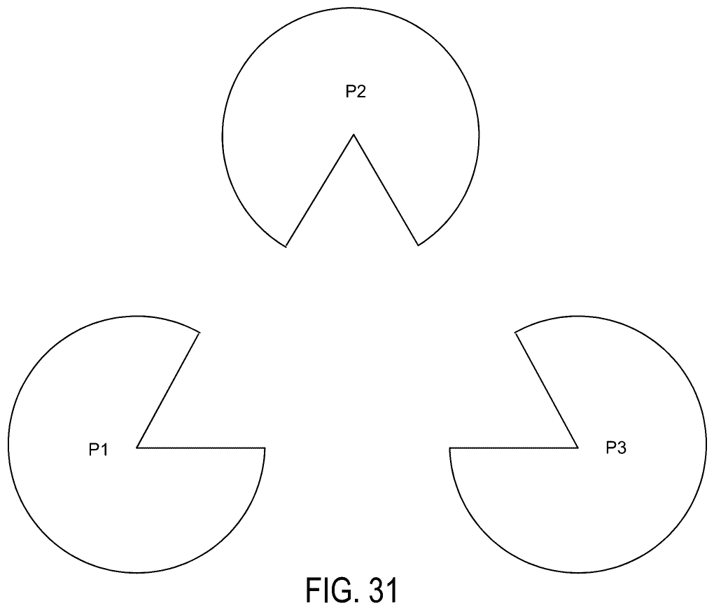

FIG. 29 shows all the circuits mentioned previously on top of each other to show a wholistic view of a normal excitatory connection. In FIG. 29, with respect to the decay circuit, an additional transistor is made to cut the positive current decay circuit and have its control wire be fed by the negative current messaging circuit (representing the circuit from FIG. 27) to prevent a decay function from executing while a growth function is being executed. As shown on the figure. It is essential to point out that the amount of growth executed by the messaging circuit shall be far greater than the amount of decay executed by the decay circuit per unit time. This translates to a greater negative potential difference per execution for messaging circuits relative to the positive potential difference in the decay circuit.

The previous messaging connection circuit relates to the excitatory connection type, where the default states of both sender and receiver gates are to be off in the case that both the presynaptic and postsynaptic nodes' state were off. For normal inhibitory connections however, the messaging circuit also contains a sender and a receiver gate, however, with the exception that the default state of the receiver transistor gate is to be “on” in the inactive state of the postsynaptic node, such that an activation of the postsynaptic nodal circuit shall mean a switching “off” of the receiver gate, through its control wire.

For reverse inhibitory connections, the messaging circuit shall contain both a sender gate and a receiver gate, such that the default state of its sender transistor gate is to be on, where the activation of the presynaptic node allows for a current to flow through the control wire switching the sender gate transistor off. This current would be supplied by a secondary circuit such that the secondary circuit is gated by both the sender gate and the receiver gates of the reverse inhibitory connections, where the default state of the sender gate is to be on for an inactive presynaptic node as clarified previously, whilst the default state of the receiver gate is to be off for an inactive postsynaptic node, to ensure that a modulation would only commence once the postsynaptic gate is switched on upon the postsynaptic node's activation.

However, recall that a reverse inhibitory connection follows a piecewise positive and negative modulation function, which means that the modulation of the connection's strength in a reverse inhibitory connection is executed differently specifically around the transition point strength value which dictates selectivity as was clarified in previous sections, where positive and negative modulation of the connection strength for strength values that happen to be less than the transition point value, follow an exponential growth and decay function, respectively, whilst following a linear growth and decay function, respectively, for values that are greater than the transition point value. The prior messaging circuit and decay circuit achieve linear growth and linear decay modulations, respectively.

To introduce both an exponential growth and decay for reverse inhibitory connections we need to multiply the voltage supplier in the messaging circuit as well as the decay circuit for every execution of modulation, because doubling the voltage supplied within the messaging and decay circuits has the effect of doubling the current that moves through the memristor. For example, if for every modulation of the connection strength, the voltage supplied to the memristor doubles, then at first modulation, we expect x amount of current moving through the memristor and therefore x amount of resistance decrease. At the second modulation we expect 2× of current and therefore 2× amount of resistance decrease. At the third modulation, we expect 4× of current and therefore 4× amount of resistance decrease. At the fourth modulation, we expect 8× of current and therefore 8× amount of resistance decrease. At the fifth modulation, we expect 16× of current and therefore 16× amount of resistance decrease and so on and so forth. This therefore would create an exponential growth/decay of the conductivity of the memristor.

Reverse inhibitory connections in a hardware setting is expected to be more complex than other connection types, since both its messaging and decay circuits require a system which allows their respective voltage supplier to grow exponentially, which in this example would be voltage doubling, such that at a certain point dictated by the transition point value the circuits transition to a traditional linear growth/decay circuit where the connections play the role of longevity rather than the role of selectivity.

The nodal circuit would be a large circuit which represents a node, and which supplies many influencer connections and messenger connections, as shown in FIG. 30. The circuit of FIG. 30 includes two positive accumulators and two negative accumulators each receiving current signals from their respective influencer connection type and specialization. These represent incoming influencer connections which feed into the node. The accumulator pairs then connect to their respective absolute balance operator and relative balance operator components, respectively, which are also connected to what we refer to as the Fspiker and Lspiker components, respectively.

The nodal circuit itself would be turned on or off by a nodal transistor as shown in the figure, which has its control wire supplied by both the Fspiker and Lspiker components, where for every transmission cycle the nodal transistor gate is turned on at a specific frequency supplied by either of these two components, which therefore turns the nodal circuit on and off in a specific frequency such that when said node is on, the nodal circuit allows all the connections connected to it (which are outgoing connections) to send current signals to other nodal circuits.

Fspiker and Lspiker are two components which shall take a DC current from the absolute balance operator component and the relative balance operator component, respectively, and map said current signal to a rate of activation at which the nodal circuit's nodal transistor gate would turn on and off within the next cycle's period, i.e., 50 milliseconds in our previous embodiment example. The Fspiker and Lspiker components are abstract components which represent any system of hardware implementation which can achieve the desired effect specified earlier.

The outgoing connections would supply the control wires of each connection's circuit transistor gate, for influencer connections this would be the only transistor found there shown on the figure, whilst for messenger connections this would be the sender gate transistor, by turning the nodal circuit on, we effectively activate all the outgoing messenger and influencer connections which sprout outward towards other nodal circuits. The connections which supplies the control wires of all the sender gates are incorporated with a delay, which varies based on the messenger connection's latency variable, and similarly, the control wires which supply all the influencer circuits would also be incorporated with such delay albeit different, since a messenger connection shall be slightly slower than its influencer pair.

In addition to supplying outgoing connections, the nodal circuit also has to be able to turn on all receiver gates from incoming connections where a set of outgoing connections from the circuit boundary shall be connected to the control wires of receiver gates from all incoming messenger connections, however this shall be implemented differently between feedforward specialization and lateral specialization connections, for the latter the outgoing connections directly connect to the receiver gates of lateral messenger connections, however for the former an additional transistor gate, which is referred to as the cell transistor gate shall mediate the outgoing connections and the control wire side of the feedforward messenger connections, such that only when the cell transistor gate is on, can a current flow through and onto the feedforward messenger connections' control wires.

The cell gate transistor, would have its control wire be connected to all incoming excitatory influencer connections from the feedforward specialization connections that are projecting from all nodes which belong to a single receptive cell, such that any signal sent by one of these connections can effectively turn on the cell gate transistor allowing for modulation to commence. For clarification, recall that each cell gate would represent one cell not one node, where a cell can be composed of many nodes and therefore a cell gate is controlled by all connections projecting from all members nodes of the cell said receptive cell gate represents. Each cell gate would mediate a set of incoming feedforward messenger connections projecting from a group of nodes representing one receptive cell, where the feedforward excitatory influencer connections would be connected to the control wire of the cell gate which represents their respective cell which the nodes they project from belong to.

Outgoing connections which supply the control wires of the receiver gates are not delayed, as was the case for those which supply both the influencer circuits transistor gates and the sender gates. The voltage suppliers of each circuit type shall be shared across all connections, the same for the digital clock which connects to the gate of the decay circuit, the delay will also be supplied externally and be shared for bands which share the same predefined latency value.

In the hardware implementation, the feedforward connectivity structure would follow as specified in the previous embodiment only replacing the software connections with their hardware counterparts laid in this part of this section while preserving the appropriate feedforward connectivity structure and the latency values for each connection band, and where the memristors' ohmic values would be initialized at a certain maximum threshold which translates to a particular minimum conductivity state, mimicking the certain minimum strength value specified for each type of the feedforward connection pair as clarified in the previous embodiment.

For the lateral connectivity structure the most suitable connectivity structure would be an all to all connectivity structure such that all the lateral connections are at a default strength value of zero, which means the maximum ohmic value for their respective memristors, this is since an all to all connectivity structure would fully capitalize over the massive parallelism of such neural network architecture implemented in a hardware setting, thereby deliver great efficiency.

### 5-C Model Implementation

We introduce four models which are tailored to learn from different sets of data.

### 5-C-i The MNIST Model

The architecture of this simple model, contains three types of layers that are stacked in a feedforward structure, the input layer, the specific selective layer (analogous to the hidden layer), and the general selective layer (analogues to the output layer). The input layer is divided by N*N sized kernels analogous to convolution layer kernels and we refer to each subsection of the input as receptive kernels. Similarly, the specific selective layer is divided into N*N sized cells each cell is composed of N*N nodes, and we refer to each of these cells as specific selective cells. Each receptive kernel from the input layer can form connections only to one specified selective cell which represents it from the second layer.

The input layer is composed of 27*27 receptive cells, such that each cell contains two nodes, one ON Node which represents White pixels, and one OFF node which represents Black pixels. ON and OFF are merely neuroscience terminologies that refer to ON and OFF ganglion cells, and they do not entail any activation meaning, in other words ON nodes can get both active or Inactive depending on what color the input pixel it represents currently is, and similarly OFF nodes can get both active or Inactive depending on what color the input pixel it represents currently is. ON does not mean active and OFF does not mean Inactive

Each receptive kernel is composed of N*N receptive cells (where each cell contains two receptive nodes as mentioned previously, one ON node and one-OFF node) therefore a receptive kernel contains N*N*2 receptive (input) nodes. Each Selective Cell is composed of X amount of specific selective nodes, where X is determined based on the size of the receptive Kernel N*N as will be clarified later. Only one selective node for each selective cell can be active at a time. The general selective layer contains 10 general selective nodes each representing one of the 10 MNIST classes.

In this model, each specific selective node is incorporated with an activity state variable (the “state variable”), a net total (positive and negative) signal sum variable (the “weighted sum variable”), and an array of 10 memory addresses each holding the values of one of 10 counter variables. On the other hand, each general selective node is incorporated with a net total (positive and negative) signal sum variable (the “weighted sum variable”) which would represent a continuous activation level of the node based on the inputs it receives. Following the general selective nodes, a SoftMax function based on the weighted sum variables will be employed to execute a non-maximum suppression, and therefore in these particular simple models, the general selective nodes are made not be binary leveled.

The Two types of connections are introduced in these simple model variants; Reverse inhibitory connections and excitatory connections, each connection composed of a pair of connections with two modes, a messenger and an influencer mode, and each pair type serves a purpose and follows its particular learning rule as follows:

The two types of unidirectional connection pair representation would lie between any node pair between the receptive layer (input layer) and the selective layer (hidden layer) within the feedforward connectivity structure, where for each type, the connection pairs consists of one connection mode performing an influence role (the “influencer connection”), capable of exercising an influence onto the postsynaptic (receiver) node's activity state, and another connection mode performing a messenger role (the “messenger connection”), capable of detecting time dependent correlation of activity states relating to the pair of nodes which lie across both terminals of the connection pair.

Note: postsynaptic node refers to a node that is on the receiving end of a connection, while presynaptic node refers to a node that is on the sending end of a connection.

The influencer connection possesses a dynamic memory variable that retains in memory a value which represent the influencer connection's weight of signal influence magnitude (the “weight variable”), where the value can undergo both positive and negative modulations, and it is also incorporated with a static latency variable which provides to the influencer connection a transmission time delay of influence. The messenger connection on the other hand is only incorporated with a static latency variable which provides to the messenger connection a transmission time delay of messaging.

One of the two connection pair types (the “excitatory connection”) follows a learning algorithm, where the algorithm positively modulates the value of the weight variable of the influencer connection via a linear growth function and based on time dependent positive correlation of activation under the condition that, its messenger connection pair detects that the presynaptic node was active, before or while the postsynaptic node is found to be active, whereas such a detection would be registered if an only if a message signal is sent through the messenger connection after a delayed time period equal to the duration of transmission latency allocated for the given messenger connection and measured from the time of the presynaptic node's moment of activation, and only when the message was sent at a moment at which the postsynaptic node is active as well. The previous strengthening mechanism is in line with Long term potentiation (LTP) which exhibits in biological excitatory connections.

Additionally, the other of the two connection pair types (the “Reverse Inhibitory connection”) follows a learning algorithm which positively modulates the weight value of the influence connection via a piecewise defined growth function which begins with an exponential growth then is followed by a linear growth, all based on time dependent negative correlation of activation under the condition that the messenger connection detects that the presynaptic node was inactive, before or while the postsynaptic node is found to be active, whereas such a detection would be registered if an only if a message signal is sent through the messenger connection after a delayed time period equal to the duration of transmission latency allocated for said messenger connection measured from the time of the presynaptic node's moment of inactivation, and only when the message was sent at a moment at which the postsynaptic node is active. Another variant for LTP however with different activation conditions.

Furthermore, a negative modulation function is introduced to the weight values of the influence connections for the first connection type (referring to excitatory connections), through a linear decay function which is consistently executed as a function of post synaptic node inactivity for every time the presynaptic node is active, in other words, If pre synaptic node was active before or while the post synaptic node was inactive Then we execute one linear decay point to the connection with a magnitude proportional to its corresponding growth function magnitude. This shall reduce the corresponding weight value. While allowing for negative weight values. The previous weakening mechanism is in line with Long term depression (LTD) which exhibits in biological excitatory connections.

In these simple models we introduce two modalities for the excitatory connections, one which is only incorporated with LTP and another which is incorporated with both LTD and LTP.

Each input node within its specified receptive kernel from the input layer will form an excitatory-reverse inhibitory connection pair with all the nodes that exist within the bounds of the specific selective cell that represent the receptive kernel it belongs. This is given that the excitatory connections used in this particular first-to-second layer connectivity only follow an LTP mechanism, i.e. only grow but do not decay.

Each and every node in all selective cells which belong to the selective layer (hidden layer) will connect to each and every node from the general selective layer (output layer 3) through only an excitatory connection which exhibits both LTP and LTD. The sensory layer is what will be referring to the black and white input sensory layer, BW layer for short. The BW layer will have one simple function which is to map a black/white pixel, to the first/second selective node from the receptive cell of the first layer of the previously mentioned architecture. Where the assumption is that for a given training cycle, a grey scale MNIST data sample image will be supplied to the software architecture model such that each pixel shall correspond to one receptive cell from the first layer of the architecture. If you recall each of the first layer's receptive cells contains two receptive nodes per receptive cell.

We will have to specify a grey scale value threshold above which we will be threshing the input sample, for example if we say that any pixel that is below 0.2, a form of high pass filter, where only grey scale values above the certain threshold are mapped as white pixels and the rest will be considered dark pixels. The goal is that for each image a function (represented by the BW layer) would map, black pixels to the first node of the corresponding receptive cell and white pixels for the second node of the corresponding receptive cell. Such mapping would mean activating the corresponding nodes. So, if in any given pixel its color is registered as white in that pixel, then the first receptive node from the corresponding receptive cell of layer 1 of the architecture, must be activated, on the other hand if it was black then the other/second receptive node is the one which shall get activated. (Notice the activation in this case is mutually exclusive for every given input image, since a pixel can only be black or white not both for a particular static image)

The learning process occurs as follows:

In the MNIST-10 model The Data set is divided into the 10 classes, each class of data samples is fed into the network such that the classes are fed to the network wholly one class at a time. After threshing the data as clarified previously, we end up with an input representing a binary node activation map, OFF nodes are active for dark pixels and ON nodes are active for white pixels.

We first set the connection weights for both reverse inhibitory and excitatory connections to zero. Then we allow for a mechanism which adds a Spontaneous activation for all free nodes (every clock cycle) while maintaining the mutual exclusive activations of the nodes for every selective cell i.e. only one node activated at a time per selective cell. The spontaneous function ensures that only one random node selected from the pool of nodes with status variable set with the value “free” within every selective cell get to be activated every major clock cycle. Only one node activation per selective cell per cycle.

Once such node gets activated then the conditions for the connection pairs which lie between the two layers will be met, such that the once randomly chosen “free” specific selective node learns one and only one ON-OFF binary map from its input receptive kernel, by modulating the excitatory and reverse inhibitory connections based on the mechanisms outlined earlier. (a kind of automatic template matching mechanism) Take note, that only one node per selective cell can be active at a time. Once a specific selective node memorizes a particular binary map, it ceases to activate in response to nothing but the exact activation of said binary map (hence specific selectivity) and its status variable changes to “unfree”, its activation would only occur whenever the network re-encounters the same stimulus/feature it learned again.

Then we allow nodes which already Learned to be selective (i.e. unfree nodes) to be activated/inactivated aka get influenced through their set of connection pairs with the input, faster than free nodes. I.e. abstracted as getting a shorter latency than unfree nodes.

This would be achieved by letting the weighted sum processing speed of a node to take two states high if net depolarization or hyper polarization i.e. signal magnitude is high, or low if net depolarization or hyper polarization i.e. signal magnitude is low, low is the default timeline specified in the major clock cycle examples. Therefore, any pre-mature node activation turns off the spontaneous activation process due to the normal inhibitory conditions as they will ensure the suppression of the rest of the nodes until the major clock cycle is complete.

This way if a node was an unfree node it will have the ability to receive a signal (depolarization or hyper polarization) before any free node gets activated, and hence a reoccurring pattern if perceived gets the node that has learned it activated first, it's necessary to clarify that all unfree nodes receive the influence faster regardless if they are receiving positive influence from a matching input or negative influence from an un matching input.

On the MNIST model example, the speed of activation is specified based on the node's binary status, free/unfree. On another variation we allow for a gradual set of states of processing speeds which vary linearly proportional to the magnitude of weighted sum depolarization or hyper-polarization signal received. The low-high variant is for this model since we do not incorporate gradual change of selectivity. The linearly proportional speed variant is for connections which grow gradually in strength before achieving their maximum selectivity threshold.

The goal is to ensure that the selective layers memorize all the features present in the data set, such that each specific node memorizes one of said features. The premise as will be clarified later, is that a data class contains common features which represent the definition of said class, and the goal becomes to isolate said common features and use them to identify new data points as they would share a small fraction of the common features.

This is where generalization come into picture, once the selective layer memorizes all the features that were found in every data class, the goal is to associate the common features which happened to be frequently encountered in one particular class with the general selective node which represent said class. This is achieved by allowing for the spontaneous growth of connections Via LTP between the selective nodes and the general selective node which is made to be active as the output representative of the data class being trained, and allowing for the spontaneous decay of connections via LTD between the selective nodes and the set of all other general selective nodes which do not represent the data class being trained. As will be made clear later this algorithm draws parallelism to the job executed by BP via gradient decent optimization, only no cost minimization or calculus is required to achieve the same task.

Every time a specific selective node gets activated depending on which class we are training the general selective node's corresponding counter within the array which lies within the given specific selective node will be incremented one point. This array will track the frequency of activating a particular selective node (i.e. perceiving a particular feature represented by a particular binary map) per a given class from the 10 generalization classes. This frequency feature will also be useful for executing a forgetting mechanism using a high pass filter as will be clarified later.

The mean value of each array counter values will represent the bias value which is exclusive to each node and the connection it projects to the third layer, where the array's total 10 counters are summed and their result divided by the number of classes is added to the connection weight value upon signal influencing at (testing).

We use those simple equations to achieve our goal in NNNs. In excitatory connections we use the following equations for LTP & LTD.

For LTP we follow:

$$New {W}_{ij} - Old {W}_{ij} + ( {x}_{i} \times {Y}_{j} \times K \times r ) \qquad ( Eq . 9 )$$

$$New {W}_{ij} - Old {W}_{ij} = K \times r \qquad ( Eq . 10 )$$

$$For LTD we follow :$$

$$New {W}_{ij} = Old {W}_{ij} + ( {x}_{i} \times ( 1 - {Y}_{j} ) \times K \times r ) \qquad ( Eq . 11 )$$

$$New {W}_{ij} - Old {W}_{ij} = K \times r \qquad ( Eq . 12 )$$

where Wij refers to the value of the weight laying between the two nodes, Xi refers to the binary activity state value of the presynaptic neuron (the predecessor node), Y, refers to the binary activity state value of the postsynaptic neuron (the successor node), r is the learning rate, and K is some arbitrary constant value such that New Wij−Old Wij=K. For the sake of explanation, we use r to signify repetitive stimulation as opposed to a typical learning rate.

For extra clarification, Xi and Yj represent the required state for such weight update to occur to the weights, for LTP, they have to be 1 and 1 respectively, and for LTD they must be 1 and 0 respectively. Variable r represents how many times the conditioned states pair happened to be true.

For reverse inhibitory connections we use:

$$New {W}_{ij} = Old {W}_{ij} + ( ( 1 - {x}_{i} ) \times {Y}_{j} \times {K}^{r} ) \qquad ( Eq . 13 )$$

These previously stated equations are used when we want to allow for gradual change in selectivity for the purpose of node count optimization, on the MNIST model we will instead go for a one-time growth of connections weight to reach selectivity.

The simplified one-time selectivity for excitatory connections

$$New {W}_{ij} = Old {W}_{ij} + ( {x}_{i} \times {Y}_{j} \times K \times r ) \qquad ( Eq . 14 )$$

the simplified one-time selectivity for reverse inhibitory connections

$$New {W}_{ij} = Old {W}_{ij} + ( ( 1 - {x}_{i} ) \times {Y}_{j} \times S \times K \times r ) \qquad ( Eq . 15 )$$

where S refers to the selectivity ratio we desire to achieve and is computed based on the kernel size, and desired tolerance level allowed. For example, 8:1 for 3*3 kernels, and 24:1 for 5*5 kernels at zero allowed tolerance for kernel cell change.

In training the node activation can be modeled with the following two equations: For free nodes: Node=Free_nodes_list.pop( ) Delay(d); Node.weighted_Sum=kernel size·K·r; Node.Set_status (“unfree”). We choose one of the free nodes in the list and wait for delay time d then significantly increase its weighted sum variable to spontaneously depolarize it. For unfree nodes: Delay(0).

$${Y}_{j} = {\sum }_{k = 0}^{k = 2 \times Kernel size} ( {W}_{ij} ( exec ) - {W}_{ij} ( Rev\_Inhi ) \times {X}_{ik} \qquad ( Eq . 16 )$$

At no delay the selective node immediately receives influence from the input baser on the kernel size, where for a 3×3 input patch we get 9 connections×2 for 2 nodes per receptive cell input, for a 5×5 input patch this would be 25×2 etc. k represents the number of receptive nodes per receptive cell, 18 nodes in 9 cells in the 3×3 patch and 50 nodes 25 cells in the 5×5 patch etc. Xix represents the nodes binary status 0 or 1, for inactive or active respectively. Notice that since the nodes in the receptive cells are mutually exclusive in activation by design, only 9 nodes will be active at a time and hence only 9 connection pairs will influence Yⱼ at a time.

In testing and validation, the node activation can be modeled with the following equation:

$${Y}_{j} = {\sum }_{k = 0}^{k = 2 \times Kernel size} ( {W}_{ij} ( exec ) - {W}_{ij} ( Rev\_Inhi ) \times {X}_{ik} \qquad ( Eq . 17 )$$

One selective layer multiplied by one N*N kernel will limit the network to only memorizing features which are N*N in size. To alleviate such limitation, we allow for a multiple sized input-selective layer pairs which run in parallel, such that kernels of different sizes are learned by each parallel selective layer. The initial configurations we picked in this model architecture is the following:

The configuration opts for one-unit stride (no padding) is as follows:
27*27 input CONV 3*3 yields 25*25 Selective cells each cell with 512 nodes
27*27 input CONV 5*5 yields 23*23 Selective cells each cell with 512 nodes
27*27 input CONV 7*7 yields 21*21 Selective cells each cell with 512 nodes
27*27 input CONV 9*9 yields 19*19 Selective cells each cell with 512 nodes
27*27 input CONV 11*11 yields 17*17 Selective cells each cell with 512 nodes
27*27 input CONV 13*13 yields 15*15 Selective cells each cell with 512 nodes

All the parallel selective layers have their specific selective nodes project their connections into the same set of general selective nodes, however this would cause a problem of proportionality, since as we specified only one node can be active at a time within any given selective cell.

This means in the first configuration, the 9*9 selective cells which are the result of 3*3 full stride kernels and which represent small features from the input would have 81 specific selective nodes influence any general selective node at a time. However, the 3*3 selective cells which are the result of 9*9 full stride kernels and which represent significantly larger features from the input would have only 9 specific selective nodes influencing the same set of general selective nodes, and as a result a disparity in activation influence power exists between specific selective nodes which represent the smaller features relative to those which represent the larger features.

The solution to this is to incorporate a weight factor multiplied by the different excitatory connections which project from the different parallel layers of specific selective nodes, the factor that best achieves such normalization would be the amount of input cells a selective node represents, in our previous example the first group of nodes represent 9 input cells (which is equal to 18 nodes since recall there are two nodes per cell ON and OFF) Whilst the second group of nodes represent 81 input cells, therefore for the former case 81 cells multiplied by factor 9 gives off the same power influence as 9 cells multiplied by factor 81.

The same principle cannot be applied for the second configuration, instead we multiply with a factor which ensures that each selective layer has equal power influence, for example connections projected from the 25*25 selective cell layer will be multiplied by factor 1, while connections projected from the 15*15 selective cell layer will be multiplied by factor 25\hat{ }2/15\hat{ }2=2.78.

To give this neural network model generalization power we have to remember that the goal is to turn this memorization machine into a generalization one. First, we need to recall the following.

Each counter variable in the array which is stored within each specific selective node represent the frequency a specific selective node was encountered in conjunction with a particular general selective node, and since LTP is based on the correlation of activation between the node pair, the connection between the two nodes will grow as a function of said frequency. In other words, these frequency values signify the connection strength level, and the variables which hold these values can be used to exercise a cut off weight strength value, were only connections with a particular weight can be allowed to communicate information to the general selective node.

A cut off weight strength value simulates forgetting as it simulates failure of communication due to synaptic weakness in biological neurons, and therefore it allows to mimic the process of forgetting and more specifically abstraction. We can therefore add a policy where we only allow certain nodes which pass a certain threshold Z to have an influence power on a given general selective node.

To understand the utility of this feature to the model we need to first define some terms. We can divide the set of all features represented by all specific selective nodes, into three categories, the set of all learnable features which can include noise, salient features and class differentiators.

The set of all learnable features includes everything the network can memorize, while salient features refer to features that are frequently encountered regardless of the class, class differentiators are a subset of salient features which differentiate between classes and therefore are frequently encountered disproportionately in one class or two classes relative to the rest of the classes.

A class differentiator feature, is a subset of the set of all salient features which are a subset of the entire set of learnable features. Where all features are represented by a designated specific selective node. Noise features are features which are encountered infrequently across any class, the cut off value which mimics abstraction, removes those features from the decision criteria.

For example, let's say that in our MNIST data set, inside the class of all samples which represent number 0, one sample had a typo where the written zero digit contained and additional white cross mark in the center of the hole of the digit zero. This cross feature happens to be encountered only once in the entire set of zero-digit samples since it's a typo, and therefore has a frequency of encounter equal to 1. This is an example of a noise feature, which shouldn't be allowed to participate in the decision-making process of the network, because it is not representative of the set of common features which are found in a large number of zero-digit samples.

Therefore, simply put, a minimum cut off value ensures we remove as much of the noise from the class definition as possible to allow for the set of all common features to have the sole influence power over the activation of the general selective node in question, while neglect any influence received from features that do not common across many samples and therefore do not represent the class.

The next criteria is what we will be referring the second cut off value, this is another cut off value which differentiates between features that are common across many classes (not class differentiators) and common features that are only present disproportionately in one class relative to the rest of the classes. To illustrate the purpose of the second cut off value let's take the following example.

Let's say three given specific selective nodes A, B and C each represents feature A, B and C and are great differentiators of classes X, Y and Z respectively. Let's assume they have the following counter frequency matrices each where the matrices follow the following counter variable space allocations [X Y Z] and while assuming our model has only those 3 general selective nodes X, Y and Z for simplicity: A=[7 3 1], B=[2 9 4], C=[6 0 8]

Since we assumed that A acts as strong differentiator for Class X it makes sense that A has been most repeatedly encountered in Class X samples which reflects on its counter variable, being encountered most at 7 times in class X. However, notice this does not mean that feature A has not been encountered in samples which belong to other classes, Y and Z, it only was encountered less, 3 times and 1 time respectively.

This means A would be connected to general selective node X with a connection that has 7 points of strength, and to general selective node Y with a connection that has 3 points of strength, and to general selective node Z with a connection that has 1 point of strength. In turn this means if a validation sample was to have this particular feature A embedded in it, general selective node X would receive 7 points of activation influence, followed by Y with 3 points and Z with a single point.

If a test sample only contain that single feature then we could call it a day because X would be most active. However usually a test sample would contain more than one learned feature and therefore it's not as cut and clear, other features could interfere differently with the same general selective node matrix through different weight matrices and cause different activation results. And here comes the value of the second cut off value.

A single cut off value matrix like this, [7 7 7] for example would entail that feature A can only interact with general selective node X, and feature B with node Y and C with node Z. ensuring that each specific selective node only interacts with the class it most belongs to. In this case we use the max value to indicate who the node can connect to, where we simply attribute a node to the class of its maximum value if we want to achieve singular connections between node and output layer, this shall allow for node specialty as it becomes a perfect class differentiator, However, not all salient features are useful in our decision space and are as cut and clear. A salient feature is defined as a feature which is frequently encountered across many samples, however one salient feature can be encountered very frequently across many samples from multiple classes, and therefore becomes an un-decisive feature, since it belongs to many classes, and here comes the value of weeding out non-class differentiators.

In other words, a class differentiator is a subset of the set of all salient features which is frequently encountered in only one class relative to the rest (we will come to know later that we could allow for a feature to belong to more than one class but less than 4 classes, to allow for sub classifications) for example, let's take the example of a top left all black corner 3*3 feature in the background of all MNIST data samples. Since all MNIST data samples share the sample black background, they will share the same black 3×3 top left corner feature. This means the counter matrix for that feature would look like this: [5000 5000 5000 5000 5000 5000 5000 5000 5000 5000]

This entails the following, first the feature is a highly encountered feature so it passes the abstraction level represented by the first cut off value (minimum cut off value), second the feature is a salient feature to each and all MNIST classes, and therefore it is not a class differentiator, since it does not differentiate one class from the rest. Therefore, another criterion is required to remove such non-discriminatory features from the decision space, as they give no value to the task in hand, the task of classification.

To know whether a feature is a class differentiator we sort each node's array of counter values (after training) then compare the top 2 frequent counter values as a percentage of the whole such that if the difference between the top two is higher than a certain percentage say 33% the node is recognized as a class differentiator and is added as part of a given class's definition otherwise it's subtracted from that given class's definition. For example in the previous case the black corner features top 2 values are 5000 and 5000 let's assume the values are slightly different say 50 and 49, when we calculate the percentage of each, we say 50/N=almost 10% and we calculate the second value 49/N where N=total counter values, we get 9.8%, if we subtract the top two percentages, we get 10−9.8=0.2%, this value is below our set threshold which 33% so we say the feature is not a class differentiator.

On another example, we have a feature with the following matrix, [7 2 1] assuming only 3 general selective nodes, if we calculate the top 2 percentages we get the following: 7/10 and 2/10, then subtracting the results we get 50%, which crosses our 33% threshold. Therefore, the node is considered a class differentiator to the first general selective node class, and retains its ability to influence the first general node.

This however isn't necessarily the optimal solution, because sometimes having specific selective nodes which differentiate a few general selective nodes from another rather than only one general node can be helpful. A Classical example is the 9,8,6 example.

A 9 shares the top loop with an 8 while a 6 shares the bottom loop with that same 8. In this case, both the top loop feature and bottom feature, should have equal ability to influence not only one general selective node, but two general selective nodes, the first top loop feature should be allowed to activate general nodes which represent both classes of 9 and 8, and the other bottom loop feature should be allowed to activate general nodes which represent both classes of 6 and 8. To achieve this we use multiple top features, so instead of comparing the top two values we also compare the second set of top pairs, that would be the 2^{nd} and the third counter values in the sorted list.

The threshold value acts as a discriminatory tolerance value, which specifies how much discrimination we can tolerate between the top two or more values, lower tolerance for discrimination (higher threshold) means we want the feature to be significantly and more disproportionately frequently encountered in one class relative to the next class, in order of different class encounter frequency.

In other words, the second cut off value selects from the already selected set of highly encountered features (where the first selection criteria were minimum cut off value) the most class differentiating set of features, to participate in the final decision of the network by only allowing the latter features to communicate with the general selective nodes.

It's necessary to clarify that both, the first and the second cut off values work hand in hand to select the proper features which are going to participate in the decision-making process of the network. Let's take the following two examples to illustrate this. If we say a cross/plus feature was found in the right top most corner of a 1-digit sample from the 1 MNIST class. Assuming it's a typo, this feature will be a class differentiator, since it only occurred in that sample which belongs to this particular class.

If we did not have a minimum cut off value, this particular feature which only occurred once across the entire class and the entire training samples, would be considered as a class differentiator feature and would participate in the decision-making process. When in fact that feature isn't a good representative of the class it belongs to since it's not common with any other sample in the same class. The second example is the black corner example mentioned earlier, it is highly common across all the samples of that same class, and therefore it passes the first selection criteria, however because that same feature occurs equally across all other class, it ceases to be a useful feature and therefore it is also selected out.

The first example illustrates a case where we maximize the inter-class distance while not minimizing the intra-class distance. Whilst the second case illustrates an example of minimizing the intra-class distance without maximizing the inter-class distance. The goal is neither, the goal is to both maximize the inter-class distance and minimize the intra-class distance, and this is achieved by using both cut off policies together, where minimizing the intra-class distance was represented by finding highly common features which are shared across a significant amount of data samples from the same class, while maximizing the inter-class distance was represented by finding a feature which is distinctly found in one class but not in the rest of the classes.

There are two problems we would encounter due to the fact that we have multiple parallel layers, each with different kernel sizes. The first problem is a need to normalize differentiability across different layers with different kernel sizes.

To illustrate the problem, we need to understand the statistical nature of features with different sizes. A 3×3 kernel size bounded feature is more likely to be encountered frequently relative to a 9×9 kernel size bounded feature. This is because feature size scales its complexity and the more complex a feature is the less likely it is to re-occur relative to smaller simpler features. The reason for this also comes from how we restrict our definition of a feature, where the level of node selectivity specifies how much difference between samples can be allowed for these samples to be considered similar and therefore represented by the same node. The greater the feature sizes get, the greater the chance for multiple points of difference becomes between any two samples, and hence the lower is the frequency of total feature encounters.

For example, the likelihood of finding a 3 pixel long vertical edge, in the right most part of the set of Digit 9 class, is higher than the likelihood of finding a particular 13*13 sized upper loop feature identical down to the pixel in the same class. This will be adjusted when we tackle tolerance on another section, as would allow for difference in pixel tolerance in selectivity which scales proportionally with feature sizes. However overall, the set of simple features will always be more frequent than the set of complex features.

But, and here is the catch, the set of complex features however limited they will always be more class differentiating, than the set of simpler features, and this scales with size. In other words, the bigger the feature is the better it is a class differentiator given that its frequently occurring in its designated class. For example, a 3×3 feature sized vertical edge, will likely be scattered across all 10 MNIST classes, alternatively a large 13×13 top loop feature is only going to be found in both the 8 and 9 MNIST Digit classes.

This means by virtue of size alone, there's a un proportionate distribution of class differentiability potential across features. This might entail that smaller features are useless since the vast majority of which would not be able to help differentiating between classes. However, this is not necessarily the case, small features can and do have the ability to aid in differentiating between classes by treating them as subsets of a large feature as opposed to treating them as isolated small features.

To achieve this, we need to allow for a relationship between larger features and smaller features which are subset of said larger features by allowing smaller features to inherit the differentiability potential from the larger features they are subset to, thereby normalizing differentiability across all feature sizes.

For example, the top loop 13×13 feature which can be found in only two classes, the classes of digits 9 and 8, would be composed of multiple smaller 3×3 features which make up the small arcs that make up the entire loop. Some of these small arcs are merely simple edges, and out of context they seem to be insignificant and not differentiating for any classes. But with the full context of the bigger feature which they help make up, these small features can play a role in becoming true class differentiators, by simply inheriting the context, in other words inheriting the array of counters which the larger feature they are a subset of has. Then using the additional inherited array of counters to augment the calculation of their own differentiability value. This means by virtue of it being a subset of an important feature, the small feature inherits such importance.

This is ground breaking for a reason, recall that large features are great class differentiators (therefore easily maximize inter-class distance) but at the same time they are less commonly found (therefore, hardly minimize intra-class distance), on the other hand small features are highly common in a given class (therefore easily minimize intra-class distance) but at the same time they are bad class differentiators (therefore hardly maximize inter-class distance).

Therefore, by allowing smaller features to inherit the differentiability potential from every larger feature that they are a subset of, we thereby achieve the optimal classification solution, both maximizing inter-class distance and minimizing intra-class distance. As you might infer this would carry for all features which are subsets of larger features, where the smaller features inherit from the set of all larger features which it is a subset of. For example, a 3×3 feature will inherit (or have access to depending on implementation method) the counter values array of a 7*7, 9*9, 11*11 and 13*13 feature it is a subset of and so on and so forth for all other features.

For this to work however, the weight of the inherited values has to be proportional in size to the feature we are inheriting from. A 13*13 feature by virtue of its complexity is more important in weight than a 9*9 feature, as it would be more class differentiating. To account for this, we multiply the inherited values with a factor, where we chose in this model to have this factor be the size of the kernel.

To optimize this process, we stack the parallel layers in a feedforward manner such that each selective node which represents a large feature lies deeper in the structure and is able to back propagate the count values to smaller nodes which represent smaller feature subsets of the larger feature. However, notice that these parallel layers although will seem to be stacked in a feedforward structure, there computations are still conducted in parallel since they do not depend on each other. The only purpose of feedforward layer stacking is to allow the deeper (larger kernel sized) selective nodes which represent larger features, to communicate back the counter values to the set of subsets of smaller feature representing nodes (which lie early in the network) which shall inherit those counter values from said deeper nodes.

The processes are merely addition operations, the factor k will be set prematurely before network training and for every increase in frequency of a given large feature encounter, the proper values will be accumulated in an array designated for all inherited values which come from forward layers. For example, let's say we have a 27*27 sized feature, which was encountered 1 time, the 27*27 sized feature can be dissected into 9 different 9*9 features and each of these 9*9 can also be dissected into 9 different 3*3 features. Once a second encounter occurs to the large feature its counter array will store 2 in the designated proper class section in the array, and will propagate this value back to all the smaller nodes which represent the smaller features that make up that large feature, were for each of these smaller features, either the 3×3 or 9×9, a second counter array will accumulate this value multiplied by the factor (the size of the large feature they are a subset of) in this case this means adding 27*27=729 points onto the proper class section of the second counter array. If the same large feature was encountered again in the same class we add another 729 points in the small features' arrays, totaling 1458 and so on so forth. Notice we propagate to all smaller features that are subsets of the larger feature concurrently (as in the larger feature propagate to both the middle feature and the smaller feature) not sequentially (as in the larger feature propagate to the middle feature and the middle feature to the smaller feature).

Later after training when we calculate the differentiability factor to select the nodes which will participate in the decision making, all we do is multiply the values of each smaller features first counter array by the size of that small kernel/feature size they represent (a normalization process), then sum the two arrays, and calculate the top two or top three differential values as we did previously. This ensures we normalized the values before using them for the second selection criteria.

The second problem is we need to set proportional minimum cut off values across different kernel sizes, since the larger the feature the less frequent it is relative to smaller features, and therefore it makes no sense to use the minimum cut off values across all parallel layers. The solution would be to get the center of mass of all the possible frequency values, this can be achieved by traversing each frequency value in a given class across all nodes, and count the different frequencies, i.e. how many features that were encountered 7 times etc. and then multiplying the count by the frequency value (equivalent to the positional value in a center of mass calculation) and divide the result by the total frequency (i.e. summing all frequency values we counted) which will be equivalent to the number of data samples trained from the MNIST class.

In summary the cut off value serves two roles. Abstraction by allowing for a minimum frequency, and node decisiveness by measuring class differentiation potential using top first or top two first counter values as means to identify which class they belong to and therefore are allowed to communicate with via signal influence directed to said class/s designation general selective node/s.

In this model, we use a cut off value instead of a regular decay function as explored in the patent publication because this model is supposed to resemble the simplest form of the models we introduce, however mechanisms employed in more complex variants of the architecture design would be based on decay functions that are time dependent as is explored deeply on the feedforward section of the patent publication.

On this section we explore the importance of allowing for a range of tolerance in specific selectivity especially when the features size and hence complexity increase. The goal of selectivity is to extract features that are found common across a wide range of samples which belong to a given class or multiple classes, how strict the selectivity is made to be reflects how less tolerant a node is to small changes in a feature it learned to represent and therefore recognize.

A very strict selectivity policy, would entail that a single pixel change in the feature is sufficient to render it different to a given selective node. Now, one pixel change difference in a 3×3 feature is totally different in impact to a one pixel change difference in a 13×13 feature. In the former case the one-pixel change would represent a change of around 1/9=11.11% of the total information carried by the small feature. While on the latter case, the same one-pixel change would represent a change of around 1/169=0.59% of the total information carried by the larger feature. That's 19 times less.

This would entail that the larger the kernel size, and hence the feature, the more noise and slight differences here and there should be allowed, as the less likely two large features will perfectly match. Introducing a proper tolerance rate would ensure that features which are “similar enough” get to be counted as representing the same information, and hence represented by the same specific selective node. However, this does not mean that this tolerance rate can go unbounded or else we entirely lose the purpose of selectivity. We advocate two specific tolerance values representing a lower bound and an upper bound, 11.11% and 22.22% respectively.

This means if we pick the lower bound, a 3×3 kernel of 9 cells can tolerate 9×11.11%=1 cell change/difference. While a 13×13 kernel of 169 cells can tolerate 169×11.11%=19 cell changes/differences. We round up (i.e. take the ceil). On the other hand, the upper bound on these two previous feature size examples, would give off a tolerance of 2 and 38 cell changes respectively. This tolerance policy ensures that the tolerance rate is proportional across all kernel/feature sizes, and therefore accounts for the same amount of allowed information change across all features, given that larger features will have more noise than smaller ones by virtue of the size difference.

It is worth noting that the tolerance ratio is a hyper parameter feature which can be tuned for optimal performance.

Finally, for the implementation of lateral connections to allow for context learning. We allow for subcells as well indicated on the segmentation section, however these additional sub cells in this variant are not used for residual connections but instead each is connected with both the input and the surrounding nodes which share the same layer but not the same selective cell.

Lateral connection pairs are composed of the excitatory and normal inhibitory connection pairs, which can be modeled with the following two equations, respectively:

$$New {W}_{ij} = Old {W}_{ij} + ( {X}_{in} \times {x}_{im} \times K \times r ) \qquad ( Eq . 18 )$$

$$New {W}_{ij} = Old {W}_{ij} + ( {X}_{in} \times ( 1 - {x}_{im} ) \times K \times r ) \qquad ( Eq . 19 )$$

where n≠m but can be abstracted with a single connection which follows both equations simultaneously as follows.

$$New {W}_{ij} = Old {W}_{ij} + ( {X}_{in} \times {x}_{im} \times K \times r ) \qquad ( Eq . 20 )$$

$$and$$

$$New {W}_{ij} = Old {W}_{ij} - ( {X}_{in} \times ( 1 - {x}_{im} ) \times K \times r ) \qquad ( Eq . 21 )$$

where n≠m.

Additionally, we allow for a window of influence which does not allow output nodes to perceive the input binary map state results before such window's termination to ensure that the collective excitation and inhibition behaviors complete their intra-layer influences on all layer nodes.

The strong normal inhibitory connection's which lie between the nodes of a given selective cell to ensure mutual exclusion should have its strength be equivalent to the highest possible collective strength of all connections received from the given input kernel bound patch. This ensures that the only way to deactivate such inhibition is through additional collective excitation received from intra-layer nodes.

In the parallel variation the spontaneous spike should be induced by suddenly incrementing the weighted sum variable of a randomly chosen free node with a net value equivalent to or less than the highest possible collective depolarization of all connections it could receive from the given input kernel bound patch. Additionally, in the parallel variant we do away with The strong normal inhibitory connection's which lie between the nodes of a given selective cell

This is for two reasons, both hyperpolarization and depolarization received by a given selective node from the input should be counter actable by their antagonist influences from intra-layer nodes via collective excitation and inhibition behaviors, to allow for the suppression of out of context features and the activation of context augmenting features.

The lateral connections have to have a substantially stronger connection baseline and linear strengthening factor relative to feedforward connections to ensure that they can suppress and bring up whatever nodes they want regardless of feedforward connection influence post first activation which was induced by said feedforward connections.

This way we ensure the battle for activation is set between and ultimately dictated by only the hyper-polarization and depolarization of the lateral web structures amongst each other.

The activation of all the sub cells happens simultaneously for all sub nodes which share the stimulus but can have different meanings hence all connections are strengthened simultaneously if any one node was active from the sub cell. while the only difference is that different contexts strengthen their own different interlayer connections and suppress hence allow for other in line to activate.

The number of nodes per sub cells equal the number of categories we are trying to categorize. So in theory we have different meanings based contexts as much as categories we got at most. In supervised learning we set the subcell node to always be active per category the same way we do for the output node per category. This way we ensure each meaning learns the same context of the its same category, categorical context.

The process happens as follows:

An input is perceived by the set of parallel layers each with its designated kernel size. Simultaneously the output node corresponding to the sample class and each subcells corresponding context class node are made active while perceiving said input. The connection pairs set between the memorization and input layer pairs and the connection set between the generalization layer and memorization layer are modified accordingly.

All context nodes are modified simultaneously as along as just any one node from the sub cell got activated regardless of their activity state, so modification for input to sub cell nodes is collectively carried equally if only one node from the sub cell meet the pair connection modification activation criteria. However this collective modification behavior only carries with feedforward connections, while with lateral connections the modifications are independent for each node per sub cell.

Overtime strong lateral connections will form between nodes of features that occur frequently together on a given training set, and form a web of connections which share the same context nodes. We distribute the frequency counter values across the context nodes accordingly, such that each context node has the frequency of the class it appears at most frequently.

Only nodes which follow the two selection policies activate once a test sample is perceived. Once a sample is perceived initially the node with the highest frequency from the subcells is activated assuming the sub cell receives the required activation signal, through collective excitation and inhibition the correct nodes per subcell is activated and the rest deactivated.

Using frequency would ensure that statistically speaking the majority of the correct nodes will be activated, while the nodes which share multiple classes and hence have multiple high frequencies would be resolved through collective excitation and inhibition behaviors.

Later when a set of features which belong to a certain web is perceived in a test sample and hence are activated, webs of nodes collectively depolarize their members and hyper-polarize non members until one web is fully activated and all other smaller webs are suppressed. This happens in a duration where the output nodes are not yet allowed to receive information from the previous layer. Once the duration passes and the web activation pattern settles the general nodes receive depolarization and hyper-polarization signals from all parallel layers.

Finally, for the connections between the generalization layer and the memorization layer, we only have one type of connection between the layers, the excitatory connection which exhibits both LTP and LTD simultaneously.

$$New {W}_{ij} = Old {W}_{ij} + ( {x}_{j} \times {Y}_{l} \times K \times r ) \qquad ( Eq . 22 )$$

$$New {W}_{ij} = Old {W}_{ij} - ( {x}_{j} \times ( 1 - {Y}_{l} ) \times K \times r ) \qquad ( Eq . 23 )$$

(Notice the minus sign to signify connection weakening instead of strengthening.)
For Yₗ in training phase it is set such that:
Yₗₖ=1
for k=training sample class label and
Yₗₖ=0
for k≠training sample class label
For Yₗ in the testing and validation phase:

$${Y}_{j} = {\sum }_{k = 0}^{k = selective nodes} {W}_{jl} ( excitatory 2 ) \times {X}_{ik} \qquad ( Eq . 24 )$$

### 5-C-ii The CIFAR Model

To incorporate a layer architecture which allows for color input we create three parallel networks, the first takes a binary threshed version of the input which is as laid in the MNIST embodiment, the second network decomposes the input into its three-color channels RGB across three parallel layers, where each of the three layers maps a corresponding pixel's channel value into 1 of 10 nodes in a given receptive cell.

The cell contains 10 nodes instead of 2 in the Previous embodiment, such that it maps the intensity range of its corresponding color channel into these 10 nodes, for example node 1, represents pixels with Red channel color intensity ranged from 0 to 25, and node 2, represents pixels with Red channel color intensity ranged from 26 to 51 and so on so forth until node 10 which would represent the red intensity range 230 to 255. The same carries on for Blue layers and Green Layers. Each color layer also passes by kernels which range in size from 3*3 to 32*32 and even greater depending on the input size.

An important difference is that all three-color layers which map a particular kernel size are then integrated into one composition selective layer which contains a set of selective nodes, each of these selective nodes integrate information from all three-color input layers which share a particular size kernel.

The following showcases how the color layers are integrated in the network:

32*32 Red layer input CONV 3*3
32*32 Blue layer input CONV 3*3
32*32 Green layer input CONV 3*3
Connect to 30*30 Selective cells each cell with 1024 nodes
32*32 Red layer input CONV 5*5
32*32 Blue layer input CONV 5*5
32*32 Green layer input CONV 5*5
Connect to 28*28 Selective cells each cell with 1024 nodes
32*32 Red layer input CONV 7*7
32*32 Blue layer input CONV 7*7
32*32 Green layer input CONV 7*7
Connect to 26*26 Selective cells each cell with 1024 nodes
32*32 Red layer input CONV 9*9
32*32 Blue layer input CONV 9*9
32*32 Green layer input CONV 9*9
Connect to 24*24 Selective cells each cell with 1024 nodes
32*32 Red layer input CONV 11*11
32*32 Blue layer input CONV 11*11
32*32 Green layer input CONV 11*11
Connect to 22*22 Selective cells each cell with 1024 nodes
32*32 Red layer input CONV 13*13
32*32 Blue layer input CONV 13*13
32*32 Green layer input CONV 13*13
Connect to 20*20 Selective cells each cell with 1024 nodes
32*32 Red layer input CONV 15*15
32*32 Blue layer input CONV 15*15
32*32 Green layer input CONV 15*15
Connect to 18*18 Selective cells each cell with 1024 nodes

We might incorporate Color tolerance in input 3×3 X-color patch, allowing for 1 to 2 points of gradation in each receptive cells' node activation. Additionally, we add a third independent layer pair structure, which takes the average RGB intensities and therefore learns a grayscale variation of the input. It is similar to the first B/W variation with only difference being that we have 10 nodes instead of 2 nodes per pixel representing input receptive cell, such that each node maps a particular grayscale intensity range. All three parallel and independent structures, The B/W, the color and the grayscale connect to the same set of nodes in the generalization output layer.

### 5-C-iii The Audio MNIST Model

In this embodiment we focus on a different type of input data, specifically an MNIST speech data set which is a temporal data type. For this our model design is slightly modified to only accommodate temporal input as opposed to special input.

The greatest differences in this model, is in the input layers. We can use the previous CIFAR model to draw an analogy while building this model. In the speech embodiment the set frequencies which make up a sound input, each is analogs to a single-color channel, so instead of using three channels to represent three color variations each isolated from the input, we use 6000 frequency channels, each isolated and representing one of 6000 frequencies in the frequency spectrum of a given input sample, ranging from 20 HZ to 6020 HZ.

In this embodiment we will have three independent network architectures, as was the case in the CIFAR models. The first B/W analogous layer, is set to be a layer that contains 6000 receptive cells, each containing two receptive nodes, ON and OFF, where ON nodes activate when a given frequency exists in a particular sound input, and OFF nodes activate when a given frequency does not exist in that sound input. This is analogous to the ON-OFF black and white edges of an MNIST data input. These are connected to an independent selective layer through a bus of connections as will be explained later.

The second independent network, is also composed of 6000 receptive cells, however instead this time each cell contains 10 nodes, which represent 10 intensity levels on a decibel scale. This is analogous to the intensity levels of each color channel in the CIFAR analogy. Therefore, each frequency can have 10 levels of intensity to represent different loudness/volume of each pitch/frequency.

These are connected to one integrated selective layer, which is composed of selective cells, each with 1024 selective nodes as in the CIFAR color layer examples. However, to incorporate kernelization and specifically using temporal kernels since we are dealing with temporal data, we use a bus of connections depending on the size of the kernels. Kernels sizes are multiples of the unit of duration which is 50 milliseconds in this model, the unit is analogous to pixel in vision.

The kernels will be parallel and would vary in size:

$$3 * ( 50 ) = 150 ms \\ 5 * ( 50 ) = 250 ms \\ 7 * ( 50 ) = 350 ms \\ 9 * ( 50 ) = 450 ms \\ 11 * ( 50 ) = 550 ms \\ 13 * ( 50 ) = 650 ms \\ 15 * ( 50 ) = 750 ms \\ 17 * ( 50 ) = 850 ms \\ 19 * ( 50 ) = 950 ms$$

where the connection pairs are a multiple of the kernel size, such that each connection is 50 milliseconds apart in latency relative to the next. So, in kernel of size three, we have a bus of three connection pairs with the following latencies; 50, 100, 150.

The third independent network, is composed of a single receptive cell with 10 nodes, each representing the average intensity of all frequency intensities. This represent information about the total loudness/volume of a sound input. This is analogous to the grayscale network in the CIFAR analogy. Similar to the previous two networks the layer is connected through a bus of connections with kernel size to an independent selective layer.

As was the case in the CIFAR model, each independent selective layer is then connected to the same output generalization layer of 10 general selective nodes representing each class.

Additionally, for context learning the same bus kernels apply for lateral connections. We use a bus of 15 connections for a single kernel of size 15 in the web structures. We also use multiple sub cells of multiple nodes. The same cut off policies and connection types across layers are used in all models.

### 5-C-iv The Integrated Model

An integrated model embodiment can be summarized as using both the MNIST and the Audio_MNIST Models outlined previously in a single model Structure such that the two models share the same one middle Generalization Layer, with the addition of allowing back and forth lateral connections between the memorization layer/s of one model and the memorization layer/s of the other model, and where both models are trained using their own data set type simultaneously.

If a set of components where to be used alternatively to achieve the same set of functionalities which execute the same set of algorithms which constitute this neuromorphic neural network architecture, and which the architecture operates under, then the aggregate implementation which achieves these set of algorithms clarified in the claims are subject to these claims whether such implementation was in a hardware, software or a hybrid form of implementation.

In an example embodiment, an artificial neural network architecture is provided, comprising:
a first layer comprising a receptive layer dissected into a predefined amount of spatial (regions) kernels, each spatial kernel encompassing a predefined amount of receptive cells, each receptive cell comprising a predefined amount of receptive nodes;
a second layer comprising a selective layer that is dissected into a plurality of selective cells, each selective cell comprising a predefined amount of sub cells each sub cell comprising a predefined amount of selective nodes and a dual state variable;
a third layer comprising an output layer composed of a plurality of selective nodes each selective node represent one training data class label and has a parallel corresponding node in every sub cell in the second layer, wherein the receptive layer is configured to transmit information to the selective layer and the selective layer is configured to transmit information to the output layer, and wherein at least one selective cell of the plurality of selective cells of the second layer encompasses a pre-allocated size of a receptive field that represents boundaries of a spatial (region) kernel of the receptive layer;
a first plurality of transmitter nodes comprising the plurality of receptive nodes in each receptive cell from the first layer and a first plurality of receiver nodes comprising the plurality of selective nodes in each selective cell from the second layer arranged within the first and second layers respectively, each transmitter node and each receiver node of the first pluralities of transmitter and receiver nodes comprising a first activity state variable, a first positive accumulator variable, a first negative accumulator variable, a weighted sum variable and a counter variable;
a second plurality of transmitter nodes comprising the plurality of selective nodes in each selective cell from the second layer and a second plurality of receiver nodes comprising the plurality of selective nodes in each selective cell from the second layer except that which include the second plurality of transmitter nodes arranged within the second layer of the pair of layers, each transmitter node and each receiver node of the second pluralities of transmitter and receiver nodes comprising a second activity state variable, a second positive accumulator variable, a second negative accumulator variable, a quotient variable and a counter variable;
a third plurality of transmitter nodes comprising the plurality of selective nodes in each selective cell from the selective layer and a third plurality of receiver nodes comprising the plurality of selective nodes in the third output layer arranged within the second and third layers respectively, each transmitter node and each receiver node of the third pluralities of transmitter and receiver nodes comprising an activity state variable, a positive accumulator variable, a negative accumulator variable, a weighted sum variable and a quotient variable;
a combination of a first two feedforward connection pairs arranged to connect a transmitter node in the first plurality of transmitter nodes and a receiver node in the first plurality of receiver nodes, the feedforward connection pairs comprising unidirectional influencer connections and messenger connections;
a combination of two lateral connection pairs arranged to connect a transmitter node in the second plurality of transmitter nodes and a receiver node in the second plurality of receiver nodes, the lateral connection pairs comprising unidirectional influencer connections and messenger connections;
a combination of a second two feedforward connection pairs arranged to connect a transmitter node in the third plurality of transmitter nodes and only the corresponding parallel receiver node in the third plurality of receiver nodes, the feedforward connection pairs comprising unidirectional influencer connections and messenger connections;
a combination of single lateral connection pair arranged to connect a transmitter node in the second plurality of transmitter nodes and a receiver node in the same second plurality of transmitter nodes, the lateral connection pair comprising unidirectional influencer connection and messenger connection;
wherein the unidirectional influencer connections of the first two feedforward connection pairs are configured to increment the first positive accumulator variable and the first negative accumulator variable of the first plurality receiver nodes respectively at least partially based on a weight value of the connections, where the weight variables are modulated according to a first time dependent correlation of activity states detected by a messenger connection of the feedforward connection pairs;
wherein the unidirectional influencer connections of the two lateral connection pairs are configured to modulate the second positive accumulator variable and the second negative accumulator variable, respectively, of the second plurality receiver nodes at least partially based on a weight value of the connections, where the weight variables are modulated according to a second time dependent correlation of activity states detected by the messenger connections of the lateral connection pairs;
wherein the unidirectional influencer connections of the second two feedforward connection pairs are configured to increment the first positive accumulator variable or the first negative accumulator variable of the third plurality of transmitter and receiver nodes at least partially based on a weight value of the connection, where the weight variables are modulated according to a second time dependent correlation of activity states detected by a messenger connection of the second two feedforward connection pair; and
wherein the unidirectional influencer connections of the single lateral connection pair are configured to modulate the first negative accumulator variable, of the same second plurality of transmitter nodes based on a pre set weight value of the connection.

The artificial neural network architecture recited above, wherein the first and second unidirectional influencer connections of the first two feedforward connection pairs are configured to influence the activity state variable of a receiver node in the plurality of receiver nodes.

The artificial neural network architecture recited above, wherein the weighted sum variable of a receiver node of the first and third pluralities of receiver nodes comprises a value which represents a difference between the first positive accumulator variable and the first negative accumulator variable of the receiver node and the value generates an influence on the activity state variable of the receiver node; and wherein the weighted sum variable of a receiver node of the second pluralities of receiver nodes comprises a value which represents a difference between the second positive accumulator variable and the second negative accumulator variable of the receiver node and the value generates an influence on the activity state variable of the receiver node.

The artificial neural network architecture recited above, wherein each of the first and second unidirectional influencer connections of the first two feedforward connection pairs, the second two feedforward connection pairs, and the two lateral connection pairs comprises a weight variable and an influence latency variable representing a transmission time delay of influence and each of the messenger connections of the first two feedforward connection pairs, the second two feedforward connection pairs, and the two lateral connection pairs comprises a messaging latency variable representing a transmission time delay of messaging.

The artificial neural network architecture recited above, wherein each of the first and second unidirectional influencer connections is configured to increment the positive accumulator variable or the negative accumulator variable of the receiver node in the plurality of receiver nodes, the increment being proportional to its weight variable and after a time equal to its transmission time delay of influence.

The artificial neural network architecture recited above, wherein the influence on the activity state variable occurs according to a rate that is directly proportional to a value stored in the weighted sum variable.

The artificial neural network architecture recited above, wherein the first unidirectional influencer connections of the first two feedforward connection pairs comprise an influencer excitatory connection and the first messenger connections comprise a messaging excitatory connection, and the time dependent correlation of activity states is detected by the messaging excitatory connection and registered if a message signal is sent through the messaging excitatory connection after a time period equal to the transmission time delay of messaging, the message signal is sent when the receiver node is active, and the transmitter node is active before or while the receiver node is active.

The artificial neural network architecture recited above, wherein the time period is measured from a moment of activation of the transmitter node in the plurality of transmitter nodes.

The artificial neural network architecture recited above, wherein the second unidirectional influencer connections of the first two feedforward connection pairs comprise an influencer reverse inhibitory connection and the second messenger connections comprise a messaging reverse inhibitory connection, and the time dependent correlation of activity states is detected by the messaging reverse inhibitory connection and registered if a message signal is sent through the messaging reverse inhibitory connection after a time period equal to the transmission time delay of messaging, the message signal is sent when the transmitter node is inactive, and the transmitter node is inactive before or while the receiver node is active.

The artificial neural network architecture recited above, wherein the time period is measured from a moment of inactivation of the transmitter node in the plurality of transmitter nodes.

The artificial neural network architecture recited above, wherein the first unidirectional influencer connections of the two lateral connection pairs comprise an influencer excitatory connection and the first messenger connections comprise a messaging excitatory connection, and the time dependent correlation of activity states is detected by the messaging excitatory connection and registered if a message signal is sent through the messaging excitatory connection after a time period equal to the transmission time delay of messaging, the message signal is sent when the receiver node is active, and the transmitter node is active before or while the receiver node is active.

The artificial neural network architecture recited above, wherein the second unidirectional influencer connections of the two lateral connection pairs comprise an influencer normal inhibitory connection and the second messenger connections of the lateral connection pairs comprise a messaging normal inhibitory connection, and the second time dependent correlation of activity states is detected by the messaging normal inhibitory connection and registered if a message signal is sent through the messaging normal inhibitory connection after a time period equal to the transmission time delay of messaging, the message signal is sent when the transmitter node is active, and the transmitter node is active before or while the receiver node is inactive.

The artificial neural network architecture recited above, wherein the influence on the activity state variable occurs according to a rate that is directly proportional to a value stored in the quotient variable.

The artificial neural network architecture recited above, wherein the first unidirectional influencer connections of the second feedforward connection pairs comprise an influencer excitatory connection and the first messenger connection comprise a messaging excitatory connection, and the time dependent correlation of activity states is detected by the messaging excitatory connection and registered if a message signal is sent through the messaging excitatory connection after a time period equal to the transmission time delay of messaging, the message signal is sent when the receiver node is active, and the transmitter node is active before or while the receiver node is active.

The artificial neural network architecture recited above, wherein the second unidirectional influencer connections of the of the second feedforward connection pairs comprise an influencer normal inhibitory connection and the second messenger connections of the lateral connection pairs comprise a messaging normal inhibitory connection, and the second time dependent correlation of activity states is detected by the messaging normal inhibitory connection and registered if a message signal is sent through the messaging normal inhibitory connection after a time period equal to the transmission time delay of messaging, the message signal is sent when the transmitter node is active, and the transmitter node is active before or while the receiver node is inactive.

The artificial neural network architecture recited above, wherein the influence on the activity state variable occurs according to a rate that is directly proportional to a value stored in the weighted sum variable.

The artificial neural network architecture recited above, wherein at least two receptive nodes of a receptive cell that belongs to the spatial kernel form feedforward connection pairs with at least one selective node which belong to a given particular sub cell from the at least one selective cell, and a first feedforward connection pair of the feedforward connection pairs comprises a first transmission time delay value that is the same as a second transmission time delay value of a second feedforward connection pair of the feedforward connection pairs.

The artificial neural network architecture recited above, wherein a selective node from a first sub cell of the at least one selective cell is configured to receive feedforward connection pairs from each receptive node of each receptive cell of the spatial kernel, the selective node configured to receive a first feedforward connection pair of the feedforward connection pairs from a first receptive cell of the spatial kernel and a second feedforward connection pair of the feedforward connection pairs from a second receptive cell of the spatial kernel, wherein the first and the second feedforward connection pairs comprise first and second transmission time delay values that are always equivalent to each other.

The artificial neural network architecture recited above, wherein each selective node of the at least one selective cell is configured to receive feedforward connection pairs from each receptive node of each receptive cell of the spatial kernel, a first selective node of the at least one selective cell is configured to receive a first feedforward connection pair of the feedforward connection pairs from a first receptive cell of the spatial kernel, a selective node from a second sub cell within the at least one selective cell, different than the first sub cell, is configured to receive a second feedforward connection pair of the feedforward connection pairs from a second or first receptive cell of the spatial kernel, wherein the first and the second feedforward connection pairs comprise first and second transmission time delay values that can be different in so far as they are allowed to comprise transmission time delay values that are different from each other wherein the transmission delay are allowed to change based on the connection strength such that, the transmission time delay value is inversely proportional to the corresponding connection weight value.

The artificial neural network architecture recited above, wherein at least one selective node of the selective nodes comprises at least one dual-state gate that represents one receptive cell and feedforward connections from the one receptive cell, and wherein the at least one dual-state gate is configured to block the information transmitted through messenger connections from the receptive layer in a first state and allow the information transmitted through messenger connections from the receptive layer in a second state.

The artificial neural network architecture recited above, wherein the at least one dual-state gate is configured to turn on if it receives information from an excitatory influencer connection only if the influencer excitatory connection projects from a layer that is at least two layers before the layer which receives the information.

The artificial neural network architecture recited above, wherein the at least one dual-state gate is configured to turn off if it does not receive information from an excitatory influencer connection that projects from a layer that is at least two layers before the layer which receives the information.

A method of processing input signals with the artificial neural network architecture recited above is provided wherein:
the first plurality of transmitter and the first plurality of receiver nodes are used in a pair of layers comprising first and second layers, respectively; and
a combination of connection pairs are provided to connect the pluralities of transmitter and receiver nodes, the combination of connection pairs comprising first and second unidirectional influencer connections of the first two feedforward connection pairs;
the method further including connecting the combination of connection pairs between a transmitter node in the first layer with a receiver node in the second layer;
mapping discrete sampled Black/White or Red or Green or Blue or grayscale intensity levels from image pixels to the first plurality of transmitter nodes;
in the event of activation of the first pluralities of transmitter nodes in the first layer within a network training phase before a preset time delay interval, eliciting the activation and inactivation of the first plurality of receiver nodes which belong to the corresponding selective cell in the second layer via the first two feedforward connection pairs and eliciting the inactivation of the second plurality of receiver nodes which belong to the corresponding selective cell in the second layer via the single lateral connection pair;
in the event of activation of the first pluralities of transmitter nodes in the first layer within a network training phase after the preset time delay interval, eliciting the spontaneous activation of a sub cell comprising changing sub cell dual state variable from a default first dual state value to the second dual state value and the activation of at least one selective node from the first plurality of receiver nodes in one sub cell after a preset time delay interval if another sub cell did not get activated before the termination of the preset time delay interval; and
in the event of activation of the first pluralities of transmitter nodes within a network validation phase, eliciting the activation and inactivation of the first plurality of receiver nodes which belong to the corresponding selective cell in the second layer via the first two feedforward connection pairs and eliciting the inactivation of the second plurality of receiver nodes which belong to the corresponding selective cell in the second layer via the single lateral connection pair.

The method recited above wherein all the first two feedforward connection pairs between all the nodes which belong to the same active sub cell relating to the receiver node in the second layer and the corresponding transmitter node in the first layer collectively and simultaneously experience equivalent modulation based on detected time dependent correlations of activity states relating to the transmitter node in the first layer and the receiver node in the second layer via messenger connections of the combination of the first two feedforward connection pairs; and influencing a positive accumulator variable and a negative accumulator variable in the receiver node in the second layer via the first and the second unidirectional influencer connections of the combination of the first two feedforward connection pairs, respectively, according to a weight value that is based at least in part on the detected time dependent correlations of activity states detected.

The method recited above wherein influencing the positive accumulator variable and the negative accumulator variable in the receiver node in the second layer comprises incrementing the variables in proportion to weight values of the first and the second unidirectional influencer connections, respectively, and after a time equal to a transmission time delay of influence of the first and the second unidirectional influencer connections, respectively.

The method recited above wherein the transmission time delay of influence of the first and the second unidirectional influencer connections increases and decreases in proportion to the increase and decrease of weight values of the first unidirectional influencer connection, respectively.

The method recited above wherein incrementing the positive accumulator variable and the negative accumulator variable by the first and the second unidirectional influencer connection, respectively, comprises incrementing the positive accumulator variable according to a linear growth function and the negative accumulator variable at least according to an exponential growth function.

The method recited above wherein the incrementing for the second unidirectional influencer connection comprises an exponential growth function followed by a linear growth function after a defined point, and the first and second unidirectional influencer connections are initially set to different strength values.

The method recited above wherein the positive accumulator variable and the negative accumulator variable are decremented by the first and the second unidirectional influencer connections, respectively, and decrementing the positive accumulator variable is according to a linear decay function and decrementing the negative accumulator variable is at least according to an exponential decay function.

The method recited above wherein the decrementing of the second unidirectional influencer connection comprises a linear decay function followed by an exponential decay function after a defined point and the sub cell dual state variable changing from the second dual state value back to the first dual state value, and the first and second unidirectional influencer connections are initially set to two minimum different strength values.

The method recited above further comprising subtracting a value in the negative accumulator variable from a value in the positive accumulator variable of the receiver node in the second layer and storing a result of the subtraction in the weighted sum variable of the receiver node in the second layer.

In another example embodiment, a method of processing input signals with the artificial neural network architecture recited above is provided wherein:
the second plurality of transmitter and the second plurality of receiver nodes are used in the second layer; and
a combination of connection pairs are provided to connect the pluralities of transmitter and receiver nodes, the combination of connection pairs comprising first and second unidirectional influencer connections of the two lateral connection pairs;
the method further comprising connecting the combination of connection pairs between a transmitter node and a receiver node in the at least one layer;
in the event of activation of the first pluralities of transmitter nodes in the first layer within a network training phase, eliciting the spontaneous activation of a sub cell comprising the activation of at least one node from the first plurality of receiver nodes in one sub cell in every selective cell in the second layer; and
in the event of activation of the second pluralities of transmitter nodes within a network validation phase in the second layer, eliciting the activation of all selective node from the second plurality of receiver nodes in every selective cell in the second layer via the two lateral connection pairs.

The further method recited above comprising detecting time dependent correlations of activity states relating to the transmitter and receiver nodes in the second layer via messenger connections of the combination of the two lateral connection pairs; and influencing a positive accumulator variable and a negative accumulator variable in the receiver node in the at least one layer via the first and second unidirectional influencer connections of the combination of the two lateral connection pairs, respectively, based at least in part on the detected time dependent correlations of activity states.

The further method recited above comprising influencing the positive accumulator variable and the negative accumulator variable in the receiver node in the second layer comprises modulating the variables in proportion to weight values of the first and second unidirectional influencer connections, respectively, and after a time equal to a transmission time delay of influence of the first and second unidirectional influencer connections, respectively.

The further method recited above wherein the transmission time delay of influence of the first and the second unidirectional influencer connections increases and decreases in proportion to the weight values of the first unidirectional influencer connection.

The further method recited above wherein incrementing the positive accumulator variable and the negative accumulator variable by the first and the second unidirectional influencer connection, respectively, comprises incrementing according to a linear growth function.

The further method recited above wherein the positive accumulator variable and the negative accumulator variable are decremented by the first and the second unidirectional influencer connections, respectively, wherein the decrementing is according to a linear decay function.

The further method recited above further comprising dividing a total magnitude of signals stored in the positive accumulator variable by a total magnitude of signals stored in the negative accumulator variable in the receiver node in the second layer, subtracting a value from a result of the division, and storing a result in the quotient variable of the receiver node in the second layer.

In still another example embodiment, a method of processing input signals with the artificial neural network architecture recited above is provided wherein:
the third plurality of transmitter nodes and the third plurality of receiver nodes are used in the second and third layers, respectively; and
a combination of connection pairs are provided to connect the pluralities of transmitter and receiver nodes, the combination of connection pairs comprising first and second unidirectional influencer connections of the second two feedforward connection pairs;
the method further comprising connecting the combination of connection pairs between a transmitter node and a receiver node in the at least one layer;
in the event of activation of a sub cell comprising the third pluralities of transmitter nodes in the second layer within a network training phase, eliciting the activation of a selective node from the third plurality of receiver nodes in the third layer selected based on training class label, while simultaneously eliciting the activation of the parallel corresponding selective node from the third plurality of transmitter nodes which belong to the active sub cell in each selective cell in the second layer; and
in the event of activation of the third pluralities of transmitter nodes within a network validation phase in the second layer waiting for the termination of a preset time delay interval followed by eliciting the activation and inactivation of the third plurality of receiver nodes in the third layer via the second two feedforward connection pairs.

The method recited above wherein detecting time dependent correlations of activity states relating to the transmitter node in the second layer and its corresponding parallel receiver node in the third layer via messenger connections of the second two feedforward connection pairs; and influencing a positive accumulator variable and a negative accumulator variable in the receiver node in the third layer via the first and second unidirectional influencer connections of the combination of the second two feedforward connection pairs, respectively, based at least in part on the detected time dependent correlations of activity states.

The method recited above wherein influencing the positive accumulator variable and the negative accumulator variable in the receiver node in the third layer comprises modulating the variables in proportion to weight values of the first and second unidirectional influencer connections, respectively, and after a time equal to a transmission time delay of influence of the first and second unidirectional influencer connections, respectively.

The method recited above wherein incrementing the positive accumulator variable and the negative accumulator variable by the first and the second unidirectional influencer connection, respectively, comprises incrementing according to a linear growth function.

The method recited above wherein the positive accumulator variable and the negative accumulator variable are decremented by the first and the second unidirectional influencer connections, respectively, wherein the decrementing is according to a linear decay function.

The method recited above further comprising subtracting a value in the negative accumulator variable from a value in the positive accumulator variable of the receiver node in the third layer and storing a result of the subtraction in the weighted sum variable of the receiver node in the third layer.

The method recited above further comprising a generalization process comprising incrementing the value of the counter variable for every time the third plurality of transmitter nodes were active during the network training phase, selecting a sub set plurality of nodes from each sub cell based on the counter variable values at the end of the network training phase, allowing the selected sub set to have strong activation and inactivation influence over the third plurality of receiver nodes via the second two feedforward connection pairs at the network validation phase, preventing the unselected sub set from having strong activation and inactivation influence over the third plurality of receiver nodes via the second two feedforward connection pairs at the network validation phase.

In another example embodiment, an artificial neural network architecture is provided, comprising:
a first layer comprising a receptive layer encompassing a predefined amount of receptive cells, each receptive cell comprising a predefined amount of receptive nodes;
a second layer comprising a selective layer that is dissected into a plurality of selective cells, each selective cell comprising a predefined amount of sub cells each sub cell comprising a predefined amount of selective nodes and a dual state variable;
a third layer comprising an output layer composed of a plurality of selective nodes each selective node represent one training data class label and has a parallel corresponding node in every sub cell in the second layer; wherein the receptive layer is configured to transmit information to the selective layer and the selective layer is configured to transmit information to the output layer;
a first plurality of transmitter nodes comprising the plurality of receptive nodes in each receptive cell from the first layer and a first plurality of receiver nodes comprising the plurality of selective nodes in each selective cell from the second layer arranged within the first and second layers respectively, each transmitter node and each receiver node of the first pluralities of transmitter and receiver nodes comprising a first activity state variable, a first positive accumulator variable, a first negative accumulator variable, a weighted sum variable and a counter variable;
a second plurality of transmitter nodes comprising the plurality of selective nodes in each selective cell from the second layer and a second plurality of receiver nodes comprising the plurality of selective nodes in each selective cell from the second layer except that which include the second plurality of transmitter nodes arranged within the second layer of the pair of layers, each transmitter node and each receiver node of the second pluralities of transmitter and receiver nodes comprising a second activity state variable, a second positive accumulator variable, a second negative accumulator variable, a quotient variable and a counter variable;
a third plurality of transmitter nodes comprising the plurality of selective nodes in each selective cell from the selective layer and a third plurality of receiver nodes comprising the plurality of selective nodes in the third output layer arranged within the second and third layers respectively, each transmitter node and each receiver node of the third pluralities of transmitter and receiver nodes comprising an activity state variable, a positive accumulator variable, a negative accumulator variable, a weighted sum variable and a quotient variable;
a first plurality of connections each comprising a combination of a first two feedforward connection pairs arranged to connect a transmitter node in the first plurality of transmitter nodes and a receiver node in the first plurality of receiver nodes, the feedforward connection pairs comprising unidirectional influencer connections and messenger connections;
a second plurality of connections each comprising a combination of two lateral connection pairs arranged to connect a transmitter node in the second plurality of transmitter nodes and a receiver node in the second plurality of receiver nodes, the lateral connection pairs comprising unidirectional influencer connections and messenger connections;
a combination of a second two feedforward connection pairs arranged to connect a transmitter node in the third plurality of transmitter nodes and only the corresponding parallel receiver node in the third plurality of receiver nodes, the feedforward connection pairs comprising unidirectional influencer connections and messenger connections;
a combination of single lateral connection pair arranged to connect a transmitter node in the second plurality of transmitter nodes and a receiver node in the same second plurality of transmitter nodes, the lateral connection pair comprising unidirectional influencer connection and messenger connection;
wherein the unidirectional influencer connections of the first two feedforward connection pairs are configured to increment the first positive accumulator variable and the first negative accumulator variable of the first plurality receiver nodes respectively at least partially based on a weight value of the connections, where the weight variables are modulated according to a first time dependent correlation of activity states detected by a messenger connection of the feedforward connection pairs;
wherein the unidirectional influencer connections of the two lateral connection pairs are configured to modulate the second positive accumulator variable and the second negative accumulator variable, respectively, of the second plurality receiver nodes at least partially based on a weight value of the connections, where the weight variables are modulated according to a second time dependent correlation of activity states detected by the messenger connections of the lateral connection pairs;
wherein the unidirectional influencer connections of the second two feedforward connection pairs are configured to increment the first positive accumulator variable or the first negative accumulator variable of the third plurality of transmitter and receiver nodes at least partially based on a weight value of the connection, where the weight variables are modulated according to a second time dependent correlation of activity states detected by a messenger connection of the second two feedforward connection pair; and
wherein the unidirectional influencer connections of the single lateral connection pair are configured to modulate the first negative accumulator variable, of the same second plurality of transmitter nodes based on a pre set weight value of the connection.

The artificial neural network architecture recited above, wherein the first and second unidirectional influencer connections of the first two feedforward connection pairs are configured to influence the activity state variable of a receiver node in the plurality of receiver nodes.

The artificial neural network architecture recited above, wherein the weighted sum variable of a receiver node of the first and third pluralities of receiver nodes comprises a value which represents a difference between the first positive accumulator variable and the first negative accumulator variable of the receiver node and the value generates an influence on the activity state variable of the receiver node; and wherein the weighted sum variable of a receiver node of the second pluralities of receiver nodes comprises a value which represents a difference between the second positive accumulator variable and the second negative accumulator variable of the receiver node and the value generates an influence on the activity state variable of the receiver node.

The artificial neural network architecture recited above, wherein each of the first and second unidirectional influencer connections of the first two feedforward connection pairs, the second two feedforward connection pairs, and the two lateral connection pairs comprises a weight variable and an influence latency variable representing a transmission time delay of influence and each of the messenger connections of the first two feedforward connection pairs, the second two feedforward connection pairs, and the two lateral connection pairs comprises a messaging latency variable representing a transmission time delay of messaging.

The artificial neural network architecture recited above, wherein the influence latency variable of the first and second unidirectional influencer connections and the messaging latency variable of the first and second messaging connections hold transmission time delay values that vary across the first plurality of connections according to a first preset time interval.

The artificial neural network architecture recited above, wherein the influence latency variable of the first and second unidirectional influencer connections and the messaging latency variable of the first and second messaging connections hold transmission time delay values that vary across the second plurality of connections according to a second preset time interval.

The artificial neural network architecture recited above, wherein each of the first and second unidirectional influencer connections is configured to increment the positive accumulator variable or the negative accumulator variable of the receiver node in the plurality of receiver nodes, the increment being proportional to its weight variable and after a time equal to its transmission time delay of influence.

The artificial neural network architecture recited above, wherein the influence on the activity state variable occurs according to a rate that is directly proportional to a value stored in the weighted sum variable.

The artificial neural network architecture recited above, wherein the first unidirectional influencer connections of the first two feedforward connection pairs comprise an influencer excitatory connection and the first messenger connections comprise a messaging excitatory connection, and the time dependent correlation of activity states is detected by the messaging excitatory connection and registered if a message signal is sent through the messaging excitatory connection after a time period equal to the transmission time delay of messaging, the message signal is sent when the receiver node is active, and the transmitter node is active before or while the receiver node is active.

The artificial neural network architecture recited above, wherein the time period is measured from a moment of activation of the transmitter node in the plurality of transmitter nodes.

The artificial neural network architecture recited above, wherein the second unidirectional influencer connections of the first two feedforward connection pairs comprise an influencer reverse inhibitory connection and the second messenger connections comprise a messaging reverse inhibitory connection, and the time dependent correlation of activity states is detected by the messaging reverse inhibitory connection and registered if a message signal is sent through the messaging reverse inhibitory connection after a time period equal to the transmission time delay of messaging, the message signal is sent when the transmitter node is inactive, and the transmitter node is inactive before or while the receiver node is active.

The artificial neural network architecture recited above, wherein the time period is measured from a moment of inactivation of the transmitter node in the plurality of transmitter nodes.

The artificial neural network architecture recited above, wherein the first unidirectional influencer connections of the two lateral connection pairs comprise an influencer excitatory connection and the first messenger connections comprise a messaging excitatory connection, and the time dependent correlation of activity states is detected by the messaging excitatory connection and registered if a message signal is sent through the messaging excitatory connection after a time period equal to the transmission time delay of messaging, the message signal is sent when the receiver node is active, and the transmitter node is active before or while the receiver node is active.

The artificial neural network architecture recited above, wherein the second unidirectional influencer connections of the two lateral connection pairs comprise an influencer normal inhibitory connection and the second messenger connections of the lateral connection pairs comprise a messaging normal inhibitory connection, and the second time dependent correlation of activity states is detected by the messaging normal inhibitory connection and registered if a message signal is sent through the messaging normal inhibitory connection after a time period equal to the transmission time delay of messaging, the message signal is sent when the transmitter node is active, and the transmitter node is active before or while the receiver node is inactive.

The artificial neural network architecture recited above, wherein the influence on the activity state variable occurs according to a rate that is directly proportional to a value stored in the quotient variable.

The artificial neural network architecture recited above, wherein the first unidirectional influencer connections of the second feedforward connection pairs comprise an influencer excitatory connection and the first messenger connection comprise a messaging excitatory connection, and the time dependent correlation of activity states is detected by the messaging excitatory connection and registered if a message signal is sent through the messaging excitatory connection after a time period equal to the transmission time delay of messaging, the message signal is sent when the receiver node is active, and the transmitter node is active before or while the receiver node is active.

The artificial neural network architecture recited above, wherein the second unidirectional influencer connections of the of the second feedforward connection pairs comprise an influencer normal inhibitory connection and the second messenger connections of the lateral connection pairs comprise a messaging normal inhibitory connection, and the second time dependent correlation of activity states is detected by the messaging normal inhibitory connection and registered if a message signal is sent through the messaging normal inhibitory connection after a time period equal to the transmission time delay of messaging, the message signal is sent when the transmitter node is active, and the transmitter node is active before or while the receiver node is inactive.

The artificial neural network architecture recited above, wherein the influence on the activity state variable occurs according to a rate that is directly proportional to a value stored in the weighted sum variable.

The artificial neural network architecture recited above, wherein at least two receptive nodes of a receptive cell that belongs to the spatial kernel form feedforward connection pairs with at least one selective node which belong to a given particular sub cell from the at least one selective cell, and a first feedforward connection pair of the feedforward connection pairs comprises a first transmission time delay value that is the same as a second transmission time delay value of a second feedforward connection pair of the feedforward connection pairs.

The artificial neural network architecture recited above, wherein a selective node from a first sub cell of the at least one selective cell is configured to receive feedforward connection pairs from each receptive node of each receptive cell of the spatial kernel, the selective node configured to receive a first feedforward connection pair of the feedforward connection pairs from a first receptive cell of the spatial kernel and a second feedforward connection pair of the feedforward connection pairs from a second receptive cell of the spatial kernel, wherein the first and the second feedforward connection pairs comprise first and second transmission time delay values that are always equivalent to each other.

The artificial neural network architecture recited above, wherein each selective node of the at least one selective cell is configured to receive feedforward connection pairs from each receptive node of each receptive cell of the spatial kernel, a first selective node of the at least one selective cell is configured to receive a first feedforward connection pair of the feedforward connection pairs from a first receptive cell of the spatial kernel, a selective node from a second sub cell within the at least one selective cell, different than the first sub cell, is configured to receive a second feedforward connection pair of the feedforward connection pairs from a second or first receptive cell of the spatial kernel, wherein the first and the second feedforward connection pairs comprise first and second transmission time delay values that can be different in so far as they are allowed to comprise transmission time delay values that are different from each other wherein the transmission delay are allowed to change based on the connection strength such that, the transmission time delay value is inversely proportional to the corresponding connection weight value.

The artificial neural network architecture recited above, wherein at least one selective node of the selective nodes comprises at least one dual-state gate that represents one receptive cell and feedforward connections from the one receptive cell, and wherein the at least one dual-state gate is configured to block the information transmitted through messenger connections from the receptive layer in a first state and allow the information transmitted through messenger connections from the receptive layer in a second state.

The artificial neural network architecture recited above, wherein the at least one dual-state gate is configured to turn on if it receives information from an excitatory influencer connection only if the influencer excitatory connection projects from a layer that is at least two layers before the layer which receives the information.

The artificial neural network architecture recited above, wherein the at least one dual-state gate is configured to turn off if it does not receive information from an excitatory influencer connection that projects from a layer that is at least two layers before the layer which receives the information.

In yet another example embodiment, a method of processing input signals with the artificial neural network architecture recited above is provided wherein:
the first plurality of transmitter nodes and the first plurality of receiver nodes are used in a pair of layers comprising first and second layers, respectively; and
a combination of connection pairs are provided to connect the pluralities of transmitter and receiver nodes, the combination of connection pairs comprising first and second unidirectional influencer connections of two feedforward connection pairs;
the method further comprising connecting the combination of connection pairs between a transmitter node in the first layer with a receiver node in the second layer;
mapping discrete sampled Black/White or Red or Green or Blue or grayscale intensity levels from image pixels to the first plurality of transmitter nodes; and
in the event of activation of the first pluralities of transmitter nodes in the first layer within a network training phase before a preset time delay interval, eliciting the activation and inactivation of the first plurality of receiver nodes which belong to the corresponding selective cell in the second layer via the first plurality of connections comprising the first two feedforward connection pairs and eliciting the inactivation of the second plurality of receiver nodes which belong to the corresponding selective cell in the second layer via the single lateral connection pair; and
in the event of activation of the first pluralities of transmitter nodes in the first layer within a network training phase after the preset time delay interval, eliciting the spontaneous activation of a sub cell comprising changing sub cell dual state variable from a default first dual state value to the second dual state value and the activation of at least one selective node from the first plurality of receiver nodes in one sub cell after a preset time delay interval if another sub cell did not get activated before the termination of the preset time delay interval; and
in the event of activation of the first pluralities of transmitter nodes within a network validation phase, eliciting the activation and inactivation of the first plurality of receiver nodes which belong to the corresponding selective cell in the second layer via the first plurality of connections comprising the first two feedforward connection pairs and eliciting the inactivation of the second plurality of receiver nodes which belong to the corresponding selective cell in the second layer via the single lateral connection pair.

The method recited above, wherein all the first two feedforward connection pairs between all the nodes which belong to the same active sub cell relating to the receiver node in the second layer and the corresponding transmitter node in the first layer collectively and simultaneously experience equivalent modulation based on detected time dependent correlations of activity states relating to the transmitter node in the first layer and the receiver node in the second layer via messenger connections of the combination of the first two feedforward connection pairs; and influencing a positive accumulator variable and a negative accumulator variable in the receiver node in the second layer via the first and the second unidirectional influencer connections of the combination of the first two feedforward connection pairs, respectively, according to a weight value that is based at least in part on the detected time dependent correlations of activity states detected.

The method recited above, wherein influencing the positive accumulator variable and the negative accumulator variable in the receiver node in the second layer comprises incrementing the variables in proportion to weight values of the first and the second unidirectional influencer connections, respectively, and after a time equal to a transmission time delay of influence of the first and the second unidirectional influencer connections, respectively.

The method recited above, wherein the transmission time delay of influence of the first and the second unidirectional influencer connections increases and decreases in proportion to the increase and decrease of weight values of the first unidirectional influencer connection respectively.

The method recited above, wherein incrementing the positive accumulator variable and the negative accumulator variable by the first and the second unidirectional influencer connection, respectively, comprises incrementing the positive accumulator variable according to a linear growth function and the negative accumulator variable at least according to an exponential growth function.

The method recited above, wherein the incrementing for the second unidirectional influencer connection comprises an exponential growth function followed by a linear growth function after a defined point, and the first and second unidirectional influencer connections are initially set to different strength values.

The method recited above, wherein the positive accumulator variable and the negative accumulator variable are decremented by the first and the second unidirectional influencer connections, respectively, and decrementing the positive accumulator variable is according to a linear decay function and decrementing the negative accumulator variable is at least according to an exponential decay function.

The method recited above, wherein the decrementing of the second unidirectional influencer connection comprises a linear decay function followed by an exponential decay function after a defined point and the sub cell dual state variable changing from the second dual state value back to the first dual state value, and the first and second unidirectional influencer connections are initially set to two minimum different strength values.

The method recited above, further comprising subtracting a value in the negative accumulator variable from a value in the positive accumulator variable of the receiver node in the second layer and storing a result of the subtraction in the weighted sum variable of the receiver node in the second layer.

In still another example embodiment, a method of processing input signals with the artificial neural network architecture recited above is provided wherein:
the second plurality of transmitter nodes and the second plurality of receiver nodes are used in the second layer; and
a combination of connection pairs are provided to connect the pluralities of transmitter and receiver nodes, the combination of connection pairs comprising first and second unidirectional influencer connections of the two lateral connection pairs;
the method further comprising connecting the combination of connection pairs between a transmitter node and a receiver node in the at least one layer;
in the event of activation of the first pluralities of transmitter nodes in the first layer within a network training phase, eliciting the spontaneous activation of a sub cell comprising the activation of at least one node from the first plurality of receiver nodes in one sub cell in every selective cell in the second layer; and
in the event of activation of the second pluralities of transmitter nodes within a network validation phase in the second layer, eliciting the activation of all selective node from the second plurality of receiver nodes in every selective cell in the second layer via the second plurality of connections comprising the two lateral connection pairs.

The method recited above, wherein detecting time dependent correlations of activity states relating to the transmitter and receiver nodes in the second layer via messenger connections of the combination of the two lateral connection pairs; and influencing a positive accumulator variable and a negative accumulator variable in the receiver node in the at least one layer via the first and second unidirectional influencer connections of the combination of the two lateral connection pairs, respectively, based at least in part on the detected time dependent correlations of activity states.

The method recited above, wherein influencing the positive accumulator variable and the negative accumulator variable in the receiver node in the second layer comprises modulating the variables in proportion to weight values of the first and second unidirectional influencer connections, respectively, and after a time equal to a transmission time delay of influence of the first and second unidirectional influencer connections, respectively.

The method recited above, wherein the transmission time delay of influence of the first and the second unidirectional influencer connections increases and decreases in proportion to the weight values of the first unidirectional influencer connection.

The method recited above, wherein incrementing the positive accumulator variable and the negative accumulator variable by the first and the second unidirectional influencer connection, respectively, comprises incrementing according to a linear growth function.

The method recited above, wherein the positive accumulator variable and the negative accumulator variable are decremented by the first and the second unidirectional influencer connections, respectively, wherein the decrementing is according to a linear decay function.

The method recited above, further comprising dividing a total magnitude of signals stored in the positive accumulator variable by a total magnitude of signals stored in the negative accumulator variable in the receiver node in the second layer, subtracting a value from a result of the division, and storing a result in the quotient variable of the receiver node in the second layer.

In still another example embodiment, a method of processing input signals with the artificial neural network architecture recited above is provided wherein:
the third plurality of transmitter nodes and the third plurality of receiver nodes are used in the second and third layers respectively; and
a combination of connection pairs are provided to connect the pluralities of transmitter and receiver nodes, the combination of connection pairs comprising first and second unidirectional influencer connections of the second two feedforward connection pairs;
the method further comprising connecting the combination of connection pairs between a transmitter node and a receiver node in the at least one layer;
in the event of activation of a sub cell comprising of the third pluralities of transmitter nodes in the second layer within a network training phase, eliciting the activation of a selective node from the third plurality of receiver nodes in the third layer selected based on training class label, while simultaneously eliciting the activation of the parallel corresponding selective node from the third plurality of transmitter nodes which belong to the active sub cell in each selective cell in the second layer; and
in the event of activation of the third pluralities of transmitter nodes within a network validation phase in the second layer, waiting the termination of a preset time delay interval followed by eliciting the activation and inactivation of the third plurality of receiver nodes in the third layer via the second two feedforward connection pairs.

The method recited above, wherein detecting time dependent correlations of activity states relating to the transmitter node in the second layer and its corresponding parallel receiver node in the third layer via messenger connections of the second two feedforward connection pairs; and influencing a positive accumulator variable and a negative accumulator variable in the receiver node in the third layer via the first and second unidirectional influencer connections of the combination of the second two feedforward connection pairs, respectively, based at least in part on the detected time dependent correlations of activity states.

The method recited above, wherein influencing the positive accumulator variable and the negative accumulator variable in the receiver node in the third layer comprises modulating the variables in proportion to weight values of the first and second unidirectional influencer connections, respectively, and after a time equal to a transmission time delay of influence of the first and second unidirectional influencer connections, respectively.

The method recited above, wherein incrementing the positive accumulator variable and the negative accumulator variable by the first and the second unidirectional influencer connection, respectively, comprises incrementing according to a linear growth function.

The method recited above, wherein the positive accumulator variable and the negative accumulator variable are decremented by the first and the second unidirectional influencer connections, respectively, wherein the decrementing is according to a linear decay function.

The method recited above, further comprising subtracting a value in the negative accumulator variable from a value in the positive accumulator variable of the receiver node in the third layer and storing a result of the subtraction in the weighted sum variable of the receiver node in the third layer.

The method recited above, further comprising incrementing the value of the counter variable for every time the third plurality of transmitter nodes were active during the network training phase, selecting a sub set plurality of nodes from each sub cell based on the counter variable values at the end of the network training phase, allowing the selected sub set to have strong activation and inactivation influence over the third plurality of receiver nodes via the second two feedforward connection pairs at the network validation phase, preventing the unselected sub set from having strong activation and inactivation influence over the third plurality of receiver nodes via the second two feedforward connection pairs at the network validation phase.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also comprising more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily comprising at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Any patent applications, patents, and printed publications cited herein are incorporated herein by reference in their entireties, except for any definitions, subject matter disclaimers or disavowels, and except to the extent that the incorporated material is inconsistent with the express disclosure herein, in which case the language in this disclosure controls.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. An artificial neural network architecture, comprising:
a first layer comprising a receptive layer dissected into a predefined amount of spatial (regions) kernels, each spatial kernel encompassing a predefined amount of receptive cells, each receptive cell comprising a predefined amount of receptive nodes;
a second layer comprising a selective layer that is dissected into a plurality of selective cells, each selective cell comprising a predefined amount of sub cells each sub cell comprising a predefined amount of selective nodes and a dual state variable;
a third layer comprising an output layer composed of a plurality of selective nodes each selective node represents one training data class label and has a parallel corresponding node in every sub cell in the second layer, wherein the receptive layer is configured to transmit information to the selective layer and the selective layer is configured to transmit information to the output layer, and wherein at least one selective cell of the plurality of selective cells of the second layer encompasses a pre-allocated size of a receptive field that represents boundaries of a spatial (region) kernel of the receptive layer;
a first plurality of transmitter nodes comprising the plurality of receptive nodes in each receptive cell from the first layer and a first plurality of receiver nodes comprising the plurality of selective nodes in each selective cell from the second layer arranged within the first and second layers respectively, each transmitter node and each receiver node of the first pluralities of transmitter and receiver nodes comprising a first activity state variable, a first positive accumulator variable, a first negative accumulator variable, a weighted sum variable and a counter variable;
a second plurality of transmitter nodes comprising the plurality of selective nodes in each selective cell from the second layer and a second plurality of receiver nodes comprising the plurality of selective nodes in each selective cell from the second layer except that which include the second plurality of transmitter nodes arranged within the second layer of the pair of layers, each transmitter node and each receiver node of the second pluralities of transmitter and receiver nodes comprising a second activity state variable, a second positive accumulator variable, a second negative accumulator variable, a quotient variable and a counter variable;
a third plurality of transmitter nodes comprising the plurality of selective nodes in each selective cell from the selective layer and a third plurality of receiver nodes comprising the plurality of selective nodes in the third output layer arranged within the second and third layers respectively, each transmitter node and each receiver node of the third pluralities of transmitter and receiver nodes comprising an activity state variable, a positive accumulator variable, a negative accumulator variable, a weighted sum variable and a quotient variable;
a combination of a first two feedforward connection pairs arranged to connect a transmitter node in the first plurality of transmitter nodes and a receiver node in the first plurality of receiver nodes, the feedforward connection pairs comprising unidirectional influencer connections and messenger connections;
a combination of two lateral connection pairs arranged to connect a transmitter node in the second plurality of transmitter nodes and a receiver node in the second plurality of receiver nodes, the lateral connection pairs comprising unidirectional influencer connections and messenger connections;
a combination of a second two feedforward connection pairs arranged to connect a transmitter node in the third plurality of transmitter nodes and only the corresponding parallel receiver node in the third plurality of receiver nodes, the feedforward connection pairs comprising unidirectional influencer connections and messenger connections;
a combination of single lateral connection pair arranged to connect a transmitter node in the second plurality of transmitter nodes and a receiver node in the same second plurality of transmitter nodes, the lateral connection pair comprising unidirectional influencer connection and messenger connection;
wherein the unidirectional influencer connections of the first two feedforward connection pairs are configured to increment the first positive accumulator variable and the first negative accumulator variable of the first plurality receiver nodes, respectively, at least partially based on a weight value of the connections, where the weight variables are modulated according to a first time dependent correlation of activity states detected by a messenger connection of the feedforward connection pairs;
wherein the unidirectional influencer connections of the two lateral connection pairs are configured to modulate the second positive accumulator variable and the second negative accumulator variable, respectively, of the second plurality receiver nodes at least partially based on a weight value of the connections, where the weight variables are modulated according to a second time dependent correlation of activity states detected by the messenger connections of the lateral connection pairs;
wherein the unidirectional influencer connections of the second two feedforward connection pairs are configured to increment the first positive accumulator variable or the first negative accumulator variable of the third plurality of transmitter and receiver nodes at least partially based on a weight value of the connection, where the weight variables are modulated according to a second time dependent correlation of activity states detected by a messenger connection of the second two feedforward connection pair; and
wherein the unidirectional influencer connections of the single lateral connection pair are configured to modulate the first negative accumulator variable, of the same second plurality of transmitter nodes based on a pre set weight value of the connection.

2. An artificial neural network architecture, comprising:
a first layer comprising a receptive layer encompassing a predefined amount of receptive cells, each receptive cell comprising a predefined amount of receptive nodes;
a second layer comprising a selective layer that is dissected into a plurality of selective cells, each selective cell comprising a predefined amount of sub cells each sub cell comprising a predefined amount of selective nodes and a dual state variable;
a third layer comprising an output layer composed of a plurality of selective nodes each selective node represents one training data class label and has a parallel corresponding node in every sub cell in the second layer, wherein the receptive layer is configured to transmit information to the selective layer and the selective layer is configured to transmit information to the output layer;
a first plurality of transmitter nodes comprising the plurality of receptive nodes in each receptive cell from the first layer and a first plurality of receiver nodes comprising the plurality of selective nodes in each selective cell from the second layer arranged within the first and second layers respectively, each transmitter node and each receiver node of the first pluralities of transmitter and receiver nodes comprising a first activity state variable, a first positive accumulator variable, a first negative accumulator variable, a weighted sum variable and a counter variable;
a second plurality of transmitter nodes comprising the plurality of selective nodes in each selective cell from the second layer and a second plurality of receiver nodes comprising the plurality of selective nodes in each selective cell from the second layer except that which include the second plurality of transmitter nodes arranged within the second layer of the pair of layers, each transmitter node and each receiver node of the second pluralities of transmitter and receiver nodes comprising a second activity state variable, a second positive accumulator variable, a second negative accumulator variable, a quotient variable and a counter variable;
a third plurality of transmitter nodes comprising the plurality of selective nodes in each selective cell from the selective layer and a third plurality of receiver nodes comprising the plurality of selective nodes in the third output layer arranged within the second and third layers respectively, each transmitter node and each receiver node of the third pluralities of transmitter and receiver nodes comprising an activity state variable, a positive accumulator variable, a negative accumulator variable, a weighted sum variable and a quotient variable;
a first plurality of connections each comprising a combination of a first two feedforward connection pairs arranged to connect a transmitter node in the first plurality of transmitter nodes and a receiver node in the first plurality of receiver nodes, the feedforward connection pairs comprising unidirectional influencer connections and messenger connections;
a second plurality of connections each comprising a combination of two lateral connection pairs arranged to connect a transmitter node in the second plurality of transmitter nodes and a receiver node in the second plurality of receiver nodes, the lateral connection pairs comprising unidirectional influencer connections and messenger connections;
a combination of a second two feedforward connection pairs arranged to connect a transmitter node in the third plurality of transmitter nodes and only the corresponding parallel receiver node in the third plurality of receiver nodes, the feedforward connection pairs comprising unidirectional influencer connections and messenger connections;
a combination of single lateral connection pair arranged to connect a transmitter node in the second plurality of transmitter nodes and a receiver node in the same second plurality of transmitter nodes, the lateral connection pair comprising unidirectional influencer connection and messenger connection;
wherein the unidirectional influencer connections of the first two feedforward connection pairs are configured to increment the first positive accumulator variable and the first negative accumulator variable of the first plurality receiver nodes respectively at least partially based on a weight value of the connections, where the weight variables are modulated according to a first time dependent correlation of activity states detected by a messenger connection of the feedforward connection pairs;
wherein the unidirectional influencer connections of the two lateral connection pairs are configured to modulate the second positive accumulator variable and the second negative accumulator variable, respectively, of the second plurality receiver nodes at least partially based on a weight value of the connections, where the weight variables are modulated according to a second time dependent correlation of activity states detected by the messenger connections of the lateral connection pairs;
wherein the unidirectional influencer connections of the second two feedforward connection pairs are configured to increment the first positive accumulator variable or the first negative accumulator variable of the third plurality of transmitter and receiver nodes at least partially based on a weight value of the connection, where the weight variables are modulated according to a second time dependent correlation of activity states detected by a messenger connection of the second two feedforward connection pair, and
wherein the unidirectional influencer connections of the single lateral connection pair are configured to modulate the first negative accumulator variable, of the same second plurality of transmitter nodes based on a pre set weight value of the connection.
